(19) United States
(12) Patent Application Publication
(10) Pub. No.: US 2011/0040486 A1
(43) Pub. Date: Feb. 17, 2011

(54) Method for standardization of chemical and therapeutic values of foods and medicines using animated chromatographic fingerprinting

(76) Inventors: Vijaya Kumar Dadala, Hyderabad (IN); Kondapuram Vijaya Raghavan, Delhi (IN)

Correspondence Address: PILLSBURY WINTHROP SHAW PITTMAN, LLP, P.O. BOX 10500, MCLEAN, VA, 22102, US

(21) Appl. No.: 12/656,106

(22) Filed: Jan. 15, 2010

Related U.S. Application Data
(63) Continuation of application No. 10/587,904, filed on Jun. 11, 2007, now abandoned.

(30) Foreign Application Priority Data
Jan. 28, 2004 (IN) 137/DEL/2004

(51) Int. Cl. G06F 19/00; G01N 30/00

(52) U.S. Cl. 702/19; 702/30

(57) ABSTRACT

The present invention provides a method of standardization of chemical and therapeutic properties and quality of foods and medicines. The present invention provides a method of chromatographic finger printing facilitating correlation of traditional methods used for chemical and therapeutic standardization of medicines and humors in the living things with physico chemical properties of the medicines and their constituents. The method is used for the qualitative and quantitative analysis of the energy involved in the medicines and living things and to understand various bio chemical reactions in living things using an energy system. It provides a rational basis to understand the traditional methods of assessment of chemical and therapeutic qualities of materials used for the said purpose. The present invention also provides the influence, of factors like pH, temperature, viscosity and ionic nature of the media along with atomic and molecular properties indicating the chemical and therapeutic values of the foods and medicines of natural and synthetic nature. The analysis of biological samples like blood indicated the utility of the method for the assessment of clinical pathological conditions of healthy and diseased. This facilitates for a better drug discovery, drug monitoring, drug targeting and drug profiling using different features of 3-D animated energy box created after analyzing the sample by different analysis, separation and detection methods.

### FIELD OF INVENTION

The present invention relates to a novel method of assessment of, chemical and therapeutic properties of foods and traditional medicines using chromatographic finger printing useful for chemical and therapeutic standardization. More particularly the present invention relates to organic, organo-metallic, metallic and metallo complex molecules which have absorptive or emission property of electromagnetic radiation presented in the form of Contour and 3-D stable and motion graphics present in natural or man made foods or medicines used as a single or formulated materials, for chemical and therapeutic standardization. The analysis of biological samples like blood indicated the utility of the method for the assessment of clinical pathological conditions of healthy and diseased.

The present invention is a novel method of the development and utilization of the Contour and 3-D chromatograms of a herbal medicine and formulation developed under standardized experimental (chemical and instrumental) conditions which is proposed as a novel method of chromatographic finger printing for medicines to achieve the chemical and therapeutic standardization. When the molecular weight, refractive index, emission and absorbance properties of electromagnetic radiation of different energies by the analyte samples and the polarity are measured at specific temperature, pH, Viscosity, ionic nature of the media and volatility using suitable detectors, the properties of the analyte molecule will be known which in turn explains the energy of the analyte and its relation with a specific efficacy. When the molecular weight of the molecule having specific polarity and structure is analyzed with its absorption and emission properties of any electromagnetic radiation, under varying physical properties like its mass, temperature, volatility and viscosity, ionic media the chemical and therapeutic properties are assessed qualitatively and quantitatively leading to the assessment of their efficacy.

When the data graphics developed under different conditions as mentioned at regular time intervals are converted into an animated movie data graph movie movable on all axis between 0-360 degrees, it facilitates to understand and standardize behavior properties of the analyte at different at different times under different conditions. Rotating the movie of the datagragh will provide more accurate and holistic interpretation of the analysis.

### BACKGROUND AND PRIOR ART REFERENCES

In the world many foods and drugs are used as a part of life for dietary, nutritional and therapeutic purposes. In India the traditional customs and social activities include, use of Ayurveda, Siddha and other Traditional Indian system of medicines to maintain the general health of people. In countries where, traditional philosophies were practiced most of the day-to-day activities will be included with some kind of traditional customs. Being the most intelligent animal, man might not have made any thing mandatory for the next generations with out any purpose. Being responsible and affectionate to the next generations to keep them healthy and happy he might have proposed some discipline in the life style. But this will be understood only by the generations who created it. Due to his personality man had also mis-used, mis-interpreted and misguided the next generations for his own benefits regarding some of these traditions in due course of time. Thus some of such traditions might have made the human life miserable. Reaching a status of universalization the present scientific community should create awareness about the excellence of the traditions and medicines and revalidate if required and bring a better living atmosphere for the future generations. It is moral and ethical responsibility of the mankind to do so. By doing so man will not go backward, but gain the knowledge which has already been created and established.

In almost all world traditional medicines the basic physicochemical properties of the medicines were used to understand the chemical and therapeutic quality and efficacy of the medicines. Similarly the physicochemical parameters of the human body (Dhatu) and its various parts were well correlated by similar properties (Dosha) of the medicines. Thus a disease was identified and a suitable medicine having the properties was selected.

The basic parameters like Tridoshas (Pitta, Kapha and Vata) used in traditional medicine are understood to be categorized based on chemical properties of the material and the same was proved by the method we reported earlier (PCT/1N00/000123). When the same property, dosha is deficient, sufficient or excess to body to weight ratio, it is called dosha (defect). The optimum (energy in the body) amount of property (Pitta, Kapha and Vata) is considered to be healthy, more or less than normal are considered to be doshas (defects) imbalanced conditions of tridoshas leads to diseases manifestation. In the present invention we report improved and new features of the method to assess the efficacy of foods and drugs used in the day-to-day life, which are helpful for accurate analysis and also to assess the clinical pathological properties of biological materials like blood.

The evidences of a well-organized system of medicine in India were traced in Harappa and Mohanzadaro (History of Medicine in India, Dr Priya Vrit Sharma). In the Indus valley civilization, a system of medicine has prevailed, in which drugs of vegetable, animal and mineral origin were used. The OSADHISUKTA of the Rigveda is the oldest document of the knowledge about plants and herbal medicines. Medicine in India owes much to the traditional knowledge of Atharvaveda of which Ayurveda is said to be a upaveda. A large number of disease-syndrome relationships were defined and described by Charaka and Susruta in their medical treatises ‘The Samhitas’. The treatment was also prescribed in a systematic manner and on rational basis.

On the other hand, it was realized that the biological phenomena couldn't be universally explained by mechanical means as each individual varies in his basic constitution i.e., Prakruthi that must be kept in mind while prescribing diet or drug to the patient. The BINARY concept like Prakriti-Purusha (in Ayurveda), Yin-Yang (in Chinese medicine), Normal-Abnormal was seen in almost all philosophies.

After going through the ancient literature it was found that the medicines were standardized using their physico-chemical properties of the materials. The color, texture, odor and taste were used as a measure of the efficacy of any medicine. When the medicines were analyzed using the method of Chromatographic Fingerprinting many generalizations and correlations were observed to be matching with traditional methods of drug standardization and therapeutic utility. They were explained with examples in the later pages of the present document.

The ancient man after many years of evolution tried to understand the nature. He started using the naturally available flora and fauna for his daily needs, in which he used the geological, plant and animal material for his dietary and health needs. Many a time some of the foods and drugs found to be beneficial for health, he made it mandatory to be used for the next generations to use under the name of TRADITIONS in day to day life and in many cultural and social activities to pass on the benefits of the medicine enjoyed by them to the later generations.

Many a time the present generations follow the health and social rules and regulations as suggested by their elders under the name of customs/traditions. No food or drug will be used/administered with out any merit in it because improvement of mind and health is a continuous process. Even though generations, who developed these customs might only be able to understand the real science of these traditions the generations who could not under stand may not be able to understand them (Traditions). The benefit and value of these customs will be enjoyed and accepted by the later generations, when they are well understood, practiced, rationally studied and explained scientifically. Otherwise the traditions become mere rituals with out serving any purpose.

It cannot be ruled out that some misinterpretations and misconceptions might have been added in due course of time. They could be removed by studying the same with rational and scientific methods and confirm and understand the real science behind in the traditional philosophies.

Many dietary habits were explained in the Dinacharya (Daily Activity/habits) and Ruthucharya (Seasonal Activity/habits) (Ritucharya, K. M. Shyam Sunder and Balasubrhmanyam, Center for Knowledge Systems, Chennai, India) to prevent formation of diseased status of the human being. Thus traditional philosophies have many preventive methods along with curative methods in traditional philosophies while dealing with human health. Because it is known that a large human population in the world cannot be maintained with curative medicines. It is thus prescribed, “Prevention is better than Cure”.

The major draw back appears to be is lack of understanding about the scientific basis of the traditional concepts used for establishing the relation of the properties of the medicines with different diseases of the human being and even animals. If this can be rationally answered most of the drug discovery problems could be solved. Another very important method practiced in traditional philosophies, which was not understandable for the modem generations, was the basis of the individualist nature of the human being and diseases for selection of suitable medicines taking both in to consideration. Thus if we can understand the chemistry behind the traditional concepts/parameters used for diagnosis and to know the efficacy of the medicines and correlate their physico chemical properties, the drug standardization, drug designing, drug monitoring and drug targeting along with disease identification become easy and understandable. In Indian traditional philosophies the concept of PRAKRITHI explains how the constitution of a human body varies from person to person, time to time, age to age and place to place. Analysis of blood samples of persons of different prakrithi show that the prakrithi concept has a basis of chemistry as understood in medicines. Figures of blood samples shown in the later part of the present document show how the concept of Prakrithi is related to Physico chemical properties of the biological substances.

The modern pharmacopoel methods being practiced for the evaluation of traditional medicines were not established based on the basic principles of traditional medicines. Hence a method of analysis to analyze the medicines with out deviating from the basic concepts is proposed. The selection, application and treatment using traditional medicines has a specific philosophical guidelines. Hence the method of standardization should also have the same basis. The present pharmacopoel methods do not have this correlation. Two different protocols should not be used for the same purpose.

In modern science, the chemical and therapeutic properties were understood by studying the constituent molecules present in drugs and foods, which can be broadly, classified in to three categories the High Polar, Medium Polar and the Non-Polar molecules like a band spectrum which will have ability to respond to different electromagnetic radiations. The total polarity of the molecule depends on the total Electrophlic and Nucleophilic moieties attached to the molecule along with the unsaturation of the molecules by their conjugation. These molecules will change their properties under different conditions like temperature, pH, pressure, viscosity and polarity of constituents and ionic or non-ionic media in which they are present. The living human body, animal body and plants will also contain the same type of molecules where in different polar molecules will carry out different functions. Diseases were cured using the medicines of same polarity as that of the disease causing chemical constituents, i.e the molecules which can create the disorder when present abnormally high or low amounts can cure the same disorder, as said Similia Similus Curator by Dr Heinemann.

### Existing Methods of Drug Standardization:

We have reported a novel method of standardization using chromatographic fingerprinting (PCT/IN00/00123) for standardization of medicines. Before explaining the proposed method of standardization, the existing methods of standardization (Chemical & therapeutic) and chromatographic finger printing are discussed below. More detailed studies were incorporated in the present method. Table 1 shows different types of standardization methods used in traditional and modern medical philosophies. There is a correlation between the chemical standardization with the therapeutic standardization in traditional methods. The traditional practitioner can assess the efficacy of the medicine using traditional methods. Where as modem method does not have these correlations. If one can correlate, then the drug discovery become accurate and less complicated.

### A. Prior Art on Chemical Standardization:

### i) Traditional:

The great sage CHARAXA explained in his CHARAKA SAMHITA “The understanding of the totality of an entity does not arise from a fragmentary knowledge of it”. (CHARAKA SAMHITA Vi. 4.5). This makes it clear that standardization and therapeutic efficacy of any medicine in which all the constituents present in, are not taken into consideration is futile. This indicates that the efficacy of the medicines is due to the totality of the constituents but will not be due to any single constituent. Thus when a molecule is separated from a mixture of constituents it loses the required original efficacy.

Traditional herbalists used to select a medicine based on the organoleptic methods available at that time like color, texture, smell and taste by which they used to assess the chemical and therapeutic efficacy of a medicine. The similar properties were used to diagnose the disease and in a patient to select suitable medicine. They were selecting suitable medicines useful for the specific individual. These methods involve intrinsic knowledge and understanding of the inter and intra therapeutic interactions of the medicines and body constituents to cure diseases. This knowledge varies from individual to individual and depends on the individual skill and ability of the practitioner or philosopher. Practically it will be difficult to provide a rational basis and understanding in terms of modem chemical terms for any mechanism to explain, using personified methods. Hence modem science uses instruments for various purposes, which eliminates the individual factors and facilitates reproducibility in data and information. Most of the times it is the energy of the disease and medicine dealt with for curing the disease. Thus measuring the energy help to over come this problem. Hence to understand the therapeutic efficacy of a medicine or food, one needs to understand their physical and chemical properties. The basic properties classified were 1. Taste (Rasa), 2. Quality (Guna) 3. Potency (Virya) 4. Post assimilative status and effect of the constituents (Vipaka) and 5. Special action (Prabhava, medicines with same chemical properties but different therapeutic efficacies). The properties of these parameters are found to be related to their physico chemical properties measurable in the form of chemical properties:

It is these three factors namely, the Doshas (Disorders), the Dhatus (biological compounds) and the Malas (excreta) that are mainly dealt for curing a disease or a disorder. If the above-mentioned properties of the medicines tally with the dosha, it will be vitiated or balanced, thus the disease is cured.

In traditional philosophies Dosha is a term used generally to describe the status of a property when it is healthy or diseased. When the same property is present in a changed, imbalanced form, then also it is said to be Dosha (Deranged).

The selection and use of drugs according to Ayurvedic basic principles vary from one situation to another according to doshic predominance of the patient. In other words there is a relation between the medicinal properties (Dravya Gunas) and disorders (doshas). Addition or deletion of one or more drugs may be necessitated to treat an identical disease in the patients with different personalities. Hence, Ayurvedic pharmacotherapy is more individualistic according to dosha predominance of the patient and not generalized as in the case of modern medicine. Identification of Tridoshas properties (Rasa, Guna, Veerya, Vipaka and Prabhava) compatible to disorders (doshas) is unique and more reliable in Ayurvedic Pharmacotherapy. In the traditional philosophy of India about 41 properties (Gunas) were explained which will help to understand the efficacy of the medicines on the diseased conditions. Table 2-4, Shadrasa Nighantu show the classification of different medicines are classified in to different groups based on taste. The selection of the most suitable medicine for a specific taste and efficacy was done from any of the plants available. These tables show groups of herbal medicines classified in to groups based on chemical properties like taste with indicated therapeutic efficacy.

Charaka the traditional philosopher has classified a set of 10 medicines for a specific property of the efficacy. Dashaimani was observed to be a classification of medicines based on the therapeutic property: The Table 5 of Charakas Maha Kashaya Dashaimani shows how different medicines of different botanical classes were grouped for a specific therapeutic purpose. When the Chromatographic Fingerprints of medicines of one group were studied, it was observed that the classification was based on the chemical constituents having a specific physico chemical property like polarity and conjugative property and ability to respond for specific electromagnetic radiations. Table 6 shows some of the traditionally classified medicines (Ganoushadha varga) based on their different properties having commonality in efficacy many of them were used as traditional preparations in the Indian families.

In traditional medicines one of the basic parameters used for chemical and therapeutic standardization is ‘Taste’. The interpretation of taste against efficacy depends on the health of the individual. The taste felt by an individual will depend on the health of the individual. For example when a medicine having Bitter (Tikta Rasa) and Pungent taste (Katu Rasa) is consumed by an individual, based on the polarity of the taste molecule and the polarity of the taste receptor, the respective message will be sent to brain after which the individual will express his observation. If the person is Pitta in nature and the medicine is bitter and pungent by taste, he will express that the Pungent is primary and the bitter is secondary by taste. If the same medicine is consumed by a Vata personality he will express Bitterness as primary taste and pungent as secondary. This indicates that the interaction between the taste receptor in the first case is more for pungent molecule and the respective taste receptor. In the second case it will be more for bitter molecule and the respective taste receptor. The taste receptor polarity in each of the individual is not same, hence the difference is observed. The response of the person will depend upon his health as on that moment which will change due to different factors. This method is generally used in traditional philosophies to identify the Prakrithi (Personality) of the patient as on that moment, for a better selection of the suitable medicine. Using present method of Chromatographic Fingerprinting the chemical properties of the molecule of a specific taste are studied and established the relation of taste with therapeutic efficacy of a medicine.

When large number of medicines single or formulations were analyzed it was observed that all the basic concepts in most of the traditional medicines were found to have a sound basis of chemistry. There will be variation in the properties of these doshas in medicines, man and animals. Thus there may not be a similar report of a specific taste by two different individuals for a medicine with a specific set of chemical constituents giving specific taste. This leads to opinion difference from person to person. Traditionally when herbal medicines are assessed for a specific taste and also for the main and subsidiary tastes. The main taste is the one, which is felt immediately after consumption. Subsidiary is the one, which is felt later. This is called Pradhana Rasa (First taste sensed/observed by an individual) and Anu Rasa (Secondary taste sensed/observed by an individual) concept. Due to this reason the personified tests like assessment taste is considered as irrational due to its non reproducibility of the same response in any place and by any person at any time.

### The Dosha Bhedas

The Doshas (Properties) in human body and medicines were understood to be present at various levels and physicians use to select a medicine suitable for a specific disease with specific property. The different combinations of the properties of Tri Doshas are explained using the above combinations.

Different permutations and combinations of the Tri doshas leading to different patterns of the human being was explained in terms of DOSHA BHEDAS as shown in Tables 7. The energy absorbed or emitted by a sample at different conditions of temperature or pH when presented in one data will be able to explain the property of the sample under test, whether medicine or blood.

In traditional medicines the Tridoshas are categorized in to 63 states where in the Tridoshas (three energies) will be present in different permutations and combination of them. If one of the energy is deficient than optimum it is called Tara (Deficient) and if it is excessive it is called Tama (Excessive) and if it is sufficient it is called Sama (Equivalent). Three energies will be varying in their quantitative level based on the influencing factors like genetic, ecological and geological conditions, temperature, pH, Viscosity and humidity etc, One, two or three of these energies will be varying in a system leading to different states of energies. Ultimately the medicines should bring a Sama, the equilibrium status of the energy of all three doshas having the energies at required levels. These energies will be present in microorganism to Universe. The ideal combination will be Sama dosha (required levels) of all three energies.

### a). Modern Chemical Standardization

The therapeutic activity of any food or drug will depend upon its physical and chemical properties. It also depends on the physico chemical properties of the diseased human being or animal, which consumes the food or medicine. This response may vary from individual to individual. This needs to be understood. Thus understanding the chemical constituents using their physico-chemical properties of medicines will help to understand the therapeutic activity of the medicine.

Traditionally, the properties of the medicines and disease patterns, in suffering and healthy humans were expressed in the traditional language, which is not understandable to the modern generations.

The physico chemical properties of the medicines play a major role on the therapeutic activity of the medicine. In modem science these properties of molecules can be understood and studied using many chemical parameters like, the molecular weight of analytes, polarity and conjugative properties leading to understand the energy system existing in the body and in medicines. Polarity is a resultant electrochemical property due to different electron donating (nucleophilic) and electron-accepting (electrophilic) moieties attached to the molecules along with the unsaturated double and triple bonds present in it influenced by an ionic or non-ionic media in which it exists. They will influence the rate of activity or reactivity of a molecule in chemical and biochemical reactions.

The second parameter that influences the activity of the molecule is the spatial arrangement of atoms leading to an asymmetric energy system in a molecule, which can create activity when it is present in a living system. Due to this reason the isomeric (Geometrical and optical isomers) molecules play an important role in the biological activity in the body where in, a large number of bio chemical pathways will be working simultaneously with out cross interactions and interference's. Hence the chemistry of CHIRAL DRUGS has become very important. Ultimately it is the total energy present in the molecule, which makes it therapeutically active. The molecular energy will depend on the energies of the atoms of the molecules, its geometry and the energy it can absorb and/or emit.

The total chemical profile compatible to the human body will be taken into consideration for standardization of therapeutic efficacy of the medicine. Hence in the present computer-based instrumental method, the total properties of all the constituents at different conditions are taken into consideration. The Chromatographic Fingerprints of the medicines were proposed as a visual tool and proof for many purposes of standardization of medicines. Before discussing the proposed method the existing methods of standardization are given below.

### Existing Analytical Methods of Chemical Standardization:

Even though there are traditional methods for standardization of medicines, they are considered as irrational as they depend on the personal skills of the individual and his health and were not explained in the atomic and molecular terminology.

None of the existing methods of chemical analysis were able to correlate the physico chemical properties like taste, texture, odour and color as used traditionally to assess efficacy of the medicine. Traditional practitioners are able to assess the efficacy of the medicines based on such simple type of tests and select the medicine, which is therapeutically efficacious.

Most of the pharmaceutical analysis was done as reported in the official methods and pharmacopoeias. The chromatographic method involves a chromatogram with the peaks due to absorbance or emission of radiation at, specific wavelength by molecules eluted by a mobile phase on a separation column and the eluents detected by any suitable detectors for detection. But when there are molecules present in the analyte samples having absorbance maxima at different wavelength values from 200-800 nm or more, they cannot be detected. Thus the existing method is found to be not suitable for the analysis of herbal medicines. Also even after such analysis at single wavelength, there is no correlation between the analytical data and its efficacy in traditional terms. Where as the traditional chemical assessment like taste is indicating the efficacy of medicines. This art of assessment has been incorporated in the basic concepts of traditional philosophies by correlating the chemical properties with their therapeutic efficacy. The protocol used for drug selection and quality control should be same in any philosophy. The existing methods of standardization do not interpret the analytical data in traditional terms. The present method is proposed for this purpose. If the meaning of the traditional parameters could be explained in terms of the chemical properties, similar correlation could be achieved.

Usually the chromatographic analysis is done using a reference standard (Internal or External). With out a standard reference material, the analysis has no meaning because the PEAK of the chromatogram does not provide any kind of chemical properties of the compound eluted. Hence, the confirmation of the Qualitative and Quantitative properties (Spectral or Chemical) of the components with relation to their efficacy is unclear.

In the qualitative and quantitative analysis of medicines/drugs (Single or Formulation), the emphasis is given mainly on the spectral and chemical properties of the components eluted after analyzing the sample. The analysis is done based on the interaction of Electro magnetic radiation say the Ultra Violet and Visible radiation even up to Near Infrared radiation on the analytes and their response to it. In the existing method of chromatography, the analytical report i.e., the chromatogram under practice is not giving any of the chemical properties like polarity and relation to the efficacy of the analyte. The chromatogram is not able to show the molecules, which does not absorb at that wavelength or have a different “Absorbance maxima” other than the set wavelength (say 225 or 254 nm). If the sample is 100% pure and if it is a known molecule, then the analysis at a fixed wavelength is acceptable, but it is highly impractical in the case of herbal medicines where in more than one molecule is present absorbing at more than one wavelength. Hence the existing method of chemical standardization was found to be not useful for the standardization of traditional medicines.

Hence any chromatogram presented at a specific wavelength is not able to provide the complete chemical profile of the ingredients present in a single medicine and a formulation. So, the chromatogram is partial in its report, and is not acceptable. Any analytical method, which is not giving complete information of the analysis, is scientifically not acceptable.

In the use of herbal medicines, the medicine as a whole is used with some standard therapeutic conditions prescribed in the ancient literature and scripts. Hence the concept of searching for an active ingredient is said to be unscientific and incomplete, because it is the total profile that is responsible for the medicinal property of the medicine. It is already mentioned (Frank R Stermirtz et al., PANS/Feb. 15, 2000/Vol 97. No 4/pp 1433-1437) that, the synergy of the other constituents present along with the major constituent is equally important because the first will not be able to do its function with out the other constituents present in the extract as explained in the beginning.

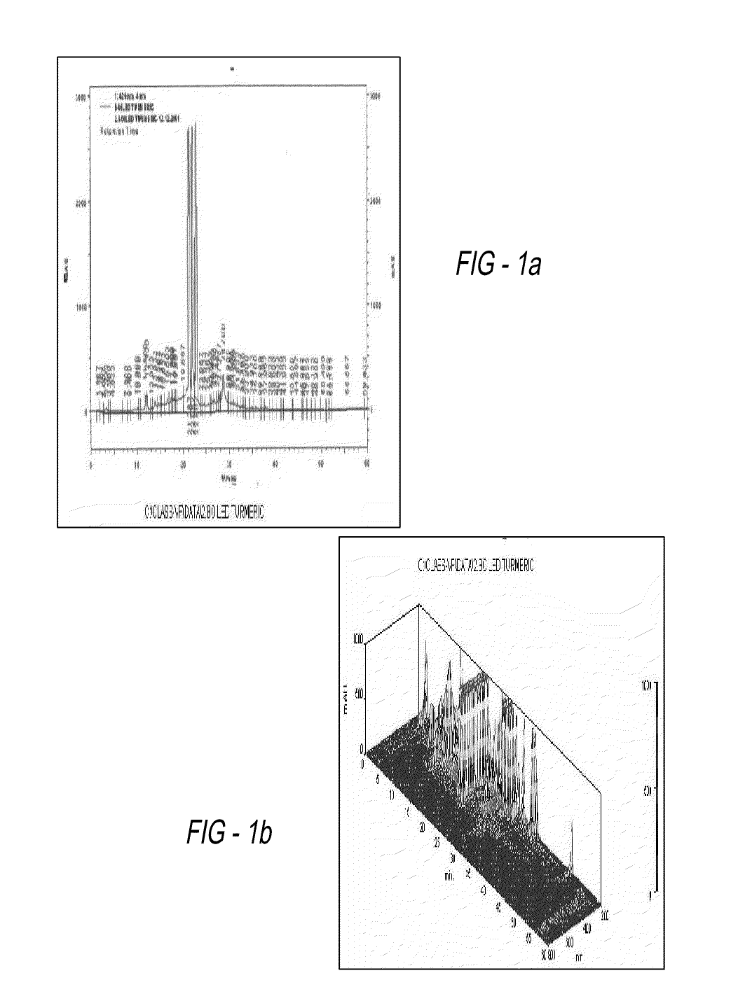

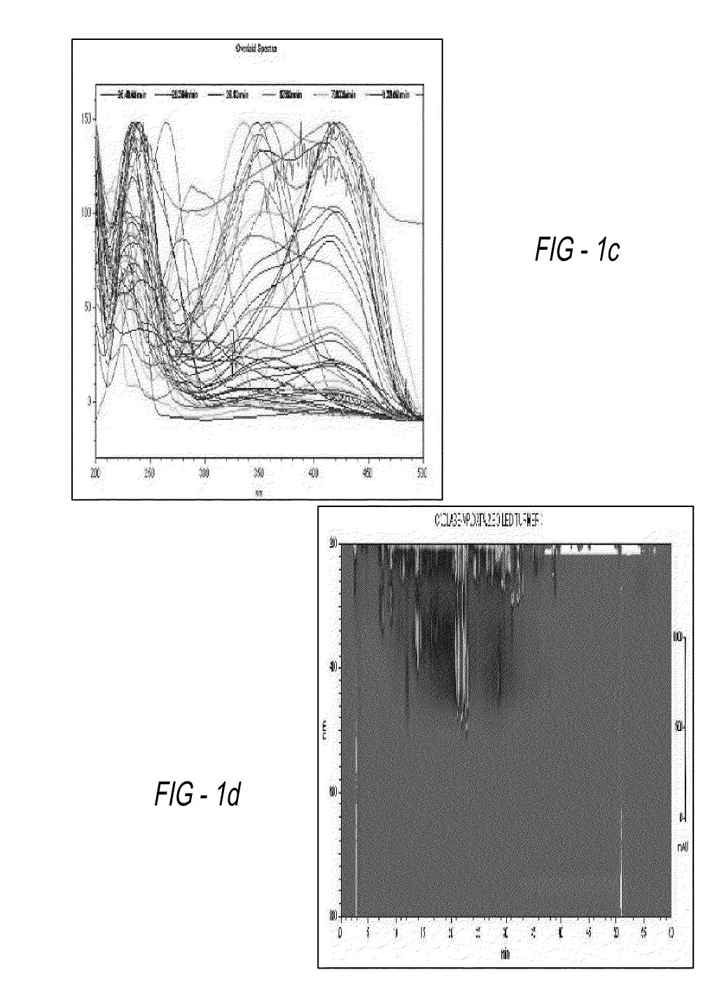

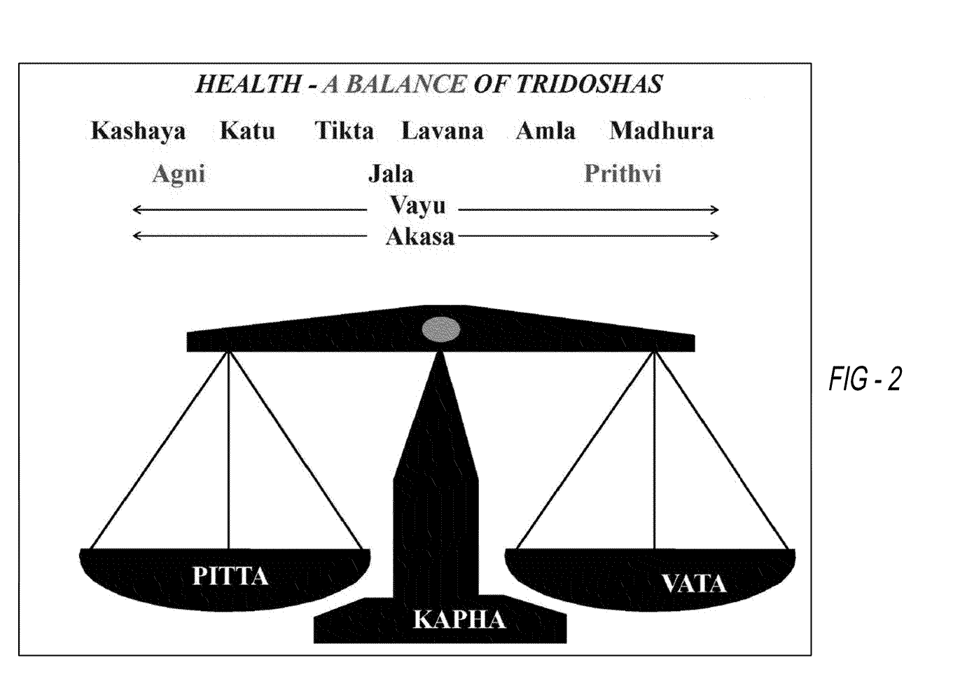

In the present method of Chromatographic Fingerprinting it is shown that in a group of molecules of medicines the property of each of the molecules, will be influenced by the others surrounding it. Thus the polarity of a molecule will vary when it is present in between a cluster of molecules having different polarities due to field effect. Even the separation pattern will change on a chromatographic column when a molecule is analyzed singly and in a mixture. FIG. 1 shows Different chromatographic features of a modem liquid chromatograph with PDA detector. FIG. 2 shows the existing method of chromatographs at different wavelengths.

### B. Prior Art on Traditional Therapeutic Standardization:

The great Indian Medical sages have understood and defined the concept of Indian medicine by clearly defining the properties, constituents and humors of the living beings. They also understood the inter and intra relations amongst them. In almost all the traditional philosophies the basic concepts include the nature and its role on the humors of the human beings. It is said that the human body is made of seven types of constituents (Saptadhatus). The normal properties (Tridoshas) are of three types. The physico chemical properties of any material in the universe are due to five elements (Pancha bhutas). The interactions of different permutation and combination of these elements will influence the health. Hence, the understanding of these properties will help to understand their physical and chemical properties and so there by, their therapeutic effficacies. The philosophers in different parts of world have also developed such concepts suitable for their science and society. In Tables 8-9 Of Rasa vs. Properties, the relation of properties and efficacy of the medicines is explained. The relation of panchabhutas and Rasas with the efficacy is also well explained in the traditional concepts of traditional medicines. Table 10 shows the relation of panchamahabhoothas and the biotransformation happening in every system of the universe. The same will happen in every part of the universe under suitable conditions. Tables 11,12 show the relation of Panchabhutas with different physicochemical properties.

In Indian traditional philosophies, herbal medicines have also been classified based on astrological parameters. The Table 13-15 of Astrological relation of plants and medicines shows the information.

### i) Traditional Method:

In ancient times (pre samhitic and pre Susrutic period in India), the physicians used NADISASTRA (Science of reading pulse) to know the status of the TRIDOSHAS (Vata, Kapha and Pitta) at the time of diagnosis to know the health status of the patient. The specific type of pulse is studied to explain the type of disorder pre-dominant in the patient (Dr P. V. Sharma, History of Medicine in India, INSA, 1992). Astastana pareeksha is one of such methods, which helps to understand the disease pattern of the patient. In traditional ayurvedic literature the morphological features of the plants were correlated with their physico chemical properties along with efficacy. Table 16 shows the same.

It is used to understand the type of dosha(s) predominant in the patient at the time of diagnosis and the respective dosha(s) to be vitiated to cure the disorder. But this art of reading NADI (Pulse) was confined to some people of high caliber, personal skill and ability with lot of discipline and experience. Hence, every traditional practitioner was not able to practice it.

The art of understanding the physico-chemical properties of the medicines and the humors of the human being was developed and standardized. The inter and intra relations of these properties with nature which influences health had been studied and standardized thus the art of pharmacology and pharmaco-therapeutics was developed by the physicians.

The therapeutic efficacy of a drug is defined as, 1) It is a substance that is capable of bringing about an (pharmacological) action in the human body (Kriyagunavat) and 2) This is due to the collective functioning of many factors, (samavayikaranam), just as a piece of cloth results because from its many component threads acting together, The role of Panchamahabhootas has been explained on which the Ayurvedic concept of physiology, pathology, pharmacology, medicine and therapeutics were founded are known as the doctrine of Panchamahabhootas. These doctrines have been expounded, among others, by the Shad-Darshanas or the six philosophical systems of India. Of these, Ayurveda has relied on some like, the Nyaya-Vaisheshika and Sankhya-Yoga Systems.

The Shad-Darshanas claim to have sought for and ascertained the ultimate causes relating to life and life process in terms of causes and effects and enunciate the laws and principles that govern them. (The Fundamental principles of Ayurveda by C. Dwarkanath).

In the world we see, there are two main types of living things, the plants and animals. It is also said that this world is made of five great elements i.e., Earth, Water, Air, Fire and Space (As said Panchabhutas in Ayurveda). The basic properties of these materials are of two types, Strong—Powerful and Mild—Soft. If we accede to this highly tenable logic we can say that in this world, all actions are due to different per mutational and combinational series of the above properties, giving a wide range of properties and materials varying in their intensity.

In the philosophy of most of the traditional medicines world over, the co-inherence of the nature of the five constituents is taken into consideration by which the body is made. They will help in understanding the disease or disorder of the patient. This coherence is called PRAKRITHI-PURUSHA in Ayurveda, Yin-Yang in Chinese medicine.

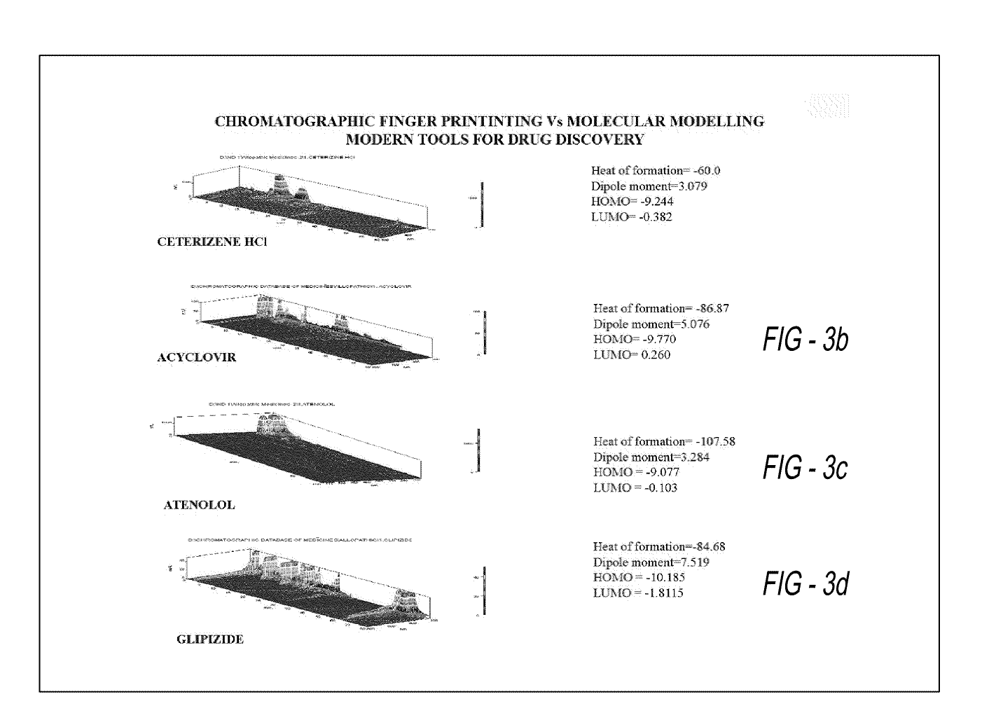

After the Panchabhoutic concept, the concept of Tridosha (Pitta, Kapha and Vata) plays a major role in the Indian traditional medicine and the seven constituents (Saptadhatus) by which the body is made up of. Thridoshas are mention to be present every part of the body and world. Table 17 shows how different diseases erupt due to the derangement of tridoshas and the root cause of the diseases. Traditionally these imbalances of tridoshas that will be looked in to, to cure any disease first. FIG. 3 shows the relation of properties, Panchabhutas with three doshas. The balancing of the doshas are dealt like a balance.

Ayurveda believes in the holistic philosophy of life and emphasis is given for the prevention of diseases rather than curing of diseases. The holistic approach of ayurveda advocates that the soul, mind and the body are the three integral parts of life and when these are in dynamic equilibrium and harmony, the state is called GOOD HEALTH (Arogya). When they are in disequilibrium and disharmony, the state is called DISEASE. (Vaishamya). According to ayurveda, the physiological features of various systems are maintained in dynamic equilibrium status by TRIDOSHAS. In other words, harmony of tridoshas bestows good health, disharmony results to disease. Hence, most of the time the tridoshas are dealt with, in curing any disease.

Chinese medicine classifies the status of the human body as YIN and YANG representing sorrow and happiness. These factors are attributed for various properties of the medicines and living beings. The maintenance of these factors is done holistically by taking the role of chemical, physiological and social factors in to consideration. Most of the time the Chinese medicine has a direct or indirect relation with various BIO ENERGY centers located in the body. The art of acupuncture uses the same. The other factors reported in other philosophies, have resemblance with Chinese medicine.

After the drug it is the disease that should be dealt with for which the selection of drug is made for. A disease is defined as “Any thing that brings a sadness and grief to this person (Purusha). They are of four types 1. The accidental (Agantavaha) 2. The body born (Sarirah) 3. The Mind born (Manasah) and 4. The natural (Swabhavikah). It is for this reason, most of the traditional concepts deal with both psychosomatic factors to cure the disease along with a disciplined and standardized method of life. Hence disease is an expression of imbalance in doshas. If the tridoshas can be analyzed the correlation of the disease and medicines could be understood.

As said above, it is mostly considered as those bodily diseases having their-source arise by the incompatibilities of the thridoshas Viz., Vata, Kapha and Pitta and blood individually or in combination with one another. But, the diseases like psychological are dealt in a different way. That is why any traditional philosophy considers all the psychosomatic factors in to consideration to deal with a disease. The individual properties of the doshas are explained as given below.

A detailed description of all the factors is given in our earlier patent for various philosophies in order to under stand more generally about different traditional medicines world over. Table 18 gives an concise description of the Indian Ayurvedic philosophy and various components in it. Tables 19-21 show how the medicines were classified based on their physico chemical properties and efficacy.

### ii) Modern Method Of Therapeutic Standardization:

The existing pharmacotherapy has not taken the above-mentioned concepts into consideration. Phytochemists are interested only in isolation, purification and structural elucidation of the active principles isolated from the plants and they passed on them to pharmacologists to study their biological activity. The pharmacologists in turn screen the molecule(s) for pharmacological activity, establish its mechanism(s) of action and substantially rate its efficacy in comparison with the existing standard drugs used in modern medicine.

This concept is in no way going to help the traditional medical practitioners since the isolation of the active principle(s) drastically change the holistic character of the medicines and their therapeutic efficacy.

Instead of assaying the solvent extraction fractions, active principles etc., obtained from the individual plants, the analysis of total extract from a medicine using a solvent compatible to the human cells and cell membranes of the body will be of much use to evaluate the pharmacological activity of such medicines.

In the modem clinical trials conducted for the therapeutic standardization they are done in three phases (four in the case of international utility), involving large number of people. The information regarding a new medicine to be submitted to Drug Controller generally consists of,

1. Chemical structure
2. Pharmacological class
3. Formulation details
4. Data on animals including data on toxicity studies
5. Data on clinical pharmacology including pharmacokinetics

### (Behavior of the Drug in the Human Body)

6. Pharmacodynamics (Actions of the drug inside the body)
7. Special studies and status of the drug in the rest of the world.
8. Data on Bio-Equivalence studies

But all the above studies are costly and time consuming. Basically they will not be taking into account of the role of the ecological factors, the genetic discipline (as practiced in the Indian family and marriage relations), the psychological, the social and other variable parameters of the patient in to consideration. This will make the effectiveness of the drug limited to a particular group or genetic type of people.

The existing modem methods of chemical and therapeutic standardization will not explain the basic concepts of traditional medicine. The success of traditional medicines is due to the strength of the basic concepts. Hence if any method can explain the efficacy of the medicines using the basic concepts it will be useful.

As said in traditional concepts the thridoshas were not taken into consideration under drug discovery including the difference of the chemical constitution of each individual. Thus it is very specific to a particular group of human beings. It is this reason it commonly fails to act on a wide range of populations.

### The Predictive Methods of Standardization for Therapeutic Efficacy:

### The Molecular Modeling:

To solve the problem of finding a lead molecule of a specific efficacy, many methods of computational chemistry are under use. It has a limitation of being able to calculate for smaller molecules only. The present hardware needs extraordinary capability to do such work on molecules of higher volumes. The parameters like Electron densities (Charges), Electrostatic potential, Dipole (and higher multiple) moments, Molecular orbitals and normal and excited state needs to be calculated. In general The Molecular Orbital Theory (MO), Density Functional theory (DFT) Valance Bond theory (VB) is under use for such calculation of energies.

Lipinskys (Advanced Drug Delivery Reviews 23 (1997) 3-25) rule of 5 says that a molecule will be poor absorptive or permeative if

### 1. There Are More Than Five Hydrogen Bonds

2. The Molecular Weight Is More. Than 500

### 3. The Log P Is Over 5

### 4. There Are More Than 10 Hydrogen Bond Acceptors And

### 5. Compound Classes That Are Subtracts For Biological Transporters Are Exceptions To The Rule.

Computational method being non practical, simulated and not developed in similar conditions as existing in human or animal body they will have many limitations. Efforts are made to understand the efficacy of a medicine using the atomic and molecular properties simulated in a computer (Computational Chemistry George P. Ford, In press). They are highly mathematical and predictive. The structure activity correlation also uses the method of mathematical modeling taking the molecular properties in to consideration: But Mostly they are not 100% accurate, and do not interpret the efficacy internis of traditional concepts of traditional philosophies. The relation of different tastes with their efficacy was attempted to assess using such kind of modeling software's. The present method will help to understand the traditional parameters for understanding the relation of efficacy with the physico chemical properties of the constituents in the medicines.

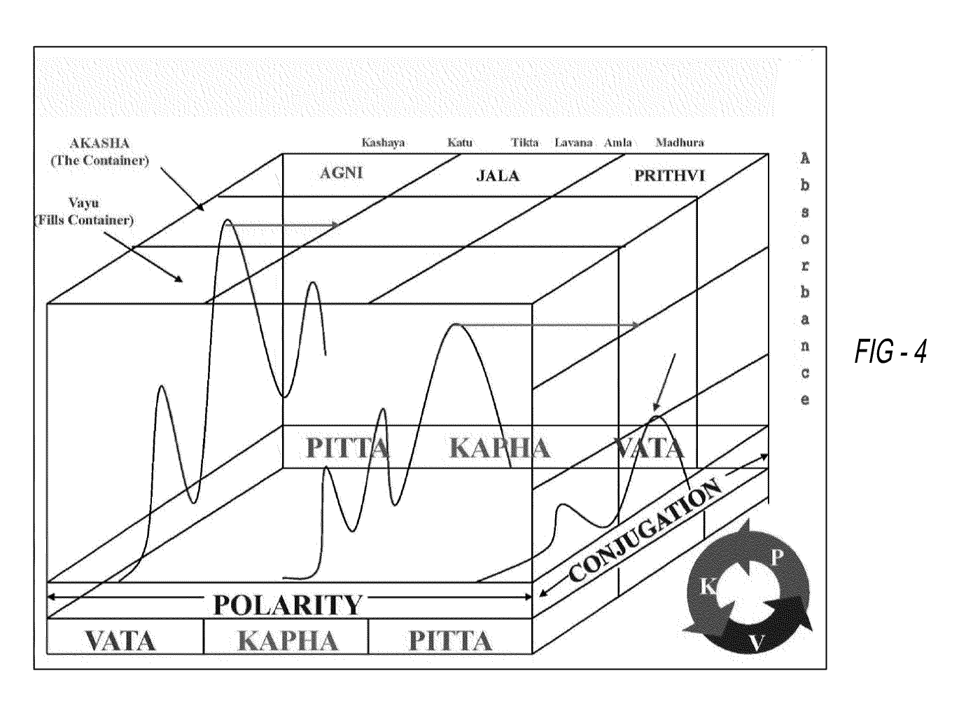

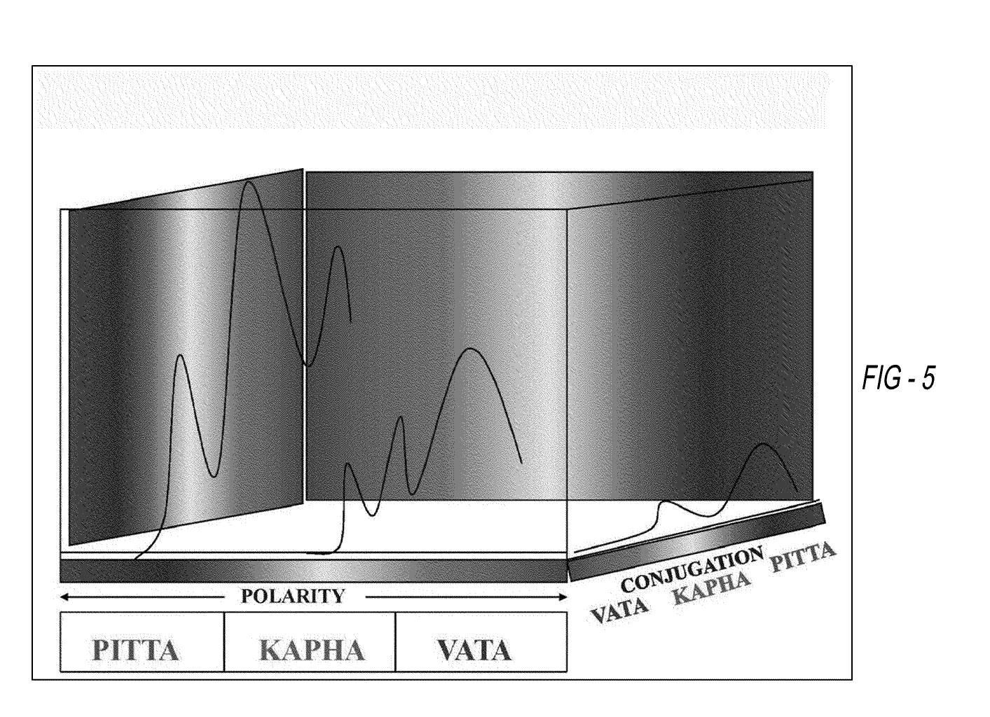

When some medicines were studied using this type of software along with present method the results were of less conclusive. FIGS. 4-5.

### The Retention Activity Correlations:

There are efforts to correlate the efficacy of the medicines with the retention of the molecules eluted on a chromatographic devise. Almost all have used the subjective parameters like retention were used with out much using the energy absorbed/emitted. The adsorption phenomena happening during the process of separation of analyte molecules over a chromatographic media is similar to the pharmaco dynamics of the medicines in human body. Many efforts are going on in predicting the efficacy of the medicines of unknown origin or of synthetic origin. The retention of the molecules was correlated with reported efficacy of a specific group of medicines with a common efficacy with many limitations. But the retention time of an elution of a molecule over a separation media will be influenced by many influencing factors, like properties of mobile phase, stationary phase, pH, temperature, viscosity and other physico chemical properties which influence the energy of the molecules under study, the medicines also undergo different changes similarly while they move through the body matter. Most of the researches were not accounted for the correlation of the energy absorbed or emitted with the efficacy of the molecule or medicine. Thus the present method has many advantages over the existing method of chemical and therapeutic standardization. Some references related to this work is given in References 1-20.

### SUMMARY OF THE INVENTION

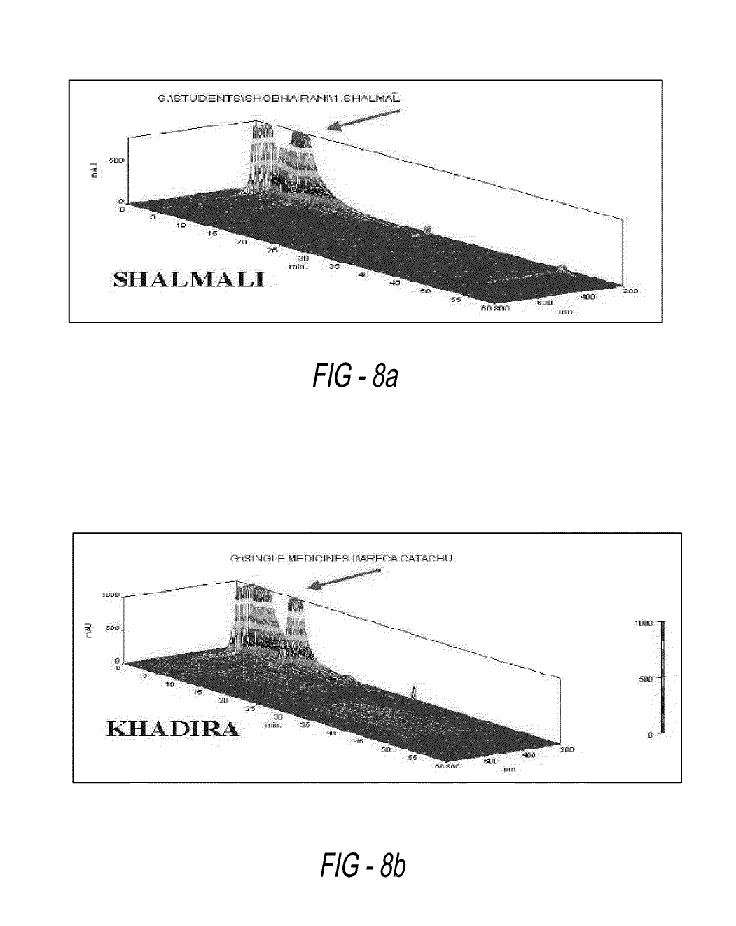

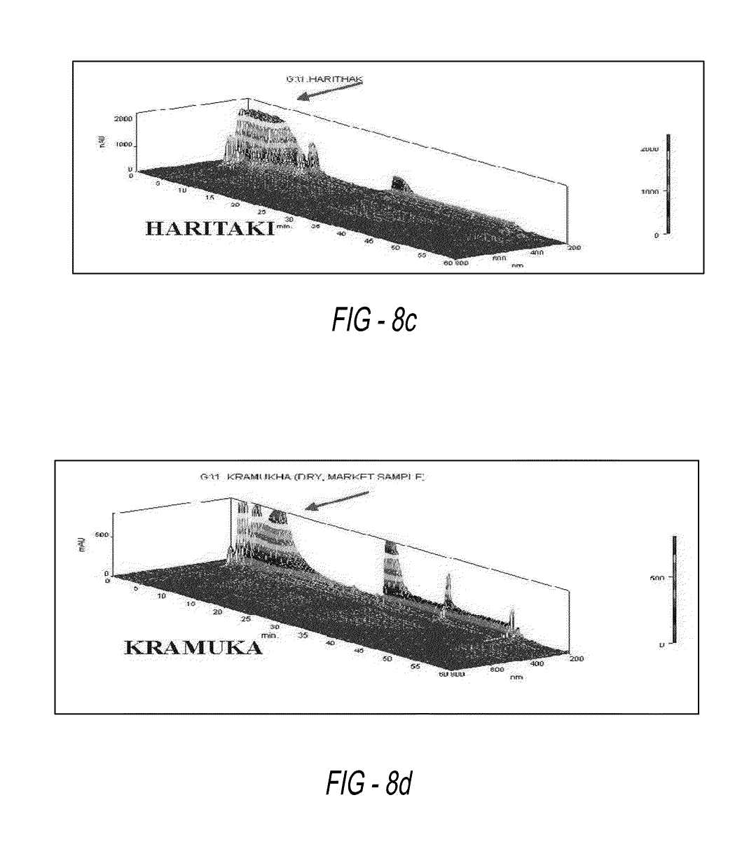

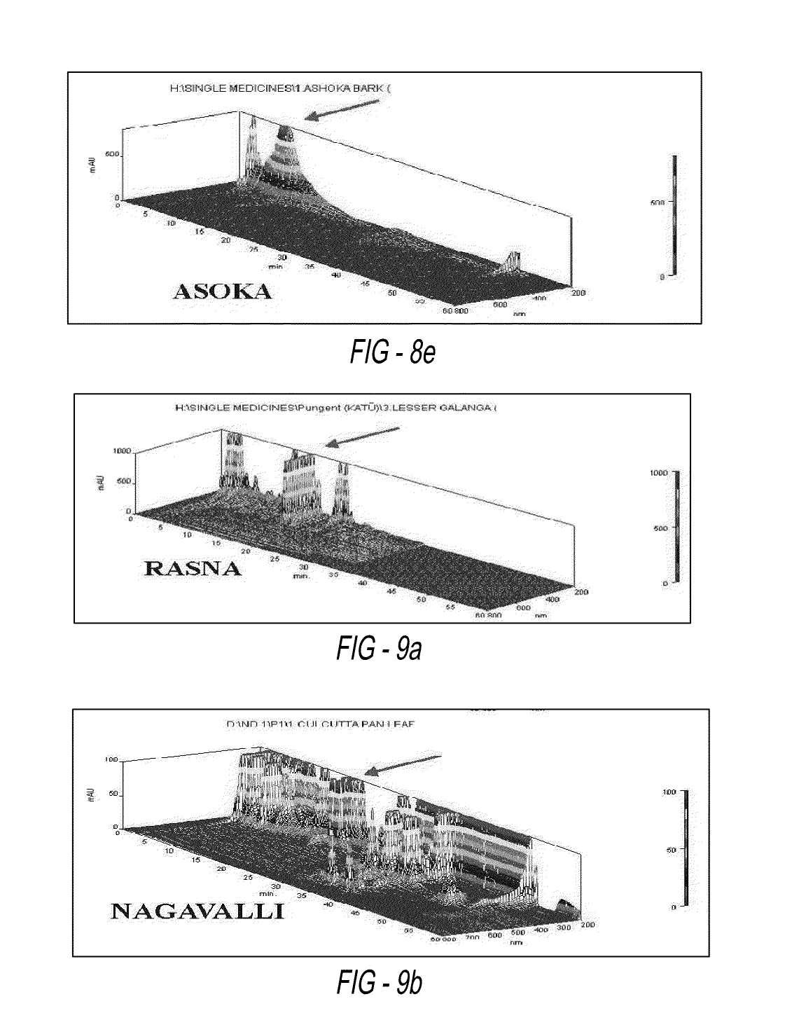

The present invention relates to a method for detection and identification of constituents of extracts of plants or animal, natural or synthetic sources possessing chemical and medicinal values and capable of responding (absorb or emit) to Electro Magnetic of radiation using a 2-D and a 3-D animated chromatographic finger printing and the generated movie movable on all axis between 0-360 degrees, (as shown in FIG. 8) chromatogram is divided in to 27 zones or further partitions there of, for chemical and therapeutic standardization where in said method comprising the steps of:
i. Extracting Organic, Organo-metallic and metallic atoms or molecules using suitable solvent.
ii. Subjecting the extract obtained in step (i) to the separation analysis based on pH, polarity under the influence of physical properties like temperature, viscosity and ionic media using a Chromatography technique under experimental conditions.
iii. Generating static and animated Contour and 3-D data graphs of the ingredients eluted based on conjugative and polarity properties along with varying energies absorbed/emitted qualitatively and quantitatively after suitable decryption and encryption of the datagragh file.
iv. Converting the, data thus obtained from step ‘iii’ in to a data image into static and animated movie datagragh movable on all axis between 0-360 degrees, using of the data of the analyte at different chemical and analytical variable conditions and analyzing the data graph based on the selection of various properties like polarity, mass and colors denoting the concentrations of the various constituents and their energy dealt with at a specific X, Y, Z pixel value of the image with time having a specific energy detected on a detector which can measure the energy absorbed/emitted by the analyte.
v. Generating a chromatogram based on the data and color analyzed, having different polarities and energies at various retention times along with different physico chemical properties like conjugative and polarity properties of the analyte constituents eluted with time at different pH and temperatures.
vi. Generating data in the form of a 2-D and 3-D forms and divided in to different zones representing a specific energy absorbed/emitted and related to efficacy of the medicine, the division of the image is based on the retention time indicated on X axis and wavelength indicated on Y-axis and absorbance on Z-axis, where in the X, Y and Z-axis are divided in to three zones based on polarity, absorbance and variable absorbance/emission qualitatively and quantitatively at specific conditions.
vii. Identifying the compounds in the said molecules by the absorptive and emission properties of various constituents in the image related to a specific efficacy due to its action on a specific single or multiple pathways based on the division of datagragh of fingerprints into different chemical and therapeutic zones.
viii. Identifying, determining and classifying the constituents by the absorptive or emission of an electromagnetic, electrical or magnetic energy of the eluted constituents based on physico chemical properties like polar, medium polar and, less or non-polar properties and conjugation for chemical and therapeutic standardization of the sample analyzed.
ix. Generating a barcode for the data using the X, Y, Z and time and energy coordinate properties of the data.
x. Generating a database of Chromatographic Fingerprints and barcodes and identifying the respective compounds of extract.
xi. Generating a database of Chromatographic Fingerprints and barcodes and identifying the respective compounds of the extract.

### OBJECTS OF THE INVENTION

The main object of the present invention is to propose a novel method for chemical and therapeutic standardization by detection and identification and animated 2-D and 3-D chromatographic finger printing of organic, organo metallic and metallic constituents of extracts of plants, animal or geological origin, natural or synthetic sources capable of responding (absorb, emit, reflect, refract or diffract) to different wavelengths of electromagnetic radiations, possessing different chemical and therapeutic properties at different pH, temperature, viscosity and ionic media using their physico chemical properties like polarity, conjugation, mass and total quantum of energy of the analytes where in the data graphs are presented as static and movable on any axis of 0-360 degrees providing complete information about the analyte.

Another object of the present invention is to identify the molecules in the said compounds by the absorptive, refractive, reflective, diffractive and emission properties of various constituents in the medicine related to a specific efficacy due to its action on a specific single or multiple pathways.

One more object of the present invention is identifying, determining and classifying the constituents by the absorptive, refractive, reflective, diffractive or emission of an electromagnetic, electrical or magnetic energy of the eluted constituents based on physico chemical properties like polar, medium polar and, less or non-polar properties and conjugation for chemical and therapeutic standardization of the sample analyzed. Yet another object of the present invention is to provide a complete chemical analysis of the constituents present in the medicine under study and their conjugative properties indicating the therapeutic efficacy as per the physico chemical and traditional parameters of the medicine using new software developed.

Yet another object of the present invention relates to a method, where in a single solvent Ethanol or aqueous Ethanol is used for extraction of the constituents; same analytical conditions and instrumental parameters were used for all samples to bring the therapeutic generalizations there by achieving the therapeutic standardization.

Still one more object of the present invention relates to a method, wherein, inbuilt software provides a novel concept of chromatographic finger printing of herbal medicines that will be useful for the quick identification of the actual profile of the compounds present in the medicine under use along with their therapeutic efficacy of the constituents.

Still another object of the present invention relates to a method of Chromatographic Fingerprinting where in the atoms/molecules are separated using a chromatographic method of separation and arranged in the specific order of polarity along with conjugative property measuring the absorptive and emission property of an electromagnetic radiation by the analytes.

Yet another object of the present invention is to provide a soft ware capable of analyzing (extracting colors) the colored contour and 3-D chromatographic image based on various colors absorbed/emitted with respect to a specific energy at different chemical, analytical and time intervals as presented in the energy box. The box denoting the concentrations and energies of various constituents eluted with time having arranged in a specific order of polarity indicated as retention time at a specific pH, temperature, viscosity and ionic media.

Yet another object of the present invention relates to a method, wherein, an inbuilt software provides a novel chromatographic finger printing of herbal medicines and formulations analyzed and are developed on a electromagnetic radiation detector like Photo Diode array Detector (PDA) connected to a chromatographic instrument like High Pressure Liquid Chromatograph, which delineates the data of the spectral properties of the constituents present in the material having the medicinal value, presented in a specific order of physico chemical properties like polarity along with conjugation generated under similar experimental analytical conditions.

One more object of the present invention relates to a method used as a data processor of 2-D and 3 D static and animated data graphs an analyte moving in 0-360 degrees on any axis.

Still another object of the present invention relates to a method which uses solvents for extraction, are selected based on the polarity, hydrophilic and hydrophobic nature of the constituents of the sample under study.

Still another object of the present invention relates to a method wherein, the polarity of the mobile phase of a non-aqueous and an aqueous solvent of a specific pH is controlled by varying the ratio of the mobile phase from 0% to 100% of an aqueous solvents like water or a buffer of a known pH, along with a non-aqueous solvent and vice-versa.

Still another object of the present invention relates to a method wherein, on analysis of 3-D and contour chromatograms using new software, gives a data having indicated the vitiation of doshas quantitatively in percentage ratio.

Still another object of the present invention relates to a method of Chromatographic Fingerprinting to assess the healthy or diseased patterns of a human being, animal or a microorganism, which helps for different purposes of disease identification, disease monitoring, drug selection, drug targeting and drug monitoring.

Still one more object of the present invention relates to a method of Chromatographic Fingerprinting where in the atoms/molecules are separated and arranged in the specific order of polarity along with conjugative property measuring the absorbance, emission, reflection, refraction or diffraction properties of an electromagnetic radiation by the analytes.

One more object of the present invention relates to a method of Chromatographic Fingerprinting where in the 3-D box is the container of the three energies where in the constituents of different properties will be having the polarity.

Still another object of the present invention relates to a method of Chromatographic Fingerprinting where in the 3-D box is the container of the three types of molecules with specific energies where in, the constituents with known properties of the molecular structure, mass, polarity and conjugation will be indicating the chemical and therapeutic properties of the constituents and the medicines.

Yet another object of the present invention relates to a method of Chromatographic Fingerprinting where in the molecules are eluted in a specific order of polarity with a range of conjugative property using detectors with measurement of absorbance, emission, reflection, refraction or diffraction properties of matter when exposed to electromagnetic radiation, along with conductivity, molecular structure and mass is useful for the chemical and therapeutic standardization.

One more object of the present invention relates to a method capable of Chromatographic Fingerprinting where in the molecules are arranged in a specific order of physico chemical properties for chemical and therapeutic standardization.

Still another object of the present invention relates to a method capable of Chromatographic Fingerprinting where in the molecules in a sample matrix are separated by means of a chromatographic technique and arrange in a specific order of polarity for chemical and therapeutic standardization based on the polarity along with conjugation properties.

Yet another object of the present invention relates to a method capable of analyzing a sample at different electromagnetic radiations, polarity, viscosity and temperature using suitable pumps to pump the liquids of mobile phase, having a detector which can measure the absorbance, emission, reflection, refraction or diffraction properties of analyte samples in a selected range of wavelength, having a software generating analysis data after coordination and compilation of signals from different types of detectors and analyzing the data for chemical and therapeutic standardization, generating barcode for the data generated after analysis and finally arranging the data in specific data base folders.

Another object of the present invention relates to a method capable of Chromatographic Fingerprinting where in the physico chemical properties of the carrier are varied for, eluting the molecules of a sample matrix to be separated on a chromatographic separation media of a planar or closed chromatographic system for chemical and therapeutic standardization.

Still another object of the present invention relates to a method capable of Chromatographic Fingerprinting where in the analytes after separated on a chromatographic system under different conditions of temperature, pH and viscosity and detected with detectors able to detect the mass, fragmentation pattern, conductivity, polarity, refraction, reflection, diffraction, absorptive and emittive properties of the analytes over a range of electromagnetic radiation for chemical and therapeutic standardization of natural, biological and synthetic materials and medicines.

Yet another object of the present invention relates to a detection system which arrays the results of interaction of radiation with matter for the molecules arranged in a specific order of polarity and results in interpretation of the chemical and therapeutic properties of analyte sample.

Still another object of the present invention relates to a method as, where in the chemical and therapeutic standardization is assessed for a material using the absorptive, refraction, reflection, diffraction and emittive properties of the molecules at a specific single or multiple wavelengths of radiation energy ranges to which the matter is exposed.

Still another object of the present invention relates to a method of chromatographic system having the data generated due to the separation of analytes over a separation media under specified analytical conditions leading to chemical and therapeutic standardization of the analytes under test.

Still another object of the present invention relates to a method of chromatographic system for chemical and therapeutic standardization based on the pattern of the energy data graphs generated due to the inter action of radiation with matter in a detection system to which the matter is exposed to.

One more object of the present invention relates to a method of bio informatics to assess the efficacy of a medicine and a diseases pattern/status of a living being for disease identification, disease monitoring, drug identification, drug targeting, drug selection, drug monitoring and drug inter action with biological systems.

Still another object of the present invention relates to a method, where in the solvents of different polarities are used for extraction based on the hydrophilic and hydrophobic nature of the sample and the constituents under study, generally ethyl alcohol is used as solvent for preparation and standardization of medicines.

One more object of the present invention relates to a method, where in the Chromatographic Fingerprints can be developed for a same medicine extracted under different pH, polarity, viscosity, ionic media and temperature values.

Another object of the present invention relates to a method, the said method is carried out using standard analytical parameters like extraction with ethyl alcohol, maintaining a regular run time although the analysis of samples, eluting with a mobile phase of acetonitrile and phosphate buffer having a pH range of 3-9, electromagnetic radiation range of 200-800 nm or below or beyond using a suitable and capable detector, maintaining column, total flow line and detector in the temperature range of 15-70° C., a mobile phase conductivity range of 0 to 50×10³ mhos.

Still another object of the present invention relates to a method, wherein the non-aqueous, organic and aqueous, water or buffer used under specified pH, viscosity, ionic media and temperature are selected based on the range of pH, viscosity, ionic media, temperature and polarity required.

One more object of the present invention relates to a method, wherein converting the analytical data into a colored image or an analyzable data comprising the conjugative and polarity properties and quantitative data of the constituents of the medicine under study.

Still another object of the present invention relates to a method, where in the therapeutic efficacy of a medicine (Single or formulated) is assessed using the quality of the constituents present in a particular polarity and electromagnetic radiation for refraction, reflection, diffraction, absorptive and emittive responses and the data graphs with X, Y, Z coordinate points indicating specific property in different of zones of the Chromatographic Fingerprint.

Still another object of the present invention relates to a method, where in the software generates a bar code for the properties of the images like a selected peak or peaks or whole image or movie movable on all axis between 0-360 degrees, using the X (Retention Time), Y (Wavelength), Z (Absorbance, In case of 3-D image and movie movable on all axis between 0-360 degrees, file like Avi, Mpeg etc), R (Number Of Red Pixels), G (Number Of Green Pixels And B (Number Of Blue Pixels) coordinates, provided by the software, which makes the product propriety for an industry.

Still another object of the present invention relates to a method, where in the solvents used for extraction is selected based on the polarity, hydrophilic and hydrophobic nature of the constituents, sample and its constituents under study.

Still another object of the present invention relates to a method, wherein the polarity of the mobile phase of a non-aqueous and an aqueous solvent of a specific pH, is controlled by varying the ratio of the mobile phase from 0% to 100% and vice-versa of an non aqueous solvents like acetonitrile, methanol aqueous solvents like phosphate buffer.

One more object of the present invention relates to a computational method of chromatographic finger printing, chemical and therapeutic standardization and bar coding of Organic, Organo-metallic and metallic atoms or molecules from a plant, animal, a naturally available or man-made materials used as medicines.

Still another object of the present invention relates to a method wherein it provides absorption/emission spectra of the compounds having displayed the conjugative and polarity properties of the molecules and the concentration of the individual concentrations of the molecules along with the polarity and quantum of energy of the molecules.

One more object of the present invention relates to a method where in the chemical and therapeutic standardization is achieved by interaction of matter to different individual electromagnetic radiations when the data is presented as chromatographic fingerprint. Still another object of the present invention relates to a method wherein, same standard analytical parameters like Extraction with same solvent Ethyl alcohol, same run time, same mobile phase acetonitrile along with phosphate buffer in a specific pH in the range of 3-9, same conductivity range of 0-50×10³ mhos and a same range of Electro Magnetic radiation from 200 nm-800 nm is used for Chromatographic Fingerprinting and chemical and therapeutic standardization along with subjecting the samples to different variable analytical factors like pH, temperature, column length, run time and Polarity of the stationary phase and mobile phase and maintaining the same order of arrangement of the molecules based on polarity, and molecular size in the specific order, is the basis of the assessment of chemical and therapeutic quality of the samples under study.

Yet another object of the present invention relates to a method of Chromatographic Fingerprinting where in the measurement of absorbance energy is indicating the activity of a constituent in absorbing the respective quantum of energy at a specific X, Y, Z position of the energy system with specific polarity and conjugative properties from the diseased conditions making to cure the disease pattern and hence therapeutically indicative.

Another object of the present invention relates to a method of Chromatographic Fingerprinting where in the respective zones and X, Y, Z coordinates of the constituents have a specific property of chemical and therapeutic efficacy of the analyte constituents present in a medicine.

Still another object of the present invention relates to a method of Chromatographic Fingerprinting where in influence of variable factors like temperature, pressure, pH, ionic media and viscosity of the mobile phase, stationary phase and sample will be influenced to arrange the atoms and molecules in a specific order of polarity whose conjugation and molecular structure will be analyzed along with conductivity will be useful for the chemical and therapeutic standardization.

Yet another object of the present invention relates to a method of Chromatographic Fingerprinting where in the gradient, ternary or quaternary run of the mobile phase ends at the ratio where it starts.

Still another object of the present invention relates to a method of Chromatographic Fingerprinting using which the interpretation of the activity of the analyte atom or molecules and their energies having a specific quantum of energy along with structural properties relates to their chemical and bio chemical and biophysical activities.

One more object of the present invention relates to a method of Chromatographic Fingerprinting using which the interaction of molecules of different polarities is assessed when they are arranged in the order of polarity.

Another object of the present invention relates to a method as, where in the temperature, pH and polarity of the mobile phase is controlled by varying the temperature, the ratio of the mobile phase of a solvent between 0 to 100% of an aqueous solvent like Water or a phosphate buffer at a required pH by using suitable buffer to maintain the required pH, polarity and ending at the ratio where it started with a non-aqueous solvent by a gradient, ternary or quaternary run.

Still another object of the present invention relates to a method, wherein the non-aqueous, organic and aqueous, water or buffer at a known temperature, viscosity and pH are solvents used are selected based on the range of temperature, viscosity, ionic media, pH and polarity required.

Yet another object of the present invention relates to a method, wherein, same standard analytical parameters like Extraction, run time, mobile phase, range of Electro Magnetic radiation influenced by variable factors like pH, temperature, column length, run time, Polarity of the column, stationary phase and mobile phase, maintaining the same order of arrangement of the molecules based on polarity and molecular size in the specified order are used to achieve chemical and therapeutic standardization.

One more object of the present invention relates to a method, for chemical and therapeutic standardization based on the pattern of the energy data graphs generated due to the inter action of radiation with matter in a detection system to which the matter is exposed to, after an orderly separation.

Still another object of the present invention relates to a method, a bio informatics tool to assess the efficacy of a medicine and a diseases pattern/status of a living being for disease identification, drug identification, drug targeting, drug selection, drug monitoring and drug inter action with biological systems

Another object of the present invention relates to use of Chromatographic Fingerprints of contour and 3-D chromatograms of the constituents as claimed in any of the proceeding claims are the basis for identification of chemical constituents for chemical and therapeutic standardization.

One more object of the present invention relates to a method of Chromatographic Fingerprinting where in the method enables to understand and standardize the variations in Physico-Chemical properties of the medicines in the form of energy variations, different states of three energies. These variations are present in medicine and living beings used for the therapeutic standardization using conjugative and polarity properties of the medicines shown in chromatographic fingerprints.

Still another object of the present invention relates to a method of Chromatographic Fingerprinting using which the variable factors like temperature, humidity, viscosity, ionic nature etc., on the physico chemical properties and thus therapeutic efficacy of a medicine can be assessed using the 3-D energy box.

Still another object of the present invention relates to a method, where in preparation of a database of a large number of samples will give many generalizations of the therapeutic efficacy of a particular group of plants or animals classified as a group for a particular disease for therapeutic identification, classification, standardization and monitoring.

In yet another object of the present invention relates to a method of Chromatographic Fingerprinting where in the atoms/molecules are separated using a chromatographic method of separation and arranged in the specific order of polarity using a separation technique where in the variable parameters like polarity, pH, temperature, ionic and electrical charge and viscosity of the reaction media, mobile phase, stationary phase and sample under analysis which will be varied leading to the interpretation of the Tridosha properties and efficacy of the same.

In yet another object of the present invention relates to a method of Chromatographic Fingerprinting where in the absorption and emission of the electromagnetic radiation by analyte constituents in a medicine along with polarity property will help to understand the efficacy of the same and the efficacy is due to these two basic properties.

In yet another object of the present invention relates to a method of Chromatographic Fingerprinting where in the 3-D box is the container of the three energies where in the constituents of Agni in nature or in the first zone of the Chromatographic Fingerprint, Jala property in the second zone of the Chromatographic Fingerprinting and Prithvi in the last zone. The Vayu is present in the last zone and in the area where in there in no constituents were present in the entire container.

In yet another object of the present invention relates to a method of Chromatographic Fingerprinting where in the chemical profile in diseased and healthy blood samples can be studied in a microorganism, animal and human being to correlate the disease profile with chemical profile indicating the relation of polarity and conjugation for drug selection, drug identification, drug targeting and drug monitoring.

In yet another object of the present invention relates to a method of Chromatographic Fingerprinting where in the energy at different doshas at deficient, sufficient and excessive states of levels indicating the energy variations of natural microorganism, animal and human being along with medicines and synthetic materials.

In yet another object of the present invention relates to a method of Chromatographic Fingerprinting using which therapeutic grouping of constituents and medicines can be done based on the said atomic and molecular properties.

In yet another object of the present invention relates to a method of Chromatographic Fingerprinting useful for the assay of the taste and its order, color of transmission and absorption and odor will be done at different levels of energy variations to understand the process of biotransformation and biogenesis.

In yet another object of the present invention relates to a method of Chromatographic Fingerprinting where in the traditional properties mentioned in the basic concepts mentioned in the traditional philosophies were correlated to the physico chemical properties of the medicines.

In yet another object of the present invention relates to a method of Chromatographic Fingerprinting where in the physico chemical properties like polarity, conjugation and quantum of energy of the atoms and molecules are useful to identify the bio chemical pathways having the same properties involving a specific energy.

In yet another object of the present invention relates to a method of Chromatographic Fingerprinting useful for understanding the evolution of the dosha and dhatu properties of the medicines in living and non-living things.

In yet another object of the present invention relates to a method of chromatographic fingerprinting of the native medicines of a particular place or country to develop suitable traditional philosophies and dictionaries for the chemical and therapeutic standardization.

In yet another object of the present invention relates to a method of chromatographic fingerprinting of the blood samples of living beings of a particular place, or country to develop suitable traditional medical philosophies and dictionaries for the chemical and therapeutic standardization.

In yet another object of the present invention relates to a method of Chromatographic Fingerprinting as, wherein the method enables to understand and standardize the variations in Physico-Chemical properties of the medicines in the form of energy variations of different states of Tri dosha energies present in medicine and living beings, for chemical, clinical and therapeutic standardization.

In yet another object of the present invention relates to a method, where in the Chemical and therapeutic standardization properties are assessed for a material using the absorbance, emission, reflection, interference, refraction and diffraction of the molecules at a specific single or multiple wavelengths range to which the matter is exposed and the data is interpreted for single and multiples of wavelengths in a fingerprint.

In yet another object of the present invention relates to a method of Chromatographic Fingerprinting for creation, improving, altering and modifying the capability of hard wares and soft wares useful for drug discovery.

In yet another object of the present invention relates to a method of Chromatographic Fingerprinting where in the arrangement of molecules in a specific order of physico chemical properties after separation on a separation media for chemical and therapeutic standardization with and with out recycling the eluent molecules either in to the same column or in to a battery of separation systems.

In yet another object of the present invention relates to a thermally protected and controlled system containing the separation media of stationary and mobile phases, detector flow cell system along with the flow line to develop chromatographic fingerprinting for chemical and therapeutic standardizations.

In yet another object of the present invention relates to a detector flow cell with thermally varying and controlling facility which change the temperatures as programmed and detect the bathochromic, hypso chromic, hyper chromic and hypo chromic variations of the spectrum at varying analytical conditions, of the samples passing through the flow cell for chromatographic fingerprinting for chemical and therapeutic standardizations.

In yet another object of the present invention relates to a One of the present object of the present invention relates to a method for the standardization of matter and radiation for the assessment of the quantum energy they can deal and arrange the matter in an order based on their physico chemical properties and kinetics.

In yet another object of the present invention relates to a method for the standardization of matter and radiation for the assessment of the quantum energy they can deal and arrange the matter in an order based on their physico chemical properties and kinetics for quantum chemical studies.

In yet another object of the present invention relates to a method of Chromatographic Finger Printing, the data is obtained for identifying the chemical constituents present in it for the purpose of chemical, therapeutic and process standardization and quality control activities of African, Allopathic, Ayurvedic, Chinese, Homoeo, Kampo (Japanese), Siddha, Unani and Tibetan medicines or any medicines.

In yet another object of the present invention relates to a method for the standardization of matter and radiation for the assessment of the quantum energy they can deal and arrange the matter in an order based on their physico chemical properties and kinetics for quantum bio chemical studies.

In yet another object of the present invention relates to a method for the standardization of matter and radiation for the assessment of the quantum energy they can deal and arrange the matter in an order based on their physico chemical properties and kinetics for quantum bio physical studies.

In yet another object of the present invention relates to a method for the standardization of matter and radiation for the assessment of the quantum energy they contain and arrange the matter in an order based on their physico chemical properties and kinetics for quantum chemical studies by using an equation E=m^{±p}C^{λ} Where in m is the mass, p is polarity at specific temperature and pressure of the analyte material and C is the speed of the respective radiation.

In yet another object of the present invention relates to a method for the standardization of matter for the assessment of the chemical, therapeutic and biological properties by the generalization of their commonalties and differences in the profile.

In yet another object of the present invention relates to a method of analysis using the patterns of electromagnetic radiations absorbed or emitted, generated for a sample for chemical and therapeutic standardization.

In yet another object of the present invention relates to a method of analysis using the graphical data patterns of electromagnetic radiations absorbed, emitted, reflected, refracted, interference, diffracted with the analyte and generate data for a sample by a separation method using different properties of the carrier media to separate over a separation media, separating and arranging the constituents in a specific order of polarity along with measured responses of the constituents with interaction of electromagnetic radiations for chemical and therapeutic standardization of material under test.

In yet another object of the present invention relates to a method of analysis for the standardization of organic reagents for chemical and activity standardization.

In yet another object of the present invention relates to a chromatographic fingerprinting method of analysis for the chemical and therapeutic standardization of Nanoparticles in materials.

In yet another object of the present invention relates to a Chromatographic fingerprinting method for the chemical and therapeutic standardization of nutritional values of foods, nutritional dietetics and nutritional genomics.

In yet another object of the present invention relates to a method of chromatographic fingerprinting for the chemical and therapeutic properties of proteins and genetic material for proteomics and genomics studies.

Still another object of the present invention relates to a method of chromatographic fingerprinting which provides the properties of the analyte with out a referral standard.

In yet another object of the present invention relates to a software capable of interpreting constituents between 0-20 minutes as Pitta in nature which are in Zone 1, of the image where in 0 minutes is acute and 20 is chronic.

In yet another object of the present invention relates to a software capable of interpreting Constituents in the range of retention times 20-40, as Kapha in nature which are in Zone 2, of the image where in where in the constituents at 20 min acts on acute and 40 min acts on chronic conditions.

In yet another object of the present invention relates to a software capable of generating a chromatogram based on the color analyzed (Extracted from finger print using a Graphic User Interface software developed), having peaks at various retention times along with different physico chemical properties like conjugative and polarity properties of the analyte constituents eluted with time.

In yet another object of the present invention relates to a software capable of interpreting Constituents in the range of retention times 40-60, as Vata in nature which are in Zone 3, of the image where in where in constituents at 40 acts on acute and 60 is chronic conditions.

In yet another object of the present invention relates to a software capable of interpreting Constituents in the range of retention times 5-15, as Kashaya, Astringent, in nature which are in Zone 1, of the image.

In yet another object of the present invention relates to a software capable of interpreting Constituents in the range of retention times 15-20 min, as Katu, Pungent, in nature which are in Zone 1, of the image.

In yet another object of the present invention relates to a software capable of interpreting Constituents in the range of retention times 25-35, as Tikta, Bitter, in nature which are in Zone 2, of the image.

In yet another object of the present invention relates to a software capable of interpreting Constituents in the range of retention times 25-35, as Lavana, Salty, in nature which are in Zone 2, of the image.

In yet another object of the present invention relates to a software capable of interpreting Constituents in the range of retention times 30-40, as Amla, Sour, in nature which are in Zone 2, of the image.

In yet another object of the present invention relates to a software capable, of interpreting Constituents in the range of retention times 35-55, as Madhura, in nature, which are in Zone 2 and 3, of the image.

In yet another object of the present invention relates to a software capable of interpreting Constituents absorbing from 200-800 nm, as Dosha kara/Vridhi, in nature which are in Zone 1, 2 and 3, of the image when a sample is analyzed on a separation media and molecules arranged in an order of polarity.

In yet another object of the present invention relates to a software capable of interpreting Constituents absorbing from 200-400 nm, as Increase of respective conjugative property said to be Dosha hara, in nature which are in Zone 1, 2 and 3, of the image when a sample is analyzed on a separation media and molecules arranged in an order of polarity.

In yet another object of the present invention relates to a software capable of interpreting Constituents absorbing from 200-800 nm, as Increase of respective property will be Sheeta Veerya, in nature which are in Zone 2, of the image when a sample is analyzed using a separation media.

In yet another object of the present invention relates to a software capable of interpreting Constituents absorbing from 200-800 nm, as Increase of respective property will be Ushna Veerya, in nature which are in Zone 1, of the image when a sample is analyzed on a separation media and molecules arranged in an order of polarity.

In yet another object of the present invention relates to a software capable of interpreting the Vipaka (Post assimilative) property, which is absent before and present after interacting with an enzyme in a medicine/biological fluid.

In yet another object of the present invention relates to a software capable of interpreting the Sookshma property (Smaller molecules or absorbing sharply at lesser wave lengths, 190-220 nm), which are in Zone 1, 2 and 3, of the image when a sample is analyzed on a separation media and molecules arranged in an order of polarity. In yet another object of the present invention relates to a software capable of interpreting the Rooksha (Volatile high to medium polar molecules) property based on the absorption spectra and polarity of the ingredients in Zone 1, 2 and 3, of the image when a sample is analyzed on a separation media and molecules arranged in an order of polarity.

In yet another object of the present invention relates to a software capable of interpreting the Snidha (Viscous medium to non polar molecules) property based on the absorption spectra of 200-800 nm and polarity of the ingredients in Zone 1, 2 and 3, of the image when a sample is analyzed on a separation media and molecules arranged in an order of polarity.

In yet another object of the present invention relates to a software capable of interpreting the Laghu property based on the absorption spectra, polarity and less number of ingredients in Zone 1, 2 and 3, of the image when a sample is analyzed on a separation media and molecules arranged in an order of polarity.

In yet another object of the present invention relates to a software capable of interpreting the Guru property based on the absorption spectra, polarity and large number of ingredients in Zone 1, 2 and 3, of the image when a sample is analyzed on a separation media and molecules arranged in an order of polarity.

In yet another object of the present invention relates to a software capable of interpreting the Sandra (Viscous molecules) property based on the absorption spectra of 200-800 nm and polarity of the ingredients in Zone 2, of the image when a sample is analyzed on a separation media and molecules arranged in an order of polarity.

In yet another object of the present invention relates to a software capable of interpreting the Sthoola (heavy molecules) property based on the absorption spectra and polarity of the ingredients in Zone 3, of the image when a sample is analyzed on a separation media and molecules arranged in an order of polarity.

Still another object of the present invention relates to a software capable of interpreting the chemical and therapeutic property of the analyte based on the 3-D and contour chromatographic fingerprints developed due to the interaction of radiation with matter and the data graph divided in to different zones and marked with respective therapeutic property based on specific X, Y and Z coordinates of the data graph or movie movable on all axis between 0-360 degrees wherein the retention time value is not a limitation In another object of the present invention relates to a method of Chromatographic Fingerprinting useful for chemical and therapeutic standardization of fuel products.

In another object of the present invention relates to a method of Chromatographic Fingerprinting useful for the standardization of agricultural products.

In another object of the present invention relates to a method of Chromatographic Fingerprinting useful as a diagnostic tool for the analysis of healthy and diseased samples for chemical and therapeutic standardization

In another object of the present invention relates to a method of Chromatographic Fingerprinting useful for the toxicity studies for chemical and therapeutic standardization.

In another object of the present invention relates to a method of Chromatographic Fingerprinting useful in chemical and therapeutic standardization of forensic samples.

In another object of the present invention relates to a method of Chromatographic Fingerprinting useful for the chemical and therapeutic standardization of industrial food and medicinal products.

In another object of the present invention relates to a method of Chromatographic Fingerprinting for the chemical and therapeutic standardization of environmental samples.

In another object of the present invention relates to a method of Chromatographic Fingerprints of data graphs of the analyte will be the basis for identification and standardization of chemical constituents to limit the scope of the invention.

In another object of the present invention relates to a method of Chromatographic Fingerprint data is used for the study of variation of chemical constituents in biological samples and to identify and standardize the chemical constituents in them to know the pathological, healthy and diseased status of the source living being thus leading to chemical and therapeutic standardization.

In another object of the present invention relates to a method of, Chromatographic Fingerprinting used for the adulterated, substituted, contradictual, commercial food and drug samples and to identify the chemical and therapeutic properties of pure and impure.

In another present object of the present invention relates to a method of wherein, the data obtained is used for the study of variation of chemical and therapeutic properties of the constituents due to various ecological factors, geological factors, genotype and phenotypic variations (in plant and animals) in naturally occurring samples and to identify and standardize the chemical constituents in them.

In another present object of the present invention relates to a method of wherein, the data obtained is used for the study of chemical constituents in synthetically prepared samples and to identify and standardize the chemical constituents in them for chemical and therapeutic standardization which ever is applicable.

In another present object of the present invention relates to a method of Chromatographic fingerprinting wherein, the data obtained is used for the study of chemical constituents in herbal products of single medicine samples and to identify the chemical constituents in them for chemical and therapeutic standardization.

In another present object of the present invention relates to a method of Chromatographic fingerprinting wherein, the data chromatograph is used for the study of chemical constituents in herbal products of formulated medicine samples and to identify the chemical constituents'in them for chemical and therapeutic standardization. In another object of the present invention relates to a method of Chromatographic fingerprinting wherein, the data obtained is used for the study of variation of chemical constituents in different brands of products of single and formulated food and medicine samples and to identify the chemical constituents in them for chemical and therapeutic standardization.

In another object of the present invention relates to a method of Chromatographic fingerprinting wherein, the data of medicines facilitates to categorize and quantify the constituents of a medicine based on polarity and conjugation from 3-D and contour chromatograms and assess the therapeutic efficacy of the medicine on which humors it is going to act (vitiate, balance).

In another object of the present invention relates to a method of Chromatographic fingerprinting wherein, the data obtained enables to understand and standardize the Physico-Chemical properties of the medicines like color for the use of therapeutic standardization of medicines and humors (Tri Doshas) using conjugative and polarity properties given in the chromatographic fingerprints.

Still another object of the present invention relates to a method of chromatographic fingerprinting which enables to understand and standardize the microcosm and macrocosm of the medicines used for therapeutic standardization using conjugative (indicated on Y-axis, microcosm) and polarity (indicated on X axis, macrocosm) properties given in the chromatographic fingerprints.

Yet another object of the present invent is presentation of measured electromagnetic radiations absorbed/emitted of the constituents diagonally opposite to each other on the scales of polarity axis and absorbance, electromagnetic radiation axis of the fingerprint indicating a specific quantum of energy at the specific pixel point dealt by the analyte molecules/molecular fragments.

Yet another object of the present invention is the said method facilitates preparation of herbal, medical and biological encyclopedias for different material present in a specific ecological and geological parts of the world.

Yet another object of the present invention is the said method facilitates chemical and therapeutic standardization based on the qualitative and quantitative inter and infra ratios of the molecules/molecular fragments present in a food and drug sample of natural and synthetic origin.

Yet another object of the present invention is the said method facilitates to assess the variations in chemical and therapeutic properties of foods and medicines under different bio chemical, biophysical conditions

Yet another object of the present invention is the said method facilitates the influence of foods and medicines of natural and synthetic origin on different srotasas/channels in the biological systems.

Yet another object of the present invention is the said method facilitates the prognosis and diagnosis of disease pathology in biological systems.

Yet another object of the present invention is the said method facilitates the validation of basic principles and concepts of different traditional and modern health philosophies.

Yet another object of the present invention is the said method facilitates the influence of foods and medicines of natural and synthetic origin on different chemical and bio chemical pathways in the biological systems.

Yet another object of the present invention is the said method facilitates the chemical and therapeutic standardization of vaccines.

Yet another object of the present invention is the said method facilitates the chemical and therapeutic standardization of toxicity of materials, foods and medicines of natural and synthetic origin.

Yet another object of the present invention is the said method is the absorption/emission data graphs of the analyte at different wavelengths presented together provides specific pattern of images and data graphs for chemical and therapeutic standardization.

Yet another object of the present invention is the said method provides analysis using the graphical data patterns of electromagnetic radiations absorbed, emitted, reflected, refracted, interfered, diffracted with the analyte and generate data for a sample by a separation method using different properties of the carrier media to separate over a separation media, separating and arranging the constituents in a specific order of polarity along with measured responses of the constituents with interaction of electromagnetic radiations for chemical and therapeutic standardization of material under test.

In another object of the present invention relates to a method of Chromatographic fingerprinting wherein, the method enables to understand and standardize the Physico-Chemical properties of the medicines like Tastes (Rasa) like Sweet, Sour, Salty, Pungent, Bitter and Astringent (Madhura, Amla, Lavana, Tikta, Katu and Kashaya as described in Ayurveda) used for therapeutic standardization using conjugative and polarity properties given in the chromatographic fingerprints.

In another object of the present invention relates to a method of Chromatographic fingerprinting, wherein the data obtained enables to understand and standardize the Physico-Chemical properties of the medicines like Property, Potency, Metabolite, Specific properties like Chirality of the molecules (Guna, Veerya, Vipaka, Prabhava) used for the therapeutic standardization using conjugative and polarity properties of the individual constituents and the whole medicine shown in the chromatographic fingerprints.

In another object of the present invention relates to a method of Chromatographic fingerprinting wherein, the data enable to understand and standardize the Physico-Chemical properties (Gunas) of the medicines like Cold, Hot, Slow in action, Sharp in action, Heavy, Light, Soft Lubricated Supple, Dry (Sheeta, Ushna, Manda, Teekshna, Guru, Laghu, Snigdha, Rooksha as described in Ayurveda) used for the therapeutic standardization using conjugative and polarity properties of the medicines shown in chromatographic fingerprints.

### BRIEF DESCRIPTION OF THE ACCOMPANYING TABLES AND FIGURES AND MOVIE

### Tables

1. The table of standardization shows different methods of chemical and therapeutic standardizations used in modem and traditional medicines.
2. The table of Shadrasa Nighantu show different medicines classified based on their taste. Traditional practioners use this for selecting a specific medicine for a specific therapeutic purpose.
3. The equivalent English terms for were given for the traditional names of the diseases used in Indian traditional philosophy.
4. The table of kashaya scanda (Chapter of Astringents) shows different single herbs used a specific therapeutic efficacy. Physico chemical properties of the medicines related to taste property are used to understand the chemical and therapeutic properties of the medicines.
5. The Sage ‘Charaka’ has classified the medicines based on their efficacy. Any medicine from these groups will be used for the required efficacy.
6. Traditionally medicines were classified in to different numbers based on the Physico chemical properties. The table of Ganoushadhas (Groups of medicines) shows the same.
7. Different proportions of Tri Doshas exist in living being due to different factors like genetic, ecological, geological, temperature, viscosity, pH and ionic nature. These properties will be continuously fluctuating in a day, season and year. This explains how each person varies from other, which was explained in the Prakrithi concept of Indian Systems of medicines. The medicine prescribed will depend based on the status of these properties, Dosha Bhedas, in the person existing as on that moment. Hence traditional practioners will suggest different medicines for the same disease in different persons.
8-9. The Physico chemical properties were correlated for using as guidelines for identification of the properties of the medicines.
10-12. The evolution of Panchabhutas (5 Elements) with different stages of living and non-living things is given. Every system has to under go this change if it under goes. The relation of color has also been established.
13-15. Traditionally medicines were related to astrological parameters. In traditional philosophies the astrological factors are taken in to consideration while selecting a medicine and treating a patient
16. The Sanskrit slokas indicate how the morphological properties were explained indicating the life existing in plants.
17. The table presents the relation of tridoshas with diseases
18. The traditional parameters used in Ayurveda were given showing the inter and infra relation among them.
19-21. Traditionally medicines were classified based on efficacy. They indicate the biochemical pathways in the modern medicine. Deepaneeya (Appetizer), Lekhaneeya (Atherosclerotic) and Vrana shodhana and Ropana (Wound healing) medicines were shown in the presentations.
22. The fingerprint is divided in to different groups based on the x, y and z coordinate.
23. The table showing the disease pathologies used in Ayurveda.
24-25. The tables show meanings of different traditional terminology used the document
26 shows the chemical and therapeutic interpretation guidelines as mention in the table
27 shows interpretation rules of fingerprints for different therapeutic and chemical properties

### FIGURES

1. Four windows of a commercially available HPLC instrument are shown. Usually chromatogram at a selected wavelength is under use. The contour chromatogram is usually used for selection of a suitable wavelength for chromatogram at a specific wavelength.

2. The present method of chromatographic analysis use chromatograms of a medicine at any selected wavelength needs to be-analyzed and presented at all 800 wavelengths for complete analysis of all of the constituents present in a sample, absorbing at different wavelengths of UV-Visible range of radiation. The examples of such chromatograms at 8 selected wavelengths were shown for a turmeric sample. This was given in our earlier patent PCT/IN00/00123.

3. The traditional philosophies consider human health as a management of a balance between three doshas. The imbalance leads to disease. The physico chemical properties of the medicines are correlated to the efficacy in terms of Tri Doshas and t5 Panchabhutas.

4-5. Molecular modeling is a modem tool for drug discovery. Different mathematical calculations of the properties of molecules were used to predict the efficacy of the medicines. The guidelines available in traditional medicines help for a traditional practitioner to assess the efficacy of the medicine. If these properties are rationally assessed the efficacy of the medicine will be understood. Fingerprints of some of the medicines were presented along with the calculated values of the medicines using molecular modeling software. Even though the polarities of some of the molecules are same, their efficacy is not known. When the molecules were arranged in a specific order of physico chemical properties the efficacy was understood. Thus the present method is found to be more nearer to the fact than the mathematical tools.

6. The 3-D (Data graph) box is divided in to 27 parts on X, Y and Z axis. The molecules are arranged in the order of polarity on X axis, the spectral properties presented on Y axis and on the Z axis the variations in the electromagnetic properties due to interaction with analyte under different influencing physico chemical properties like temperature, viscosity, ionic nature and thermodynamic properties of the separation media, mobile phase, ionic nature and analyte moieties. The quantum of energy is measured for a required efficacy.

7. The 3-D Energy Box: When the Chemical Constituents Were Arranged in the Order of Polarity along with their absorptive/emissive property the quantum of energy in different electromagnetic radiations were found to be useful for the chemical and therapeutic properties of the medicines. The VIBGYOR color on X and Y-axis indicates the Polarity and conjugative properties of the molecules, which are classified again in to three categories. The color 3-D box shows the same.

The polarity on the x-axis and the ultraviolet and visible spectrum representing the conjugative properties are measured along with their quantitative properties on the z-axis. Thus in the 3-D box, a specific x, y and z coordinate indicates a specific quantum of energy able to be dealt by the molecule. Hence the energy of the molecule will be E will be equivalent to the mass of the analyte sample having a specific charge (Polarity) and being able to deal a specific amount of energy equivalent to the radiation absorbed or emitted by the analyte matter. Thus the total energy dealt by the whole sample will be E=MC², where in the energy is the total energy of all the analytes present in the sample and the total white light (having all ranges of radiations).

But a molecule absorbing at only specific wavelength cannot have the energy of a different molecule absorbing at a different wavelength. Hence the specific quantum of energy possessed by the sample will depend on the specific wavelength dealt by the molecule. Because, no matter will be active when it is neutral, particularly a medicine with many molecules. When the frequency and wavelength is different for different radiations the radiation what we see at a particular time have not started at the same time from the source. Hence time plays a very important role in every aspect including the activity of a medicine for a person. Thus separation, measurement of the absorbed/transmitted electromagnetic radiation by their individual constituents present at various conditions of temperature, pH and ionic media has helped to assess the chemical, biological and therapeutic properties of the material under test using the above method.

8. Movie 1

The figure of 3-D energy box show a data graph generated for the same medicine analyzed under different analytical conditions like time, temperature, viscosity, and pH.

It shows the change of polarity and thus the retention time, the spectrum influenced by bathochromic, hypsochromic, hypo chromic and hyper chromic effects due to the same factors. Thus it will help to assess the efficacy of the medicine or a biological sample about its changes in the physico chemical properties due to the above factors. Thus an accurate standardization of the analyte samples will be possible. A soft copy of the 3-Danimation movie has been provided with the document.

The box is the container where in the matter is shown to be changing its properties. The deficient energy present in different molecules of all polarity groups is presented to be changing to sufficient and excessive levels of energy due to different influencing factors. Any extremes of this energy gained or lost will lead to imbalance in the properties of the material. Thus fulfilling the deficiency and removing the excessive energy will be the methods of treatments to bring normalcy in the energy levels leading to a healthy condition. Thus maintaining harmony in all the three types of energies will bring a healthy condition. Some of the Treatment used in Indian System of medicines like yoga, meditation, and pranayama involves the same. They help in bringing harmony in the variations in the energy levels, which were disturbed. Bringing back to normalcy will bring health.

When the external source of energy enters in to the body in the form of light having different wavelengths of energy, it will influence the internal energy system present in the form of quantum energy. Thus by not allowing the external energy in the form of light is maintained by CLOSING the eyes, the fluctuations of energy inside the body will be prevented. Thus creation of any imbalance in TRIDOSHAS is prevented leading to healthy condition. Thus the energy box is the closed human body in which different variations of energy will happen.

The energy box is presented in the form of software, which presents the qualitative and quantitative chemical and therapeutic qualities of a medicine or diseased and healthy conditions in a biological system. Some of the Chromatographic Fingerprints of the samples of biological nature are presented.

Level 1 show the deficient energy level of the molecule or a biological system. Thus the biochemical pathways that could not happen due to deficiency of sufficient energy for the said mechanism will not be triggered.

Level 2 show that the sufficient levels of energy of the sample under test due to which a status of healthy condition will prevail leading to a healthy system.

Level 3 show the excessive levels of energy of molecules present in a medicine or a biological system. The removal of the excessive energy of the system will bring the normalcy in the energy system and thus the health is achieved.

For example if the system is exposed to varying states of energy then it becomes unstable. Irregular breathing, irregular eating habits, irregular day to day activities, temperatures fluctuating from very low to very high etc. Many of the epidemics erupt during the intermediate stages of seasons of cold and hot climatic temperatures, humid and non-humid conditions etc, Even the fluctuating the moods of the mind also will influence the health. Hence maintaining equilibrium in every state of life is essential. The flexibility property of the human being will give tolerance against these variations hence person who possess this property will be usually healthy and happy.

Hence maintaining healthy levels of energy will lead to healthy condition for which different molecules with energy absorbing, conditioning and donating properties will be useful. The behavior of a molecule under different conditions like temperature, pH, viscosity, ionic nature of the media in which the molecule is present can be understood. The responsive (absorption/emission) property of molecules under experimental conditions at three different levels will indicate the qualitative and quantitative changes due to the influence of different conditions like pH, temperature, viscosity and ionic nature of the media where the reaction or activity is under going. It is this reason any medicine will not behave 100% similar in different human beings. In a set of animals, which are maintained under experimental conditions, may have some commonality in the response. But practically in an un controlled conditions the same response cannot be observed. Hence the medicine tested in controlled conditions may differ in the day-to-day life of the humans in uncontrolled conditions. The study of the response of the chemical and bio chemical reactions could be tested under practical conditions.

In the animated figure the same is shown. The radiations when moved with respect to time the quantum of energy will not be the same. Similarly a molecule having a particular quantum of energy will vary in its energy when it is exposed to different temperatures, pH and Ionic media and give different results from person to person and place to place, so on. Even though the medicine is consumed at single time various constituents in it will be moving in different speeds due to their interaction with the surface on it is moving, like a set of molecules get separated over a chromatographic surface. It is the final quantum of energy being able to be measured which actually brings a change in the chemical atmosphere. Thus measurement of the energy dealt by a molecule along with its electrical charge will help to understand the chemical and therapeutic property of the sample under test.

9. The fingerprints of medicines with a specific color were given. The relation of color with efficacy was mentioned in traditional medicines. The color of absorbance is due to the chemical constituents present in it. The transmitted color of the sample was used as an indicator for the efficacy of the medicine. Thus indirectly the color of absorbance is used for the said efficacy.

10-15. The fingerprints of different medicines with a specific taste were given in different figures. The order of taste is found to be the order of chemical constituents in a specific order of polarity. Hence taste classification of medicines is the classifications based on polarity of the chemical constituents. The medicines will possess the required efficacy if they contain constituents having required polarity along electromagnetic radiation properties qualitatively and quantitatively.

16. The three Highly Bitter medicines were fingerprinted. Substitution of single medicines is common in commercial market assessment of right variety will help to select and used to achieve better clinical uses. In a state of unconformity fingerprints will help to identify the better variety. Usually Swertia Chirata is substituted with Andrographis Paniculata. It can be seen that the high polar constituents present in Swertia is not seen in Andrographis. Hence it cannot be used for Pitta hara properties. Thus the efficacy should be checked while substituting any medicine. The rich profile in the retention times of 25-30 minutes with Bitter taste can be seen in all the samples.

17-18. The medicines like Chitraka and Danti are mentioned to have a special property called “The Prabhava”. Even though the medicines contain all tastes the first is majorly Pitta Kaphahara and the second is Kapha Vatahara. So first will close the channels and the second open the channel. There are different types of Prabhava. The medicines like Rudraksha and Sahadevi were also told to be examples of Prabhava. When the Rudraksha was soaked for longer time more quantity of samples were found to be get extracted. Sahadevi is mentioned for the treatment of Cancer.

19. Lekhaneeya medicines: When medicines used for a specific efficacy are analyzed and the fingerprints were studied the common molecules can be seen indicating efficacy.

20. Charaka Dashaimani Jeevaneeya medicines: The fingerprints of medicines classified as Jeevaneeya (Vitalizes) were shown. The commonality of the constituents at 35-40 minutes in all samples proves that the therapeutic classification of Charaka was based on the chemical properties. Molecules of specific polarity have been mentioned for a specific efficacy.

21. Two generally used Medhya dravyas: fingerprints of Bacopa and Centella were presented. The Profile of Bacopa is more in Pitta and the profile in Centella is rich in constituents. Different substitutions need to be standardized.

22. When some of the Medhya Rasayana dravyas were observed a common chemical profile is seen as show marked. Thus different targeted efficacies were indicated in classifying the medicines based on efficacy rather than plat pharmacognostic properties.

23. Rasayana dravyas of Swasa (Bronchial) diseases

24. Rasayana dravyas of Sthoulya (Obesity)

25. Rasayana dravyas: Medicines like Gingokobiloba and Ashwagandha were considered as highly potent herbal Rasayana medicines. The similarity of two different plants for same efficacy will help for better substitutions.

26. Rasayana dravyas in general found to have an array of constituents in the entire range of polarity. Hence commonly they will be wide acting medicines. But medicines having molecules from 30-55 are found to be the immunomodulators. Constituents from 0-30 are anti oxidants.

27. Finger prints of Different sources of Boerrhavia species: Variation of chemical constituents among different genotypic & phenotypic plants should be standardized before using them.

28. Finger prints of Different sources of Vidarigandha species: Different sources of Vidarigandha (Ipomoea digitata) shows variation of chemical assay of the constituents the common molecules present in all varieties show that all these have some commonalities and variations.

29. Finger prints of Different sources of Amra Gandhi Haridra species: Collection and Processing of medicines needs to be standardizes. Herbal medicines collected from different soils, pealed and unpeeled show variations of chemical assay.

30. Different sources of Akarakarabha were presented. This helps to identify different types of the single medicine available in the world.

31-32. Some of the medicines are used for achieving a child of required sex. The medicines presented are used in Indian Systems of medicine for having a male child. This process is called as Pumsavana in Ayurveda.

33. The Jeemutha Lunar effect: The influence of lunar effect on the chemical constituents of plants was reported in traditional texts, one of such plants has been studied. The plant is showing different molecules of different efficacy when collected during specific timing. This emphasizes the need of standardization while collecting herbal medicines. If molecule similar to progesterone can be seen in the sample collected on the full moon day of a specific month.

34. Fingerprints of Sea buck thorn. Some of the herbal-material used in day-to-day life will have many therapeutic properties. Standardization of such material; from different sources will help to select correct variety for clinical or nutritional purposes.

35. Fingerprints of different sources of Aegle marmalous fruit are presented. Usually the immature fruit is prescribed for clinical purposes. The ripe fruit show toxic profiles. Thus the collection specifications need to be standardized.

36. Fingerprints f Drynaria qurcifolia show a rich profile. It is used for Osteo Arthrites. In Tamil ‘Mudu’ means joint Vattukkal means Vata hara. Arthritis is due to Vata, which will be cured by this medicine.

37. Single medicines used for hepatitis: Some of the medicines used for hepatic disorders were shown; medicines having constituents at the required polarity are proved to be potent.

38-39. Fingerprints of some Indian leafy vegetables are shown. The leafy vegetables have become rich sources of anti oxidants and immunomodulators. If they are a part of the life as food material the health is maintained well.

40: Genetically modified orange juice: When the foods and the medicines are modified by different methods they should not lose or change the properties as mentioned in traditional texts. If it happens the traditional philosophies of medicines will go erratic, as they have been designed based on the properties of material having specific physicochemical properties. The fingerprints of a genetically modified food product, the orange juices were presented in the figure. After genetic modification, if the products do not contain the same properties like the original with similar efficacy, the efficacy cannot be tested by traditional methods and so will act differently. If all herbal medicines are genetically modified the traditional philosophies will go erratic leaving the countries in dilemma about the traditional medicines and foods being used in day-to-day life.

41. Fingerprints of some anti stress medicines were presented which show common chemical constituents which possess common therapeutic properties.

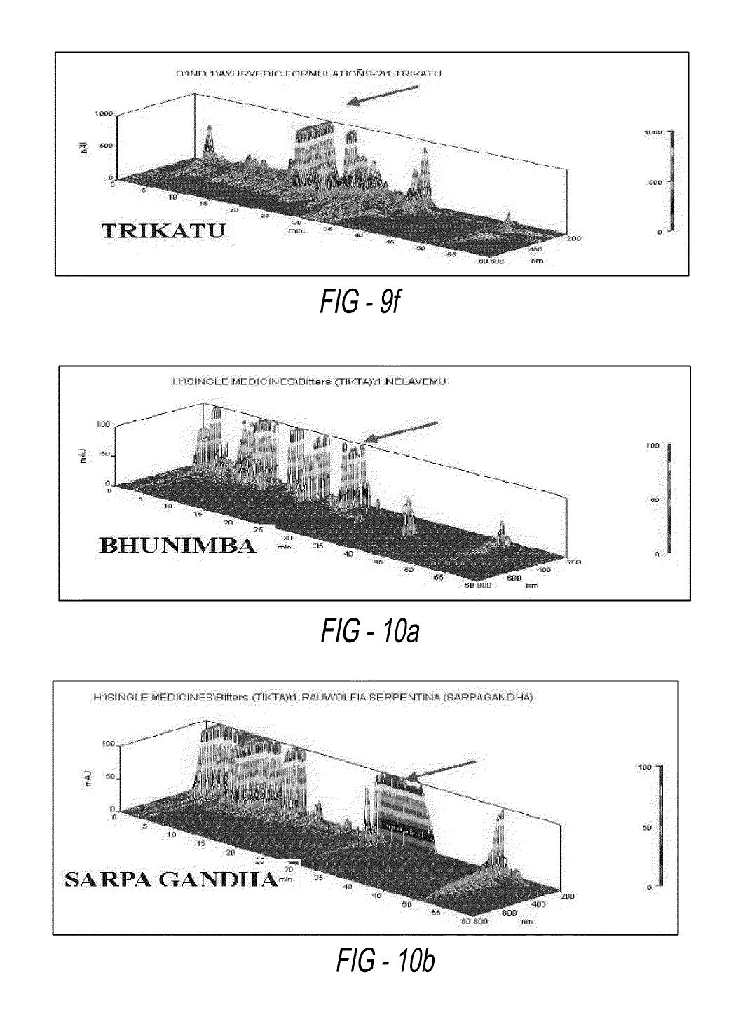

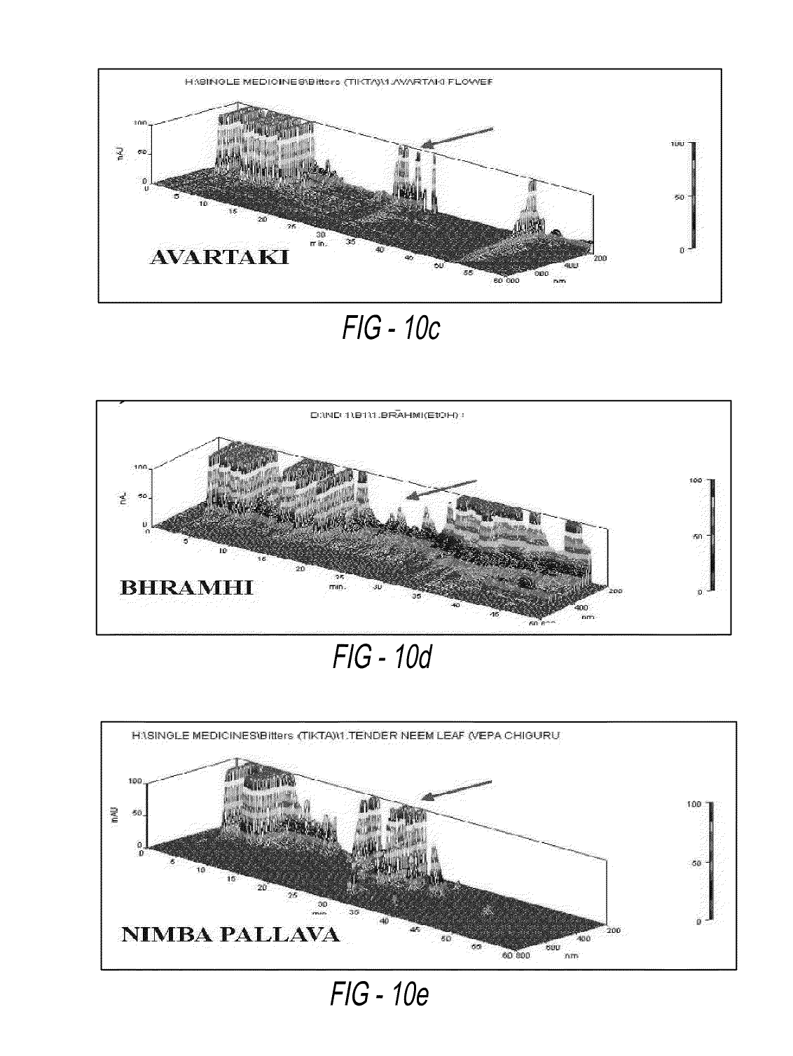

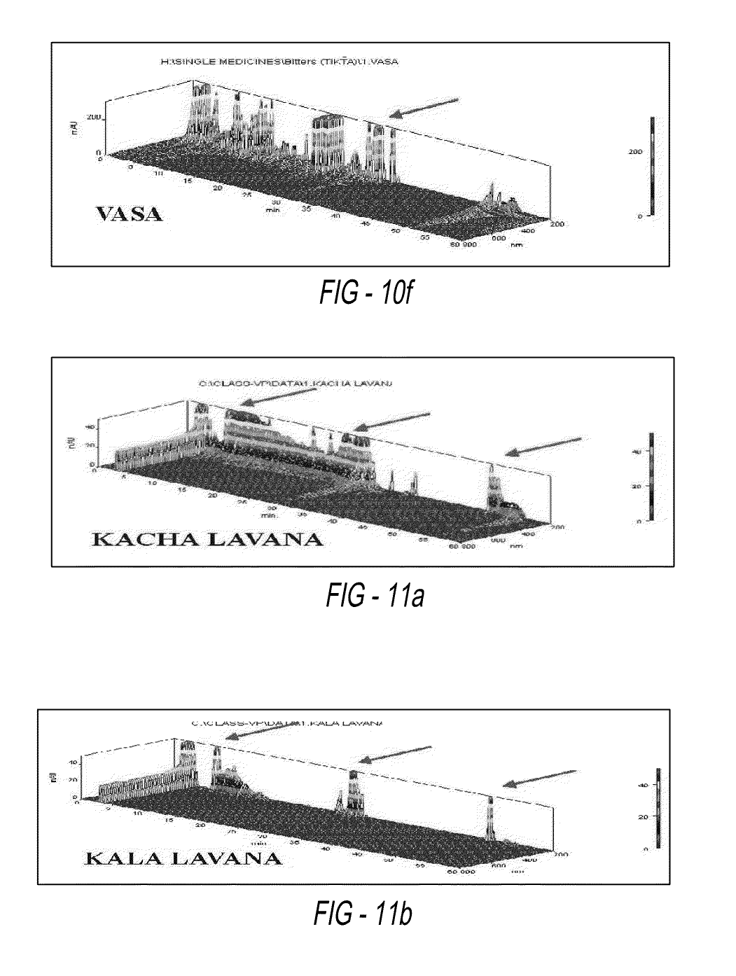

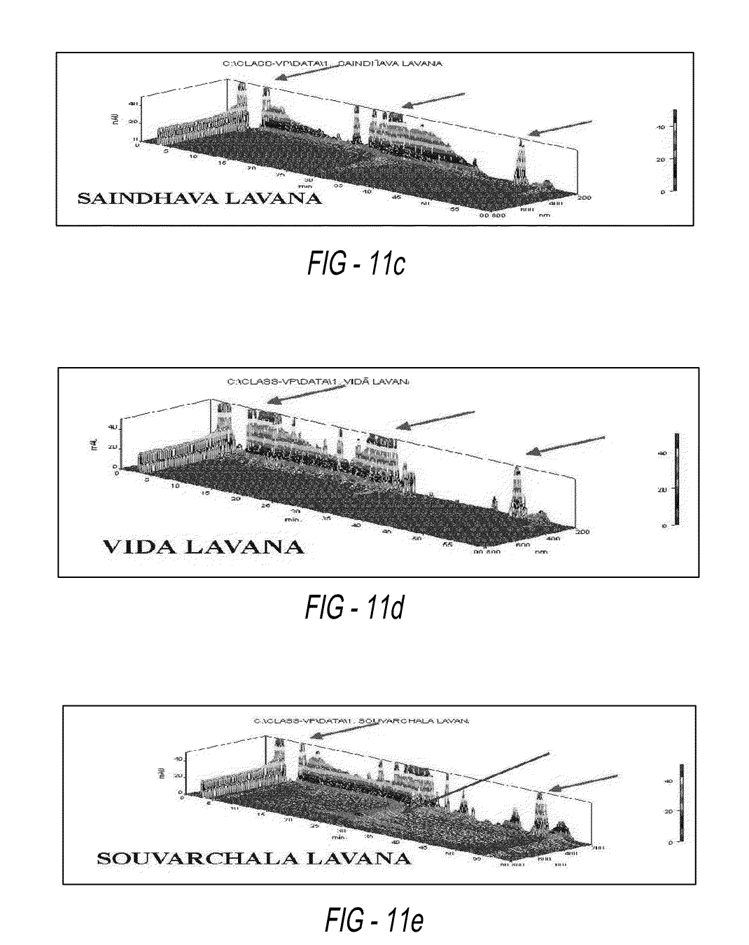

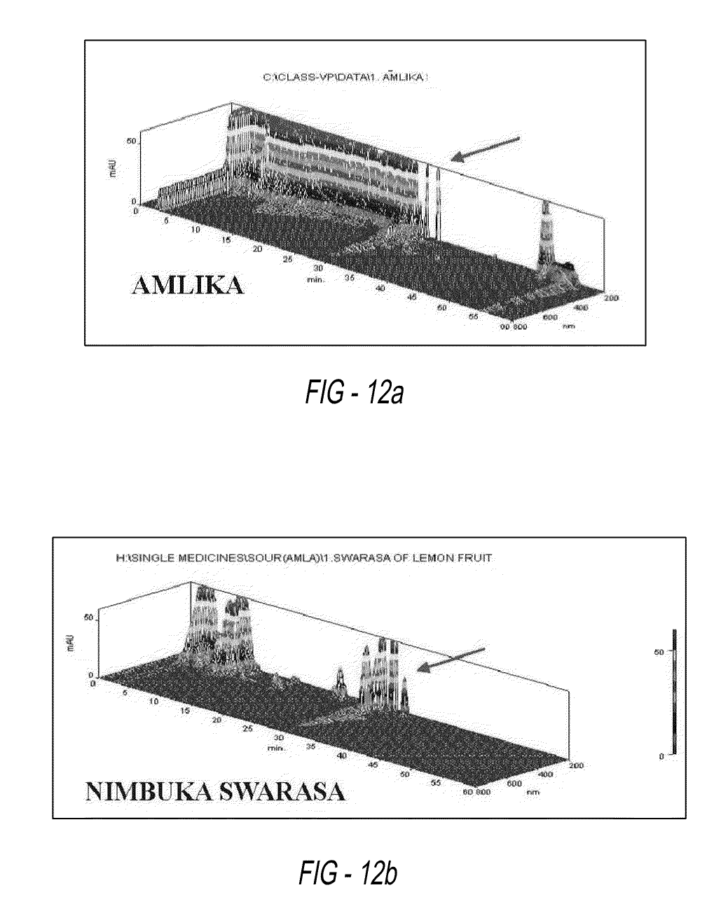

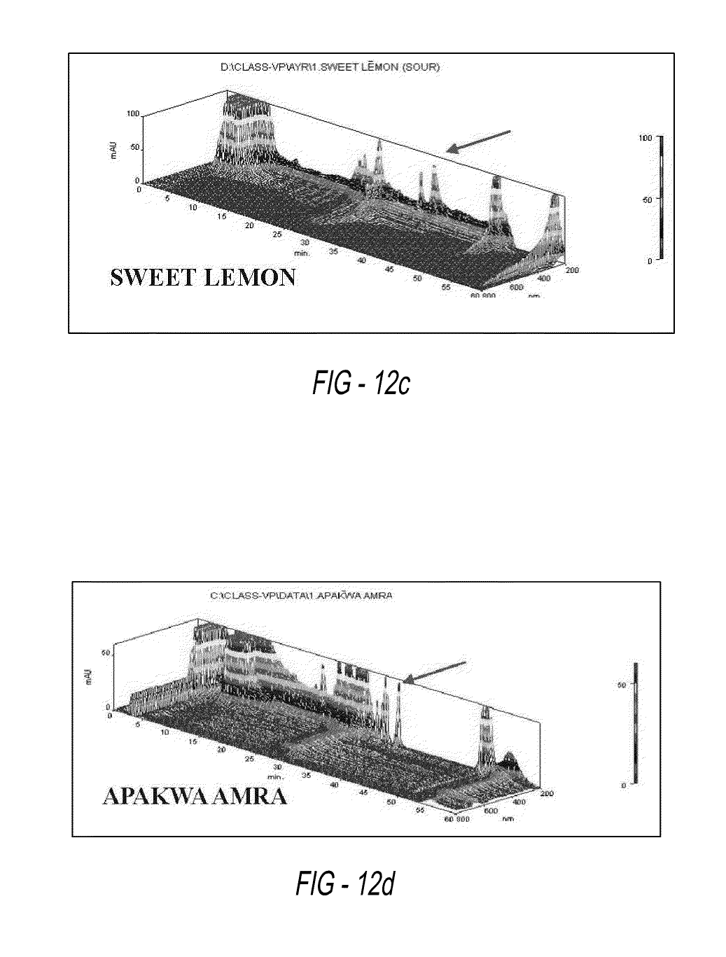

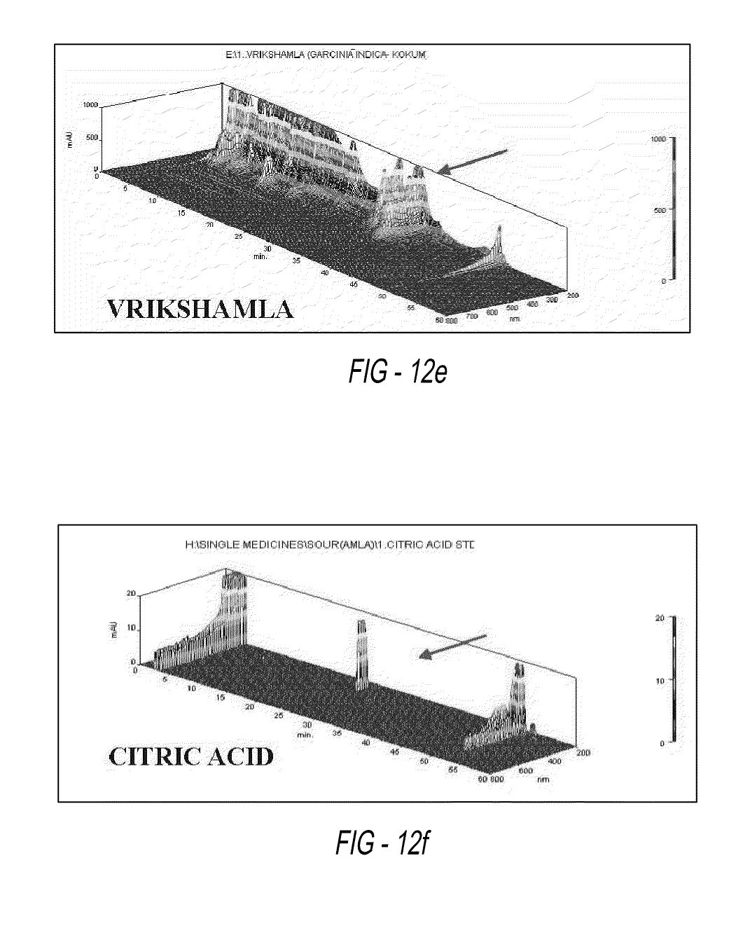

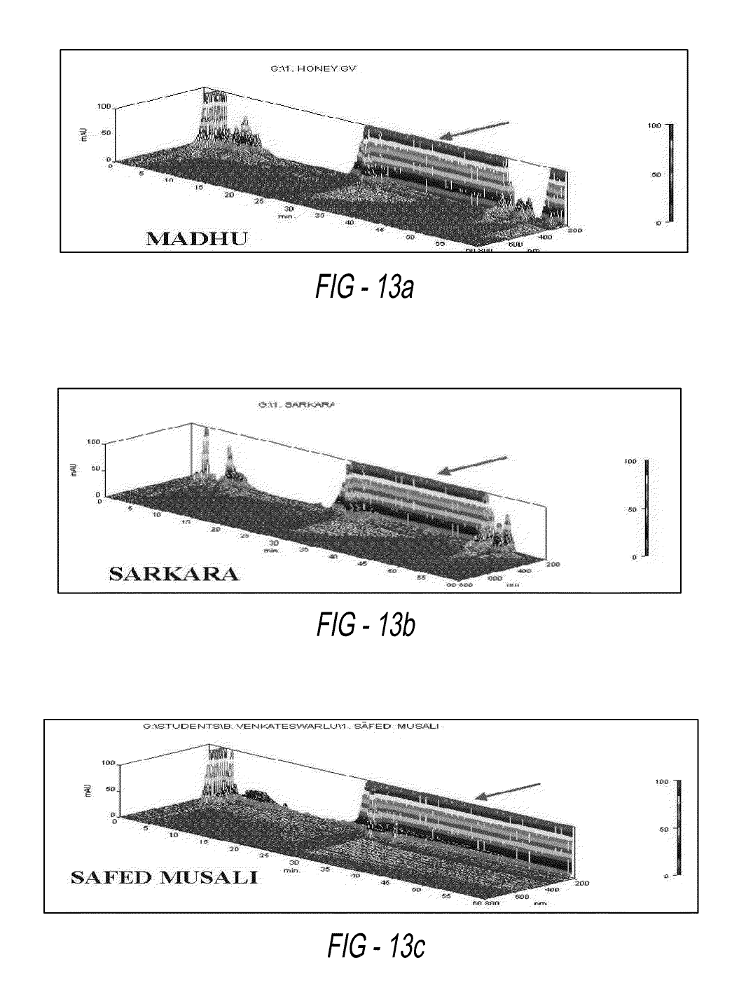

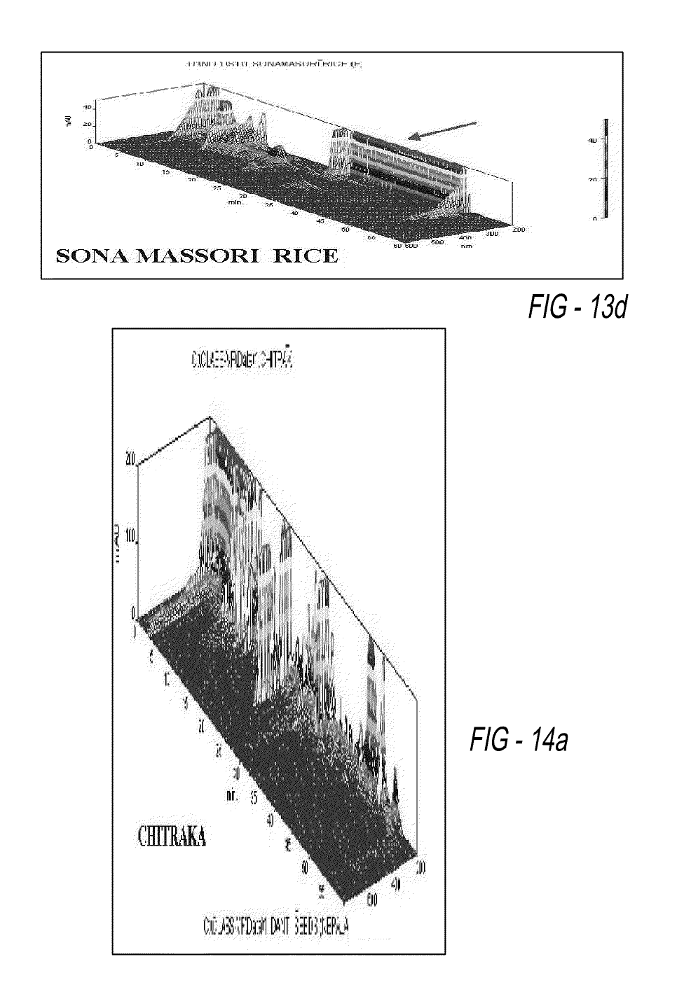

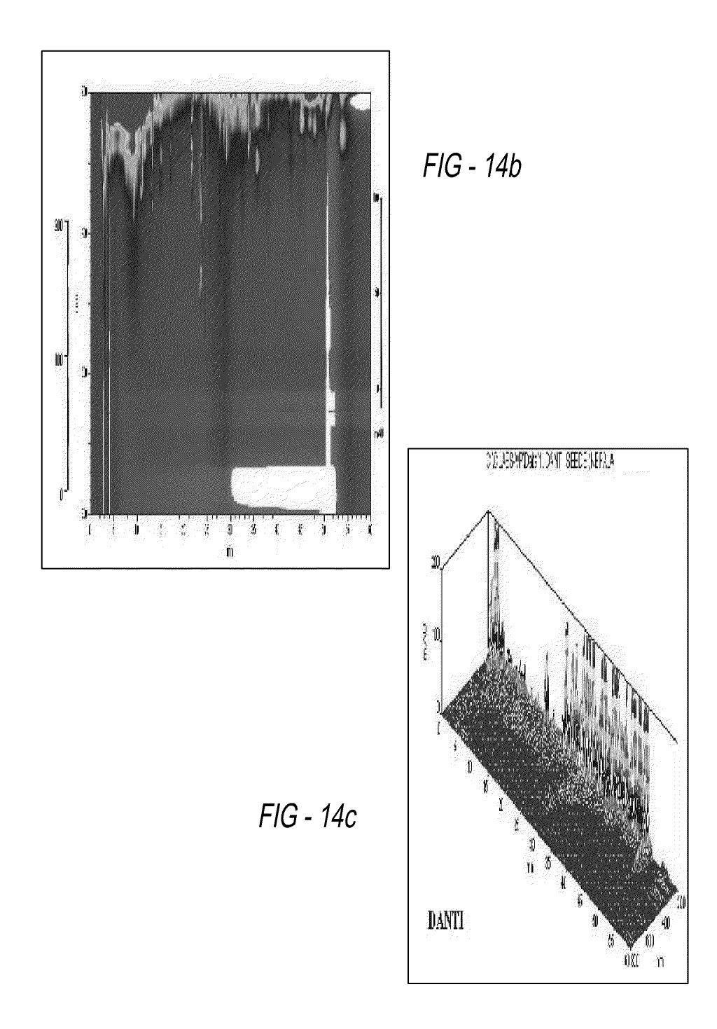

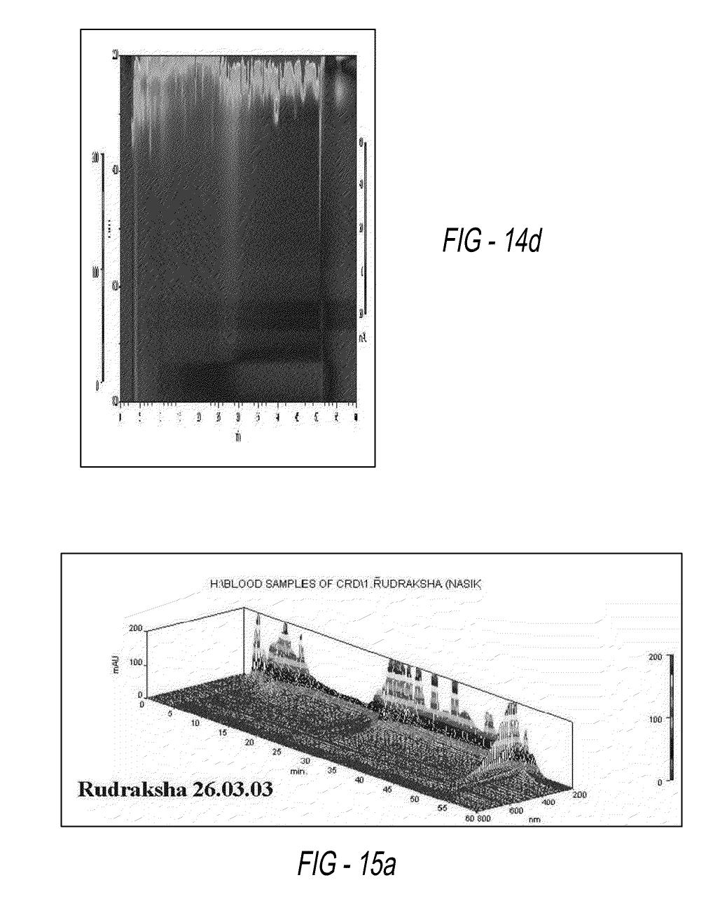

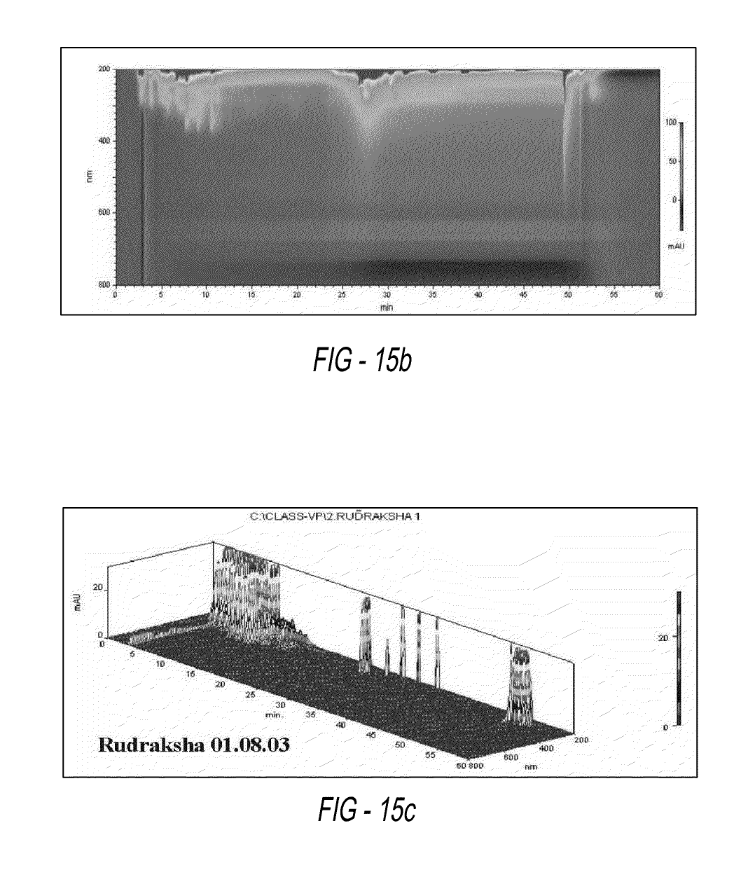

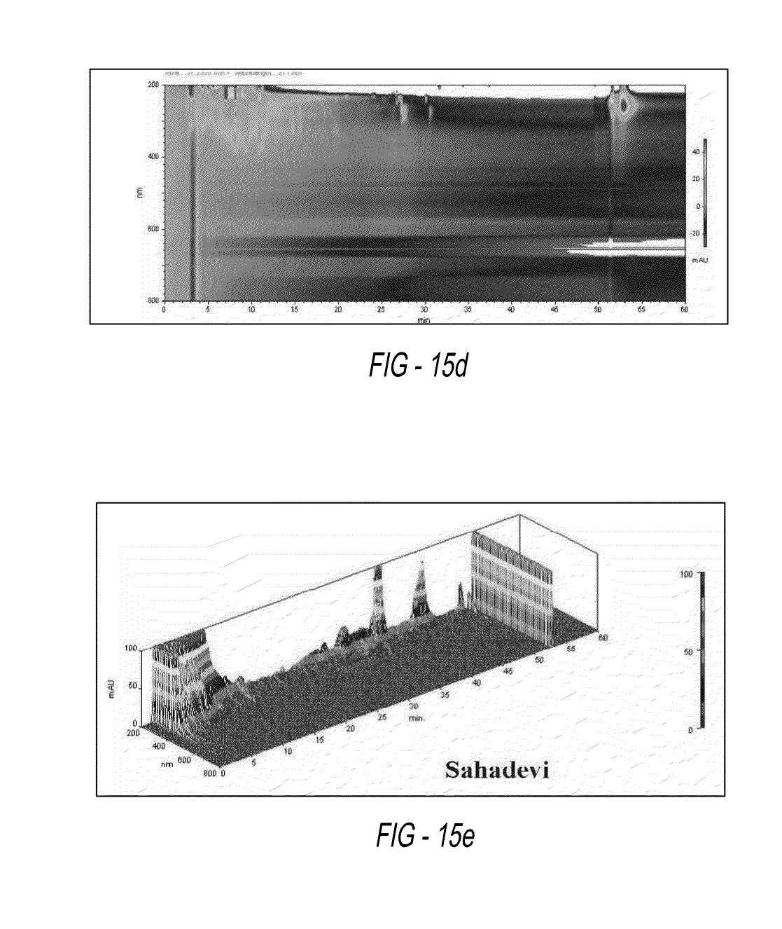

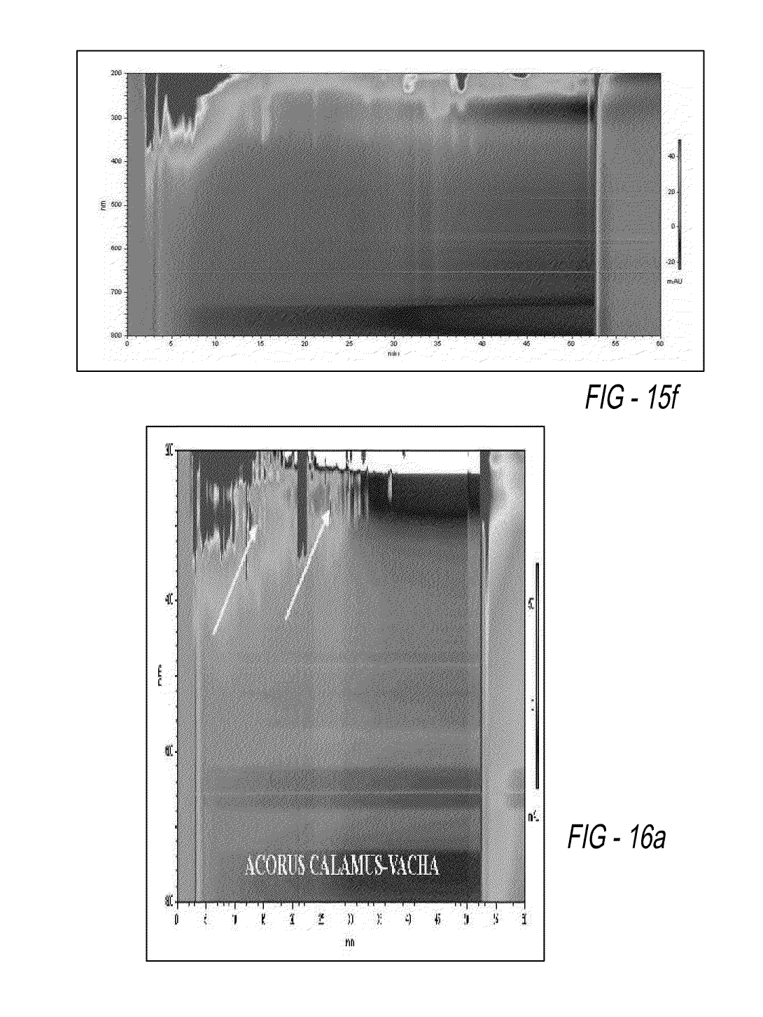

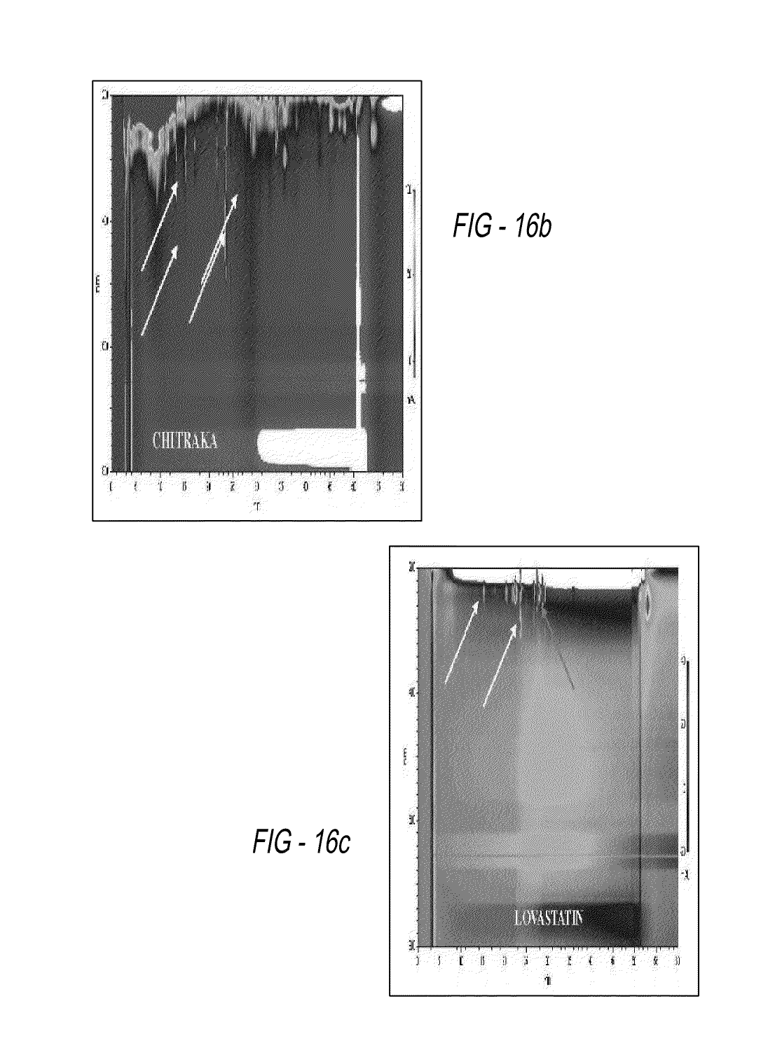

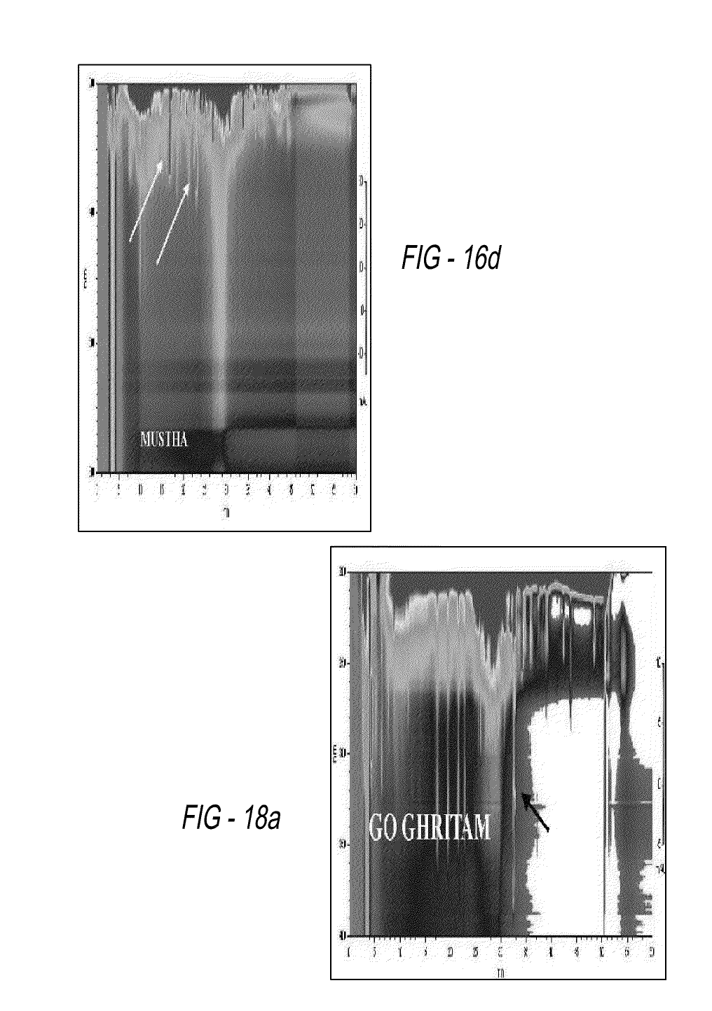

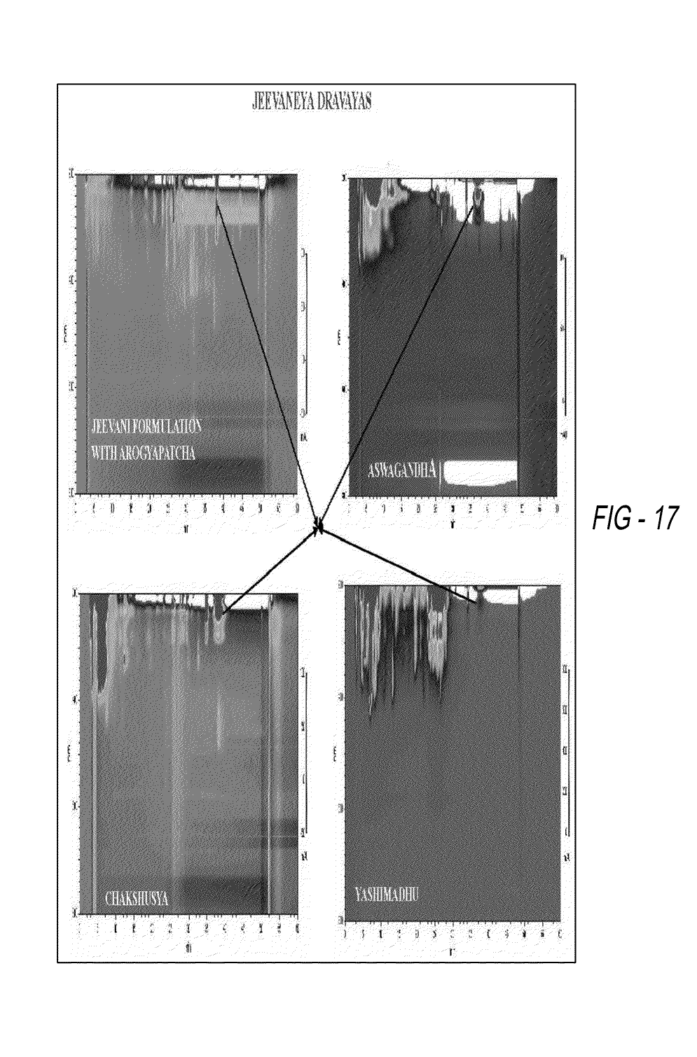

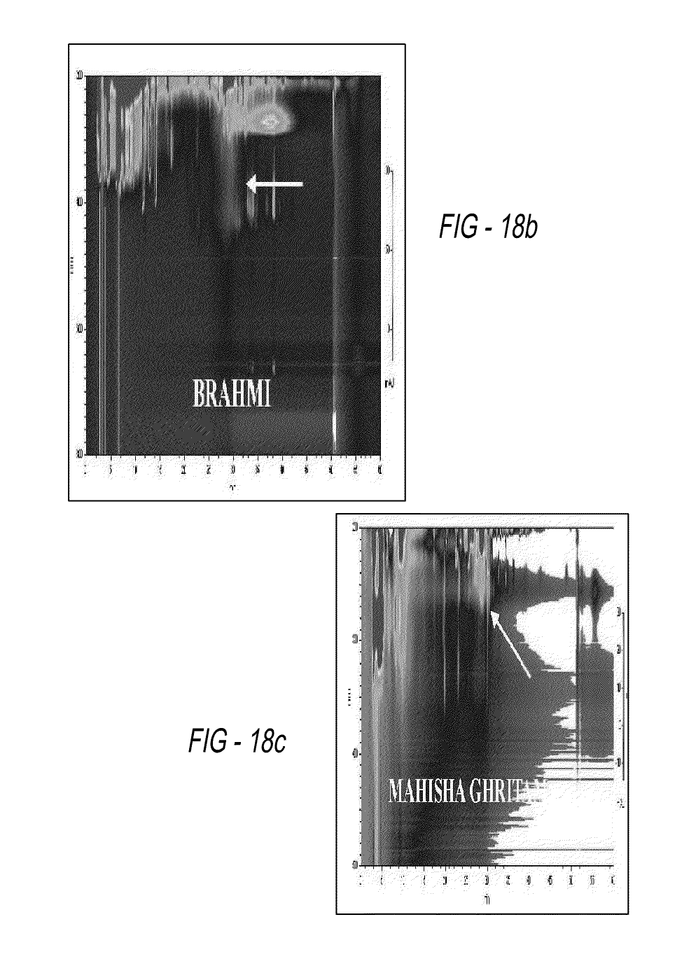

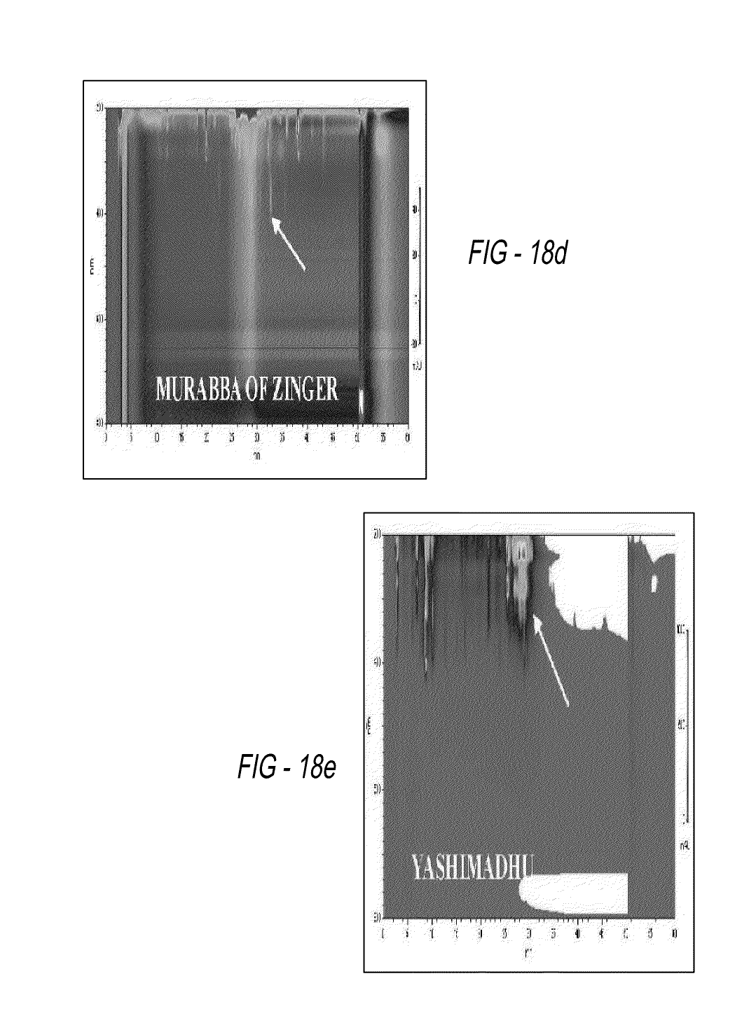

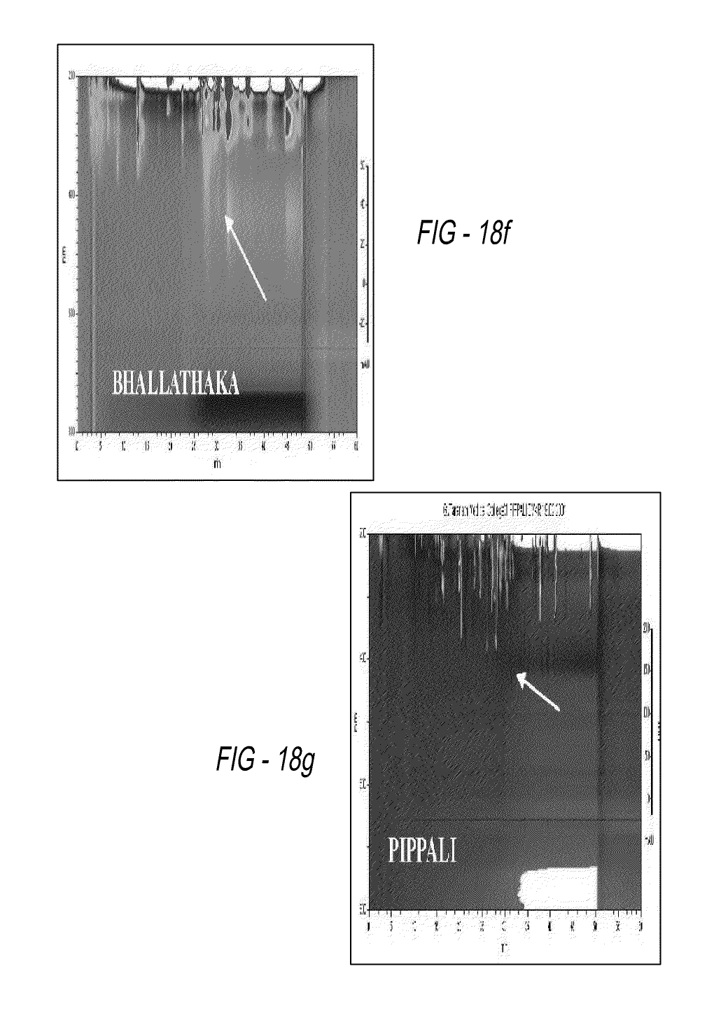

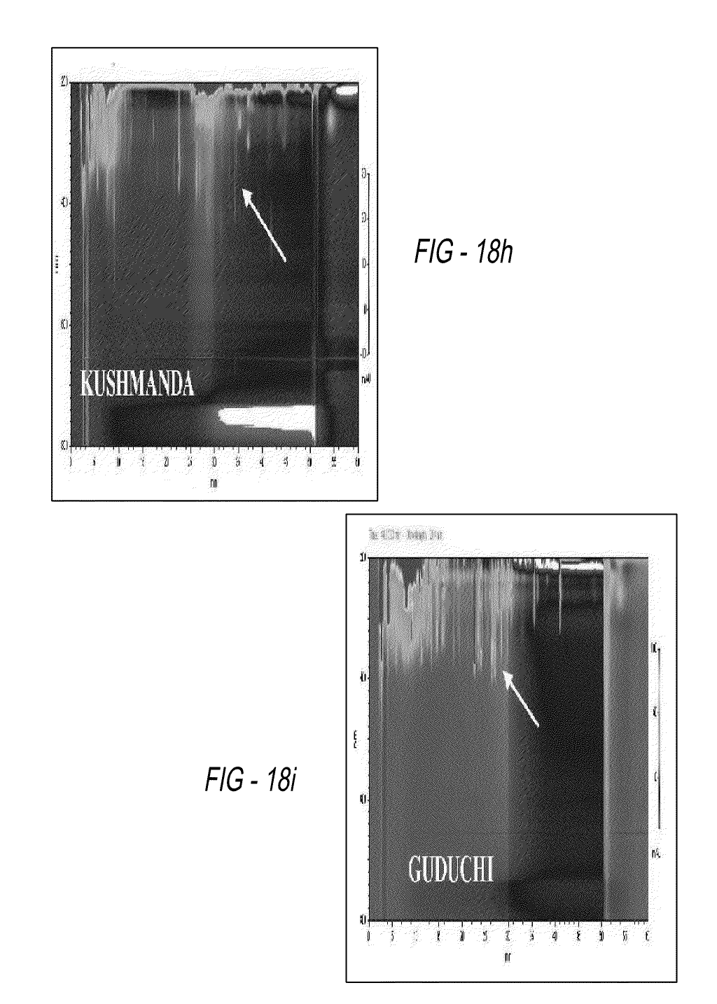

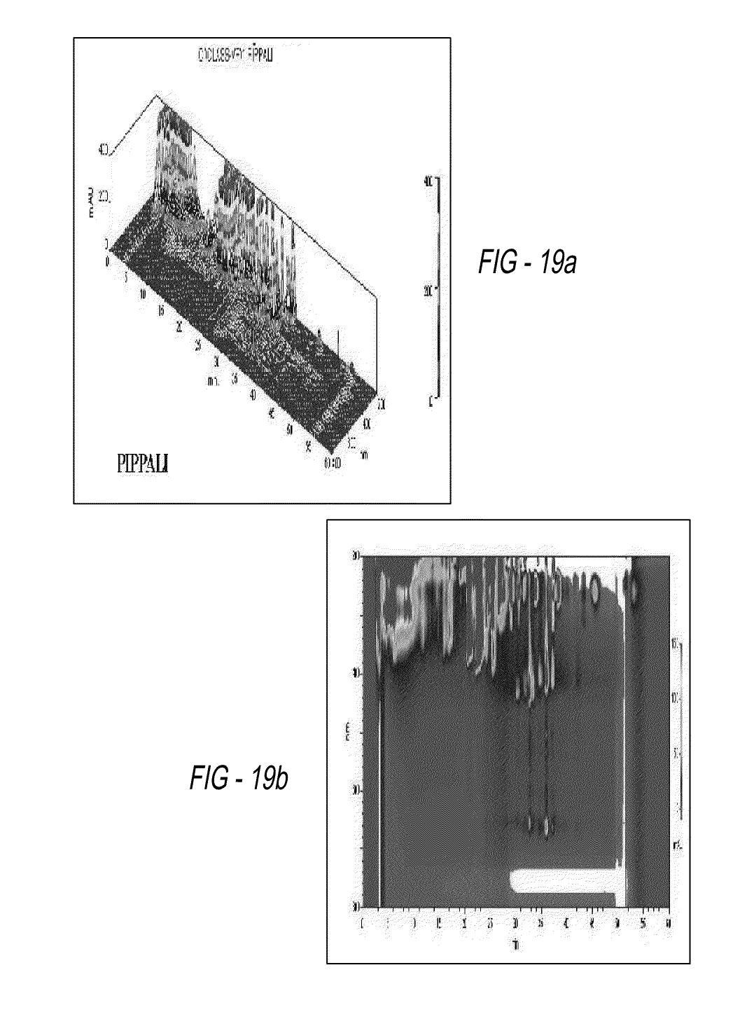

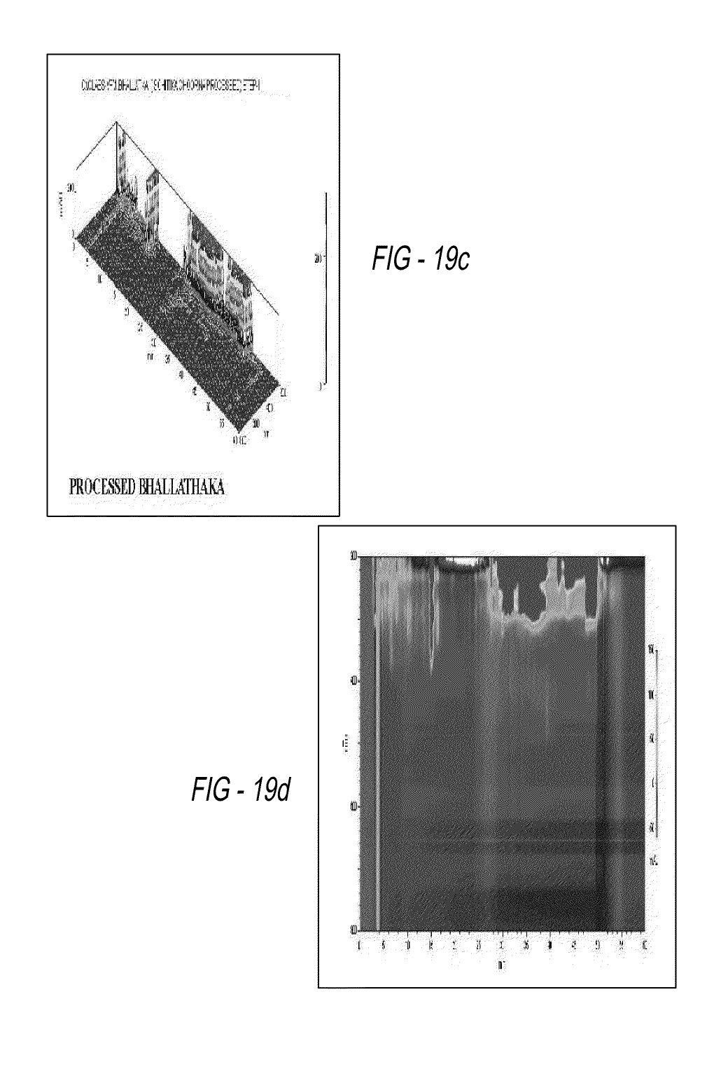

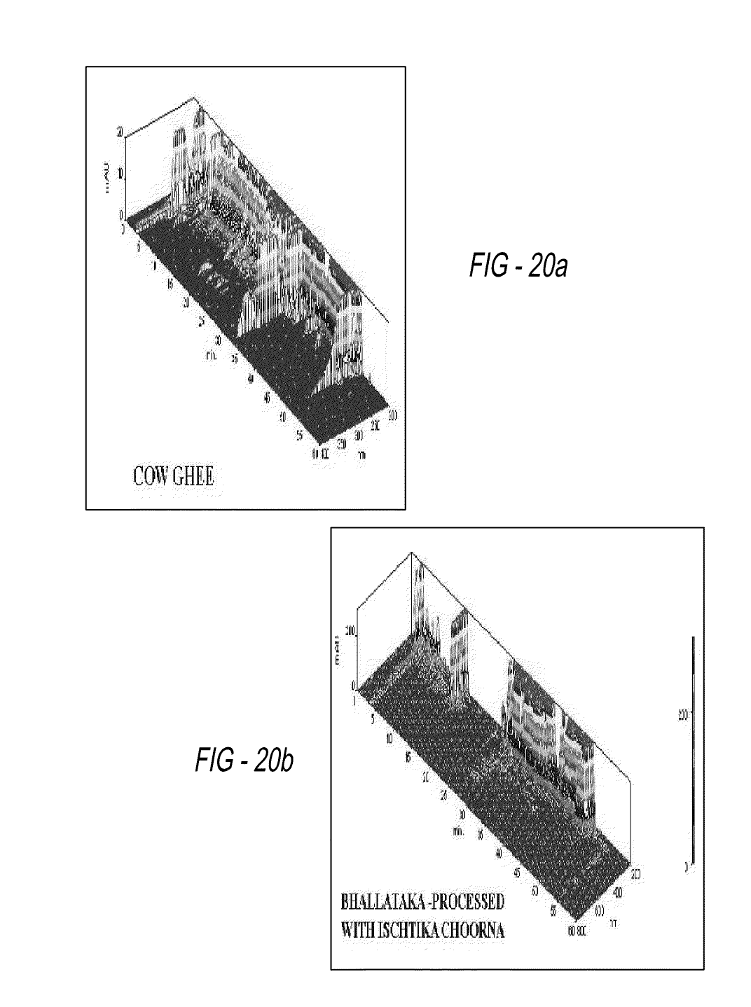

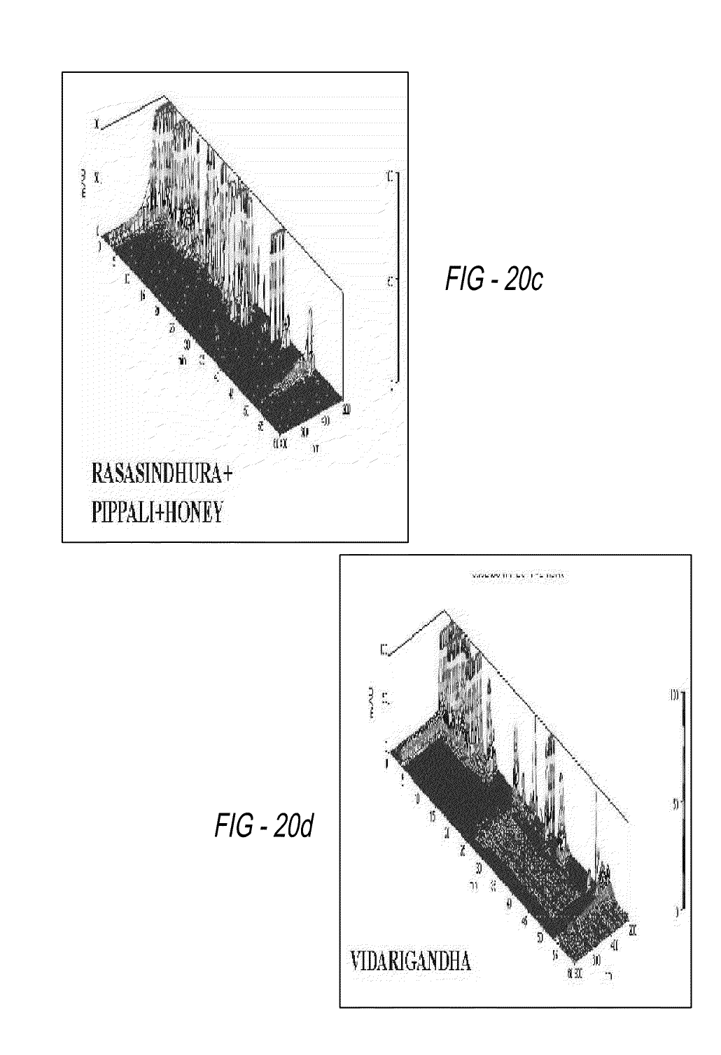

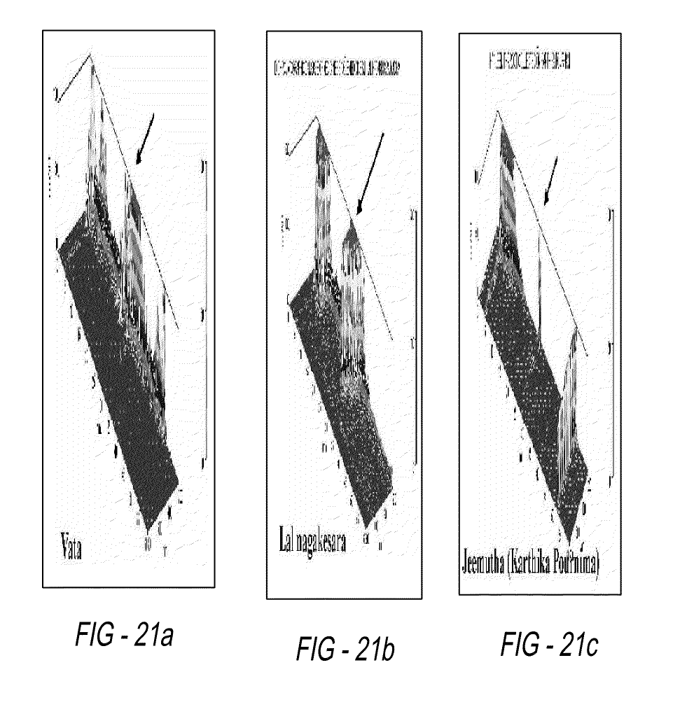

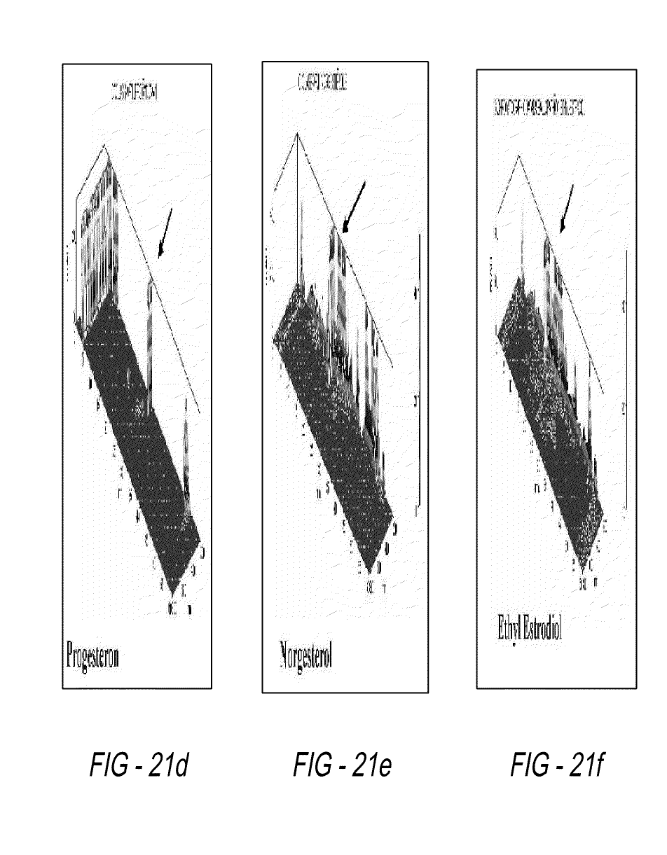

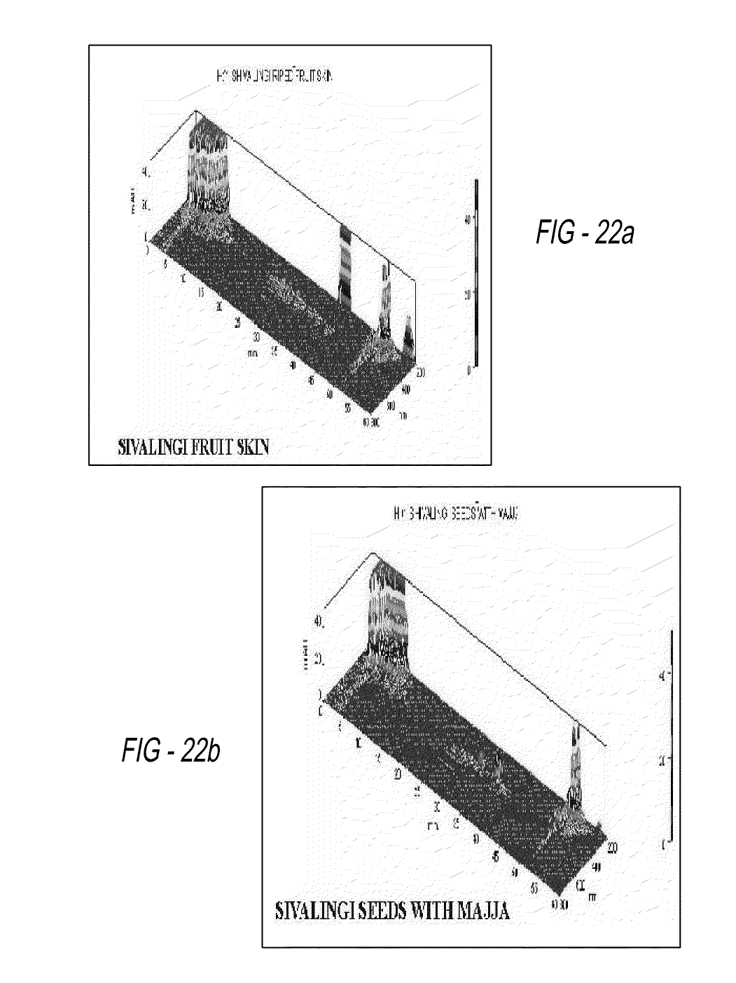

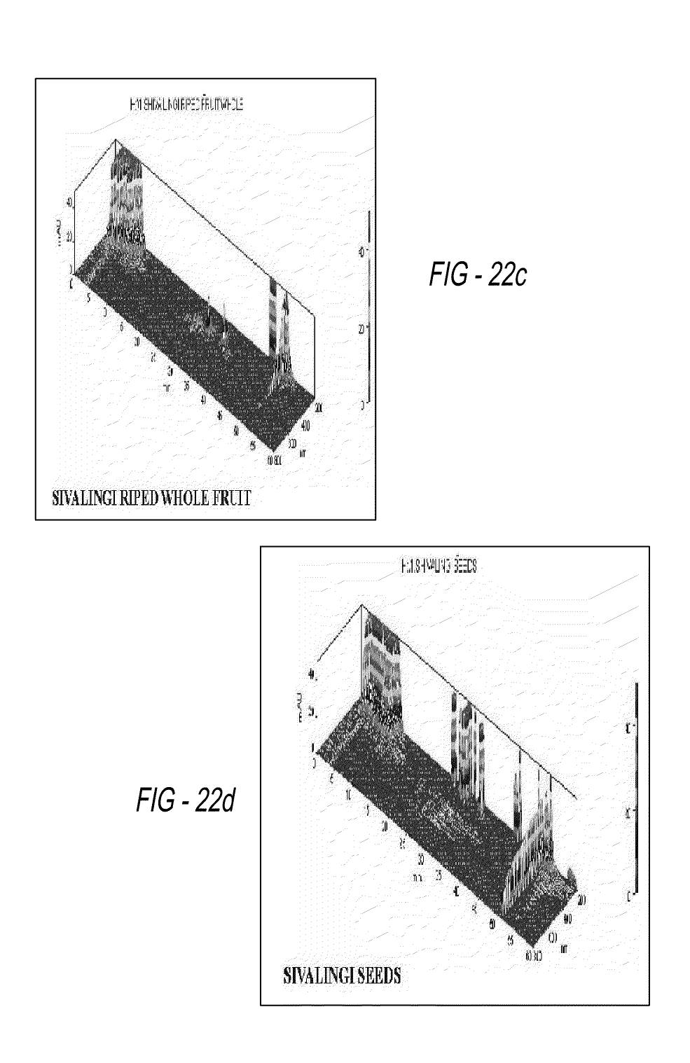

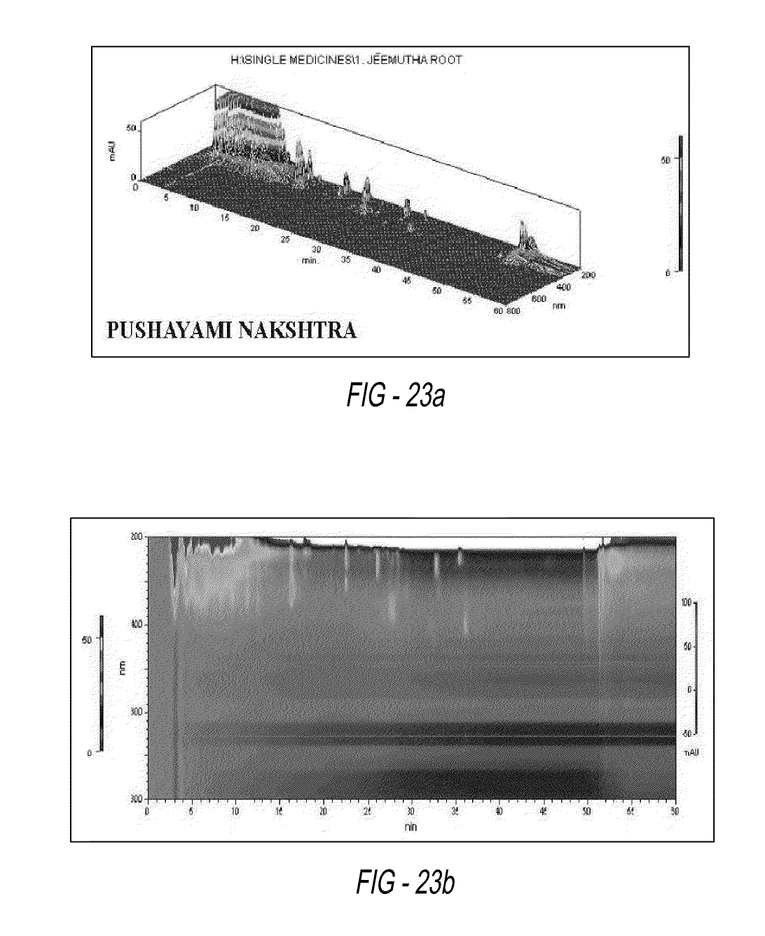

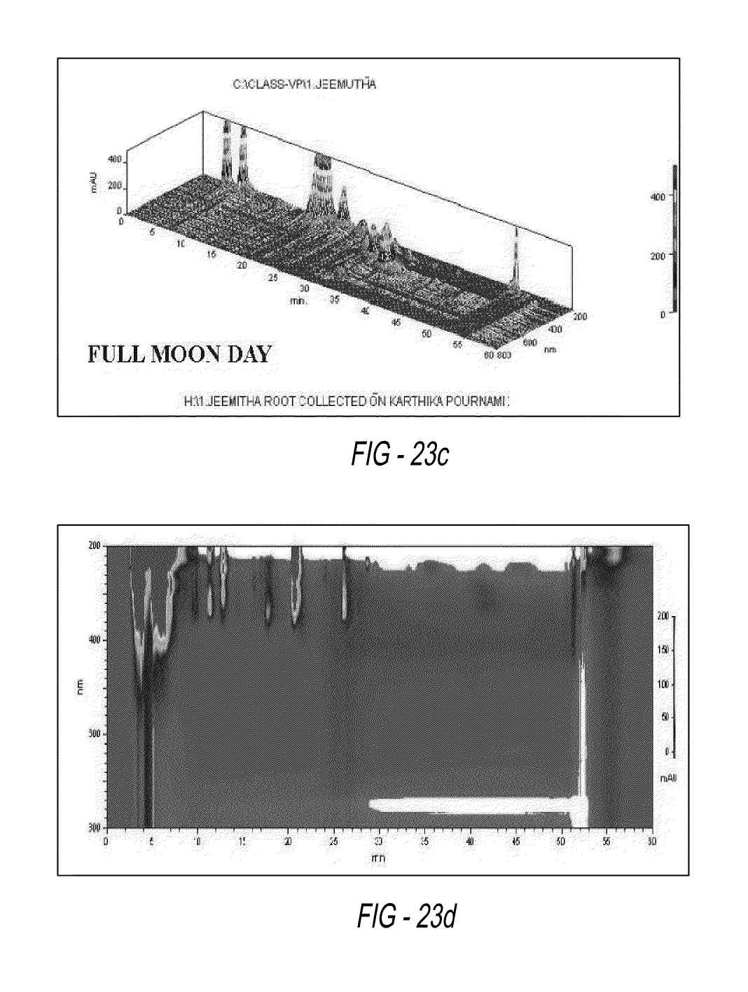

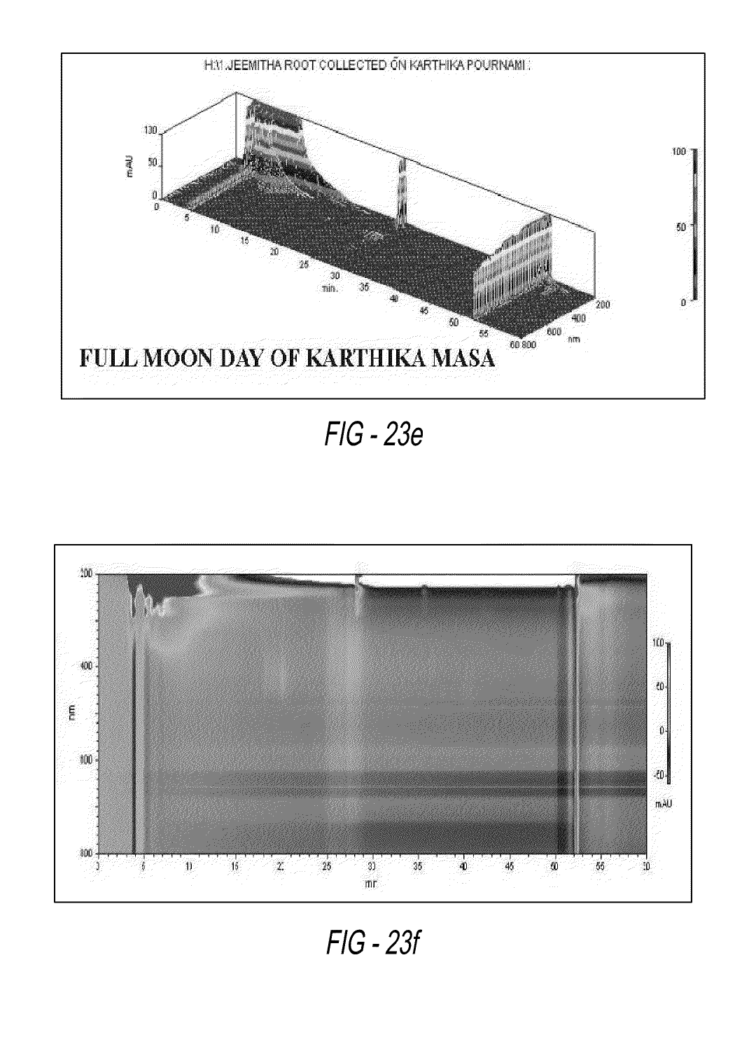

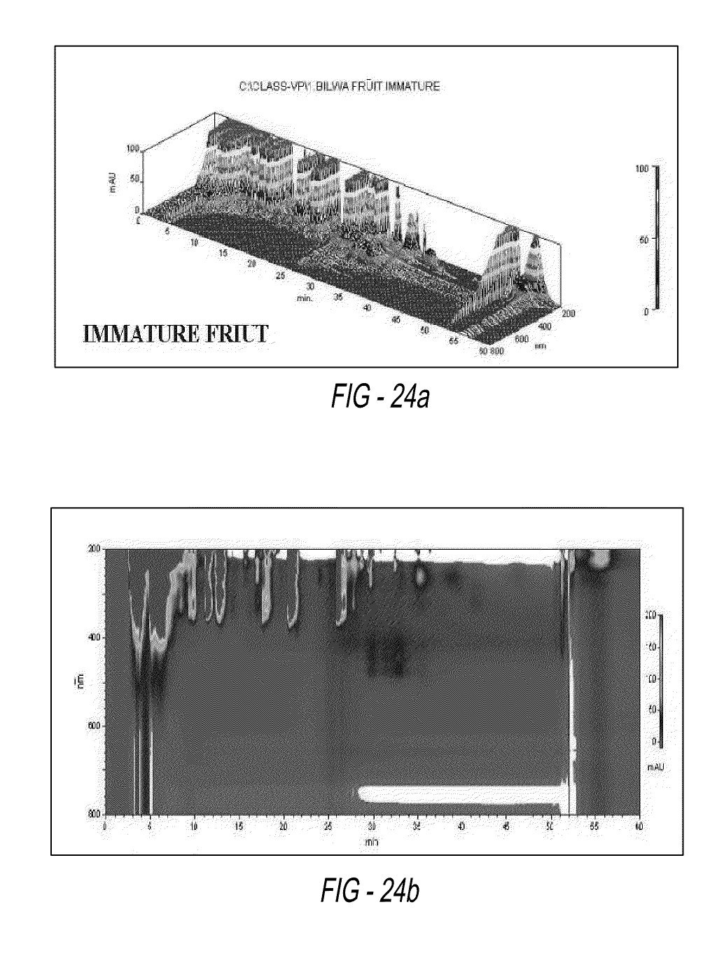

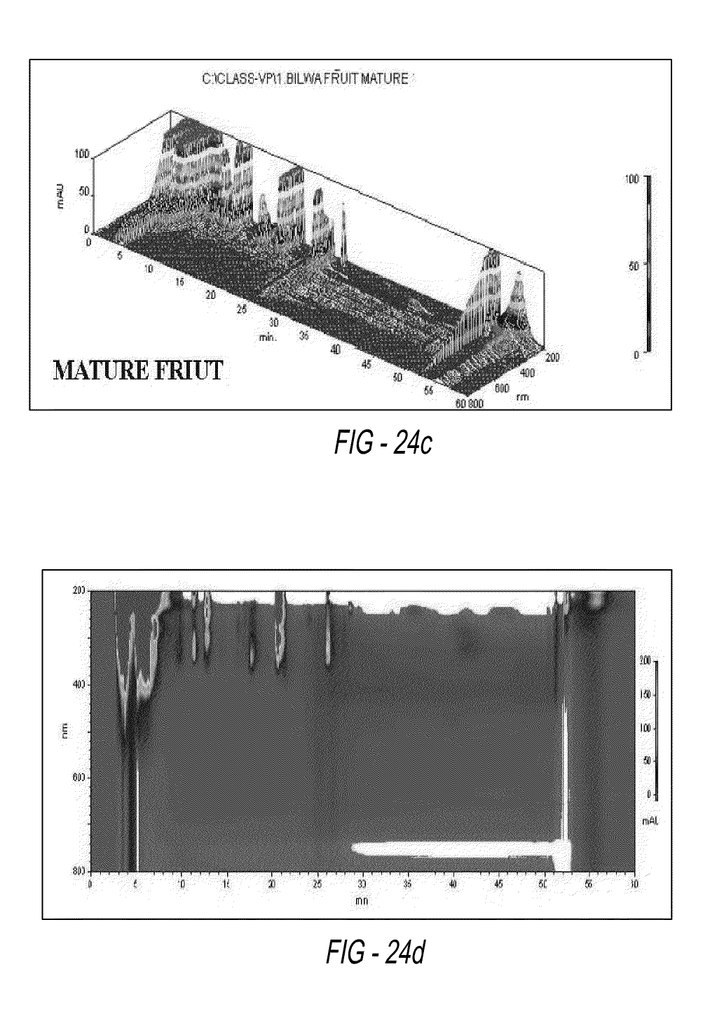

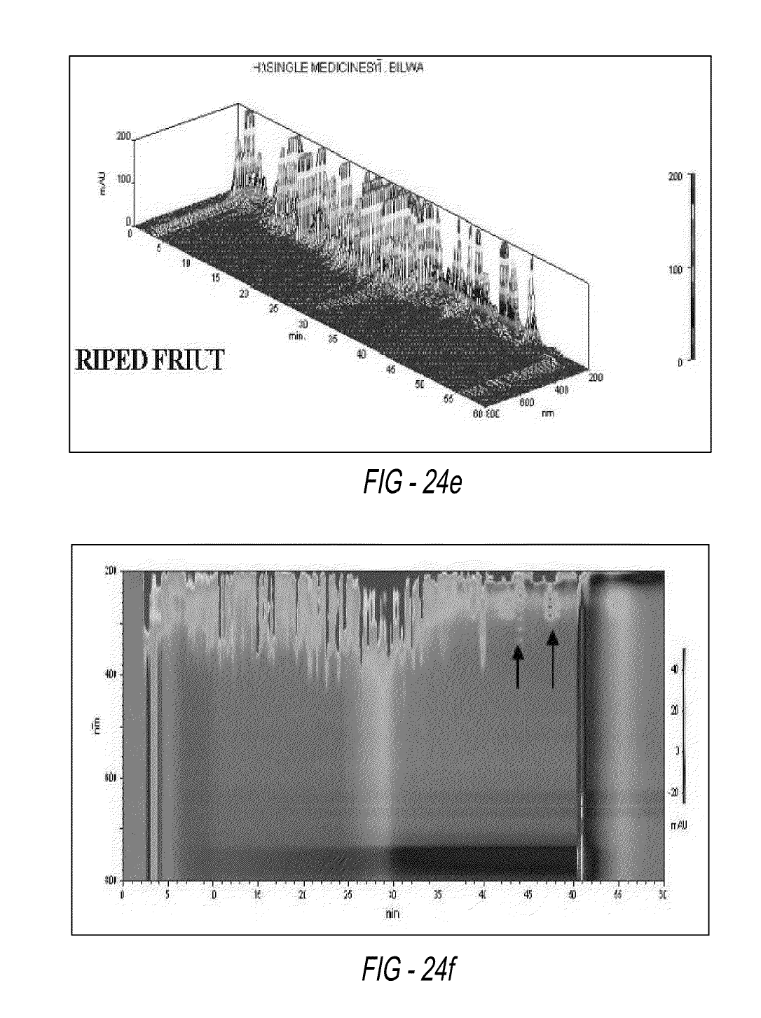

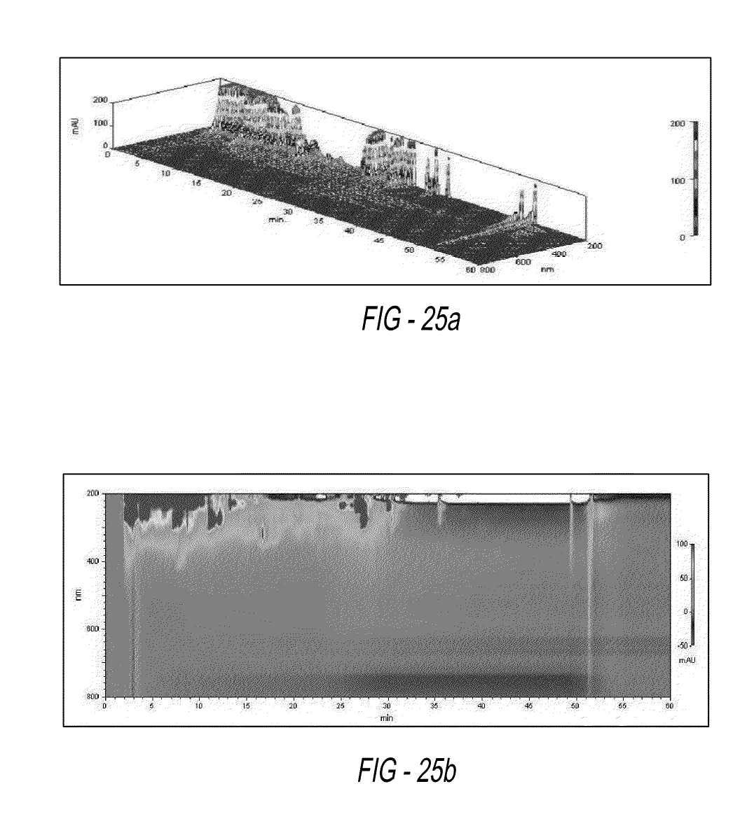

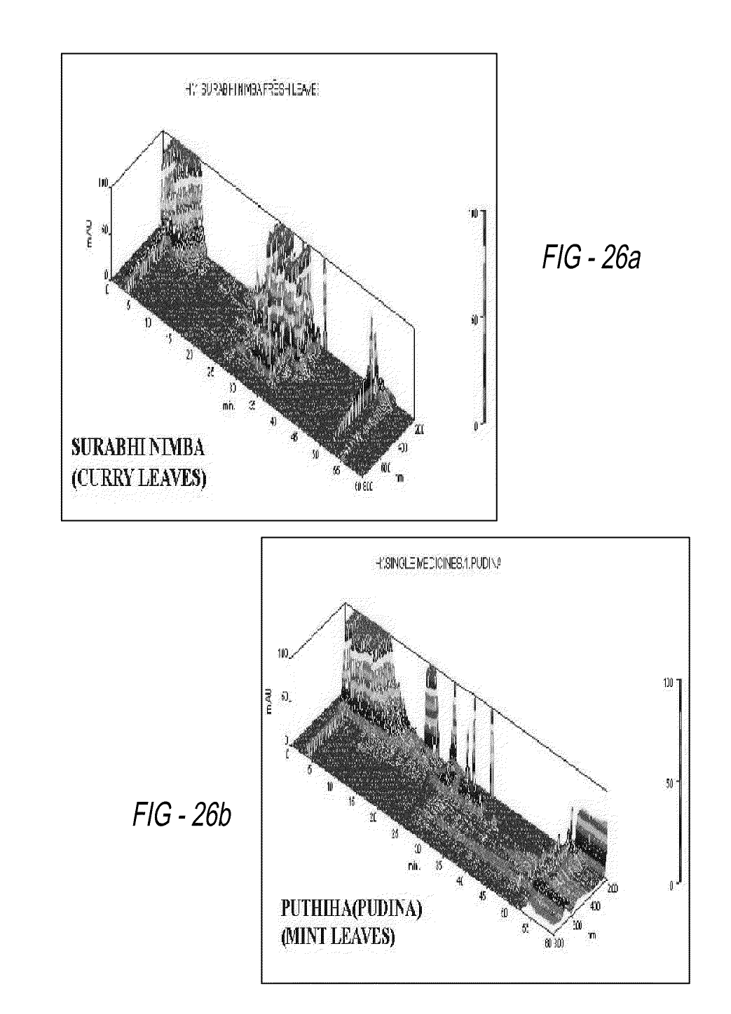

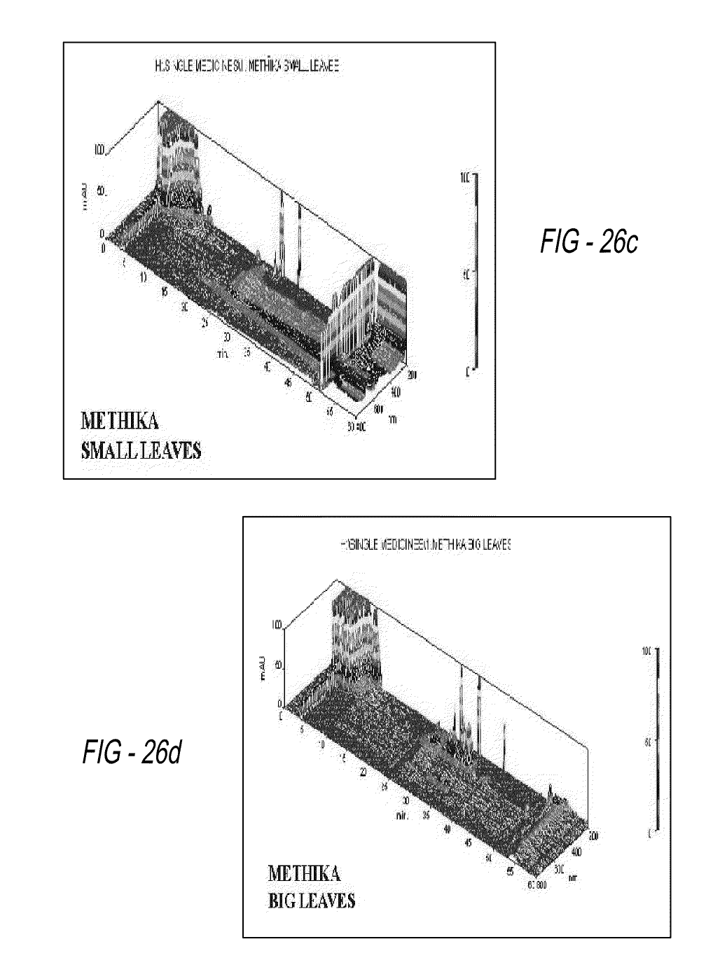

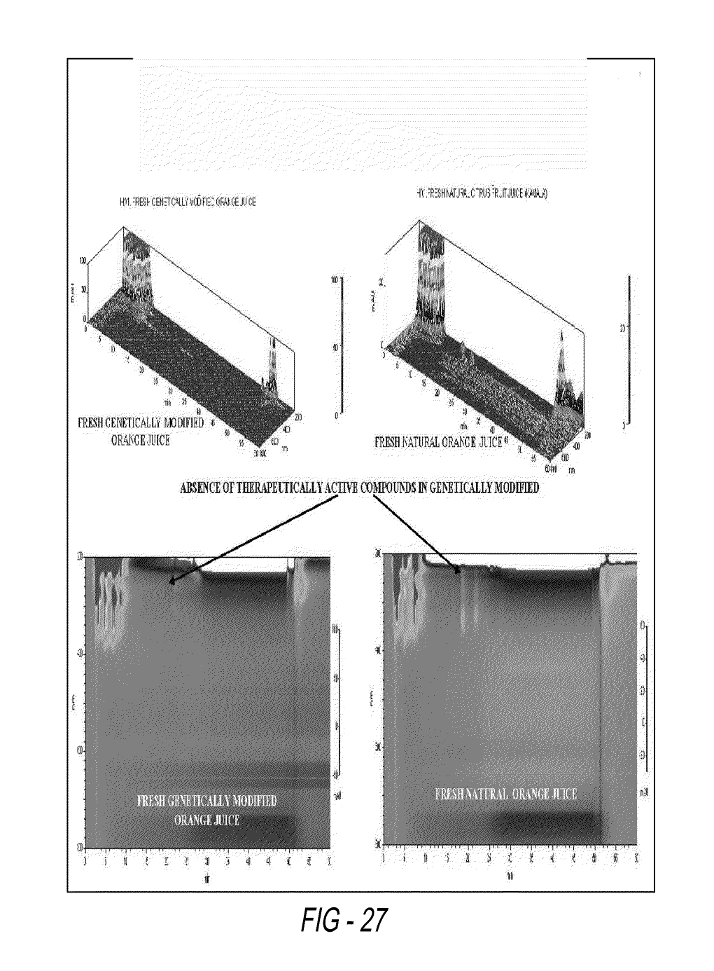

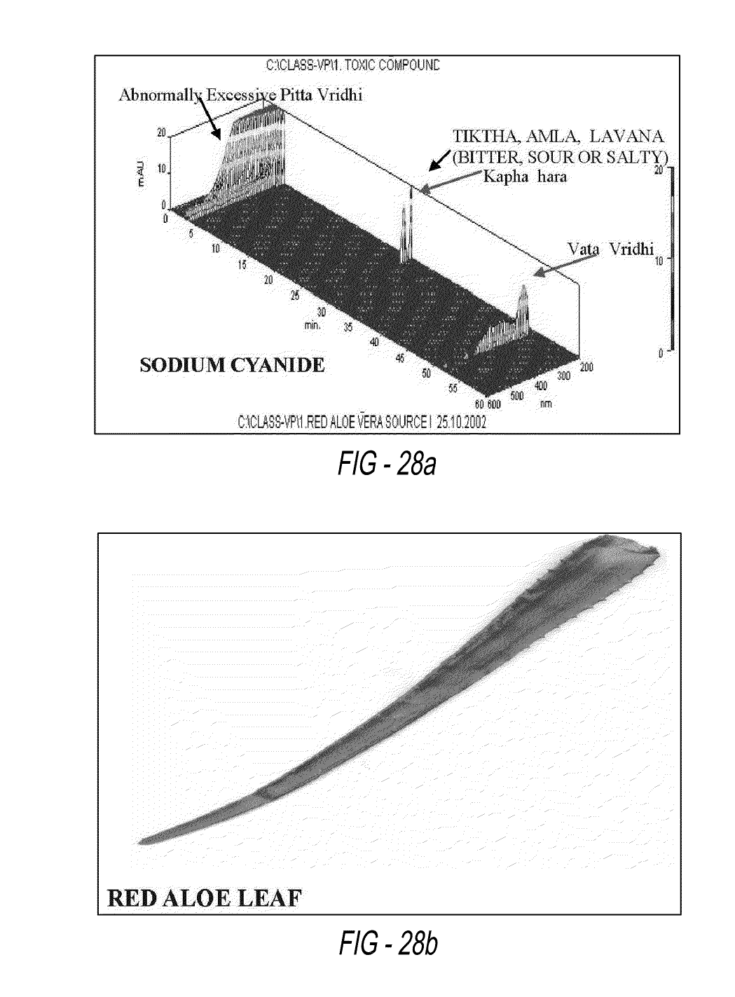

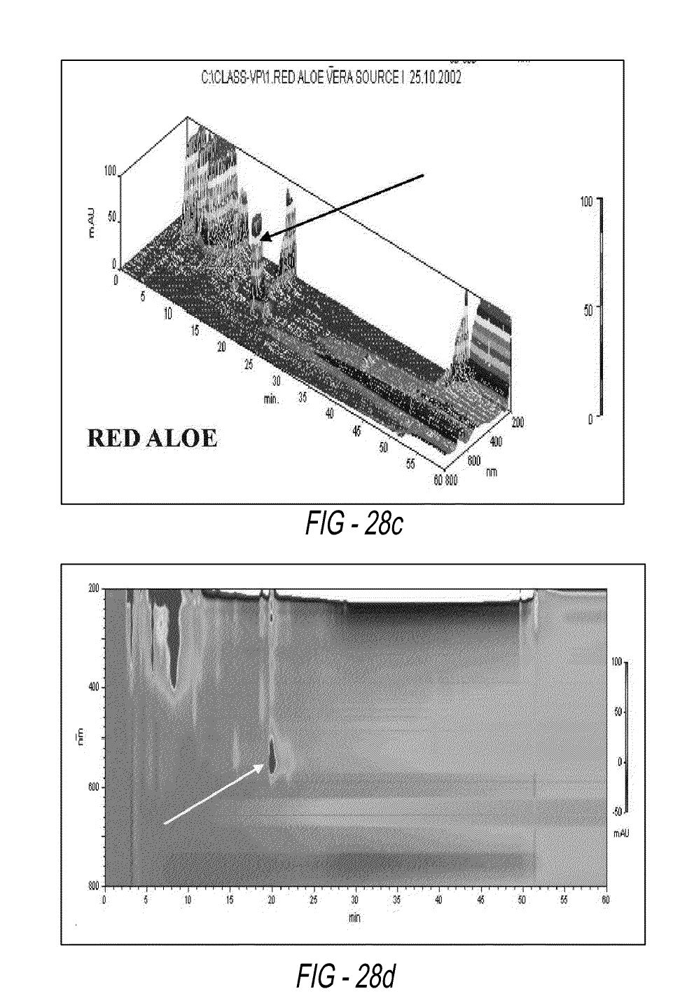

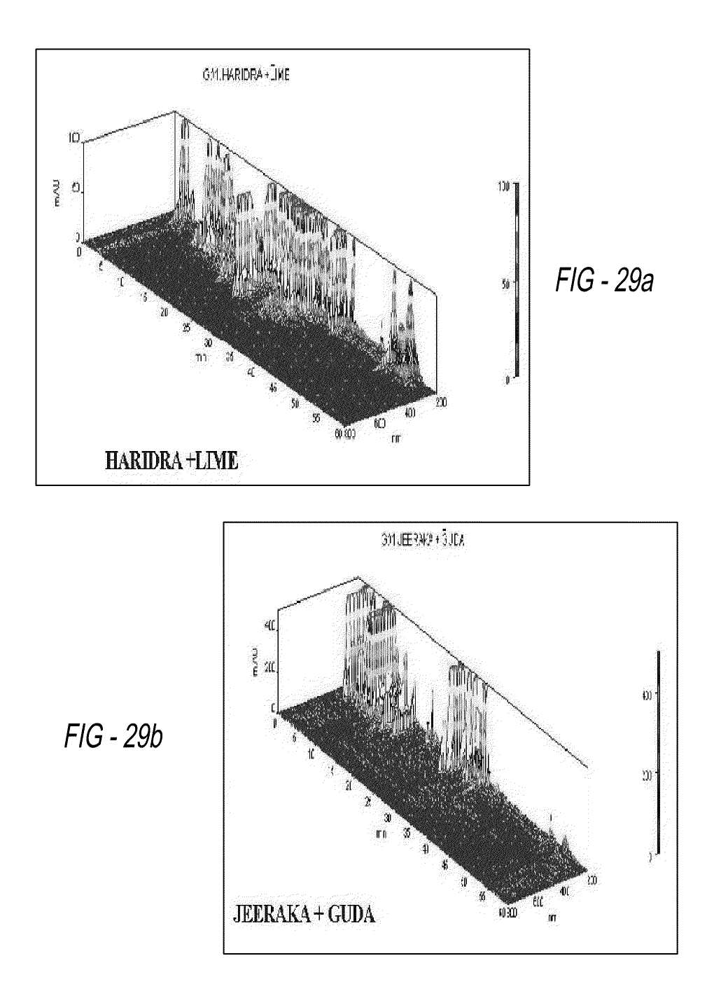

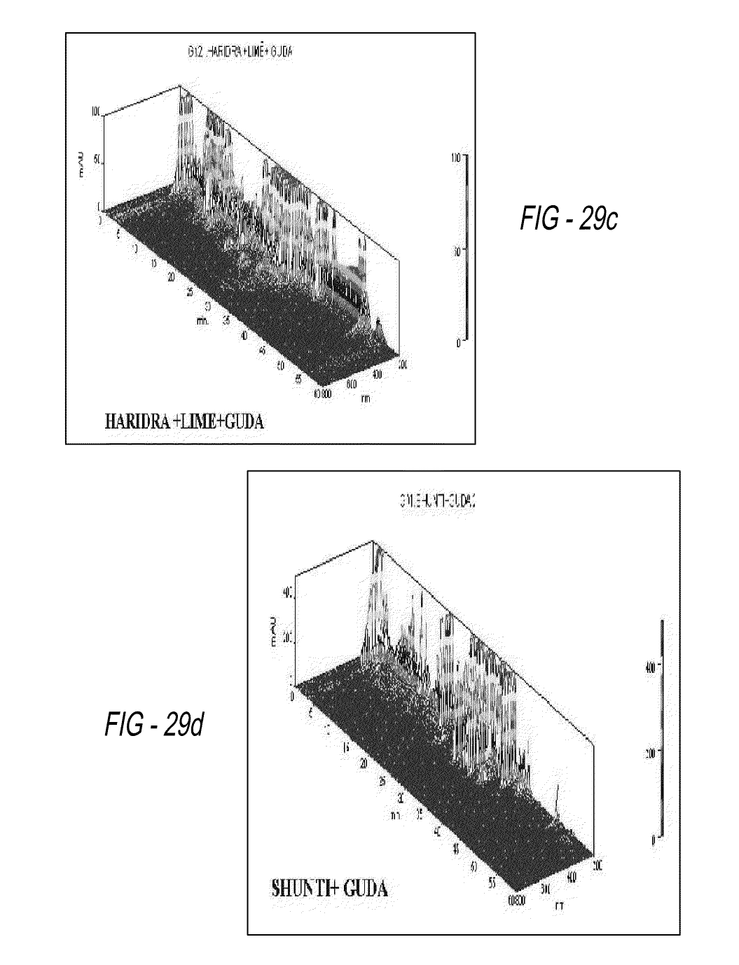

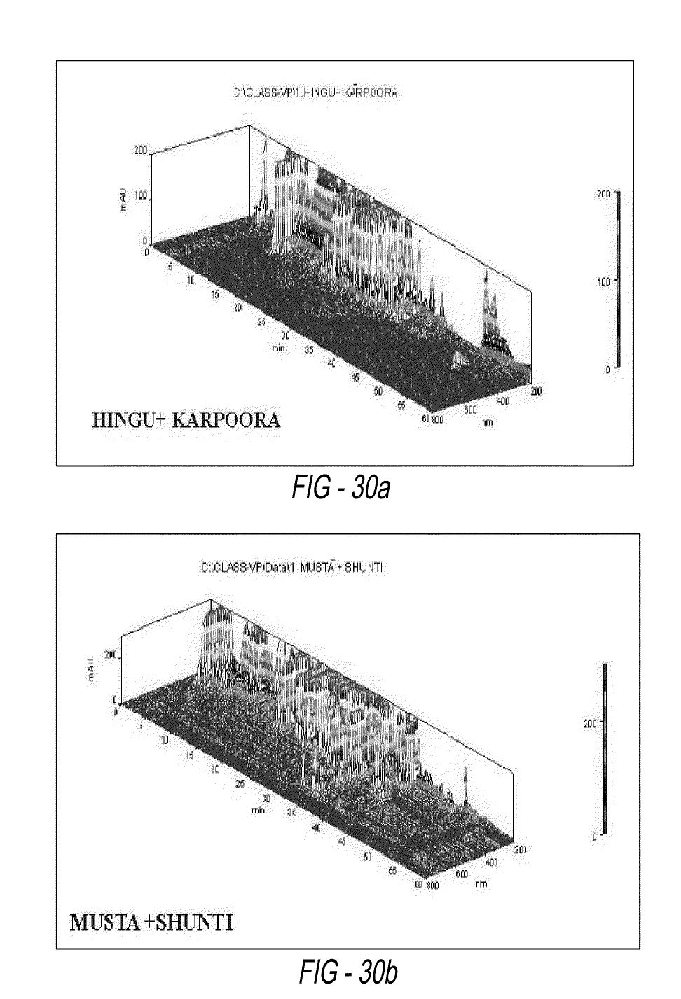

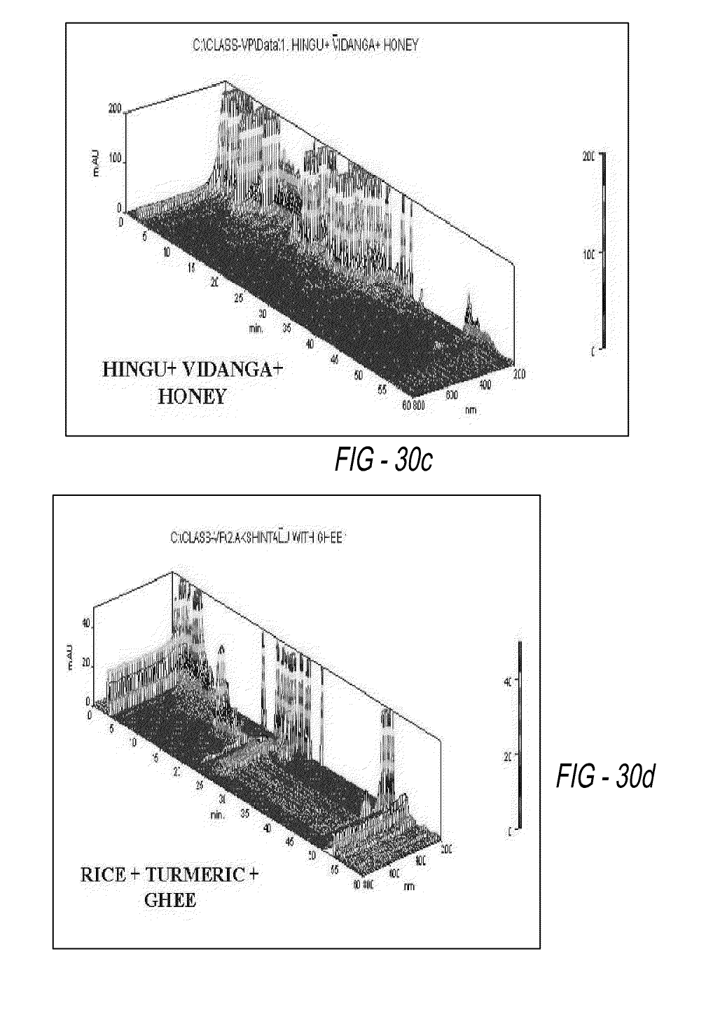

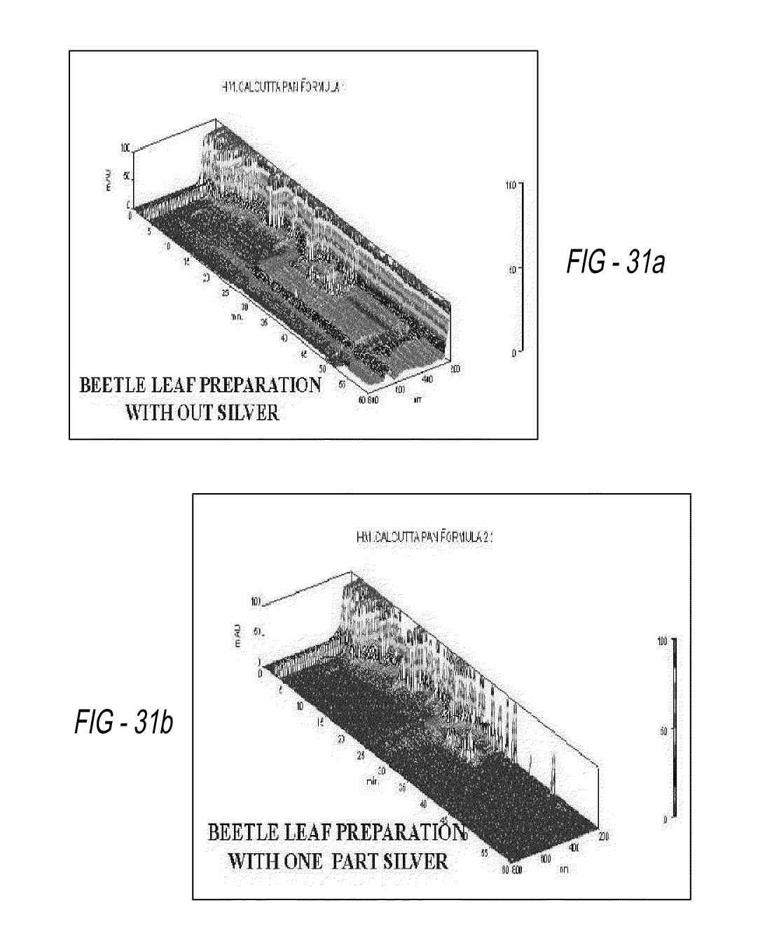

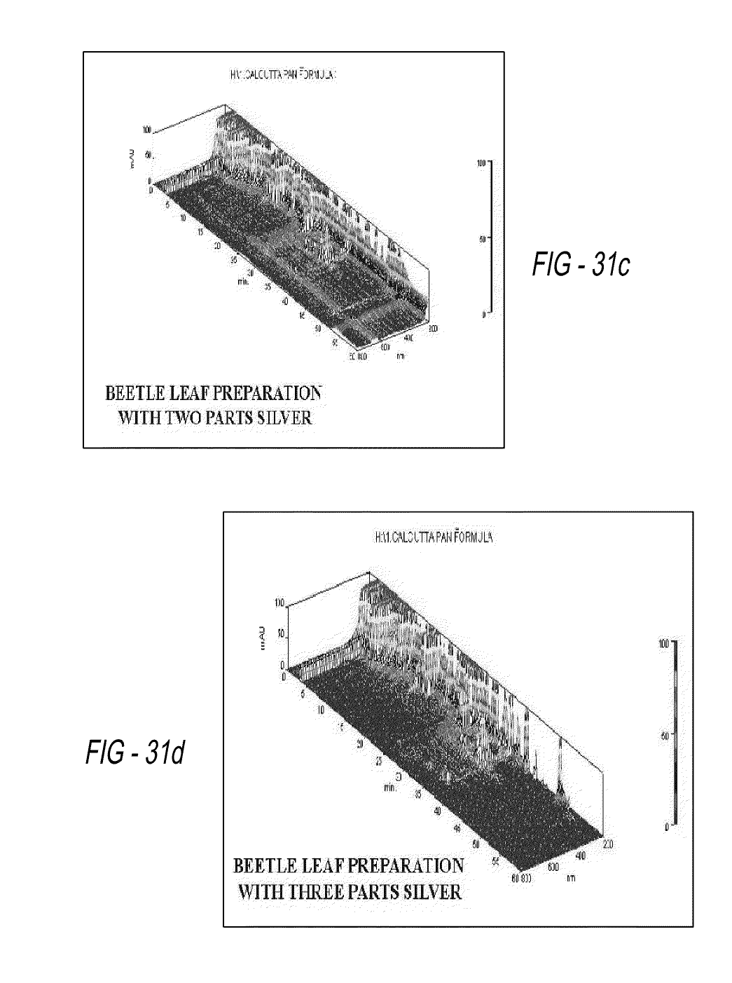

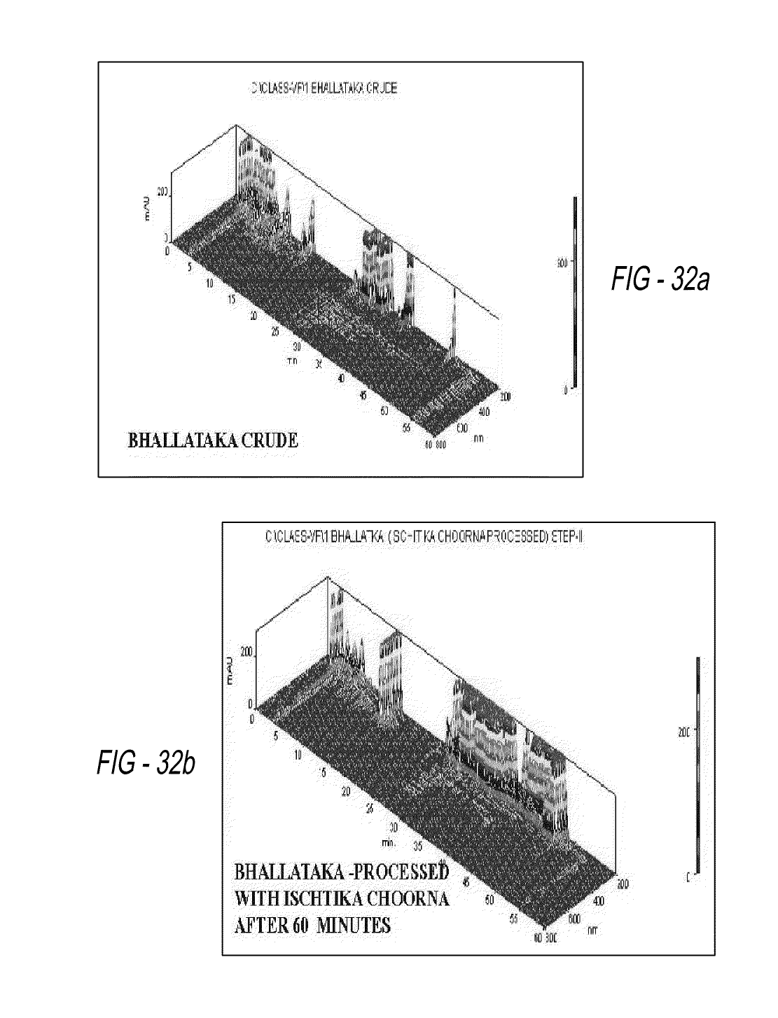

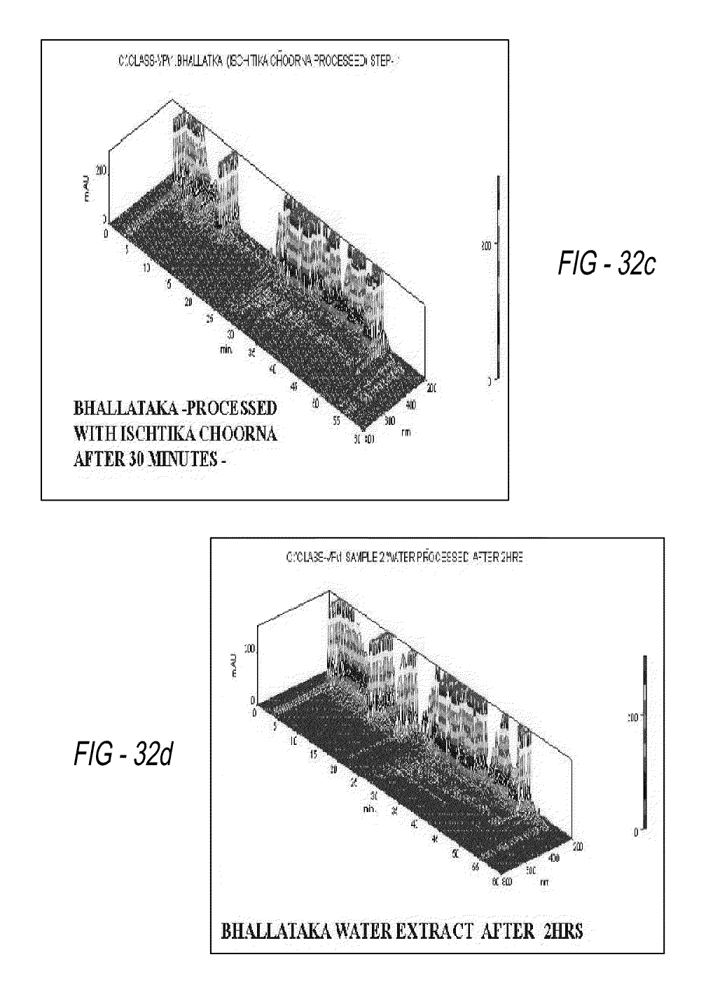

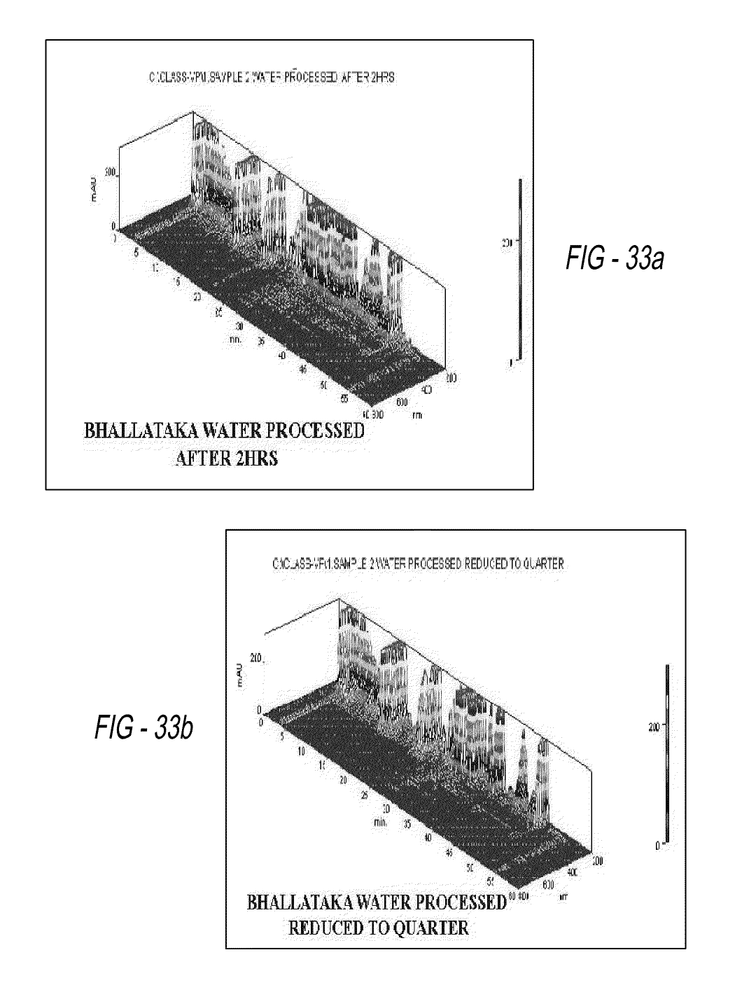

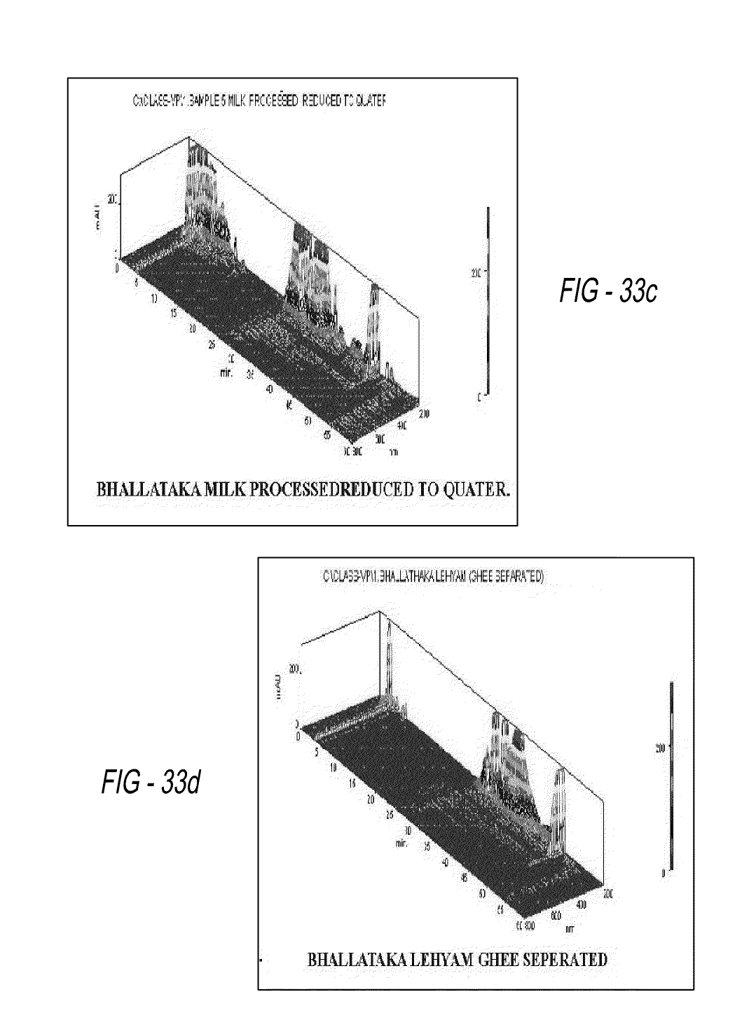

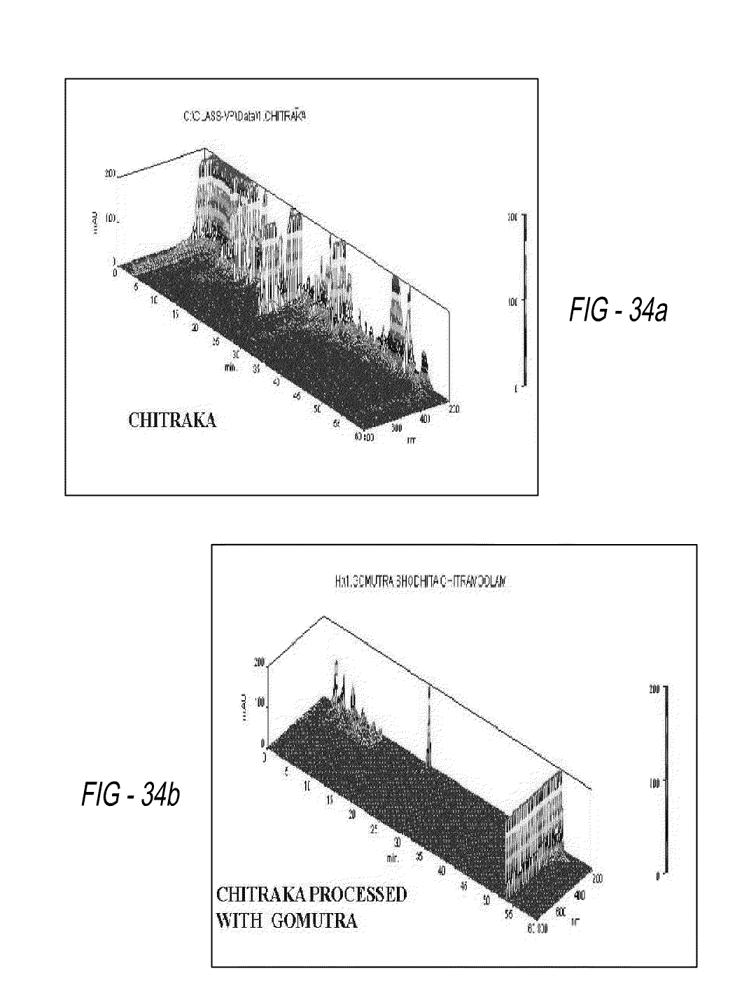

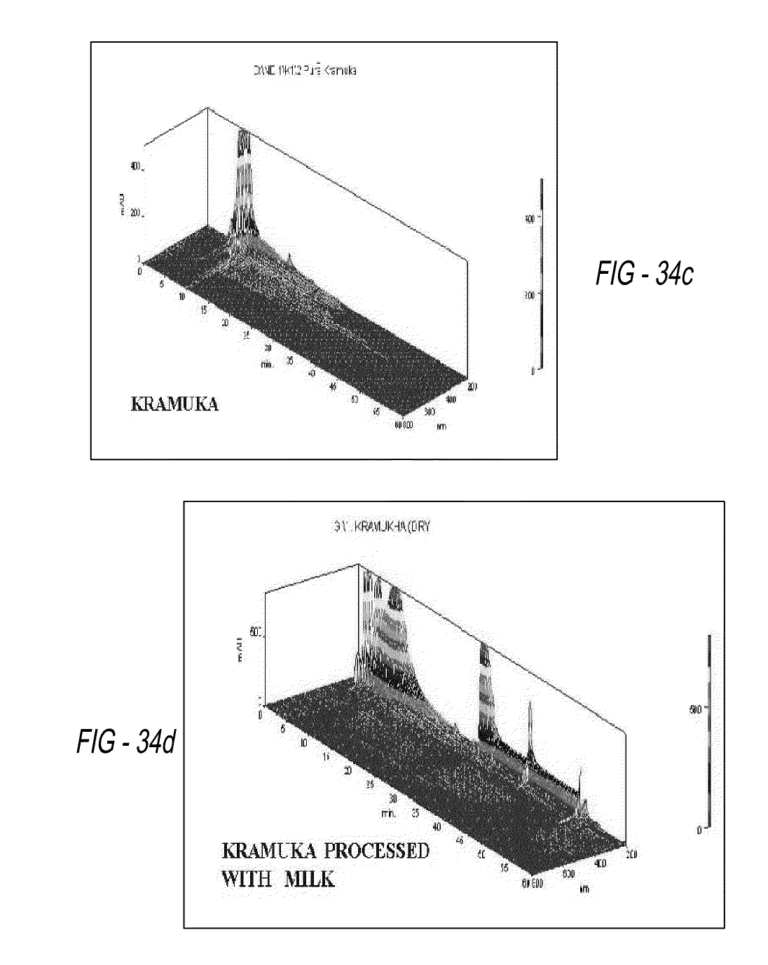

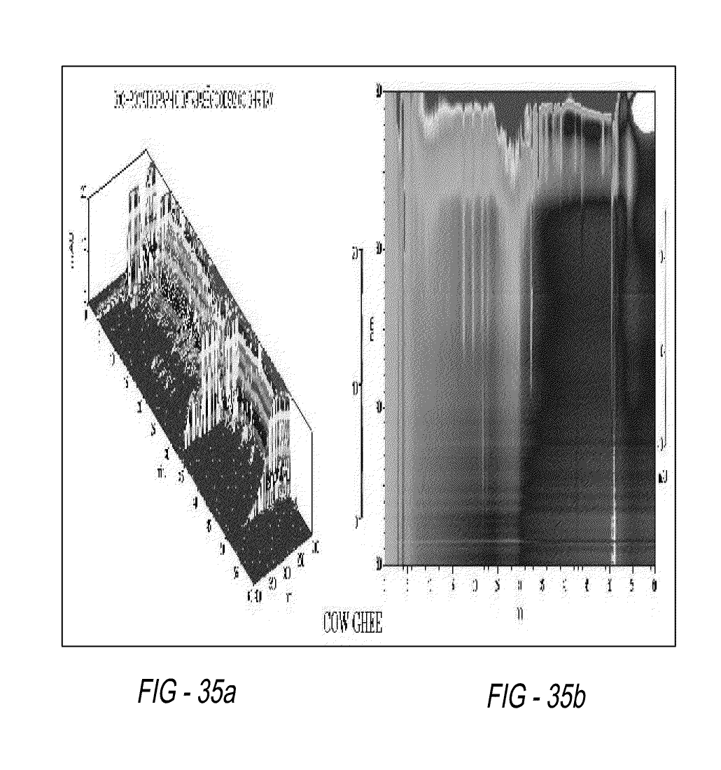

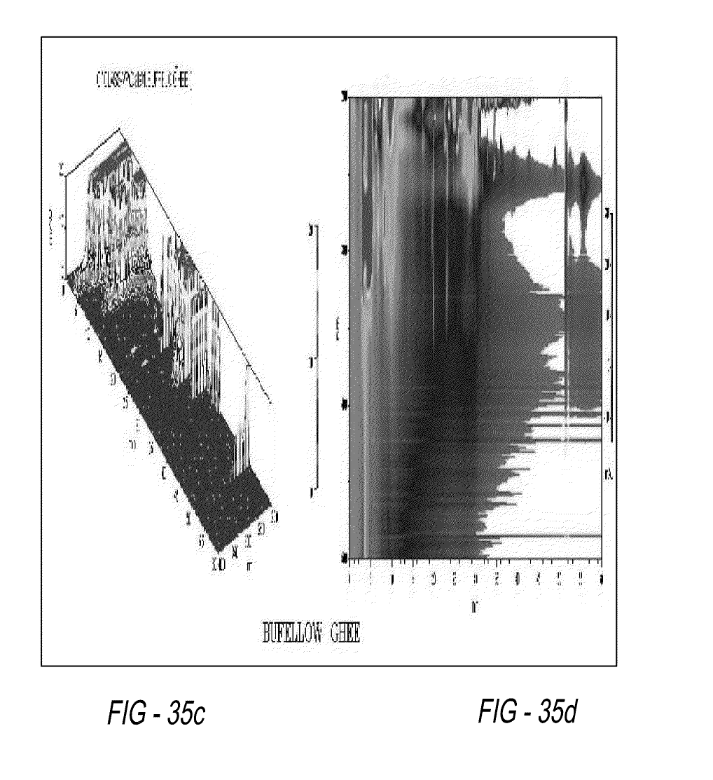

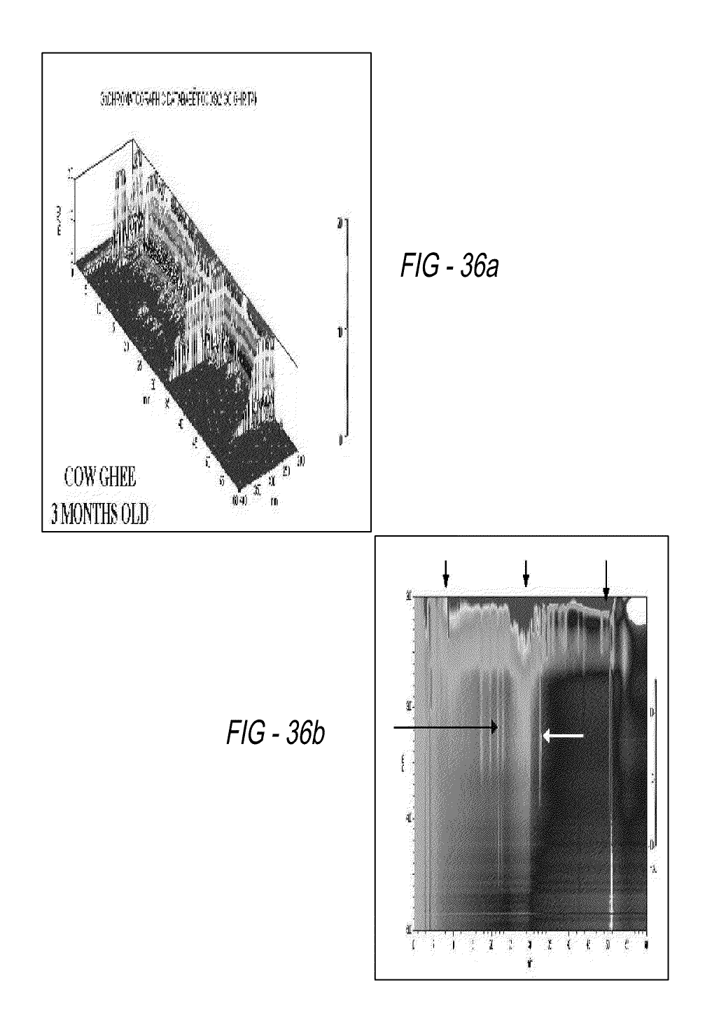

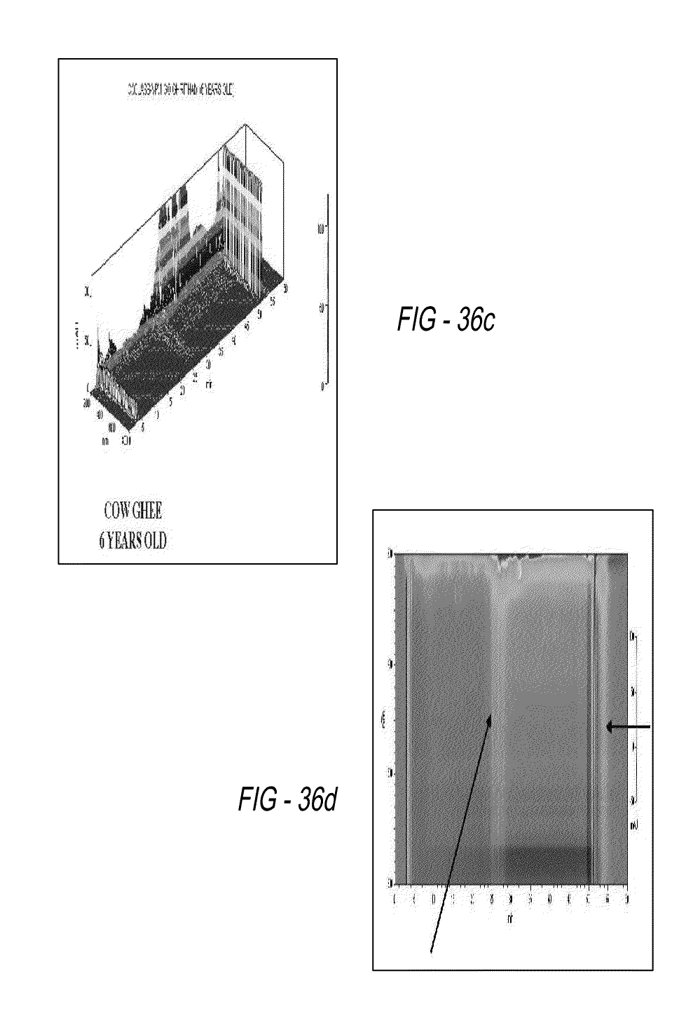

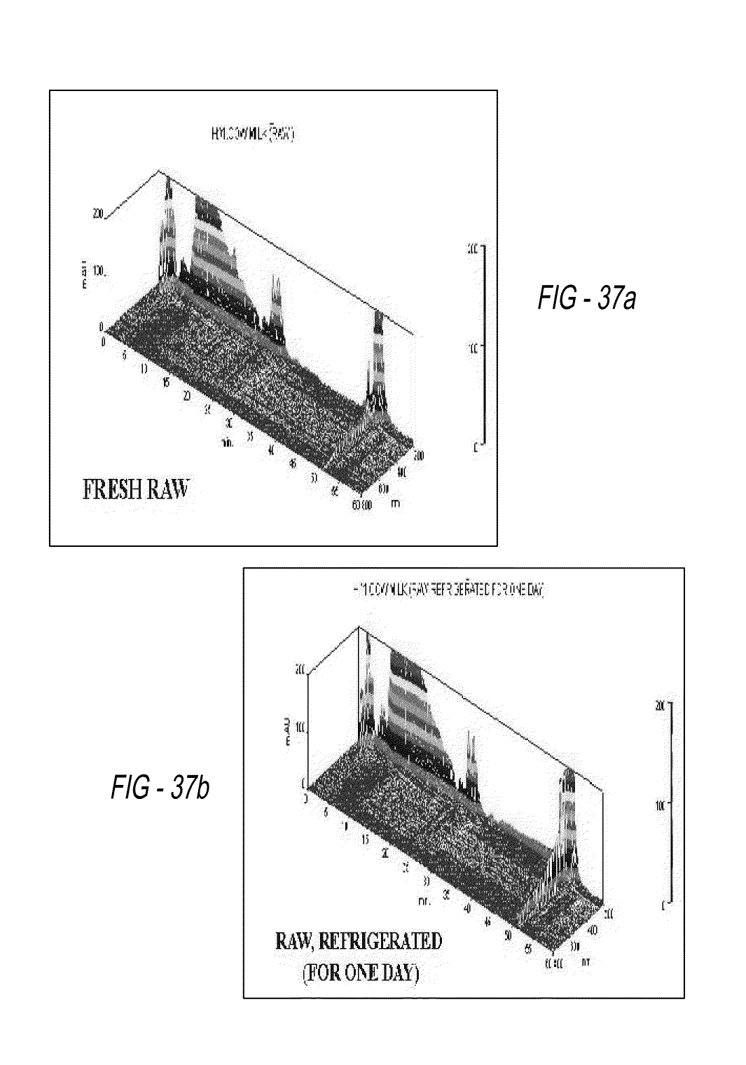

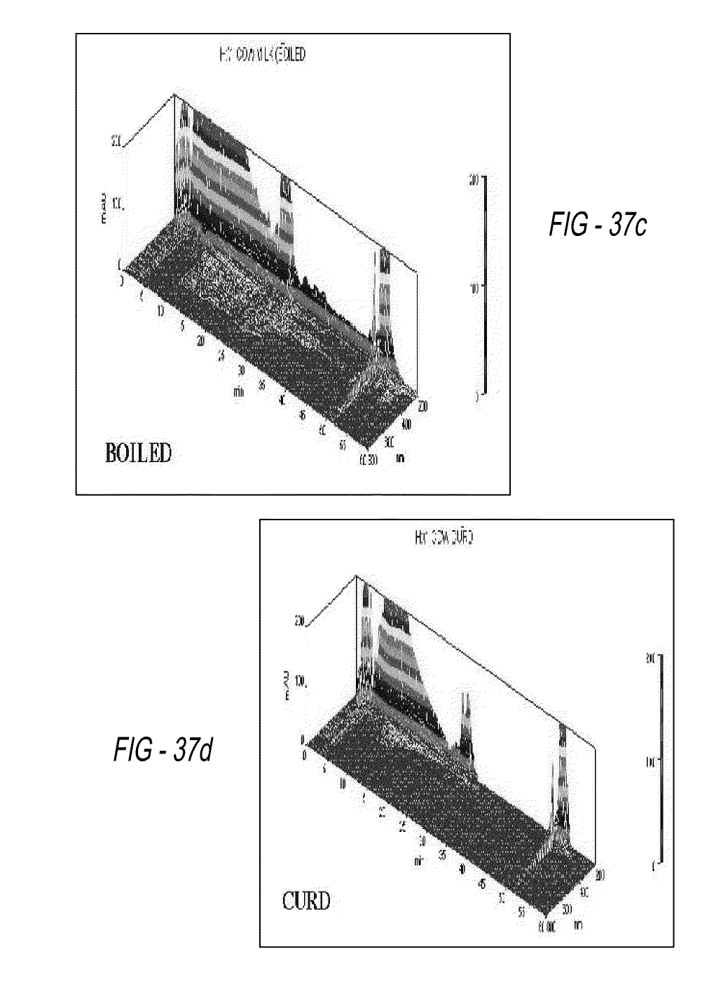

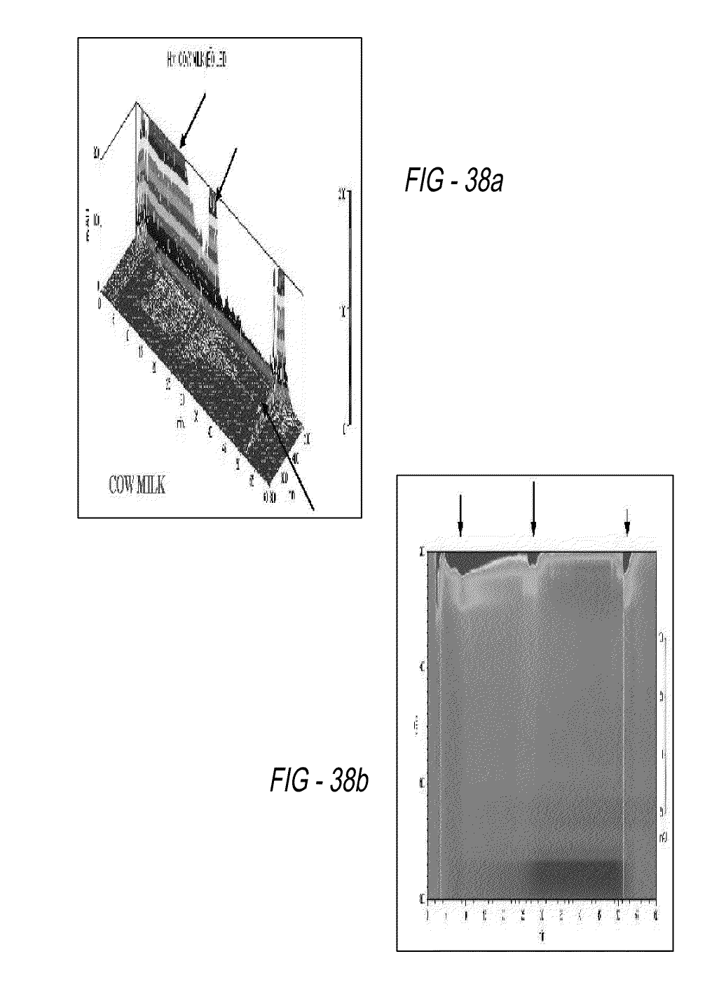

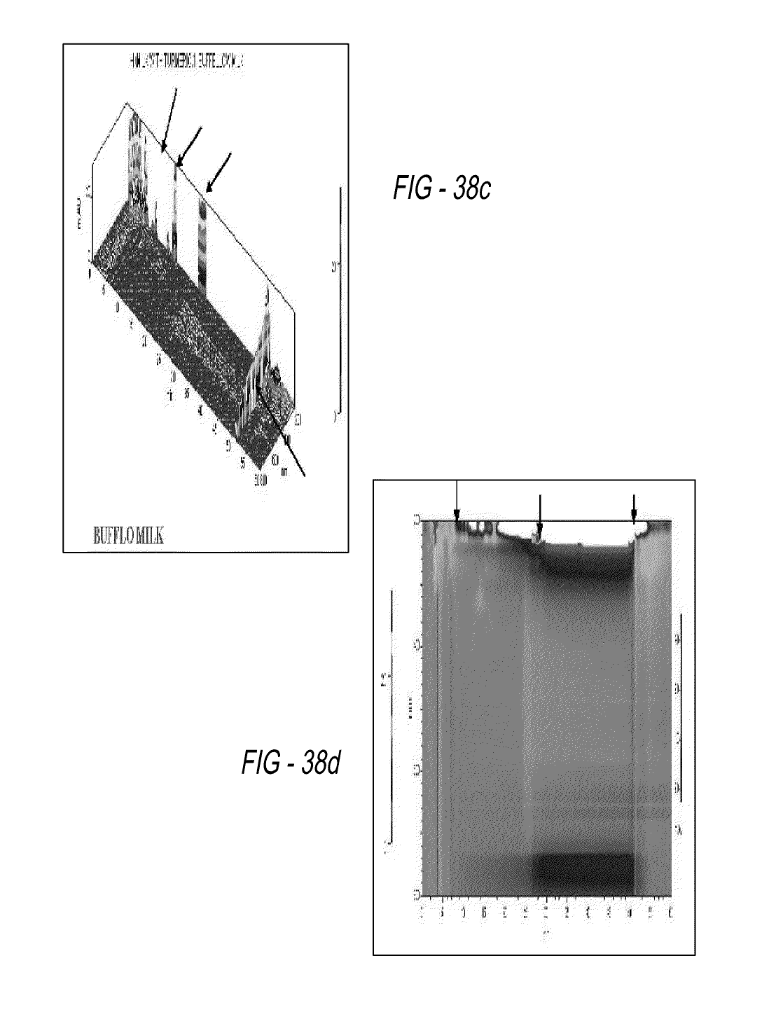

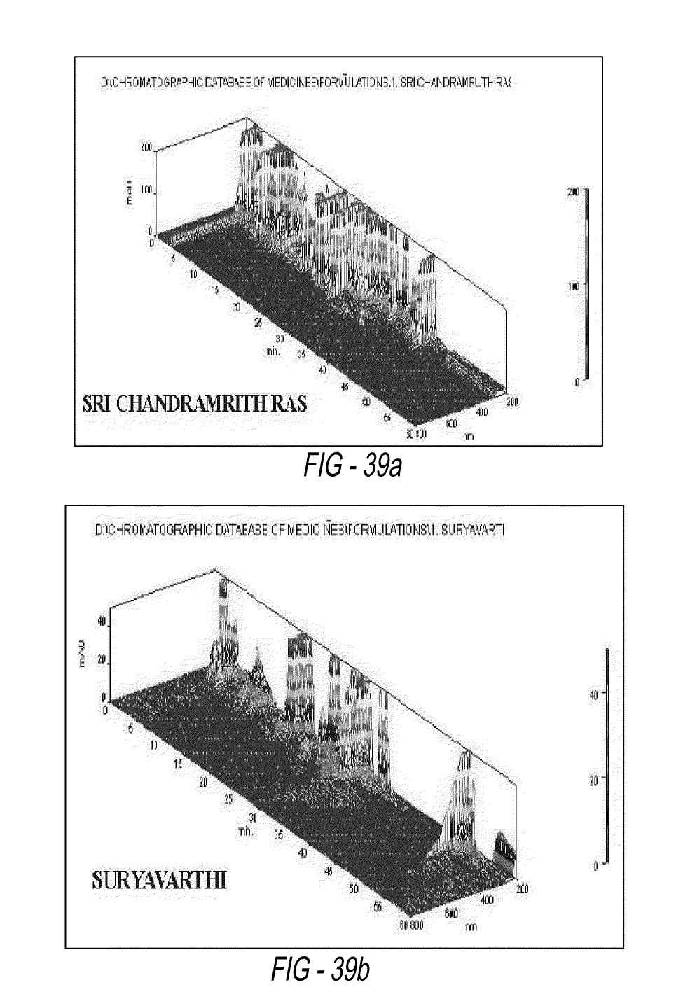

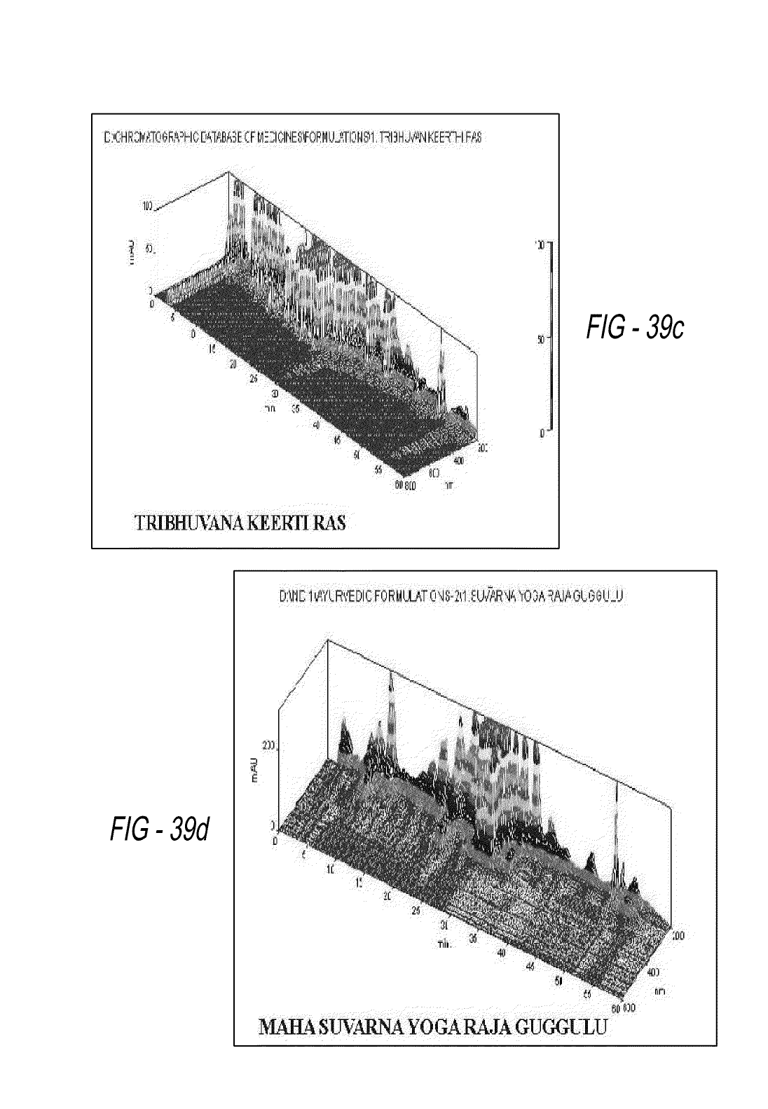

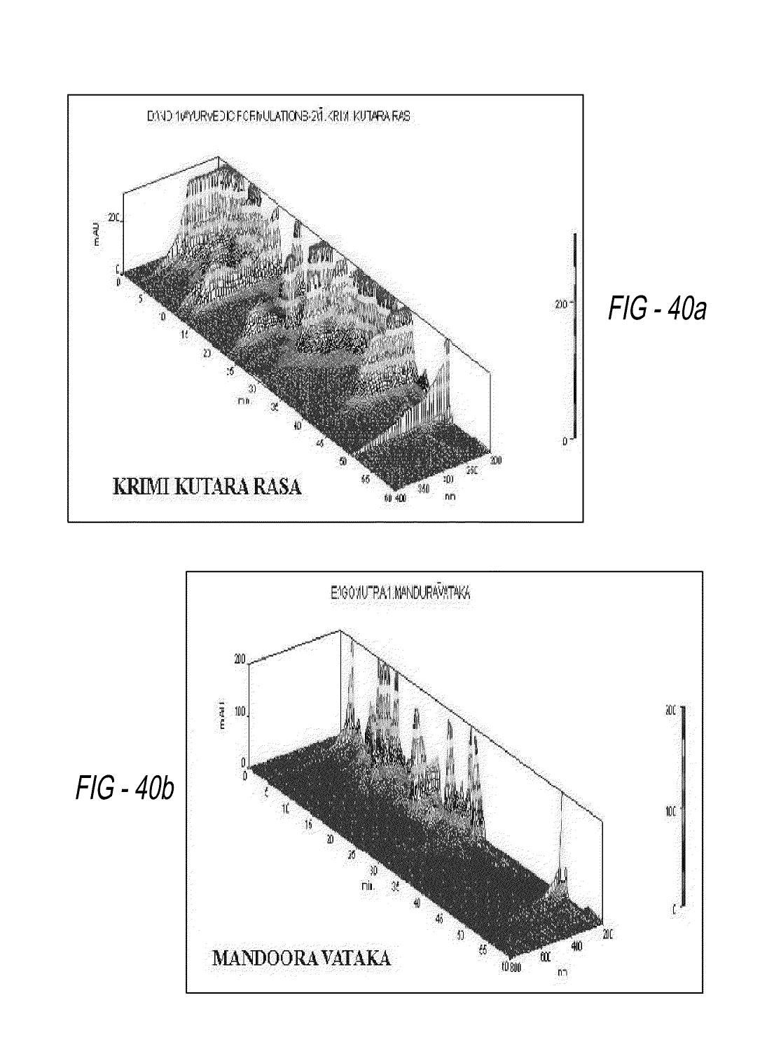

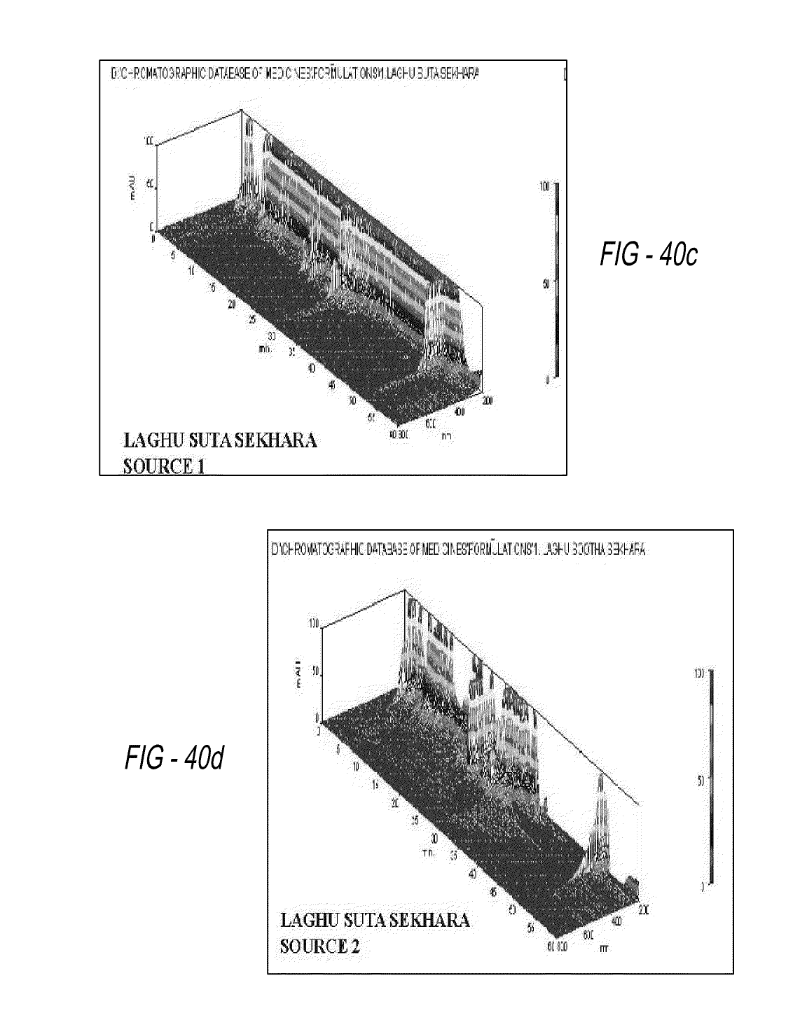

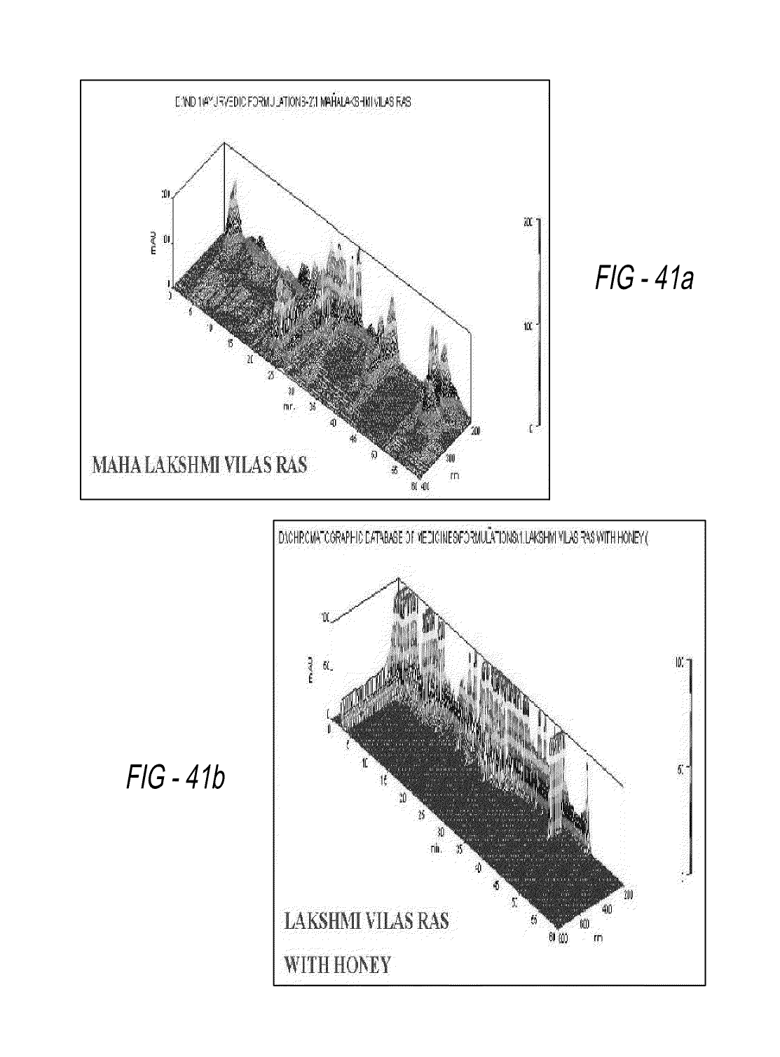

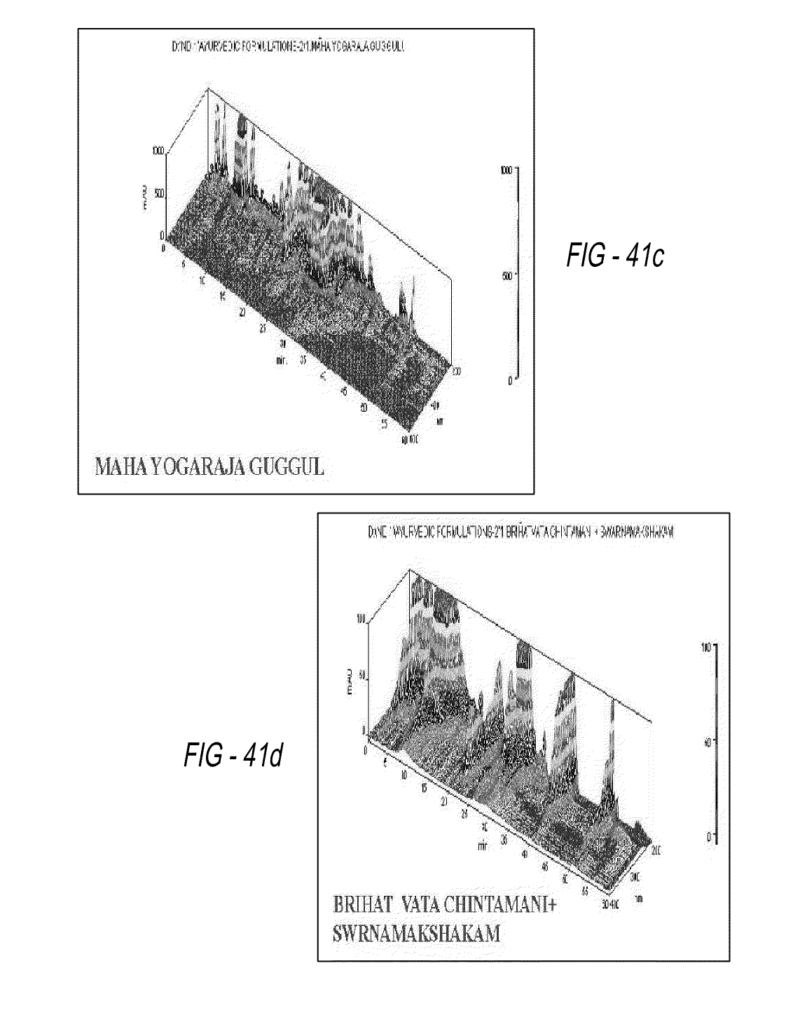

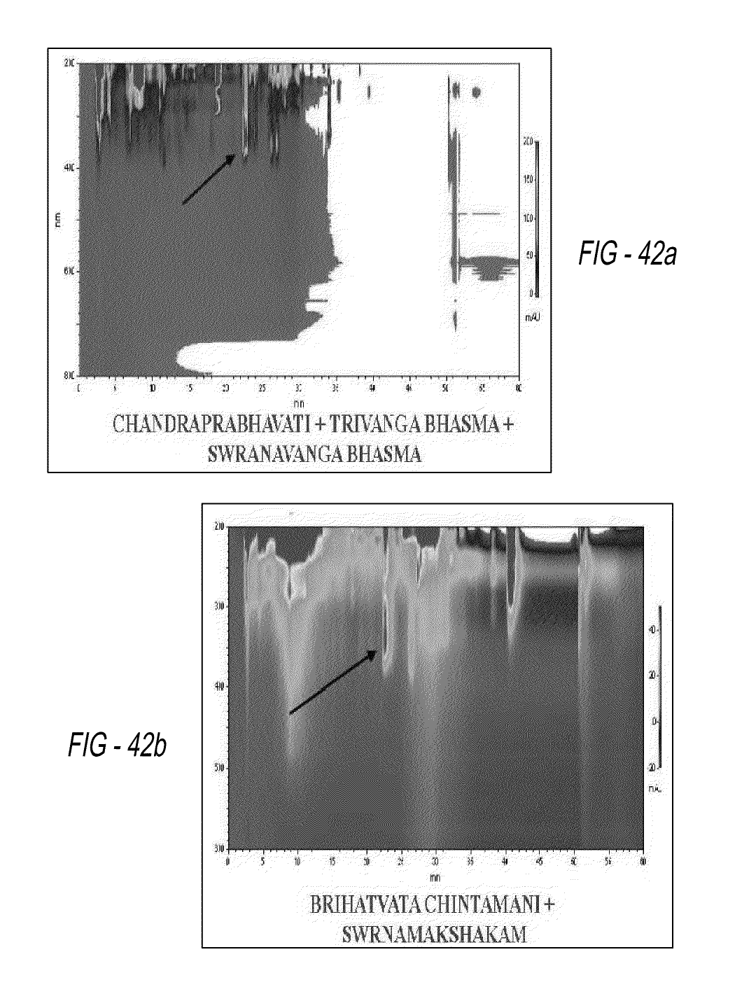

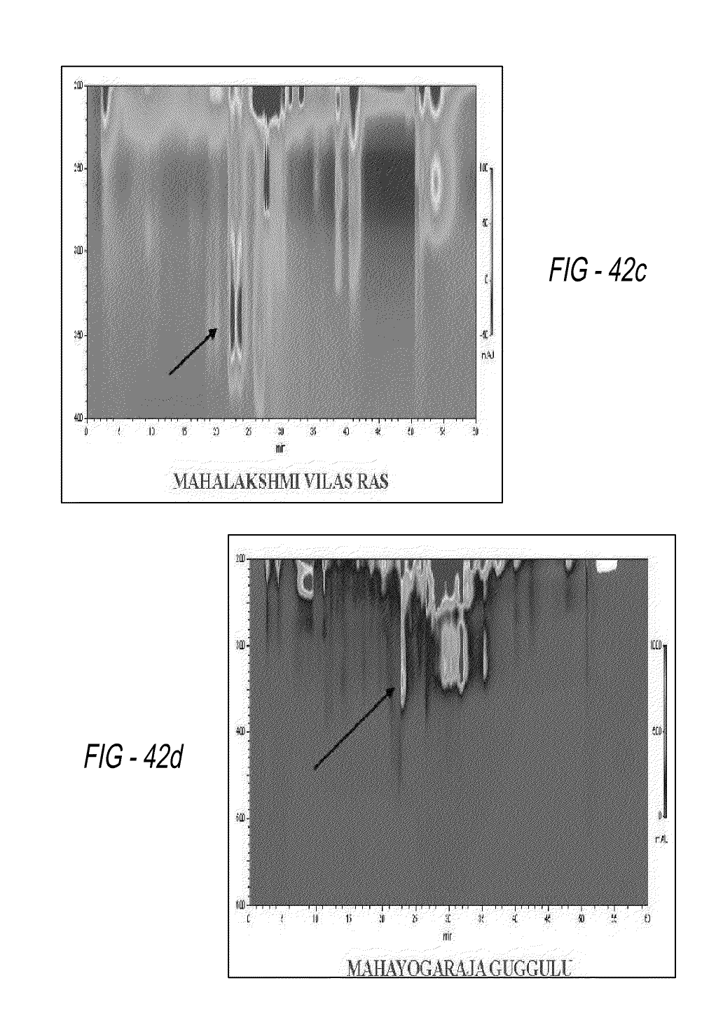

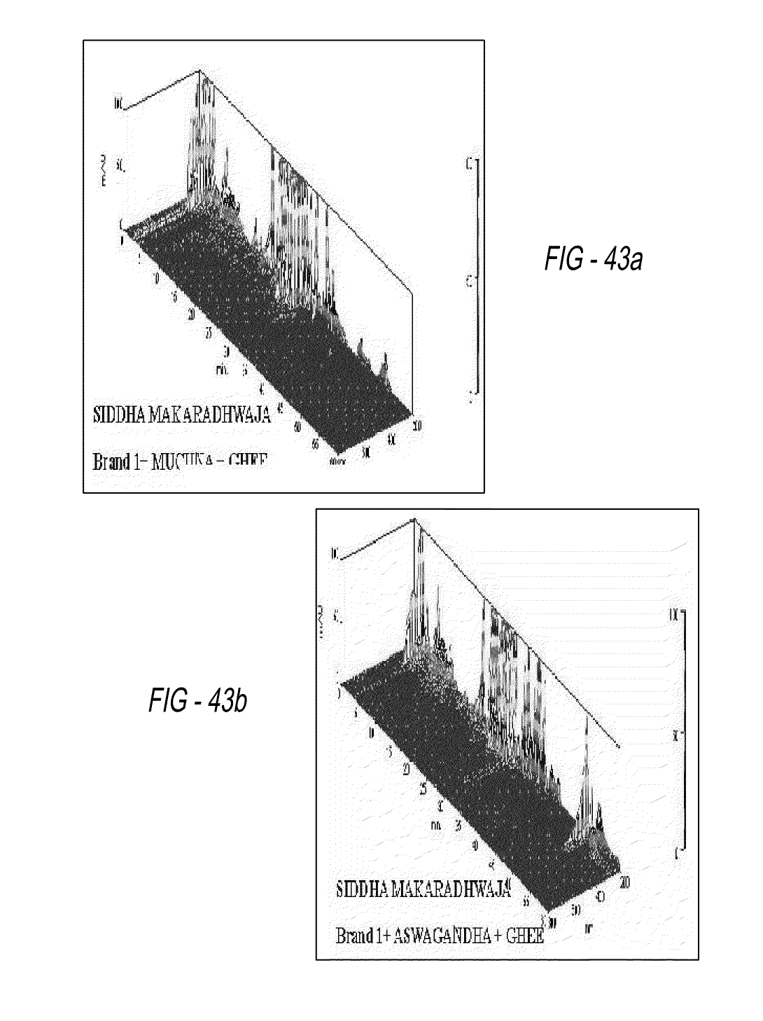

42. Fingerprints of unknown material: When some materials like Sodium cyanide was analyzed, the Physico-chemical properties of the material were studied using the fingerprints as shown in the figure. Each country can develop the native plants as their traditional medicine using the basic concepts of traditional medicine. As any herbal medicine is selected based on the traditional literature, when it is reported as a medicine to have the required physicochemical properties required for a specific efficacy, assessment of their Physico-chemical would help to understand the efficacy of the medicine. Thus the method helps to confirm the presence of properties of a medicine whether it has all required properties to be a medicine, as mentioned in traditional texts. Taste is one of the basic parameter used in traditional drug standardization. The order of taste is mentioned towards a specific efficacy of the material having the respective taste. If one can assess the taste of any material, which facilitates, understanding the efficacy of it, the drug discovery becomes easy. Taste being a subjective parameter, one needs a tool, which can give the taste of an unknown, unbiased. Taste even changes with person and his health. Tastes were related to polarity based on our method. The selection of a material of specific taste helps to select a material of specific polarity to deal with a specific disease, which is also related to polarity. The Astringency (Kashaya) and Pungent (Katu) are found to be to high polar, where the second is less polar to first one. Bitter (Tikta), Salty (Lavana), Sour (Amla) and Madhura (Sweet) are stretched from medium polar to non-polar as shown in FIGS. 10-15. The Madhura, in traditional terminology was mentioned as the post assimilated (Vipaka) condition of Sweet. Then it is Vata hara. So understanding the Vipaka of any molecule/medicine will help to understand the final efficacy of it. The molecules at 2-4 minutes indicate Pitta vridhi, (very high polar molecules leading to hyper acidity) this makes the rest of the molecules to get fast absorbed by the body. The molecules around 30 minutes are indicating Bitter, Sour and Salty by taste. Being a salt it should be salty by taste. The High polar molecules seen in salts but not in all bitters confirm this. Or the salt or bitter may be dominating each other. It was observed that the polarity difference of these bitter, salty and sour tastes is very narrow.

Being an unpalatable toxic chemical it will be difficult to confirm by humans. It is not showing any sweet property as shown in the sweet example. The chemical is also showing Vata vridhi (hyper conjugated) indicating that it cannot be madhura by nature. The post-assimilated (Vipaka) status of this material was not studied due to many experimental limitations, but can be studied. Many of the medicines, which are bitter, show similar molecules at the same retention time. The salts at very high concentrations show sour taste. Thus the taste is related to the amount of energy, the molecules possess and the taste receptor it can trigger having a specific polarity. So it is the quantum of energy it can deal with that plays role in the efficacy of the medicine, irrespective of its structure, many times. So salts should be acting due to their crystalline structures of the atoms arranged in specific order and geometry, which makes them therapeutically active. The polarity of the crystals could be controlled due to the geometrical arrangements of the ionic molecules in the crystal. These crystalline molecules should be triggering the respective taste receptors, resulting to specific tastes. That is why a PDA detector was able to give spectra of salts also. This indicates the utility of the present invention for assessing the property of an unknown plant or material. Thus it helps for assessment of the chemical and therapeutic unreported medicines.

43-44. Some of the medicines used for female fertility was presented. Constituents at 25-30 minutes are found to be present. Hence molecules having the specific polarity and conjugation were found to possess similar efficacy whether traditional or modern.

45. Traditional Medicines used in Indian cultural and traditional activity: Compounds of Betel leaf added with many ingredients are a tradition in Indian society. This was mentioned as medicine for some diseases. Using foods as traditional medicine in day-to-day life is a part of Indian society.

46-47. Traditional Medicines used in Indian cultural and traditional activity: Some of the herbal medicines are used in the day-to-day life of Indian society having many therapeutic properties. They protect the health of the people making them healthy.

48-49. Process standardization of Bhallathaka: Process standardization of medicines is required to protect the efficacy of a medicine. The change of chemical constituents and their efficacy should be assessed to monitor batch to batch and brad to brand variation.

50. Crude and processed single medicines with different anupanas were presented indicating the needs of process standardization of medicine preparation in every step of preparation.

51-54. Process standardization of Daruharidra Rasakriya: Process standard of Rasakriya of Daruharidra (Berberis aristata) is presented in this figure. One can show how the chemical assay of the medicine has been changed as per the need Dose dependent. Toxicity is reported in such preparations where one has to standardize the processed product for assessing efficacy and toxicity of the medicine. The final product at 8^{th} step possesses Madhya property, which was indicated in the Indian traditional texts.

55. Cow products are widely used in India and worldwide. They too need to be standardized before us. Different Ghee samples were fingerprinted which show different chemical constituents.

56. Ghee sample lose their products on long storage. The Cow ghee sample shows different profiles when analyzed at different shelf life.

57. Ghee and honey in different ratios was used in different conditions. Usually equal ratios of both are prohibited. The fingerprints show the same.

58-59. Cow milk is considered to be highly nutritious. Cow milk in different conditions was analyzed to monitor the shelf life of the product.

60-61. Cow curd is said to be influencing the elimination process. Which can be seen due to a constituent at 42 minute as marked. Similar profile is seen in the patients suffering with cardiac diseases.

62-63. Turmeric with milk is a regularly used material along with Piper nigrum. The samples show a rich profile when combined.

64. Fingerprints of herbal formulations used for hepatitis were presented.

65. Fingerprints of herbal formulations used for Diabetes were presented.

66. Fingerprints of herbal formulations used for Psoriasis were presented.

67. Fingerprints of herbal formulations used for Vitiligo were presented

68. Fingerprints of herbal formulations used for Bronchial disorders were presented

69-74. Fingerprints of classical Ayurvedic formulations presented. Different formulations used for different diseases were presented which are prepared based on the concepts of traditional philosophies. Some of them are herbo-mineral medicines with inorganic medicines/materials.

75. Fingerprints of herbal Medicines with gold used for Diabetes were presented

76. Siddhamakaradwhaja: Traditionally herbal medicines are processed by different methods using different materials namely anupanas. The effect of such processing should be monitored for their quality to confirm the achievement of required efficacy in the processed medicines.

77. Shadguna Rasa Sindhoora with an herbal medicine, Pushkaramula, Vibheethaki and honey were presented.

78. Fingerprints of Kajjali in different conditions were presented.

79. Fingerprints of Rasa Parpati in different conditions were presented.

80. Some inorganic medicines used for different efficacies were presented.

81. Different products of Azadirachta Indica have been shown with standards.

82-83. Some of the single medicines used in traditional treatments were presented

84. Pterocorpus marsupium is one of the plat material used for diabetes. The fingerprints of stem bark and heartwood can b seen where in the heartwood is showing good results in the treatment of diabetes. It is showing its effect on Thyroid mechanism. The use of stem bark will increase vata instead of decreasing. Hence it is a wrong substitute.

85. The Fingerprints of Hypericum, St. Johnwart have been presented. The molecules present between 0-20 mins. are indicating Pitta vridhi indication their role in increasing the heat mechanism of the body.

86-87. Different commercial brands of alcoholic extracts of Hypericum mother tincture used in Homoeo treatments have been shown. The inconsistent assay will provide inconsistent clinical results.

88. Fingerprints of Kava-Kava, a Fijian traditional medicines has been presented at different prakrithi conditions. The medicine is expressing similar results in any prakrithi with minor differences. The molecule at 15 mins is showing its effect on Pitta, Pleeha, Spleen. Excessive use deranges the same. It is showing effect on thyroid system due to the molecule at 22 mins.

89. Fingerprints of Saw Palmetto has been presented at different prakrithi conditions. The medicine is expressing similar results in any prakrithi with minor differences. The molecule is showing its effect on Pitta, Pleeha, Spleen.

90. Fingerprints of Apple a fruit has been presented at different prakrithi conditions. The medicine is expressing different results in different prakrithi conditions. The molecules at 12 and 15 minutes are showing stress relieving property only in Pitta prakrithi. In the same prakrithi it is also acting on Pleeha also. But is indicating Pitta vridhi in this prakrithi and Pitta hara in other two prakrithi. Thus the method facilitates to understand the behaviors of foods and medicines in different prakrithi person of different part of the world.

91. Fingerprints of a polio vaccine has been presented in different prakrithi conditions. It is showing contra indications in Pitta and Kapha prakrithi persons. It is showing effect on Maha srothas as seen in figure of Mamentane a medicine used for Alzheimer's disease.

92-93. The fingerprints of shelf life studies of a traditional medicine have been presented. A qualitative and quantitative change in the profiles can be seen with time in different shelf lives of medicine.

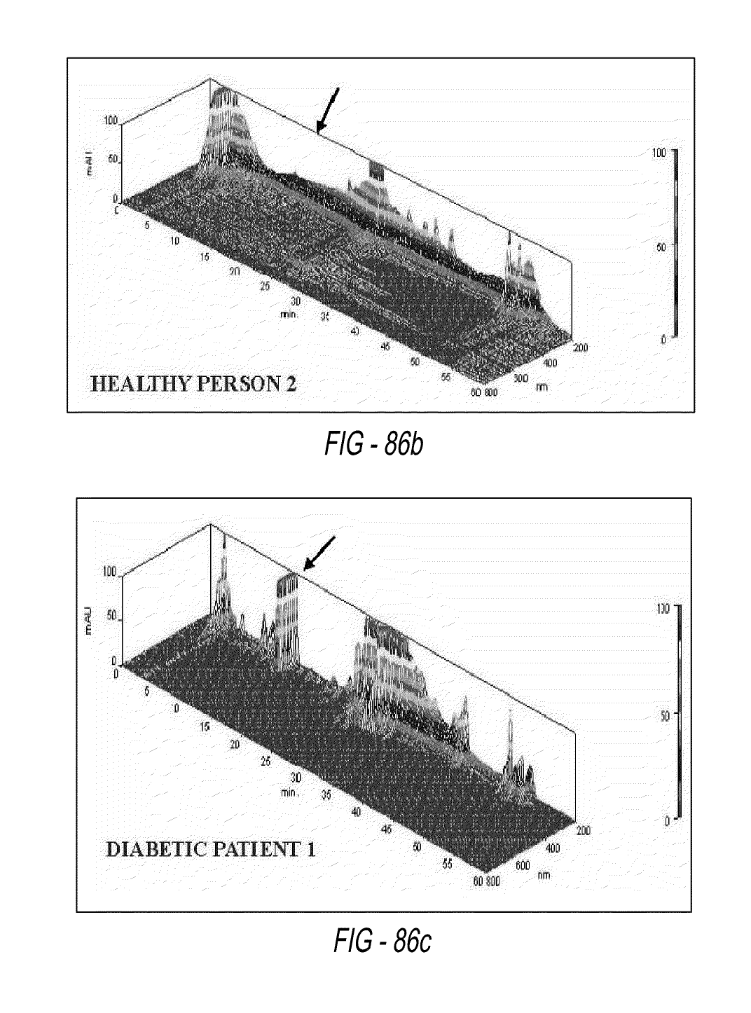

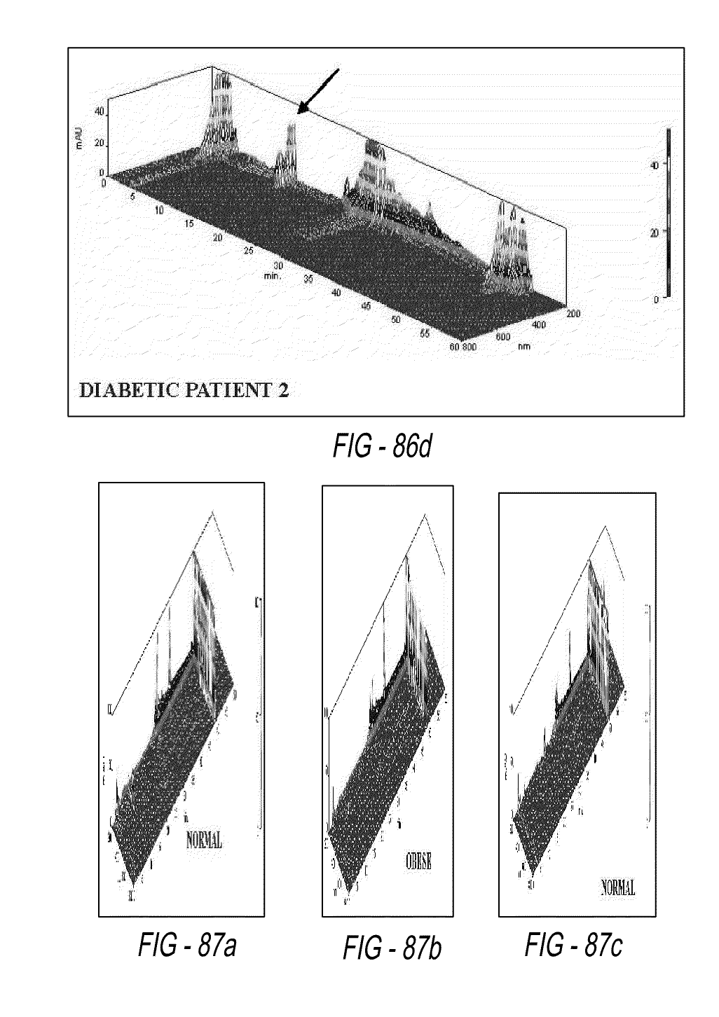

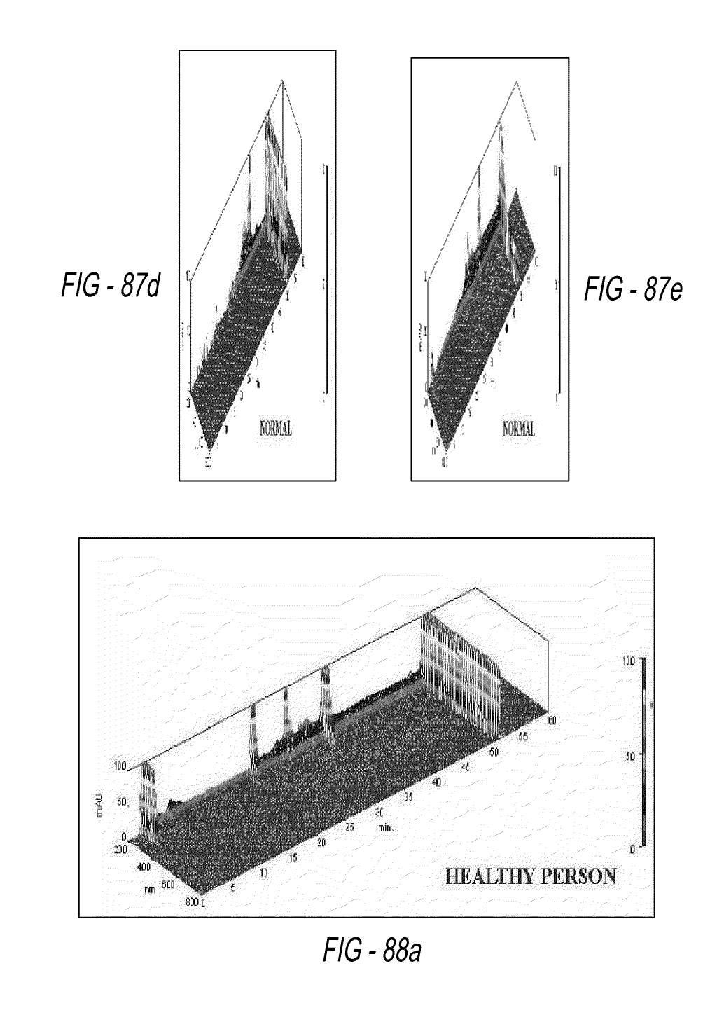

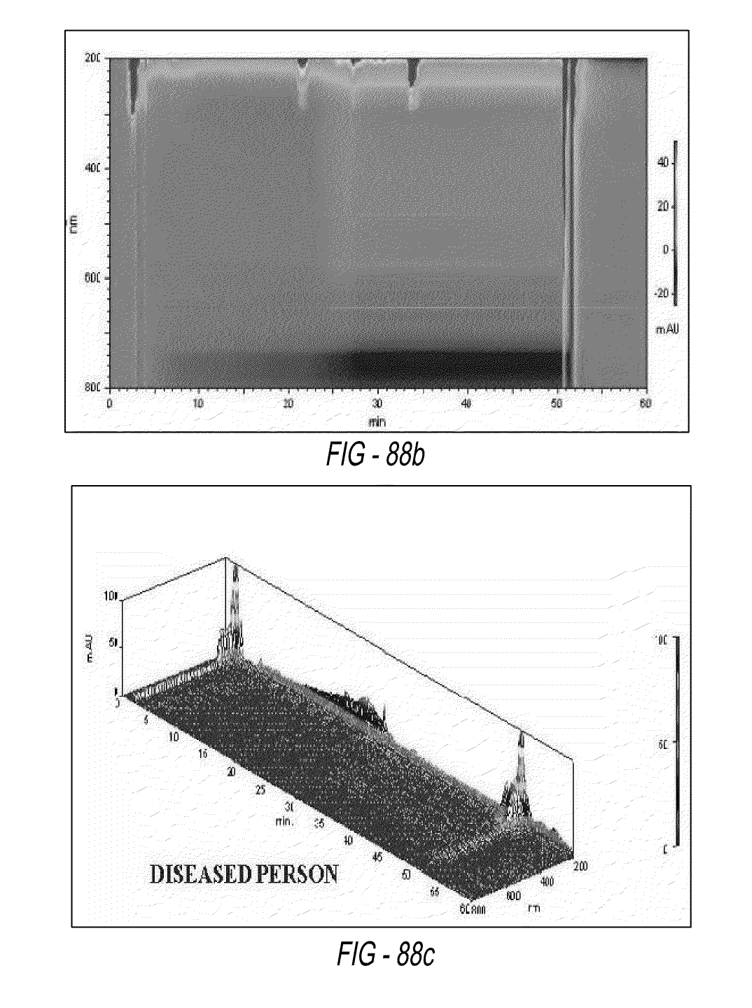

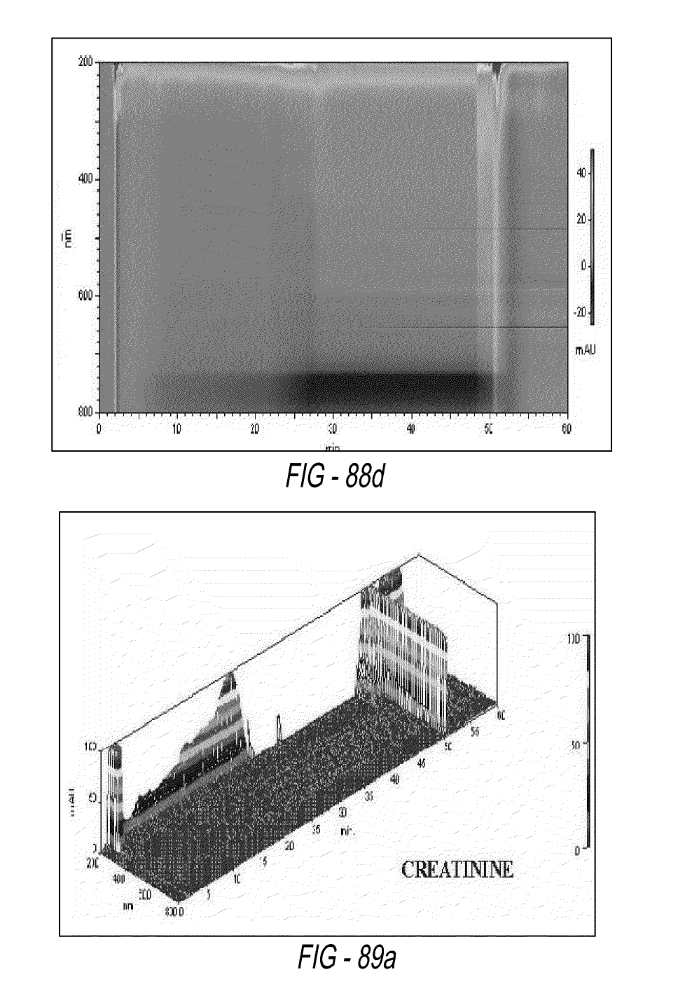

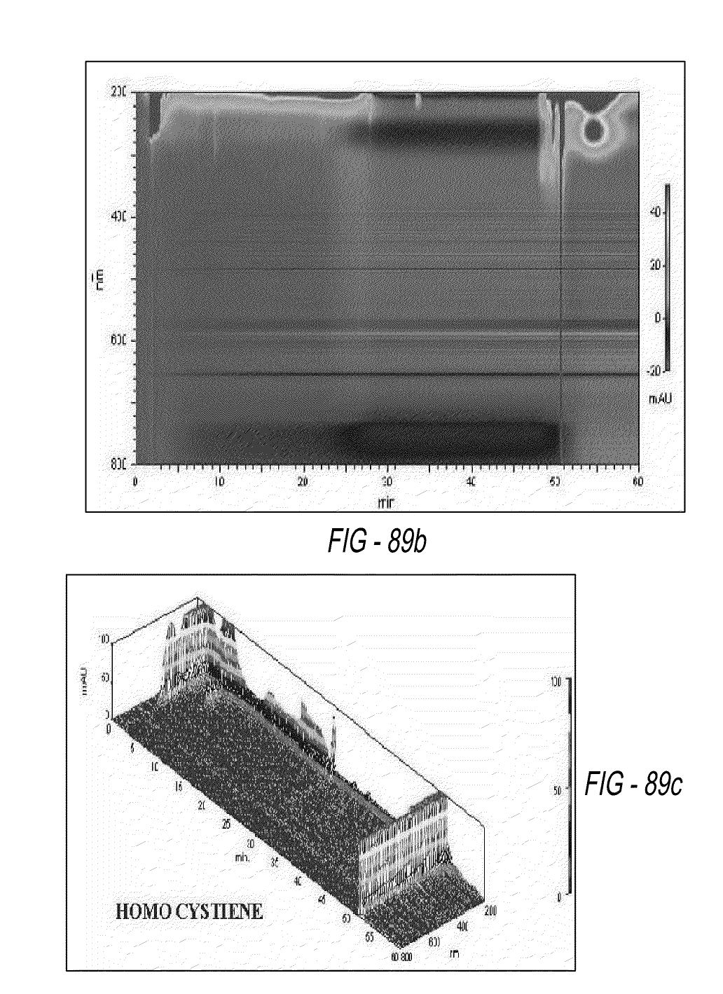

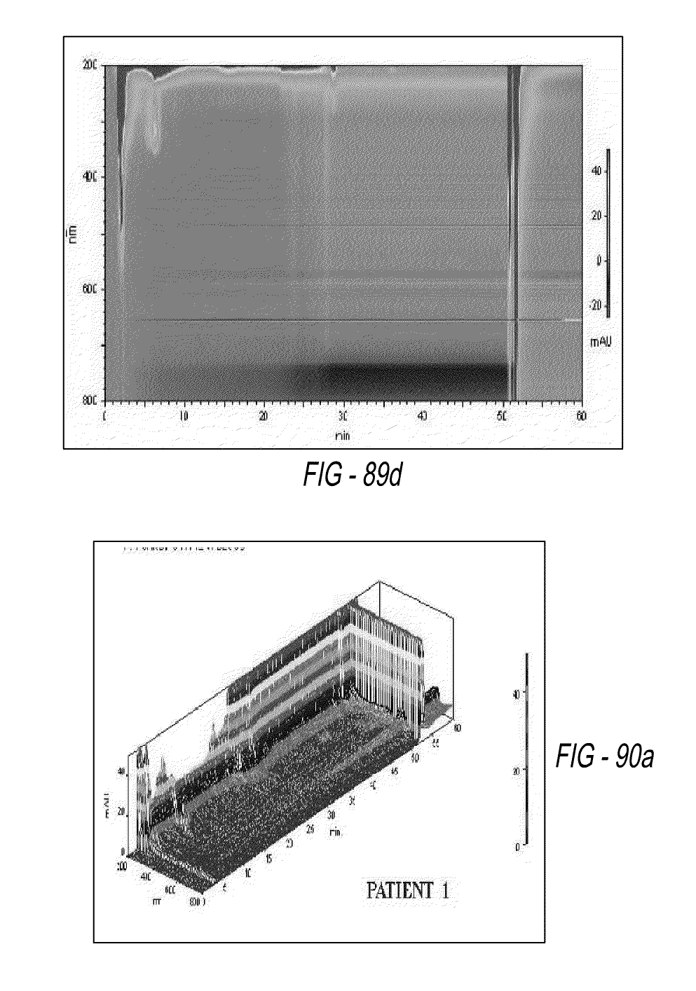

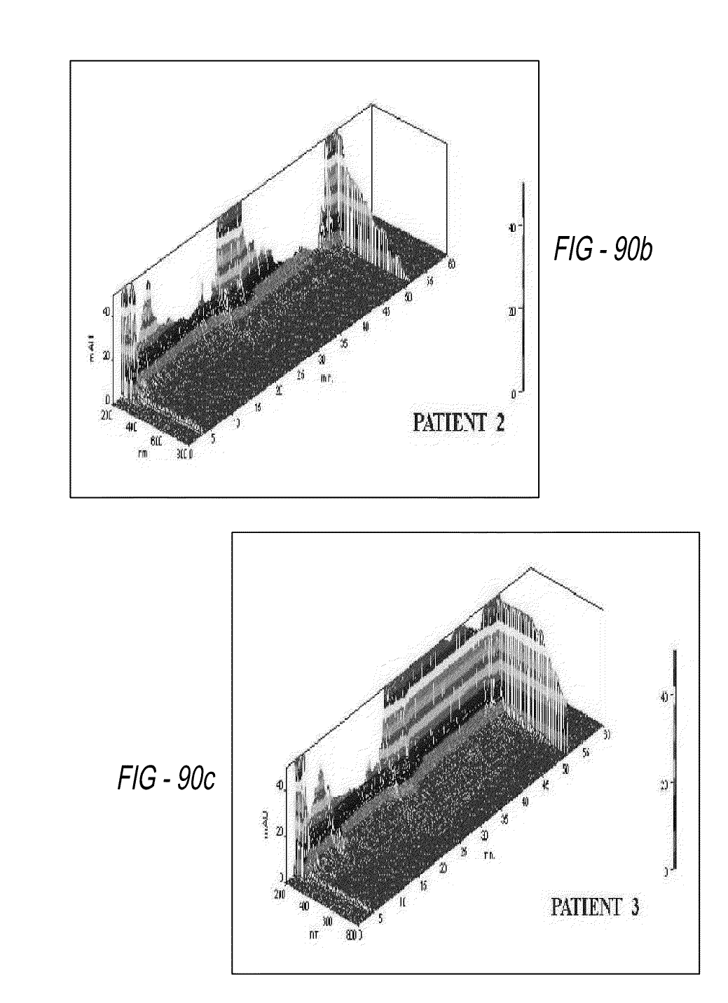

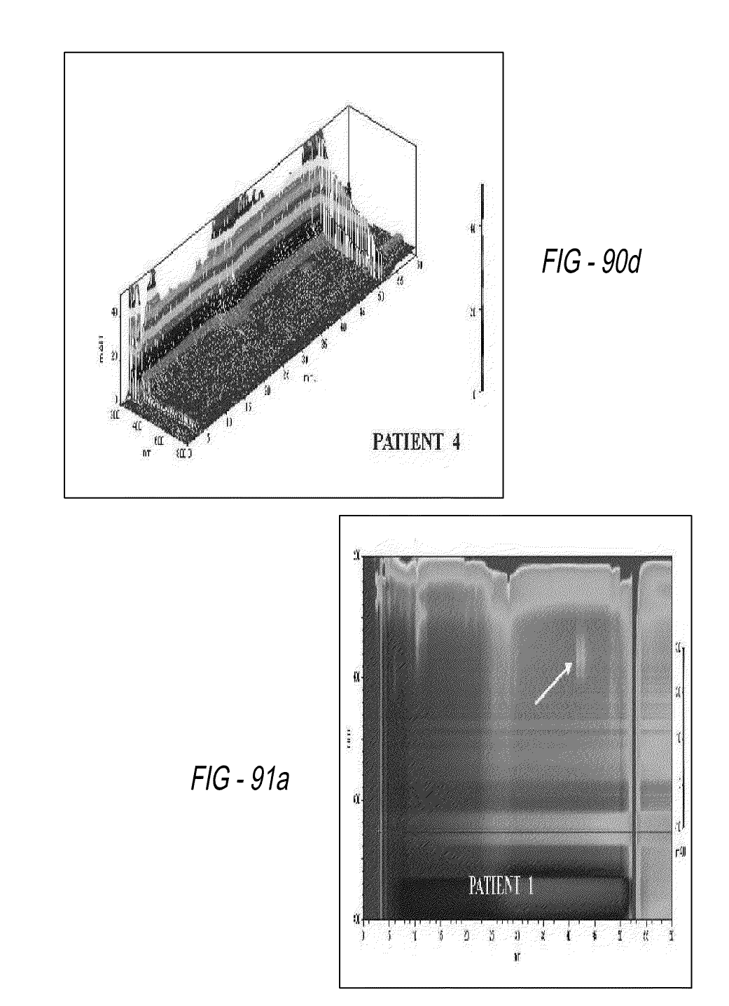

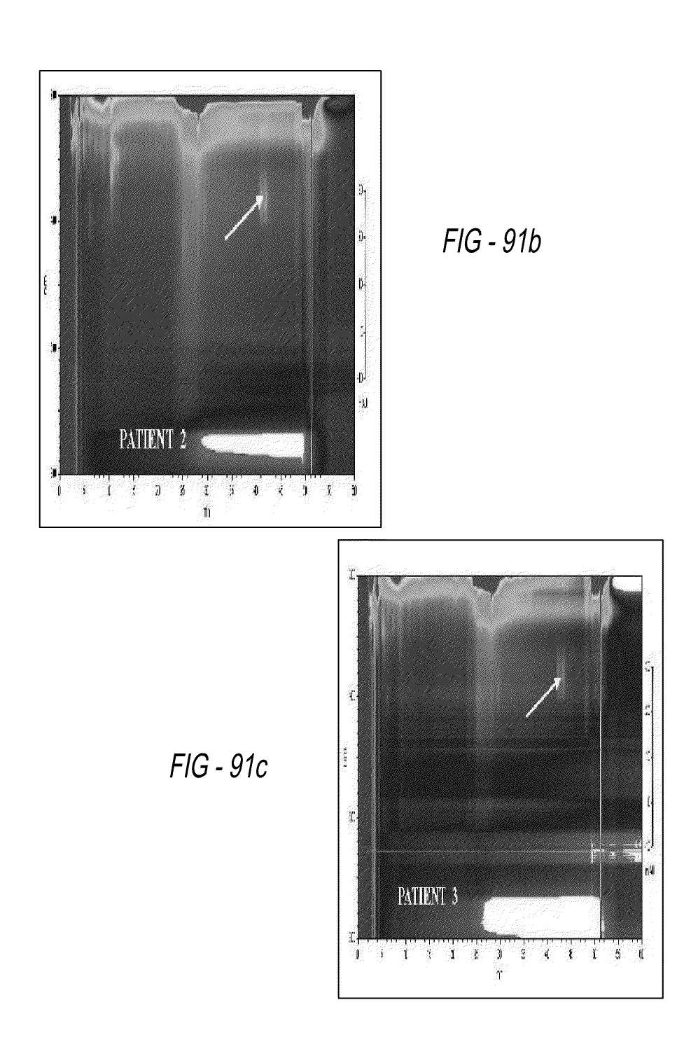

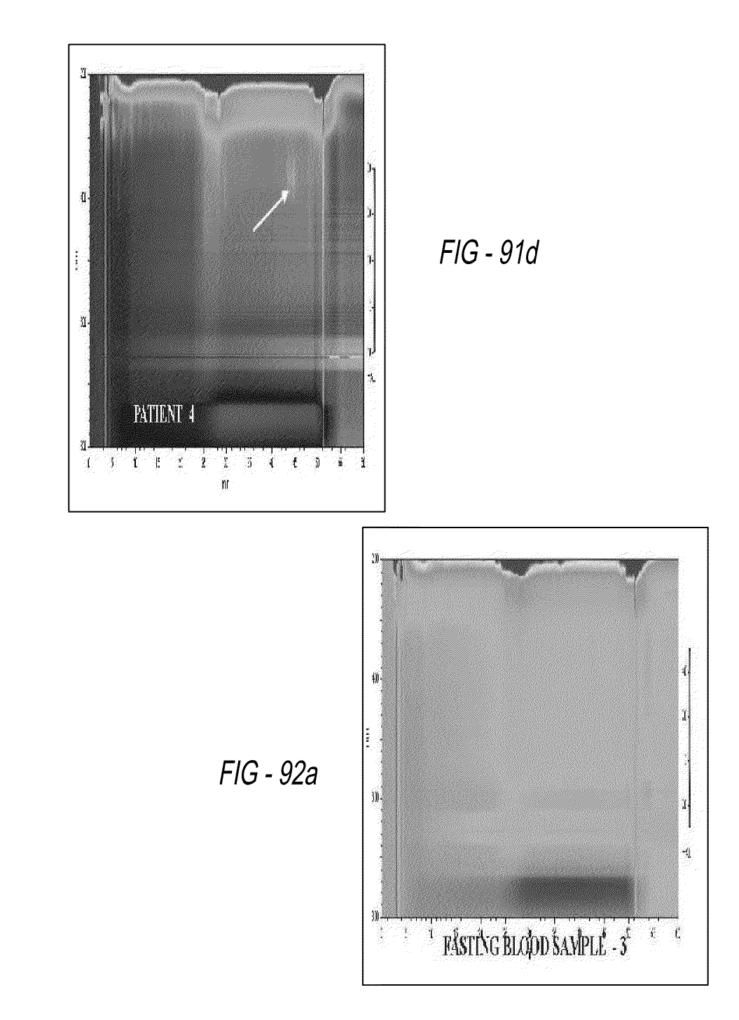

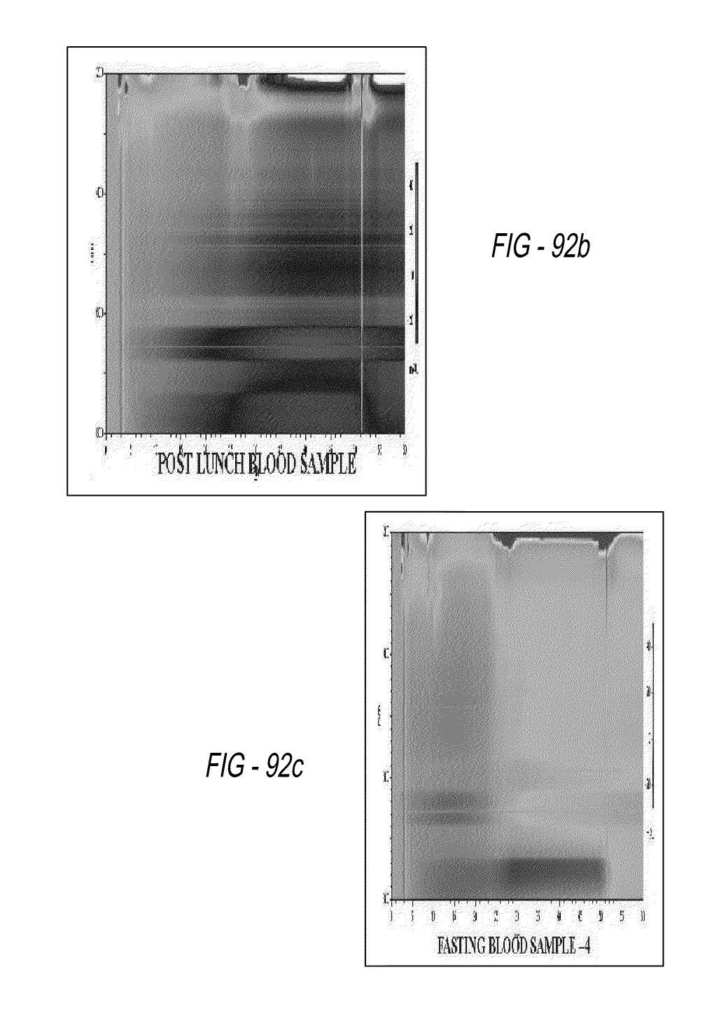

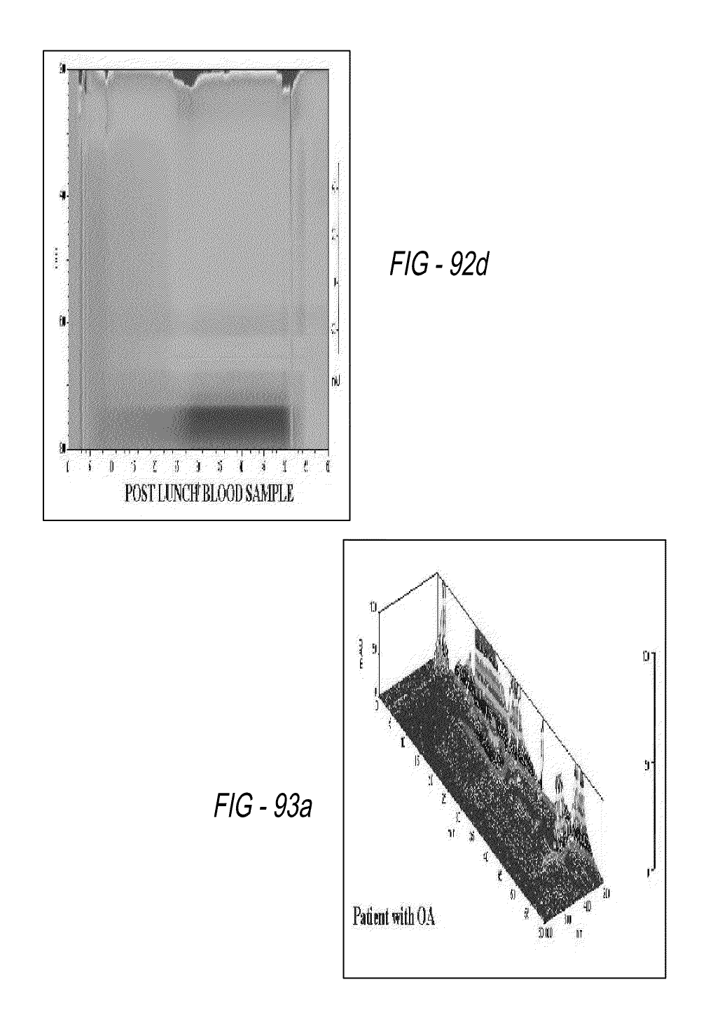

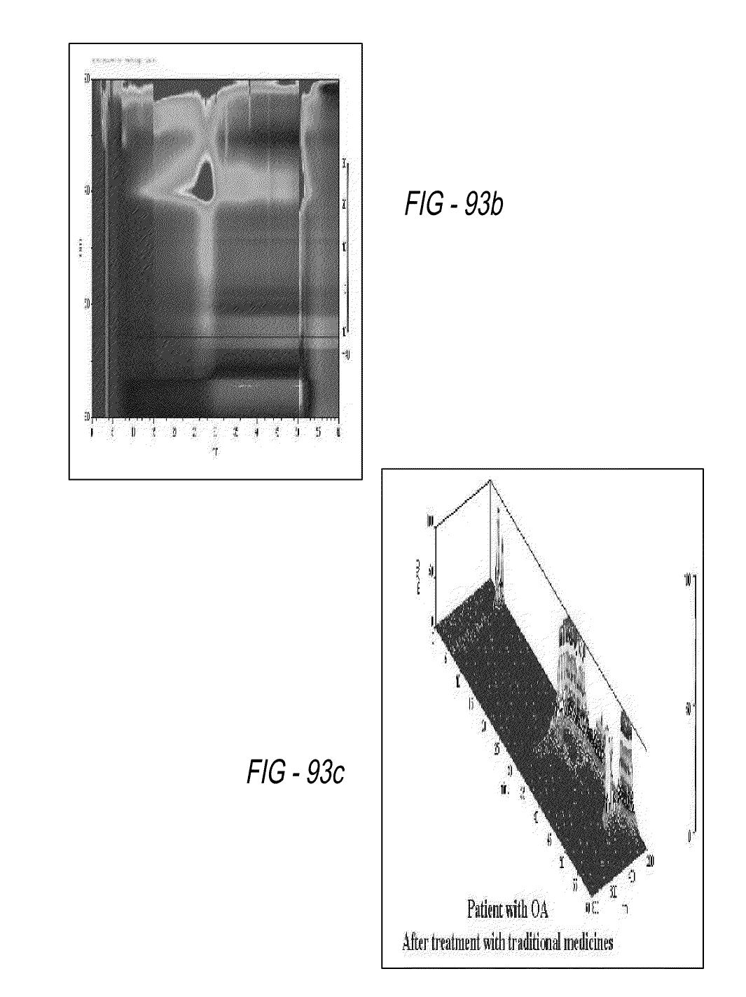

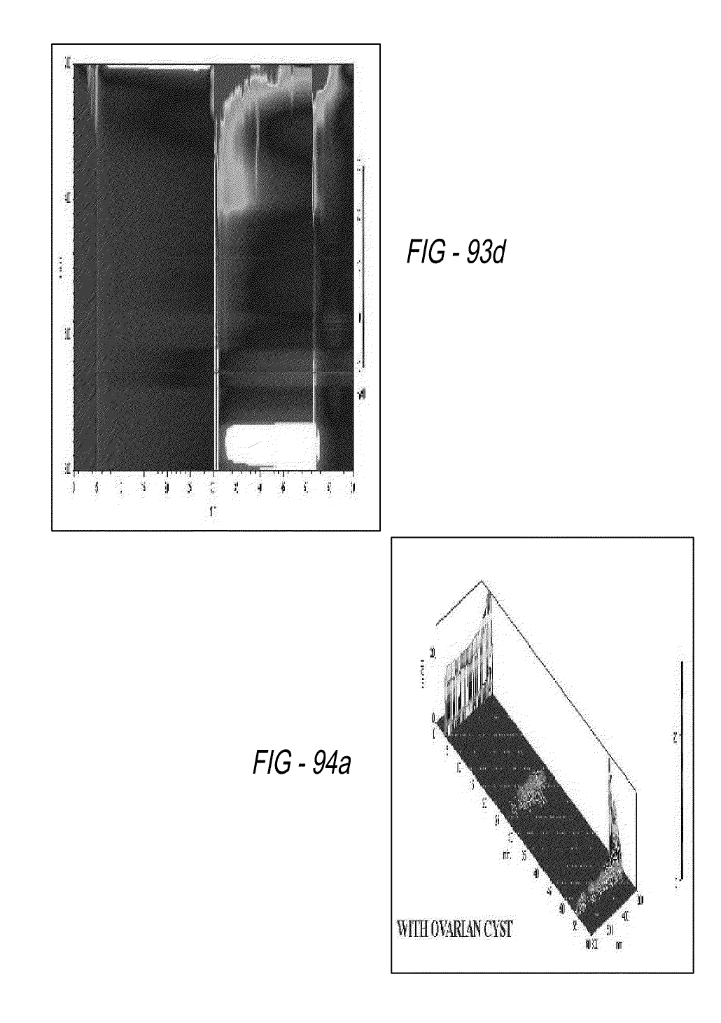

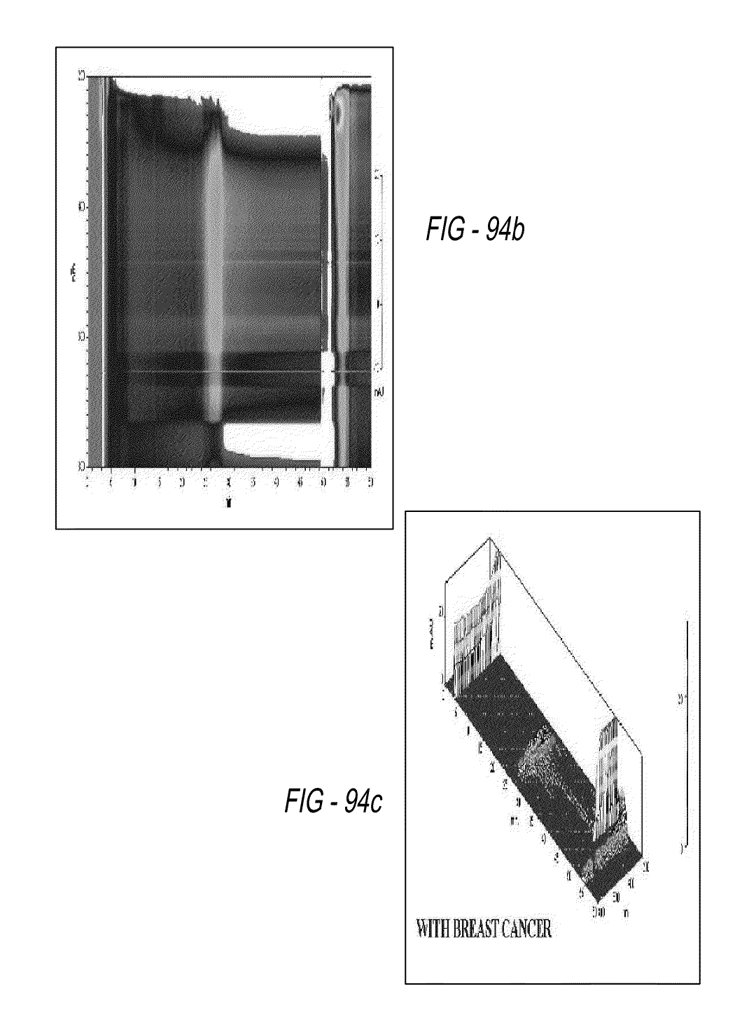

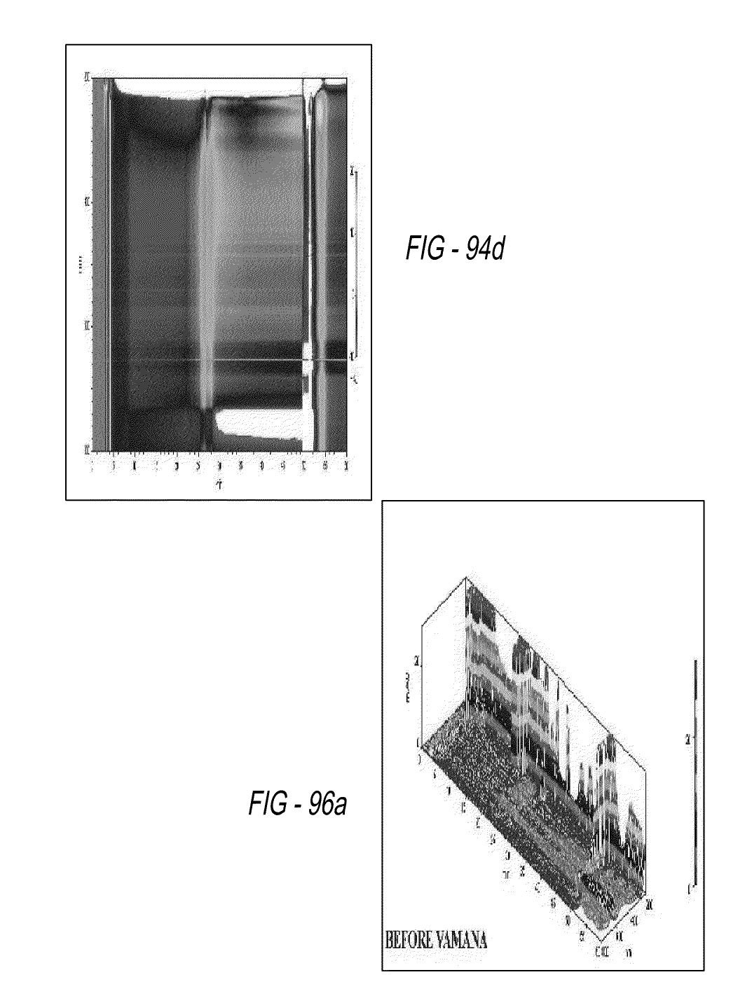

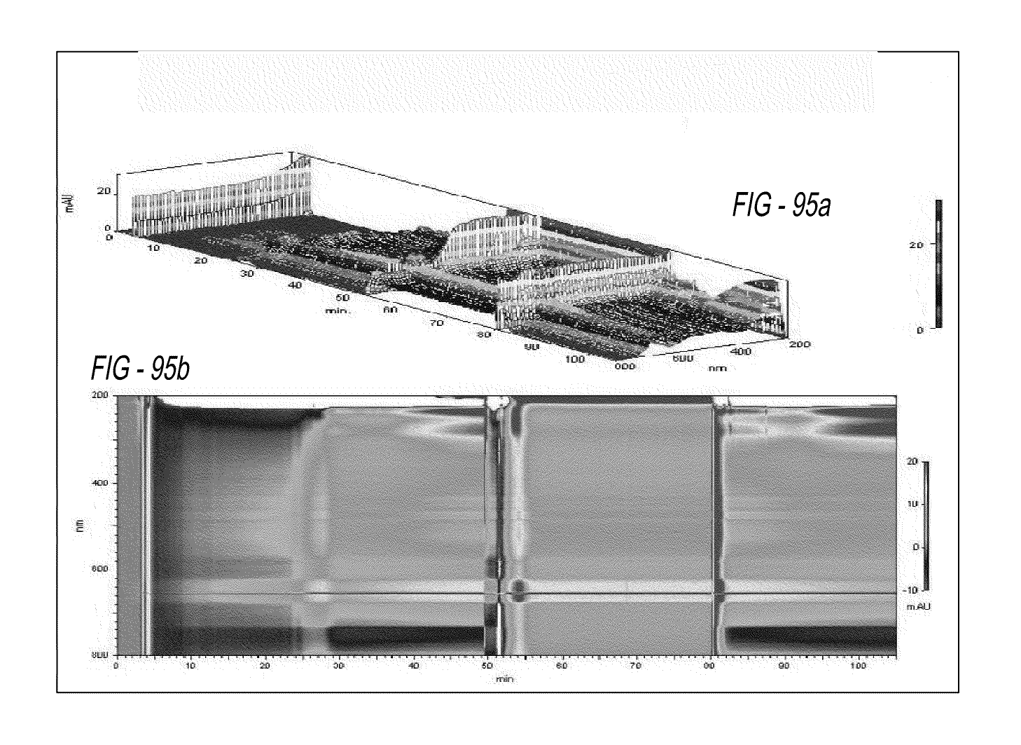

94-95 The fingerprints of different medicines prepared by classical methods using the raw material as said in the text and by modem methods of preparing the same using thick pastes and extracts show that the required efficacy is present in the classical preparations than modern preparations. The molecule acting on thyroid mechanism could be seen in the product prepared classically. Hence modernization of traditional medicines by deviating from the classical methods of preparation could be leading to unwanted clinical results. A set of two molecules can be seen in FIG. 95 showing no difference of chemical profile.

96. Hamsa Pottali: Some of the inorganic medicines were analyzed and presented. Inorganic products are considered as more potent in Indian traditional medicines. Figures of ESCA show how the medicines are changing their properties due to processing. The ESCA being a surface analysis for some of the inorganic medicine no difference could be seen even for different medicines.

97-98. Mineral inorganic medicines used for diabetes have been presented. The medicine Vasantha Kusumakaram is indicating different mechanism of action when compared to the other two.

99. Different commercial samples of Swrnamakshakam, an inorganic medicine used for diabetes has been presented. The brand-to-brand variation will be producing different clinical results.

100-102. Some of the Bhasmas used in the Indian Systems of medicine are used quiet often for different clinical results. Same medicine prepared under different process conditions as mentioned in classical texts of Ayurveda are showing different chemical profiles indicating different clinical results. A social stigma has been developed on such products due to lack of proper understanding, usage, quality and awareness.

103-105 Fingerprints of nine Paashanas have been presented in the figure. Paashanas are some of the rare material used in the traditional medicines of India. One needs excellent skill in using them.

106-116. Some of the Siddha System of medicines were presented. The basic principles of selecting, preparing, standardization and utility of all philosophies will be common. Thus the basis of the traditional philosophies is the basic principles based on which the entire philosophy will be dealt. Some time the method of applying the principle may vary like in Siddha system of medicines. In Ayurveda the concepts give priority to Vata and in Siddha the Pitta is given importance.

117. Fingerprints of Nanoparticle of Iron are presented. In some of the traditional medicines, similar molecular pattern is seen where iron has been used as one of the constituent in the preparation. A circular absorption pattern is seen for the molecules of such kind in any zone of the fingerprint.

118. Fingerprints of some Unani medicines have been presented in which the therapeutic properties could be seen in the fingerprints. The medicine Bahamany Safed is reported to produce when consumed excessively. The same can be seen as an yellow band at 35 minutes. The Salabmisri has Rasayana property due to the molecules from 35-50 minutes.

119-130. Fingerprints of some Homoeo medicines have been shown in the figure. The mother tinctures and dilutions of some medicines were presented. The efficacy can be assessed under stood based on the fingerprint. It can be seen that different potencies of same medicine has different efficacies. The efficacy is increasing with dilution. Belladonna is Rasayana at 200 potency. Causticum CM is more potent and rasayan than 200 potency. Heparsulf 10 is more potent than 200. This shows the facts of many of the principles of Homoeopathy.

131-133. Allopathic medicines: Allopathic medicines used for diabetes were presented.

134. A commercial allopathic medicines used for Postmenopausal syndromes were presented. The common chemistry can be observed as described.

135-141. Many commercial allopathic medicines used for different purposes were presented. The medicines of HIV treatment indicate that they does not effect the Rasayana property due to lack of molecules between 30-50. Hence they will only be able to control the viral load due to the molecules at 0-10 minutes. Onmeprazole show a Ropaneeya property under simulated acidic condition. The medicine has not acted so, in the other prakrithi. This confirms that the prakrithi, the chemical constitution will decide the effect of any medicine. That is why the concept of Prakrithi plays an important role in Indian Systems of medicines.

142-143. The analysis of standard samples likes Chlorogenic acid and Lycopine at different time intervals under chemical conditions show that the molecules under go changes due to the media in which it is present in due course of time. Hence the role of media, prakrithi and bio chemical conditions decides the efficacy and life, of the medicines. This is explained as biotransformation in Ayurveda as shown in table 10 of this document. All system of the universe will under go this change. The Lycopine to sample shows a major molecule at 35 minutes absorbing at 500 nm. It shows its shrothoshodhaka property/ability of cleansing in the medal brain, head part thus acts as stress reliever. This molecule has slowly diminished with time.

144-145. Many of the Coxibs have been used for Arthrites for a long period. The Celebocoxib is found to be different in action when compared to other medicines. All other have a molecules at Pain relieving/stress relieving property due to the molecules at 12 minutes.

146. Some of the medicines used for Alzheimer's disease show variations in profiles. Mamentane is showing its effect on Matta srothas when consumed excessively.

147. Fingerprints of some of the toxic herbal medicines have been presented. The profile of spectra as marked with arrow was generally seen in these samples. A vibrating spectra leading to Vata vridhi should be the cause of the effect.

148. Fingerprints of a biotechnology product have been presented. Even though the general molecules are similar at 5 and 50 minutes the profile in between this zones is showing much difference.

149-151. Toxic compounds: Some of the cytotoxic compounds show the use of spectrum for the assessment of toxicity of the analyte samples. A wavy nature of the absorption spectrum is indicating toxic nature. Similar pattern is seen in herbal medicines also.

152. Fingerprints of Pesticide samples: Some of the pesticide samples show the utility of the method for the monitoring the changed properties after a biological degradation of a pollutant.

153. Fingerprints of Klebsialla Aero and Staphyllo Coccus (Micro organisms) were presented. When the human blood samples were analyzed these profiles were seen.

154. Fingerprints of Animal blood samples: Fingerprints of animal blood samples shows the molecules indicating the disease, which are used as models of the drug discovery for same disease. But the Prakruthi of the animals is different from humans. Thus use of animal experiments for drug discovery needs to be relooked. The fingerprints of different animals were provided showing different molecules with specific polarity. These animals might have been used as models for studying a specific disease due to their disease profiles. But the drug may be responding to the respective disease profiles only with out indicating any correlation to a human being as the Nature and living conditions of animals and humans are incomparable. Even the drug discovery is conducted on animals of controlled living conditions and diet. But practically it will be impossible in humans. That is why the medicine may be successful in humans. The concept of Prakrithi (Individualization due to variation in physico chemical properties) is not mentioned in animals for the medicines mentioned for use in persons of specific prakrithi. Thus use of animals for validation of activity of a fraction of medicine needs to be re looked. The assessment of physicochemical properties like polarity and quantum of energy (playing more role than structure of the molecule) able to be dealt by the medicine may be a better tool for drug discovery.

155. Fingerprints of different human healthy and diseased were presented.

156. Fingerprints of Healthy human blood samples: This fingerprints of diseased and healthy blood samples were analyzed. The concept of Prakruthi as mentioned in traditional literature, is the basis for any traditional practioner for treatment of a disease in him, the variations due to different energy changes of tridoshas. Thus most of the traditional practices are individualistic.

157. Fingerprints of DNA samples of Healthy and diabetic have been shown. The DNA molecule/fragment is generally seen at 15 minutes in diabetic patients. Thus presence of a molecule of similar polarity will not allow the DNA to cleave from the base chromosome. Thus molecules at 15-20 minutes will be preventing DNA damage.

158. Fingerprints of DNA samples of different healthy personalities were presented along with a obese personality. The presence of a hyper conjugated molecule at 27 minutes show that this is an indicator DNA molecule/fragment for obesity. The molecules like HDL cholesterol, Medicines acting on diabetes, molecules influencing insulin mechanism do show the same polarity. Different actions of different DNA constituents could be understood by the present method. This also will help to assess the Deha prakrithi of the person.

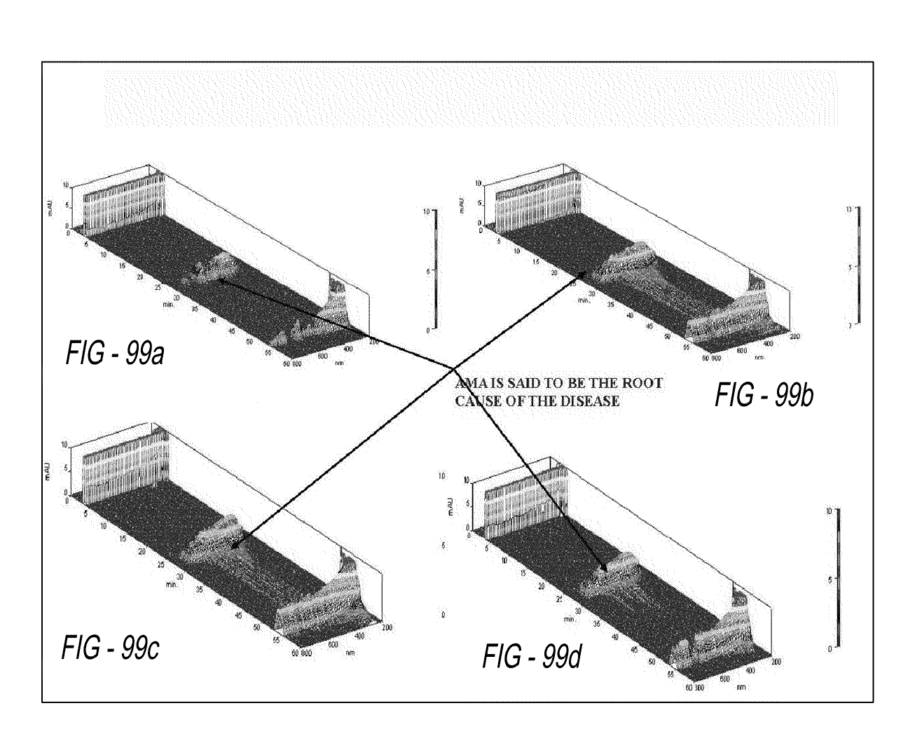

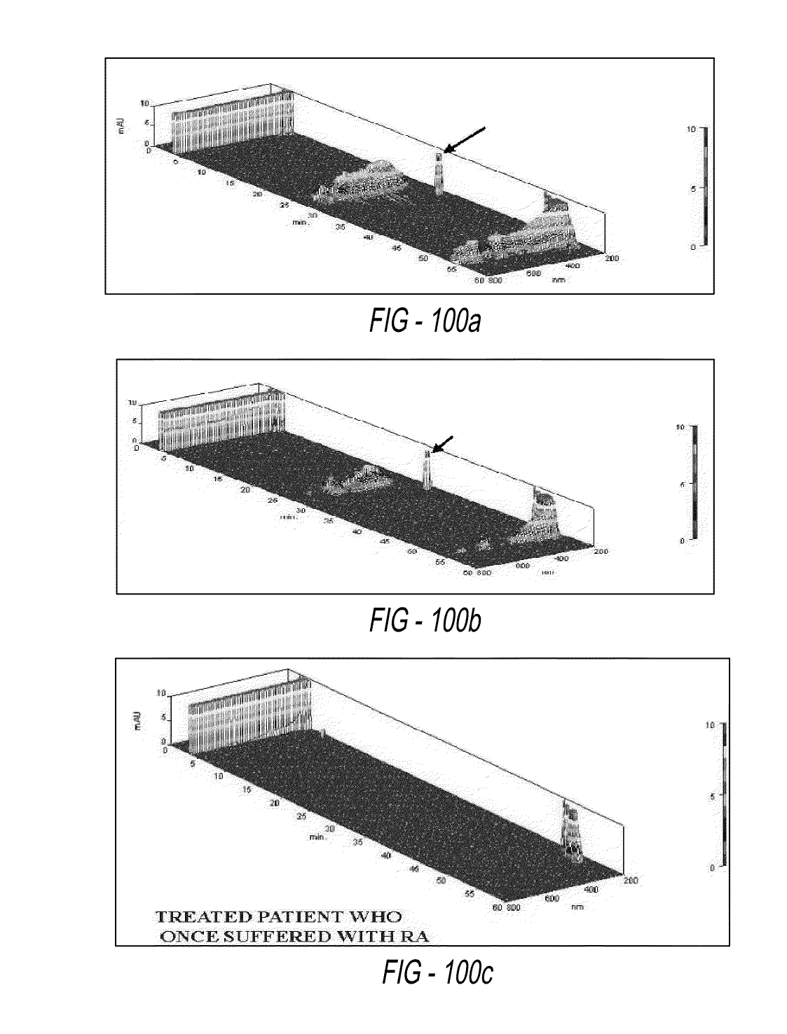

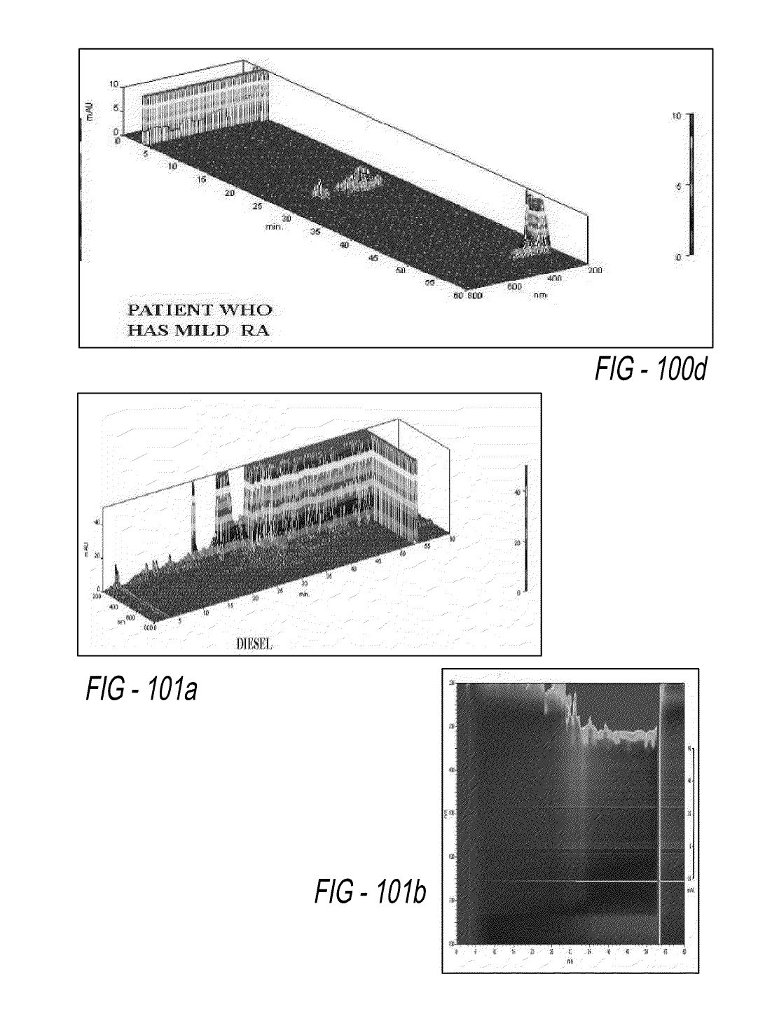

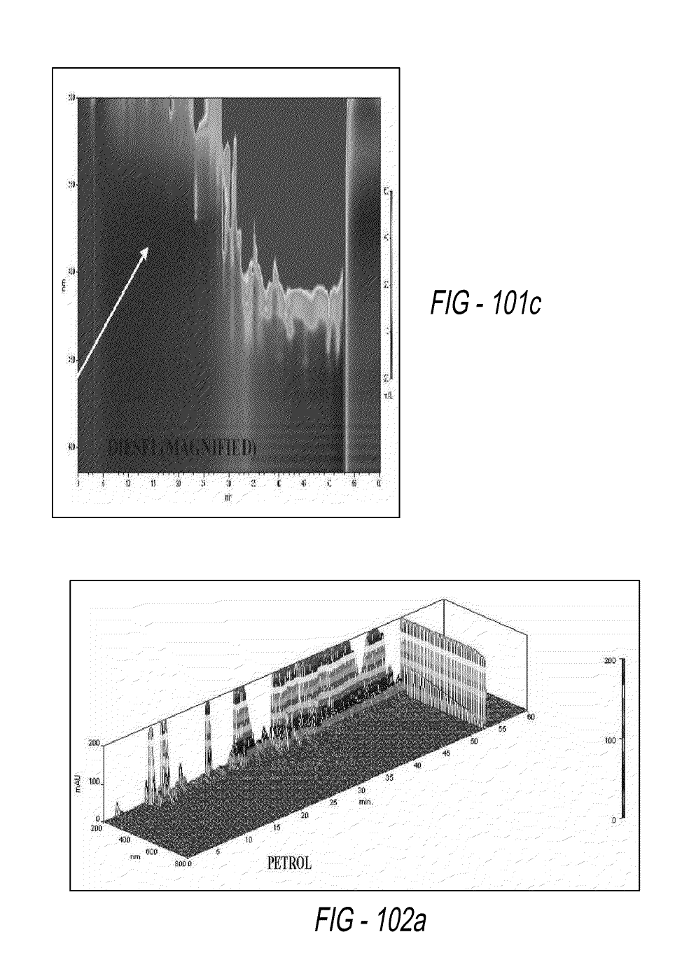

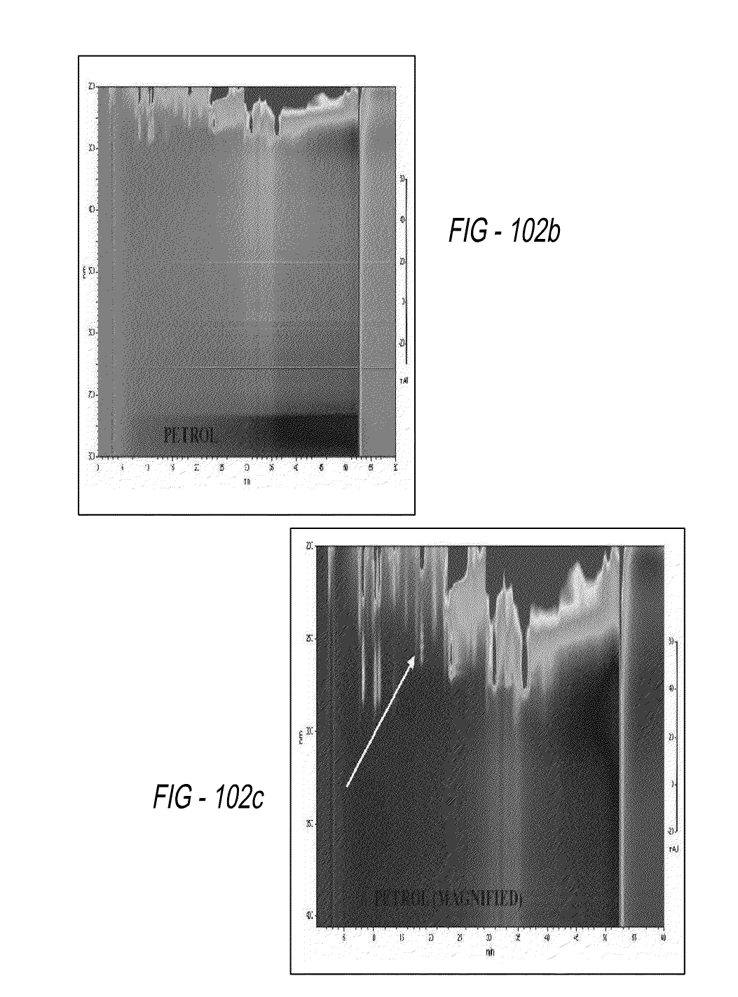

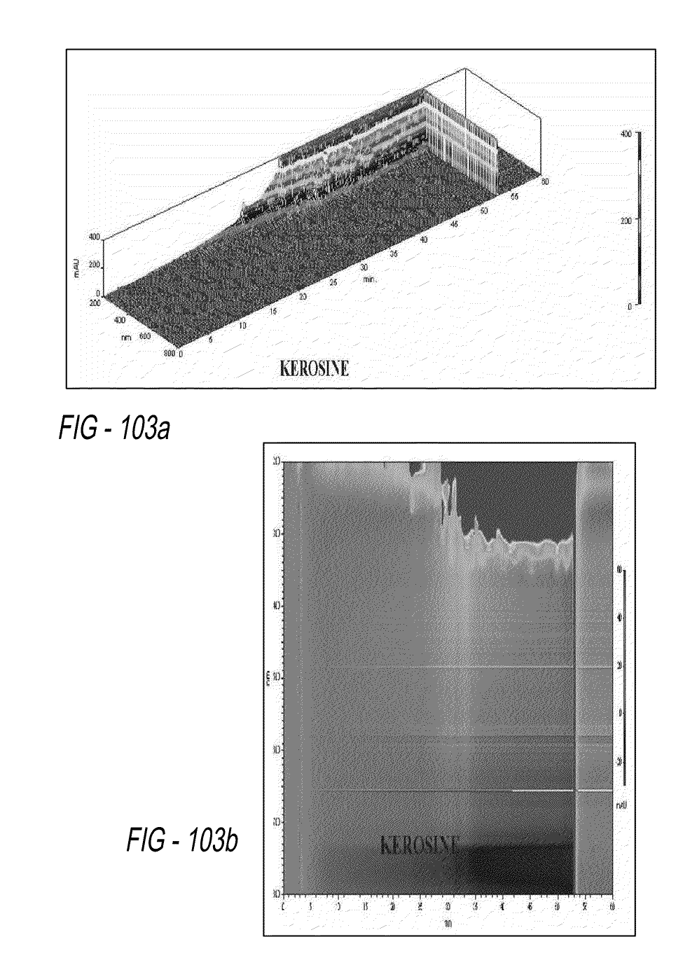

159. Fingerprints of WBC samples of different healthy personalities, of whom the DNA were analyzed as shown in FIG. 158, were presented. The presence of a molecules between 35-45 minutes show, that this constituent majorly influence the immunity/Rasayana property of the body. This also will help to assess the prakrithi of the person.

160. Fingerprints of platelets samples are presented. The presence of a molecules between 35-45 minutes show, that this constituent majorly influence the immunity/Rasayana property of the body. Absence/presence of this profile indicates the health. This also will help to assess the prakrithi of the person.

161. Fingerprints of some of the biological indicators for pathological studies show that presence and absence of such profiles show the health status. The molecule at 55 minutes shows the role of Vata in health indicated by Creatinine. The molecule at 8 minutes show the role of Pitta in heart diseases and blood related diseases as indicated by Homocystiene.

162-163. Blood samples of Cardiac patients: Blood samples of different patients with heart diseases were fingerprinted. The disease-causing component (Shrotavarodha) can be seen. A medicine having the required properties will help for curing the disease. The similar profile can be seen in curd. Traditionally curd is prevented for such kind of patients.

164. Blood samples of different types of patients of hepatic disease: Fingerprints of blood samples of hepatitis patients of B and C indicate constituents at twenty minutes (a specific polarity). Medicine having a constituents at the same time indicates that the method is used for disease identification molecule identification, drug selection, drug targeting and drug monitoring.

165-168. Blood samples of Diabetic patients: Fingerprints of blood samples of diabetic patients show that degeneration is different in different people.

169. The fingerprints of Blood samples of Arthrites patients show the role of Ama in the said disease as seen at 27 minutes absorbing at 400 nm.

170-171. The fingerprints of blood samples of different cancer patients were presented which show the role of ama in the diseases. Ama and Vata vridhi is said to be the root causes of many or all diseases in Indian Systems of medicines.

172. The fingerprints of blood samples of a Psoriasis patient before Vamana (Cleansing therapy) and after Vamana were presented. This proves the rationality of Panchakarma therapy used in Indian Systems of medicines for better clinical results with lesser chemical load. The disease causing molecules at 20 minutes, which deranged the Yakrith/liver are absent after the therapy.

173-174. Fingerprints of animal DNA sample magnified portions show an array of bands of DNA.

175. Fingerprints of blood samples of Osteo Arthrites patients. The Ama is said to be the root cause of this disease. It can be seen in the Kapha zone of the patients. The Vridhi of Pitta and Vata are said to be the factors in such patients traditionally.

176. Fingerprints of blood samples of Rheumatoid Arthrites patients. The Ama is said to be the root cause of this disease also. It can be seen in the Kapha zone of the patients. The Vridhi of Pitta and Vata are said to be the factors in such patients traditionally. The molecule at 30 minutes is seen in patients with this inflammatory, Kapha disease. The same is absent in healthy patient after treatment along with absence of Ama.

177-179. Fingerprints of some Hydrocarbon fuels like Petrol, Diesel and Kerosene are presented. The molecules at 20 minutes show the fire component of the fuels and the constituent between 35-60 show the carbon load of the samples.

180. Fingerprints of a reaction reagent used in the organic reactions is analyzed. The fingerprint will give information about the mechanism of the reaction how it creates the required end product molecule. The binary molecules at 40 mins, at 25 to 30 minutes and at 5 minutes help for the same.

181. Fingerprints of some standard antioxidants at different time intervals have been show to under stand the Vipaka concept of the traditional philosophies. The molecules under go chemical and bio chemical modifications and change their chemical and therapeutic properties due to their presence in due course of time. The efficacy of the molecule is due its final properties it reached with time, is termed as Vipaka.

182. Flow charts of Herboprint

183. Schematic diagram of chromatographic system used.

### DETAILED DESCRIPTION OF THE PRESENT INVENTION

Accordingly, the novel basis of the present method is, presenting the molecules (matter) arranged in the order of polarity and their energies of absorption and/or emission properties (radiation) of the chemical constituents present in a medicine, displayed in 3-D and contour chromatograms. This is described as a novel method of Chromatographic Fingerprinting for the assessment of chemical and therapeutic efficacy of medicines. When the energy absorbed or emitted is studied under different conditions like temperature, pH the variations is used for the assessment of efficacy. When the chemical constituents of a medicine are arranged in the order of polarity and presented along with conjugative property, the chemical profile of the medicine shows correlation with therapeutic efficacy of medicines as said in the traditional philosophies. The Chromatographic Fingerprint generated by this method is providing energy involved due to the conjugative and polarity properties of the individual molecules present in the medicines giving the therapeutic efficacy of the medicine.

The charge or polarity of any molecule depends on different charged functional groups, which will influence the activity of the molecule. In a molecule the UV-Visible absorbance/emission capacity depends on the structure and functional groups of the molecules. When the double or triple bonds are present in the molecules, alternatively in the structure, it is called as conjugated. Thus the measurement of these properties will give the therapeutic efficacy of a medicine. The conjugative properties will influence the absorption and emission properties of the constituents and study of these properties will help to understand the molecular properties of the analyte. Hence use of the conjugative and polarity properties of the medicines for therapeutic standardization is the novelty of the proposed method along with the elution pattern of the molecules over a chromatographic separation media.

The present method is proposed for the quality control of herbal medicines and formulations, mostly useful for the assessment of chemical and therapeutic efficacy by using Chromatographic Fingerprinting and standardization (chemical and therapeutic) of traditional medicines. Unlike a method being used for analyzing only active ingredient or lead molecule (which is not known in many herbal medicines) for the analysis of medicines at a single wavelength. It gives the total profile of the chemical constituents present in the traditional medicines along with physical and chemical properties of the compounds (Say UV-Visible absorptive and polarity properties related to efficacy). In the first part of the method, a 2D and 3D image of the Chromatographic Fingerprint of the medicine will be generated. But as an Image cannot become Analytical Data, a computer-based (Microchip, Dongle switch, software and hardware locked) method is developed to give the Qualitative and quantitative data of the ingredients in the form of an analytical chromatographic report. This was reported in our earlier report (PCT/IN00/00123)

As said above the absorptive or emission spectra and polarity of the compounds will indicate the conjugative and polarity properties of the compounds and thus indicating the chemical/medicinal activity of the medicines. This profile of spectra of all the constituents in a single picture, “THE CHROMATOGRAPHIC FINGERPRINT” as proposed now will become the blue-print of the constituents present, in biological, herbal medicines and formulations. This becomes a method of identification and standardization of herbal medicines than the existing, as the peaks will express the UV-VIS or NIR radiation. Properties or conjugative and polarity properties of the constituents related to efficacy, unlike in a conventional chromatogram taken at a single wavelength along with the quantification of the constituents.

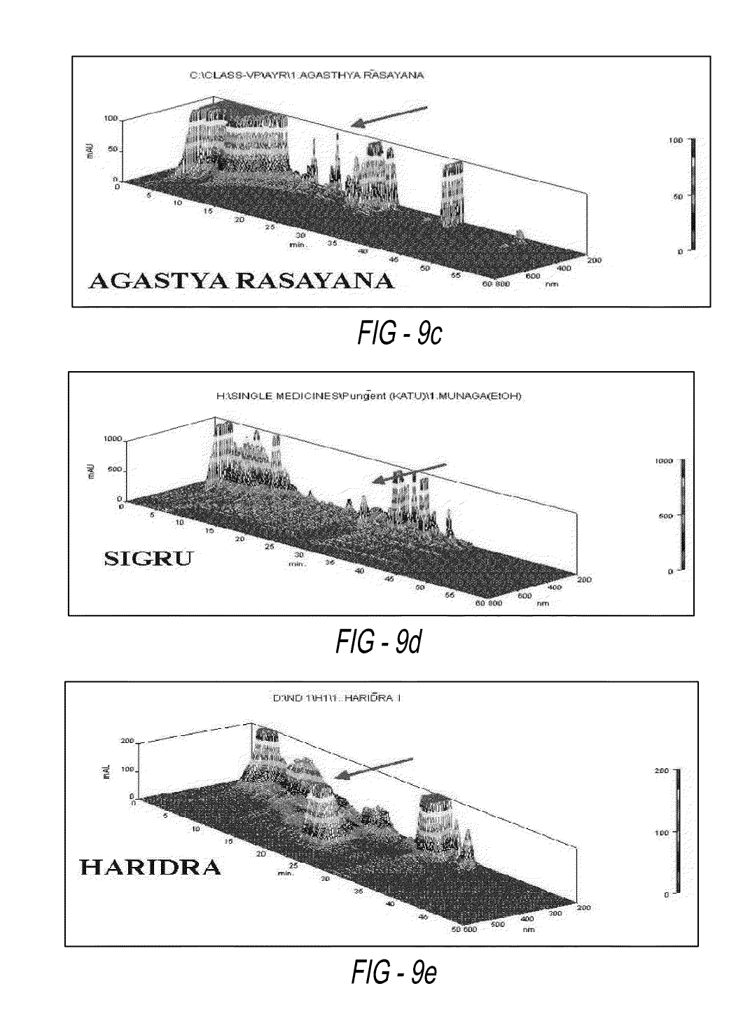

As described in the traditional standardization methods, the colors of the medicines were used to know and standardize their therapeutic efficacy. The colors of the molecules can be understood by their absorptive properties of the radiation of the UV-VIS and NIR range of radiation. The absorbance of a molecule at a particular radiation depends on the structure, functional groups, conjugation, and the extent of unsaturation. Hence the UV-VIS absorbance of any molecule is widely used in the qualitative and quantitative properties of the constituents. The colors and the therapeutic efficacies of various medicines were given in the ancient literature. FIG. 9 of medicines with different colors indicate how efficacy was related to colour of the medicine. When medicines of some color were analyzed a similarity of efficacy was observed.

When the molecules are separated based on the polarity and their absorptive property of a range of electromagnetic radiation indicate the quantum of energy able to be dealt by the molecule. Almost all molecules are majorly absorbing at Ultraviolet radiation. Thus when they are consumed the same radiation present in excessive gets absorbed from the system and the derrangement of energy system gets reverted to normal. Excessive storage of such energy could be the causative factor for a disease and removal of the same radiation leads to bring back the healthy conditions. The medicines, which are red in color, are unable to absorb the respective wavelength of the white light, the material exposed to, so it is red in color. The energy absorbed by the molecule will be ultra violet wavelength. Thus molecules (subjective) with a specific polarity are absorbing radiation (energy), when a suitable medicine with absorptive property at a suitable wavelength will have a specific efficacy. The causative and curative energy has been dealt by the molecules, which can handle a specific quantum of energy.

Ultimately the colors of the molecules are due to a specific chemical nature of the molecule. When the same is studied the chemical property can also be understood. Thus study and understanding of the interaction of the electromagnetic radiation with matter will be useful to study the chemical nature and thus the therapeutic efficacy of the material under test. The same, principle has been used in the present, method of Chromatographic Fingerprinting and standardization. Hence the use of Chromatographic Fingerprints for understanding the chemical and therapeutic properties of medicines is proposed as a novel method of standardization and assesses the efficacy of biological and herbal medicines.

The main novelty of the present method involves in the “Arrangement of molecules in a specific order of polarity which is displayed in the chromatographic fingerprint and division of the Chromatographic Fingerprint into different therapeutic zones based on the scales of wavelength (Conjugation) and retention time (Polarity) to understand the therapeutic efficacy (in traditional terms) of a single or a formulated medicine indicated by the energy absorbed or emitted by the molecule at different pH, temperature, ionic media and viscosity conditions, in a 2-D and 3-D data graph” using an instrumental and software based program. Analysis of the molecular weight of the constituent will add more information and authenticity for standardization.

After developing the analysis data in to a data base the database operations for accessing it for different commercial and regulatory activities ERP&CRM features were added to the software.

Using the computer-based (Microchip, Dongle switch, software and hardware controlled and locked) software developed, a novel chromatogram is generated which shows the conjugative (Wavelength on X axis) and polarity of all the constituents shown in a single Chromatographic Fingerprint. A barcode can also be generated for a selected peak of a molecule given in the image. Where in the X (Retention Time), Y (Wave length in contour chromatograms and absorbance in 3-D chromatograms), R (The red color indicating the highest concentration of the constituent, G (the green color indicating the lesser concentration of the constituent and B (Blue color indicating still lesser concentration of the constituent) coordinates, provided by the present software is feed in any commercially available re-salable bar coding software's, added in the present software generates a barcode for a single constituent, or for many constituents. The Image of the Chromatographic Fingerprint can be viewed on a display window attached to it. It will be displayed whenever the electronic eye of the vending machine reads the bar code. This makes the image (Finger print) and bar code proprietary for a product of an industry or a country. This is claimed as another novelty of the proposed method. The present method of giving a bar code to a medicinal product for commercial purposes is, by giving a registered number for the said product. It has no relation with the actual chemical constituents and efficacy of the medicines. But in the proposed novel method of bar coding the generation of a bar code for a product based on the chemical profile while doing the analysis it self, will be more regulatory compliance than the existing method under practice.

The data generated at different states is graphically presented in 2D and 3-D data graph, which will be useful for qualitative and quantitative chemical and therapeutic standardization.

The main embodiment of the present invention is to propose a novel method for chemical and therapeutic standardization by detection and identification and 2-D and 3-D animated chromatographic finger printing of organic, organo metallic and metallic constituents of extracts of plants, animal or geological origin, natural or synthetic sources capable of responding (absorb, emit, reflect, refract or diffract) to different wavelengths of electromagnetic radiations, possessing different chemical and therapeutic properties at different pH, temperature, viscosity and ionic media using their physico chemical properties like polarity, conjugation, mass and total quantum of energy of the analytes where in the data graphs are presented as static and movable on any axis of 0-360 degrees providing complete information about the analyte.

One of the embodiments of the present invention is to identify the molecules in the said compounds by the absorptive, refractive, reflective, and diffractive and emission properties of various constituents in the medicine related to a specific efficacy due to its action on a specific single or multiple pathways.

One of the embodiment of the present invention is identifying, determining and classifying the constituents by the absorptive, refractive, reflective, diffractive or emission of an electromagnetic, electrical or magnetic energy of the eluted constituents based on physico chemical properties like polar, medium polar and, less or non-polar properties and conjugation for chemical and therapeutic standardization of the sample analyzed.

Another embodiment of the present invention is to provide a complete chemical analysis of the constituents present in the medicine under study and their conjugative properties indicating the therapeutic efficacy as per the traditional concepts of the medicine using new software developed.

Another embodiment of the present invention relates to a method where a single solvent Ethanol or aqueous Ethanol is used for extraction of the constituents; same analytical conditions and instrumental parameters were used for all samples to bring the therapeutic generalizations there by achieving the therapeutic standardization.

Another embodiment of the present invention relates to a method, wherein, an inbuilt software provides a novel concept of chromatographic finger printing of herbal medicines that will be useful for the quick identification of the actual profile of the compounds present in the medicine under use along with their therapeutic efficacy of the constituents.

Still another embodiment of the present invention relates to a method of Chromatographic Fingerprinting where in the atoms/molecules are separated using a chromatographic method of separation and arranged in the specific order of polarity along with conjugative property measuring the absorptive and emission property of an electromagnetic radiation by the analytes.

Still another embodiment of the present invention is to provide a soft ware capable of analyzing (extracting colors) the colored contour and 3-D chromatographic image based on various colors with respect to a specific energy as presented in the energy box. The box denoting the concentrations and energies of various constituents eluted with time having arranged in a specific order of polarity indicated as retention time at a specific pH, temperature, viscosity and ionic media.

Still another embodiment of the present invention relates to a method, wherein, an inbuilt software provides a novel chromatographic finger printing of herbal medicines and formulations analyzed and are developed on a electromagnetic radiation detector like Photo Diode array Detector (PDA) connected to a chromatographic instrument like High Pressure Liquid Chromatograph, which delineates the data of the spectral properties of the constituents present in the material having the medicinal value, presented in a specific order of physico chemical properties like polarity along with conjugation generated under similar experimental analytical conditions.

Still another embodiment of the present invention relates to a method used as a data processor of 3 D data graphs and color contour image of an ingredient.

Still another embodiment of the present invention relates to a method which uses solvents for extraction, are selected based on the polarity, hydrophilic and hydrophobic nature of the constituents of the sample under study.

Still another embodiment of the present invention relates to a method wherein, the polarity of the mobile phase of a non-aqueous and an aqueous solvent of a specific pH is controlled by varying the ratio of the mobile phase from 0% to 100% of an aqueous solvents like water or a buffer of a known pH, along with a non-aqueous solvent and vice-versa.

Still another embodiment of the present invention relates to a method wherein, on analysis of 3-D and contour chromatograms using new software, gives a data having indicated the vitiation of doshas quantitatively in percentage ratio.

Still another embodiment of the present invention relates to a method of Chromatographic Fingerprinting to assess the healthy or diseased patterns of a human being, animal or a microorganism, which helps for different purpose of disease identification, disease monitoring, drug selection, drug targeting and drug monitoring. Still another embodiment of the present invention relates to a method of Chromatographic Fingerprinting where in the atoms/molecules are separated and arranged in the specific order of polarity along with conjugative property measuring the absorbance, emission, reflection, refraction or diffraction properties of an electromagnetic radiation by the analytes.

Still another embodiment of the present invention relates to a method of Chromatographic Fingerprinting where in the 3-D box is the container of the three energies where in the constituents of different properties will be having the polarity. Still another embodiment of the present invention relates to a method of Chromatographic Fingerprinting where in the 3-D box is the container of the three types of molecules with specific energies where in, the constituents with known properties of the molecular structure, mass, polarity and conjugation will be indicating the chemical and therapeutic properties of the constituents and the medicines.

Still another embodiment of the present invention relates to a method of Chromatographic Fingerprinting where in the molecules are eluted in a specific order of polarity with a range of conjugative property using detectors with measurement of absorbance, emission, reflection, refraction or diffraction properties of matter when exposed to electromagnetic radiation, along with conductivity, molecular structure and mass is useful for the Chemical and therapeutic standardization.

Still another embodiment of the present invention relates to a method capable of Chromatographic Fingerprinting where in the molecules are arranged in a specific order of physico chemical properties for chemical and therapeutic standardization.

Still another embodiment of the present invention relates to a method capable of Chromatographic Fingerprinting where in the molecules in a sample matrix are separated by means of a chromatographic technique and arrange in a specific order of polarity for chemical and therapeutic standardization based on the polarity along with conjugation properties.

Still another embodiment of the present invention relates to a method capable of analyzing a sample at different electromagnetic radiations, polarity, viscosity and temperature using suitable pumps to pump the liquids of mobile phase, having a detector which can measure the absorbance, emission, reflection, refraction or diffraction properties of analyte samples in a selected range of wavelength, having a software generating analysis data after coordination and compilation of signals from different types of detectors and analyzing the data for chemical and therapeutic standardization, generating barcode for the data generated after analysis and finally arranging the data in specific data base folders.

Still another embodiment of the present invention relates to a method capable of Chromatographic Fingerprinting where in the physico chemical properties of the carrier are varied for eluting the molecules of a sample matrix to be separated on a chromatographic separation media of a planar or closed chromatographic system for chemical and therapeutic standardization.

Still another embodiment of the present invention relates to a method capable of Chromatographic Fingerprinting where in the analytes after separated on a chromatographic system under different conditions of temperature, pH and viscosity and detected with detectors able to detect the mass, fragmentation pattern, conductivity, polarity, refraction, reflection, diffraction, absorptive and emittive properties of the analytes over a range of electromagnetic radiation for chemical and therapeutic standardization of natural, biological and synthetic materials and medicines.

Still another embodiment of the present invention relates to a detection system which arrays the results of interaction of radiation with matter for the molecules arranged in a specific order of polarity and results in interpretation of the chemical and therapeutic properties of analyte sample.

Still another embodiment of the present invention relates to a method as, wherein the chemical and therapeutic standardization is assessed for a material using the absorptive, refraction, reflection, diffraction and emittive properties of the molecules at a specific single or multiple wavelengths of radiation energy ranges to which the matter is exposed.

Still another embodiment of the present invention relates to a method of chromatographic system having the data generated due to the separation of analytes over a separation media under specified analytical conditions leading to chemical and therapeutic standardization of the analytes under test.

Still another embodiment of the present invention relates to a method of chromatographic system for chemical and therapeutic standardization based on the pattern of the energy data graphs generated due to the inter action of radiation with matter in a detection system to which the matter is exposed to.

Still another embodiment of the present invention relates to a method of bio informatics to assess the efficacy of a medicine and a diseases pattern/status of a living being for disease identification, disease monitoring, drug identification, drug targeting, drug selection, drug monitoring and drug inter action with biological systems

Still another embodiment of the present invention relates to a method, where in the solvents of different polarities are used for extraction based on the hydrophilic and hydrophobic nature of the sample and the constituents under study, generally ethyl alcohol is used as solvent for preparation and standardization of medicines.

Still another embodiment of the present invention relates to a method, where in the Chromatographic Fingerprints can be developed for a same medicine extracted under different pH, polarity, viscosity, ionic media and temperature values.

Still another embodiment of the present invention relates to a method, the said method is carried out using standard analytical parameters like extraction with ethyl alcohol, maintaining a regular run time although the analysis of samples, eluting with a mobile phase of acetonitrile and phosphate buffer having a pH range of 3-9, electromagnetic radiation range of 200-800 nm or below or beyond using a suitable and capable detector, maintaining column, total flow line and detector in the temperature range of 15-70° C., a mobile phase conductivity range of 0 to 50×10³ mhos.

Still another embodiment of the present invention relates to a method, wherein the non-aqueous, organic and aqueous, water or buffer used under specified pH, viscosity, ionic media and temperature are, selected based on the range of pH, viscosity, ionic media, temperature and polarity required.

Still another embodiment of the present invention relates to a method, wherein converting the analytical data into a colored image or an analyzable data comprising the conjugative and polarity properties along with quantum and quantitative data of the constituents of the medicine under study.

Still another embodiment of the present invention relates to a method, where in the therapeutic efficacy of a medicine (Single or formulated) is assessed using the quality of the constituents present in a particular polarity and electromagnetic radiation for refraction, reflection, diffraction, absorptive and emittive responses and the data graphs with X, Y, Z coordinate points indicating specific property in different of zones of the Chromatographic Fingerprint.

Still another embodiment of the present invention relates to a method, where in the software generates a bar code for the properties of the images like a selected peak or peaks or whole image or movie using the X (Retention Time), Y (Wavelength), Z (Absorbance, In case of 3-D image and movie file like Avi, Mpeg etc), R (Number Of Red Pixels), G (Number Of Green Pixels And B (Number Of Blue Pixels) coordinates movable on all axis between 0-360 degrees, provided by the software, which makes the product propriety for an industry.

Still another embodiment of the present invention relates to a method, where in the solvents used for extraction is selected based on the polarity, hydrophilic and hydrophobic nature of the constituents, sample and its constituents under study.

Still another embodiment of the present invention relates to a method, wherein the polarity of the mobile phase of a non-aqueous and an aqueous solvent of a specific pH, is controlled by varying the ratio of the mobile phase from 0% to 100% and vice-versa of an non aqueous solvents like acetonitrile, methanol aqueous solvents like phosphate buffer.

Still another embodiment of the present invention relates to a computational method of chromatographic finger printing, chemical and therapeutic standardization and bar coding of Organic, Organo-metallic and metallic atoms or molecules from a plant, animal, a naturally available or man-made materials used as medicines.

Still another embodiment of the present invention relates to a method wherein it provides absorption/emission spectra of the compounds having displayed the conjugative and polarity properties of the molecules and the concentration of the individual concentrations of the molecules along with the polarity and quantum of energy of the molecules.

Still another embodiment of the present invention relates to a method where in the chemical and therapeutic standardization is achieved by interaction of matter to different individual electromagnetic radiations when the data is presented as chromatographic fingerprint.

Still another embodiment of the present invention relates to a method wherein, same standard analytical parameters like Extraction with same solvent Ethyl alcohol, same run time, same mobile phase acetonitrile along with phosphate buffer in a specific pH in the range of 3-9, same conductivity range of 0-50×10³ mhos and a same range of Electro Magnetic radiation from 200 nm-800 nm is used for Chromatographic Fingerprinting and chemical and therapeutic standardization along with subjecting the samples to different variable analytical factors like pH, temperature, column length, run time and Polarity of the stationary phase and mobile phase and maintaining the same order of arrangement of the molecules based on polarity, and molecular size in the specific order, is the basis of the assessment of chemical and therapeutic quality of the samples under study.

Still another embodiment of the present invention relates to a method of Chromatographic Fingerprinting where in the measurement of absorbance energy is indicating the activity of a constituent in absorbing the respective quantum of energy at a specific X, Y, Z position of the energy system with specific polarity and conjugative properties from the diseased conditions making to cure the disease pattern and hence therapeutically indicative.

Still another embodiment of the present invention relates to a method of Chromatographic Fingerprinting where in the respective zones and X, Y, Z coordinates of the constituents have a specific property of chemical and therapeutic efficacy of the analyte constituents present in a medicine.

Still another embodiment of the present invention relates to a method of Chromatographic Fingerprinting where in influence of variable factors like temperature, pressure, pH, ionic media and viscosity of the mobile phase, stationary phase and sample will be influenced to arrange the atoms and molecules in a specific order of polarity whose, conjugation and molecular structure will be analyzed along with conductivity will be useful for the chemical and therapeutic standardization.

In yet another embodiment of the present invention relates to a method of Chromatographic Fingerprinting where in the gradient, ternary or quaternary run of the mobile phase ends at the ratio where it starts.

In yet another embodiment of the present invention relates to a method of Chromatographic Fingerprinting using which the interpretation of the activity of the analyte atom or molecules and their energies having a specific quantum of energy along with structural properties relates to their chemical and bio chemical and biophysical activities.

In yet another embodiment of the present invention relates to a method of Chromatographic Fingerprinting using which the interaction of molecules of different polarities is assessed when they are arranged in the order of polarity.

In yet another embodiment of the present invention relates to a method as, where in the temperature, pH and polarity of the mobile phase is controlled by varying the temperature, the ratio of the mobile phase of a solvent between 0 to 100% of an aqueous solvent like Water or a phosphate buffer at a required pH by using suitable buffer to maintain the required pH, polarity and ending at the ratio where it started with a non-aqueous solvent by a gradient, ternary or quaternary run.

In yet another embodiment of the present invention relates to a method, wherein the non-aqueous, organic and aqueous, water or buffer at a known temperature, viscosity and pH are solvents used are selected based on the range of temperature, viscosity, ionic media, pH and polarity required.

In yet another embodiment of the present invention relates to a method, wherein, same standard analytical parameters like Extraction, run time, mobile phase, range of Electro Magnetic radiation influenced by variable factors like pH, temperature, column length, run time, Polarity of the column, stationary phase and mobile phase, maintaining the same order of arrangement of the molecules based on polarity and molecular size in the specified order are used to achieve chemical and therapeutic standardization.

In yet another embodiment of the present invention relates to a method, for chemical and therapeutic standardization based on the pattern of the energy data graphs generated due to the inter action of radiation with matter in a detection system to which the matter is exposed to, after an orderly separation.

In yet embodiment of the present invention relates to a method, a bio informatics tool to assess the efficacy of a medicine and a diseases pattern/status of a living being for disease identification, drug identification, drug targeting, drug selection, drug monitoring and drug inter action with biological systems

In yet another embodiment of the present invention relates to use of Chromatographic Fingerprints of contour and 3-D chromatograms of the constituents as claimed in any of the proceeding claims are the basis for identification of chemical constituents for chemical and therapeutic standardization.

In yet another embodiment of the present invention relates to a method of Chromatographic Fingerprinting where in the method enables to understand and standardize the variations in Physico-Chemical properties of the medicines in the form of energy variations, different states of three energies. These variations are present in medicine and living beings used for the therapeutic standardization using conjugative and polarity properties of the medicines shown in chromatographic fingerprints.

In yet another embodiment of the present invention relates to a method of Chromatographic Fingerprinting using which the variable factors like temperature, humidity, viscosity, ionic nature etc., on the physico chemical properties and thus therapeutic efficacy of a medicine can be assessed using the 3-D energy box.

In yet another embodiment of the present invention relates to a method, where in preparation of a database of a large number of samples will give many generalizations of the therapeutic efficacy of a particular group of plants or animals classified as a group for a particular disease for therapeutic identification, classification, standardization and monitoring.

In yet another embodiment of the present invention relates to a method of Chromatographic Fingerprinting where in the atoms/molecules are separated using a chromatographic method of separation and arranged in the specific order of polarity using a separation technique where in the variable parameters like polarity, pH, temperature, ionic and electrical charge and viscosity of the reaction media, mobile phase, stationary phase and sample under analysis which will be varied leading to the interpretation of the Tridosha properties and efficacy of the same.

In yet another embodiment of the present invention relates to a method of Chromatographic Fingerprinting where in the absorption and emission of the electromagnetic radiation by analyte constituents in a medicine along with polarity property will help to understand the efficacy of the same and the efficacy is due to these two basic properties.

In yet another embodiment of the present invention relates to a method of Chromatographic Fingerprinting where in the 3-D box is the container of the three energies where in the constituents of Agni in nature or in the first zone of the Chromatographic Fingerprint, Jala property in the second zone of the Chromatographic Fingerprinting and Prithvi in the last zone. The Vayu is present in the last zone and in the area where in there in no constituents were present in the entire container.

In yet another embodiment of the present invention relates to a method of Chromatographic Fingerprinting where in the chemical profile in diseased and healthy blood samples can be studied in a microorganism, animal and human being to correlate the disease profile with chemical profile indicating the relation of polarity and conjugation for drug selection, drug identification, drug targeting and drug monitoring.

In yet another embodiment of the present invention relates to a method of Chromatographic Fingerprinting where in the energy at different doshas at deficient, sufficient and excessive states of levels indicating the energy variations of natural microorganism, animal and human being along with medicines and synthetic materials.

In yet another embodiment of the present invention relates to a method of Chromatographic Fingerprinting using which therapeutic grouping of constituents and medicines can be done based on the said atomic and molecular properties.

In yet another embodiment of the present invention relates to a method of Chromatographic Fingerprinting useful for the assay of the taste and its order, color of transmission and absorption and odor will be done at different levels of energy variations to understand the process of biotransformation and biogenesis.

In yet another embodiment of the present invention relates to a method of Chromatographic Fingerprinting where in the traditional properties mentioned in the basic concepts mentioned in the traditional philosophies were correlated to the physico chemical properties of the medicines.

In yet another embodiment of the present invention relates to a method of Chromatographic Fingerprinting where in the physico chemical properties like polarity, conjugation and quantum of energy of the atoms and molecules are useful to identify the bio chemical pathways having the same properties involving a specific energy.

In yet another embodiment of the present invention relates to a method of Chromatographic Fingerprinting useful for understanding the evolution of the dosha and dhatu properties of the medicines in living and non-living things.

In yet another embodiment of the present invention relates to a method of chromatographic fingerprinting of the native medicines of a particular place or country to develop suitable traditional philosophies and dictionaries for the chemical and therapeutic standardization.

In yet another embodiment of the present invention relates to a method of chromatographic fingerprinting of the blood samples of living beings of a particular place or country to develop suitable traditional medical philosophies and dictionaries for the chemical and therapeutic standardization.

In yet another embodiment of the present invention relates to a method of Chromatographic Fingerprinting as, wherein the method enables to understand and standardize the variations in Physico-Chemical properties of the medicines in the form of energy variations of different states of Tri dosha energies present in medicine and living beings, for chemical, clinical and therapeutic standardization.

In yet another embodiment of the present invention relates to a method, where in the Chemical and therapeutic standardization properties are assessed for a material using the absorbance, emission, reflection, interference, refraction and diffraction of the molecules at a specific single or multiple wavelengths range to which the matter is exposed and the data is interpreted for single and multiples of wavelengths in a fingerprint.

In yet another embodiment of the present invention relates to a method of Chromatographic Fingerprinting for creation, improving, altering and modifying the capability of hard wares and soft wares useful for drug discovery.

In yet another embodiment of the present invention relates to a method of Chromatographic Fingerprinting where in the arrangement of molecules in a specific order of physico chemical properties after separation on a separation media for chemical and therapeutic standardization with and with out recycling the eluent molecules either in to the same column or in to a battery of separation systems.

In yet another embodiment of the present invention relates to a thermally protected and controlled system containing the separation media of stationary and mobile phases, detector flow cell system along with the flow line to develop chromatographic fingerprinting for chemical and therapeutic standardizations.

In yet another embodiment of the present invention relates to a detector flow cell with thermally varying and controlling facility which change the temperatures as to programmed and detect the bathochromic, hypso chromic, hyper chromic and hypo chromic variations of the spectrum at varying analytical conditions, of the samples passing through the flow cell for chromatographic fingerprinting for chemical and therapeutic standardizations.

In yet another embodiment of the present invention relates to a one of the present embodiment of the present invention relates to a method for the standardization of matter and radiation for the assessment of the quantum energy they can deal and arrange the matter in an order based on their physico chemical properties and kinetics.

In yet another embodiment of the present invention relates to a method for the standardization of matter and radiation for the assessment of the quantum energy they can deal and arrange the matter in an order based on their physico chemical properties and kinetics for quantum chemical studies.

In yet another embodiment of the present invention relates to a method of Chromatographic Finger Printing, the data is obtained for identifying the chemical constituents present in it for the purpose of chemical, therapeutic and process standardization and quality control activities of African, Allopathic, Ayurvedic, Chinese, Homoeo, Kampo (Japanese), Siddha, Unani and Tibetan medicines or any medicines.

In yet another embodiment of the present invention relates to a method for the standardization of matter and radiation for the assessment of the quantum energy they can deal and arrange the matter in an order based on their physico chemical properties and kinetics for quantum bio chemical studies.

In yet another embodiment of the present invention relates to a method for the standardization of matter and radiation for the assessment of the quantum energy they can deal and arrange the matter in an order based on their physico chemical properties and kinetics for quantum bio physical studies.

In yet another embodiment of the present invention relates to a method for the standardization of matter and radiation for the assessment of the quantum energy they contain and arrange the matter in an order based on their physico chemical properties and kinetics for quantum chemical studies by using an equation E=m^{±p}C^{λ}Where in m is the mass, p is polarity at specific temperature and pressure of the analyte material and C is the speed of the respective radiation.

In yet another embodiment of the present invention relates to a method for the to standardization of matter for the assessment of the chemical, therapeutic and biological properties by the generalization of their commonalities and differences in the profile.

In yet another embodiment of the present invention relates to a method of analysis using the patterns of electromagnetic radiations absorbed or emitted, generated for a sample for chemical and therapeutic standardization.

In yet another embodiment of the present invention relates to a method of analysis using the graphical data patterns of electromagnetic radiations absorbed, emitted, reflected, refracted, interference, diffracted with the analyte and generate data for a sample by a separation method using different properties of the carrier media to separate over a separation media, separating and arranging the constituents in a specific order of polarity along with measured responses of the constituents with interaction of electromagnetic radiations for chemical and therapeutic standardization of material under test.

In yet another embodiment of the present invention relates to a method of analysis for the standardization of organic reagents for chemical and activity standardization.

In yet another embodiment of the present invention relates to a chromatographic fingerprinting method of analysis for the chemical and therapeutic standardization of Nanoparticles in materials.

In yet another embodiment of the present invention relates to a Chromatographic fingerprinting method for the chemical and therapeutic standardization of nutritional values of foods, nutritional dietetics and nutritional genomics.

In yet another embodiment of the present invention relates to a method of chromatographic fingerprinting for the chemical and therapeutic properties of proteins and genetic material for proteomics and genomics studies.

One of the embodiments of the present invention relates to a method of chromatographic fingerprinting which provides the properties of the analyte with out a referral standard.

In yet another embodiment of the present invention relates to a software capable of interpreting constituents between 0-20 minutes as Pitta in nature which are in Zone 1, of the image where in 0 minutes is acute and 20 is chronic.

In yet another embodiment of the present invention relates to a software capable of interpreting Constituents in the range of retention times 20-40, as Kapha in nature which are in Zone 2, of the image where in where in the constituents at 20 min acts on acute and 40 min acts on chronic conditions.

In yet another embodiment of the present invention relates to a software capable of generating a chromatogram based on the color analyzed (Extracted from finger print using a Graphic User Interface software developed), having peaks at various retention times along with different physico chemical properties like conjugative and polarity properties of the analyte constituents eluted with time.

In yet another embodiment of the present invention relates to a software capable of interpreting Constituents in the range of retention times 40-60, as Vata in nature which are in Zone 3, of the image where in where in constituents at 40 acts on acute and 60 is chronic conditions.

In yet another embodiment of the present invention relates to a software capable of interpreting Constituents in the range of retention times 5-15, as Kashaya, Astringent, in nature which are in Zone 1, of the image.

In yet another embodiment of the present invention relates to a software capable of interpreting Constituents in the range of retention times 15-20 min, as Katu, Pungent, in nature which are in Zone 1, of the image.

In yet another embodiment of the present invention relates to a software capable of interpreting Constituents in the range of retention times 25-35, as Tikta, Bitter, in nature which are in Zone 2, of the image.

In yet another embodiment of the present invention relates to a software capable of interpreting Constituents in the range of retention times 25-35, as Lavana, Salty, in nature which are in Zone 2, of the image.

In yet another embodiment of the present invention relates to a software capable of interpreting Constituents in the range of retention times 30-40, as Amla, Sour, in nature which are in Zone 2, of the image.

In yet another embodiment of the present invention relates to a, software capable of interpreting Constituents in the range of retention times 35-55, as Madhura, in nature, which are in Zone 2 and 3, of the image.

In yet another embodiment of the present invention relates to a software capable of interpreting Constituents absorbing from 200-800 nm, as Dosha kara/Vridhi, in nature which are in Zone 1, 2 and 3, of the image when a sample is analyzed on a separation to media and molecules arranged in an order of polarity.

In yet another embodiment of the present invention relates to a software capable of interpreting Constituents absorbing from 200-400 nm, as Increase of respective conjugative property said to be Dosha hara, in nature which are in Zone 1, 2 and 3, of the image when a sample is analyzed on a separation media and molecules arranged in an order of polarity.

In yet another embodiment of the present invention relates to a software capable of interpreting Constituents absorbing from 200-800 nm, as Increase of respective property will be Sheeta Veerya, in nature which are in Zone 2, of the image when a sample is analyzed using a separation media.

In yet another embodiment of the present invention relates to a software capable of interpreting Constituents absorbing from 200-800 nm, as Increase of respective property will be Ushna Veerya, in nature which are in Zone 1, of the image when a sample is analyzed on a separation media and molecules arranged in an order of polarity.

In yet another embodiment of the present invention relates to a software capable of interpreting the Vipaka (Post assimilative) property, which is absent before and present after interacting with an enzyme in a medicine/biological fluid.

In yet another embodiment of the present invention relates to a software capable of interpreting the Sookshma property (Smaller molecules or absorbing sharply at lesser wave lengths, 190-220 run), which are in Zone 1, 2 and 3, of the image when a sample is analyzed on a separation media and molecules arranged in an order of polarity.

In yet another embodiment of the present invention relates to a software capable of interpreting the Rooksha (Volatile high to medium polar molecules) property based on the absorption spectra and polarity of the ingredients in Zone 1, 2 and 3, of the image when a sample is analyzed on a separation media and molecules arranged in an order of polarity.

In yet another embodiment of the present invention relates to a software capable of interpreting the Snidha (Viscous medium to non polar molecules) property based on the absorption spectra of 200-800 nm and polarity of the ingredients in Zone 1, 2 and 3, of the image when a sample is analyzed on a separation media and molecules arranged in an order of polarity.

In yet another embodiment of the present invention relates to a software capable of interpreting the Laghu property based on the absorption spectra, polarity and less number of ingredients in Zone 1, 2 and 3, of the image when a sample is analyzed on a separation media and molecules arranged in an order of polarity.

In yet another embodiment of the present invention relates to a software capable of interpreting the Guru property based on the absorption spectra, polarity and large number of ingredients in Zone 1, 2 and 3, of the image when a sample is analyzed on a separation media and molecules arranged in an order of polarity.

In yet another embodiment of the present invention relates to a software capable of interpreting the Sandra (Viscous molecules) property based on the absorption spectra of 200-800 nm and polarity of the ingredients in Zone 2, of the image when a sample is analyzed on a separation media and molecules arranged in an order of polarity.

In yet another embodiment of the present invention relates to a software capable of interpreting the Sthoola (heavy molecules) property based on the absorption spectra and polarity of the ingredients in Zone 3, of the image when a sample is analyzed on a separation media and molecules arranged in an order of polarity.

One of the embodiments of the present invention relates to a software capable of interpreting the chemical and therapeutic property of the analyte based on the 3-D and contour chromatographic fingerprints developed due to the interaction of radiation with matter and the data graph divided in to different zones and marked with respective therapeutic property based on specific X, Y and Z coordinates of the data graph or movie movable on all axis between 0-360 degrees, wherein the retention time value is not a limitation.

In another embodiment of the present invention relates to a method of Chromatographic Fingerprinting useful for chemical and therapeutic standardization of fuel products.

In another embodiment of the present invention relates to a method of Chromatographic Fingerprinting useful for the standardization of agricultural products.

In another embodiment of the present invention relates to a method of Chromatographic Fingerprinting useful as a diagnostic tool for the analysis of healthy and diseased samples for chemical and therapeutic standardization

In another embodiment of the present invention relates to a method of Chromatographic Fingerprinting useful for the toxicity studies for chemical and therapeutic standardization.

In another embodiment of the present invention relates to a method of Chromatographic Fingerprinting useful in chemical and therapeutic standardization of forensic sciences.

In another embodiment of the present invention relates to a method of Chromatographic Fingerprinting useful for the chemical and therapeutic standardization of industrial food and medicinal products.

In another embodiment of the present invention relates to a method of Chromatographic Fingerprinting for the chemical and therapeutic standardization of environmental samples.

In another embodiment of the present invention relates to a method of Chromatographic Fingerprints of data graphs of the analyte will be the basis for identification and standardization of chemical constituents to limit the scope of the invention.

In another embodiment of the present invention relates to a method of Chromatographic Fingerprint data is used for the study of variation of chemical constituents in biological samples and to identify and standardize the chemical constituents in them to know the pathological, healthy and diseased status of the source living being thus leading to chemical and therapeutic standardization.

In another embodiment of the present invention relates to a method of, Chromatographic Fingerprinting used for the adulterated, substituted, contradictual, commercial food and drug samples and to identify the chemical and therapeutic properties of pure and impure.

In another present embodiment of the present invention relates to a method of wherein, the data obtained is used for the study of variation of chemical and therapeutic properties of the constituents due to various ecological factors, geological factors, genotype and phenotypic variations (in plant and animals) in naturally occurring samples and to identify and standardize the chemical constituents in them.

In another present embodiment of the present invention relates to a method of wherein, the data obtained is used for the study of chemical constituents in synthetically prepared samples and to identify and standardize the chemical constituents in them for chemical and therapeutic standardization which ever is applicable.

In another present embodiment of the present invention relates to a method of Chromatographic fingerprinting wherein, the data obtained is used for the study of chemical constituents in herbal products of single medicine samples and to identify the chemical constituents in them for chemical and therapeutic standardization.

In another present embodiment of the present invention relates to a method of Chromatographic fingerprinting wherein, the data chromatograph is used for the study of chemical constituents in herbal products of formulated medicine samples and to identify the chemical constituents in them for chemical and therapeutic standardization.

In another embodiment of the present invention relates to a method of Chromatographic fingerprinting wherein, the data obtained is used for the study of variation of chemical constituents in different brands of products of single and formulated food and medicine samples and to identify the chemical constituents in them for chemical and therapeutic standardization.

In another embodiment of the present invention relates to a method of Chromatographic fingerprinting wherein, the data of medicines facilitates to categorize and quantify the constituents of a medicine based on polarity and conjugation from 3-D and contour chromatograms and assess the therapeutic efficacy of the medicine on which humors it is going to act (vitiate, balance).

In another embodiment of the present invention relates to a method of Chromatographic fingerprinting wherein, the data obtained enables to understand and standardize the Physico-Chemical properties of the medicines like color for the use of therapeutic standardization of medicines and humors (Tri Doshas) using conjugative and polarity properties given in the chromatographic fingerprints.

In another embodiments of the present invention relates to a method of chromatographic fingerprinting which enables to understand and standardize the microcosm and macrocosm of the medicines used for therapeutic standardization using conjugative (indicated on Y-axis, microcosm) and polarity (indicated on X axis, macrocosm) properties given in the chromatographic fingerprints.

Yet another embodiment of the present invent is presentation of measured electromagnetic radiations absorbed/emitted of the constituents diagonally opposite to each other on the scales of polarity axis and absorbance, electromagnetic radiation axis of the fingerprint indicating a specific quantum of energy at the specific pixel point dealt by the analyte molecules/molecular fragments.

Yet another embodiment of the present invention is the said method facilitates preparation of herbal, medical and biological encyclopedias for different material present in a specific e ecological and geological parts of the world.

Yet another embodiment of the present invention is the said method facilitates chemical and therapeutic standardization based on the qualitative and quantitative inter and intra ratios of the molecules/molecular fragments present in a food and drug sample of natural and synthetic origin.

Yet another embodiment of the present invention is the said method facilitates to assess the variations in chemical and therapeutic properties of foods and medicines under is different bio chemical, biophysical conditions

Yet another embodiment of the present invention is the said method facilitates the influence of foods and medicines of natural and synthetic origin on different srotasas/channels channels in the biological systems.

Yet another embodiment of the present invention is the said method facilitates the prognosis and diagnosis of disease pathology in biological systems.

Yet another embodiment of the present invention is the said method facilitates the validation of basic principles and concepts of different traditional and modern health philosophies.

Yet another embodiment of the present invention is the said method facilitates the influence of foods and medicines of natural and synthetic origin on different chemical and bio chemical pathways in the biological systems.

Yet another embodiment of the present invention is the said method facilitates the chemical and therapeutic standardization of vaccines.

Yet another embodiment of the present invention is the said method facilitates the chemical and therapeutic standardization of toxicity of materials, foods and medicines of natural and synthetic origin.

Yet another embodiment of the present invention is the said method is the absorption/emission data graphs of the analyte at different wavelengths presented together provides specific pattern of images and data graphs for chemical and therapeutic standardization.

Yet another embodiment of the present invention is the said method provides analysis using the graphical data patterns of electromagnetic radiations absorbed, emitted, reflected, refracted, interfered, diffracted with the analyte and generate data for a sample by a separation method using different properties of the carrier media to separate over a separation media, separating and arranging the constituents in a specific order of polarity along with measured responses of the constituents with interaction of electromagnetic radiations for chemical and therapeutic standardization of material under test.

In another embodiment of the present invention relates to a method of Chromatographic fingerprinting wherein, the method enables to understand and standardize the Physico-Chemical properties of the medicines like Tastes (Rasa) like Sweet, Sour, Salty, Pungent, Bitter and Astringent (Madhura, Amla, Lavana, Tikta, Katu and Kashaya as described in Ayurveda) used for therapeutic standardization using conjugative and polarity properties given in the chromatographic fingerprints.

In another embodiment of the present invention relates to a method of Chromatographic fingerprinting, wherein the data obtained enables to understand and standardize the Physico-Chemical properties of the medicines like Property, Potency, Metabolite, Specific properties like Chirality of the molecules (Guna, Veerya, Vipaka, Prabhava) used for the therapeutic standardization using conjugative and polarity properties of the individual constituents and the whole medicine shown in the chromatographic fingerprints.

In another embodiment of the present invention relates to a method of Chromatographic fingerprinting wherein, the data enable to understand and standardize the Physico-Chemical properties (Gunas) of the medicines like Cold, Hot, Slow in action, Sharp in action, Heavy, Light, Soft Lubricated Supple, Dry (Sheeta, Ushna, Manda, Teekshna, Guru, Laghu, Snigdha, Rooksha as described in Ayurveda) used for the therapeutic standardization using conjugative and polarity properties of the medicines shown in chromatographic fingerprints.

### Proposed Method of Chemical Standardization

Hence UNLIKE a method currently under use, where in a chromatogram is given at a single wavelength, a novel method of chromatographic standardization, finger printing and bar coding is proposed, using contour and 3-D chromatograms. It provides the TOTAL CHEMICAL PROFILE (properties like polarity and conjugation, there in) of the chemical constituents present in complex medicines like herbal medicines and formulations or any medicine. Further bar coding the finger prints thus generated will provide many commercial features in dealing such medicines using the ENTERPRISE RESOURCE PLANNING (ERP) and CUSTOMER RELATIONSHIP MANAGEMENT (CRM) applications.

The existing method of TLC Chromatographic Fingerprinting being used as a chromatographic finger print, is showing only an assay of the constituents present in it. It is not providing any chemical property like conjugation or polarity. Another method of Chromatographic Fingerprinting by HPLC shows a chromatogram at a single wavelength presented as a “CHROAMTOGRAPHIC FINGER PRINT” of the medicine. In this, a selected peak is identified chemically, what it is by structure, using various other analytical techniques like NMR, LC-MS and IR for structural elucidation. So the single chromatogram by it self is not able to say what the efficacy of the medicine is, with out the support of other costlier analytical instruments. It will be highly impractical to use such costly techniques for a complex herbal medicine and formulations prepared by formulating various organic and inorganic medicines for a particular therapeutic purpose.

The quality of any formulated medicine will depend on the process with which it was made. This will be different for each pharmacy or pharmacist. What actually needed for the quality control of herbal medicines and formulations is a simple analytical method that can give the number of constituents (qualitative and quantitative) present in a single medicine or formulation, and the therapeutic efficacy of the medicine under study. Hence any method, which does not provide the above information, will be incomplete.

In the proposed method of chemical standardization the constituents were first extracted in to a suitable solvent. The extract was subjected to separation into individual constituents on a High Pressure Liquid Chromatograph under standardized analytical conditions. The 3-D and contour chromatograms given by the instrument were converted in to CHROMATOGRAPHIC FINGERPRINT data graphs. The images were analyzed using image analysis software specially prepared for this work. The out put data is interpreted for the said standardization. Detailed description of the method is given in experimental description of the method.

### Proposed Method of Therapeutic Standardization

The traditional therapeutic standardization is highly individualistic by ability and perception of the doctor. A general availability of such method will be practically difficult. But the existing scientific scenario emphasizes that any method or mechanism needs to be STANDARDIZED, and REPRODUCIBLE. Hence in the present method of chemical and therapeutic standardization an instrumental method is proposed which brings down the human factor. The proposed method envisages the same with out deviating from the traditional concepts.

As explained above if one can assess the therapeutic efficacy of the medicine by the physico-chemical properties (Polarity and conjugation), the activity of the medicines can be understood thus achieving the therapeutic standardization. In the present method the CONJUGATIVE AND POLARITY properties are taken in to consideration to assess the therapeutic efficacy of a medicine.

In the ancient literature a clear classification of soils and plants were given based on their physico-chemica nature and therapeutic efficacy. The selection of medicines for a particular disease was done based on the guidelines like color, texture, odor and physical appearance. The soil types and the diversity of the drug action were also mentioned while selecting a medicine. The effect of climate and its effect in the efficacy on the drug plants were also clearly mentioned. Because the chemical constituents present in the plant depends on these geological and ecological variable factors, guide lines were laid down for the place of collection, time (seasonal and daily) of collection, part of plant for collection and age of plant for collection, required for a specific therapeutic action Some of the examples of the Chromatographic Fingerprints show the same.

This confirms that this method will be useful in many purposes of dealing the traditional medicines. It can be useful for modern medicines also to understand their therapeutic efficacy in traditional terms.

### Various Steps Involved in the Present Invention

In the present method of analysis a Validated High Pressure Liquid Chromatograph equipped with a Binary or ternary Gradient system of pumps, a Photo Diode Array Detector (PDA), suitable instruments for measurement of conductivity and mass of the analytes are used along with a Software based data processor for presentation of the chromatographic fingerprints were used. After the complete elution of all ingredients, the 3D and contour chromatograms (having the information of the UV—Visible Spectra, absorbance and retention times of all the constituents present in a single medicine or formulation) were converted into a data graph image and proposed as a Chromatographic Fingerprint This enjoys the merit of not requiring any internal or external, standard sample for an authentic qualitative and quantitative: analysis of all the ingredients present in a medicine, unlike in the present method of analysis of medicines.

### Experimental Description of the Method

The proposed method is described in 4 steps with reference to the accompanying drawings, flow charts and examples, which are provided to illustrate some of the embodiments of the invention, and the same should not be construed as limitations on the inventive concept embodied herein. The entire method is described in the steps mentioned below.

### The Procedure is Explained in the Following Steps

Step 1: Sample preparation
Step 2: Experimental work done on the instrument
Step 3: Data generation and analysis.

### Step 4: Interpretation of the Chromatographic Fingerprints.

Step 5: Applications of the method.

### Step 1

### Sample Preparation

All samples were extracted with Ethyl alcohol and preferably with buffer of specific pH if required. When the pH of the aqueous alcohol extract is varied the extraction of constituents also has varied. The basic pH has extracted more number of constituents than acidic pH. Suitable pH was selected for extraction of different medicines for selective extraction using buffers.

### Step 2

### Experimental Work Done on the Instrument

### The Development

The extract was subjected to separation analysis, using High-Pressure Liquid Chromatographic instrument, In the present method of analysis a Validated High Pressure Liquid Chromatograph equipped with a Binary or a ternary Gradient system of pumps, a Photo Diode Array Detector (PDA), a conductivity detector or sensor and a Software based data processor, for the preparation of the chromatographic fingerprints were used. A known amount of the sample (say 20 ul) of extract is injected into rheodyne injector (fitted with 20 ul loop). Elution of the sample was performed with suitable time programmed gradient system of mobile phase at a fixed flow (1 ml/min). Care is taken that no part of the sample is left in the column un-eluted. The following analytical conditions set for the analysis.

a. A reverse phase-column was used along with a time programmed gradient elution of an aqueous phosphate buffer (In the pH range of 3.0-9.0) and a non-aqueous solvents (acetonitrile or methanol) as eluents, based on the chemical nature of the sample under analysis.
b. A wavelength range of 200 to 800 nm was used for the PDA detector and the run time is fixed based on the time program. The range of wavelength will be up to 1100 nm based on the model of detector used.
c. The change in the concentration of non-aqueous solvent like Acetonitrile along with an aqueous mobile phase like phosphate buffer in the pH range of 3.0-9.0 as a gradient in the varying ratio 0-100% of non aqueous solvent with in a stipulated time of run with covering the entire range of polarity was used for elution. The composition of the mobile phase will end where it Started. The polarity measured will help to select the required range of polarity to be covered for the total elution of the constituents. The time is not a limitation if the entire range of polarity could be covered in lesser time with out sacrificing the resolution by changing the column size, particle size, temperature, pH, viscosity, ionic nature of the whole media and other variable parameters that influence the elution pattern.
d. The gradient of solvents, temperature & pH used for the elution of the molecules.
e. Elution of same sample at different temperatures in the range of 15-70° C. and different

pH values in the entire range of pH and polarity required.

The instrument was triggered for the analysis after injecting the sample into the injector. The run was stopped whenever the analysis is completed or the instrument will stop the run automatically after the entire time program is completed. Mostly the time of analysis was fixed based on the dimensions of the column and decided by the absorption of the eluting compounds.

### The Separation

When a chemical constituent is in liquid, if it is immiscible in the liquid, it will not get dissolved and does not interact with the media or the constituents in the media. There is no interaction between both. If the constituent is miscible then it should be charged, compatible to the media. If it is anionic, then it will bond with the cationic (like Hydrogen in water) component of the media or any such ion present in the media. It may also bond with anionic part of the media. Thus it will form a new soluble or insoluble moiety, in the medium. The new moiety will be come a foreign body in the media container, which will have its own physico chemical properties. If the molecule is zwitter ionic then both reactions will happen. In water type of solvents are used then hydrogen bonding will also influence the interactions among the ionic molecules along with already happening ionic, covalent or coordinate covalent bonding among the ionic constituents present in the media.

If a material moves over a smooth surface, it simply moves from one place to another, with out any interaction with in no time if there is no inertia, due to any interaction between both. If the constituent is charged then it will interact with the charged surface at different rates and intensities and its movement will get influenced. The interactions depend upon the charges of the surface and the moving molecule. When the movement of the material is due to a third factor, and it is charged/uncharged, it also influences the movement of the material.

When a charged/uncharged molecule is made to move over a charged surface like a stationary phase of a chromatographic column, the velocity/movement of the molecule will depend on the total charge interactions of the molecules, media and surface. The charge can be understood using the polarity property where cation is high polar (high conductive) anion is non polar (non conductive) and zwitter ion is medium polar. The molecule after interacting with the stationary phase, may get distorted based their chemical and thermal stabilities. The chemically labile constituents may get divided/fragmented if they are weakly bound. The hydrophilic and hydrophobic moieties of the single molecules may also get divided and elute at both extremes of the retention times. The same will happen for a molecule in the biological system, thus chromatographic separation pattern correlates to the behavior of the medicine in a biological system under healthy or diseased conditions.

When a molecule is moving over a stationary phase of a closed chromatographic system, it can move like a spherical band with out any fronting or tailing viz., one component of the molecule strongly interacts with the stationary phase. Instead of making the peak sharp by changing the analytical conditions the behavior can be used as a measure for the nature of the analyte molecule. The shape of the band moving on the surface will decide the shape of the peak/peaks in a single, contour and 3-D chromatograms. This elution patterns also influence the data processing parameters for quantifying the area occupied by the data graph.

Organic or Organo metallic Molecules having different types of charges will behave differently over different conditions of separations over a stationary phase influenced by specific polarity solvents. When a stationary phase like C18 with good number of theoretical plates and carbon loading is used for the elution of molecules of different polarity ions, driven by a mobile phase with varying polarity, all molecules in a mixture gets arranged one after the other, based on the hydrophilic and hydrophobic polarity interactions. The same can be implemented on a normal phase stationary phase, but the interpretation gets reversed as the pattern of elution reverses in it from the reverse phase column.

The behaviors or the separation patterns and elution patterns get influenced due to the factors like pH, temperature of the column as the thermodynamic properties of the analyte, stationary phase and mobile phase vary. A molecule elutes faster under elevated temperatures due to influenced polarity and thermodynamic properties. The spectra of the molecules will also get influenced due to blue shift or red shift. Thus when a medicine is consumed, the body pH and temperature will influence its movement in the body and will not behave in the same manner in the persons of other pH and temperatures. All other factors, which influence the above properties, of the medicine and biological system, at the site of action can change the behavior of the medicine. Hence all these factors need to be standardized for assessing the therapeutic efficacy of the medicine.

When a common method of analysis was used for different mixtures of samples of food or drug, molecules having common polarity will elute at specific retention time. All medicines used for a particular disease or nutritional purposes were analyzed, they all will elute at the same retention time, if they have same polarity. By generalizing the elution pattern of different molecules in different samples one can come to a conclusion about the properties of molecules, which have same efficacy. From a database of analytical data created using specific analytical conditions, many generalizations were brought out regarding the chemical and therapeutic properties of different medicines. The efficacy of the constituent at a particular zone was understood based on the polarity and conjugative properties of the molecules indicated by the retention time and UV Visible spectrum of the constituents arranged in a specific order of polarity. After getting separated each of the ingredients enters in to the photo diode array detector.

The molecules were separated on a chromatographic phase using the polarity inter actions of the analyte molecules, and mobile phase under the influence of pH, temperature and viscosity. A column having a specific polarity is used for analysis and the polarity of the mobile phase is varied constantly in the increased or decreased order, On a reverse phase column, the constituents present in the sample will elute in the same order, i.e., the high polar constituents will be eluted first, the medium polar constituents will elute next followed by the low or non-polar constituents. The most preferred pattern is to change the polarity of the mobile phase either increased or decreased order of polarity such that no constituent of any polarity will be left un-eluted from the column thus achieving total elution. Thus controlling the polarity of the mobile phase will facilitate to bring a required influence on the polarity of the constituents to achieve separation of required order of elution. The order of elution of different polar molecules will depend on the order of elution with respective polar mobile phases.

The order and properties of polarity and elution in the case of normal phase columns are applicable same as in the case of reverse phase column but in reverse. In a normal phase column the non-polar constituents will elute first and followed by polar constituents, based on the order of polarity of the mobile phase used for elution.

The elution order of the molecules will be depending on the elution order of polarity interactions between column, molecules and mobile phase. Analysis on any kind of column where in the molecules are able to be arranged in a specific order of polarity using a variable mobile phase or a carrier with variable gradient of polarity will facilitate to execute this method.

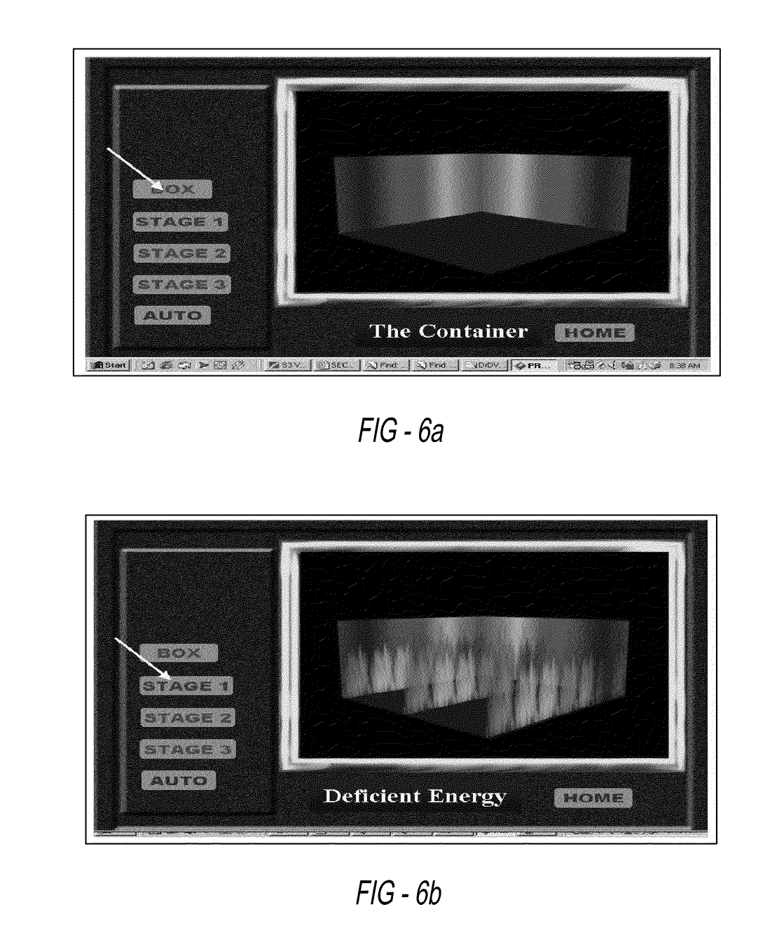

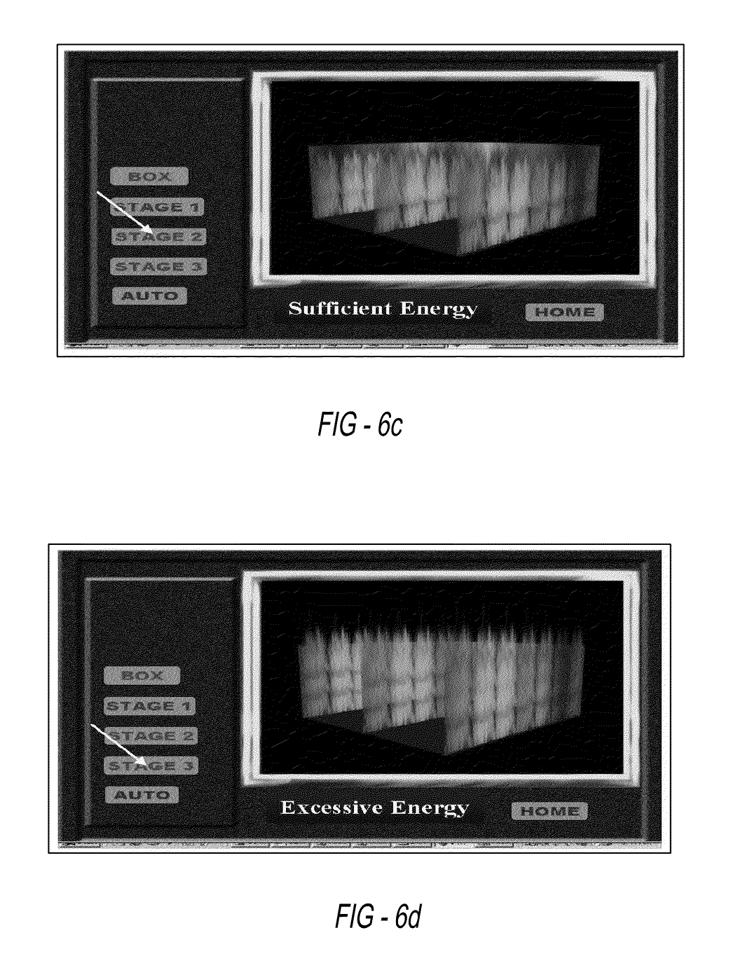

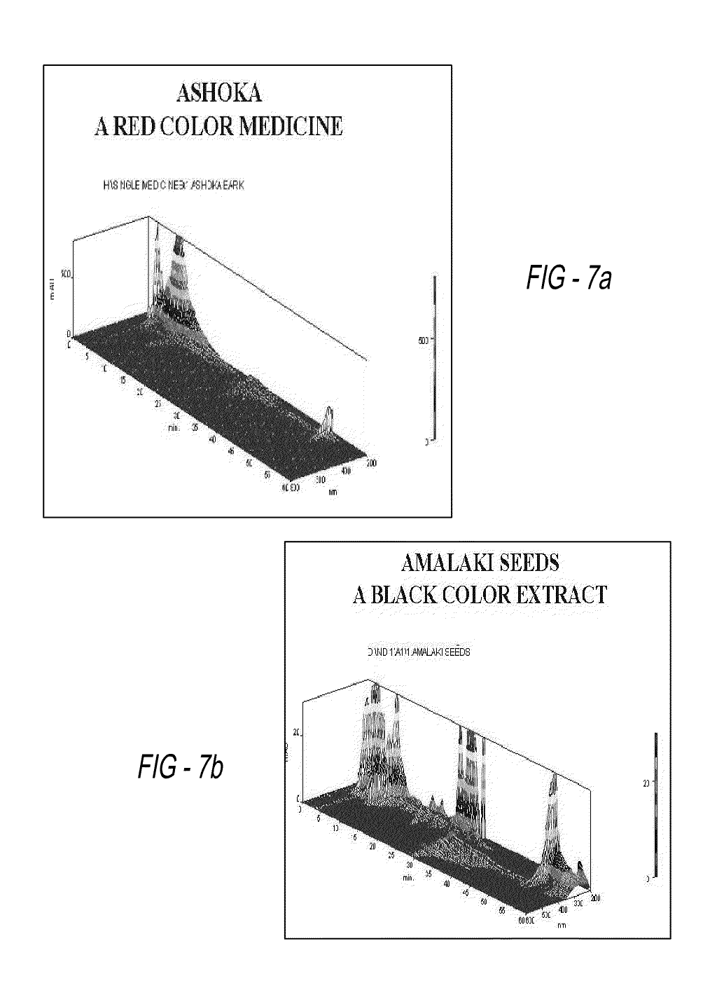

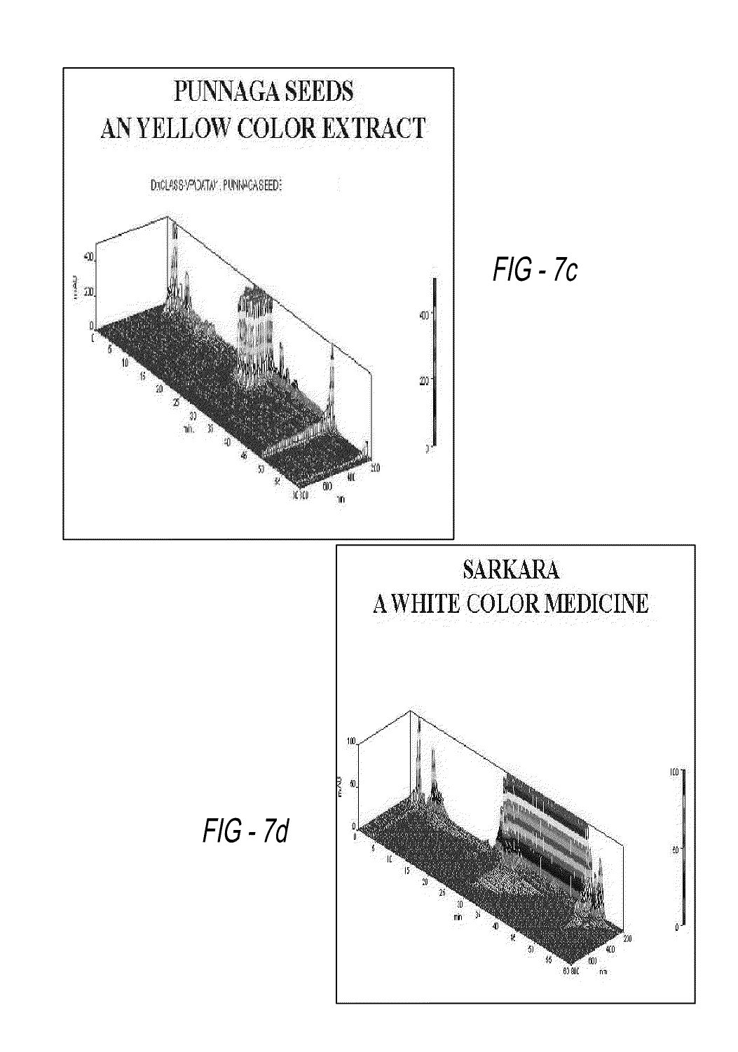

The interaction of the polarity of the molecules being separated, the polarity of the stationary phase used and the polarity of the mobile phase used for the elution of the sample will control the elution pattern of the molecules. The resultant inter action of all the three and other related parameters like temperature etc., will decide the elution pattern and order of elution of the constituents based on their polarity. Thus in a medicine all the polar molecules will elute in first ‘Zone 1’ (Polar zone of the image), all the medium polar molecules will elute in ‘Zone 2’ (Medium polar zone of the image) and all the low polar or non polar molecules will elute in ‘Zone 3’ (Non polar zone of the image). When the molecules eluted in these three zones of many Chromatographic Fingerprints many generalizations were made regarding the chemical and therapeutic efficacy of the medicines. This is another basis of therapeutic standardization. We have reported in our earlier patent (PCT/IN00/00123) about the division of the fingerprint on X and Y axis in to 9 different parts for the standardization of different samples, FIG. 6. In the present improved method the division of the 3-Dimensional box has been presented with quantitative levels at different analytical and biological conditions of the samples showing the absorbance properties of the constituents separated and analysed. The zones in a 3-D box were shown marked in the FIG. 7. The radiation absorbed/emitted were presented on both axis. The polarity and energy being able to deal by the analyte molecule can be measured by suitable detectors.

Mostly the elution of the samples was done from high polarity mobile phase to low polarity mobile phase. Thus in the finger prints the constituents present in the first zone (Zone-1) will be of high polar in nature on a reverse phase column and reverse to this on a normal phase column. The same pattern applies to the other zones, the medium polar constituents eluted in the medium polar zone (Zone-2) and the low or non polar constituents eluted in the non-polar zone (Zone-3). This pattern reverses when a normal phase column is used due to its elution property as described above and the column and mobile phase conditions. Thus in the present elution also the elution of the constituents is controlled and driven in the required pattern by controlling the polarity of the mobile phase and the order of changing it in an orderly way using instrumental parameters.

If the analyte molecule is single, the ideal polarity will be the net of the polar and non-polar atoms present in it. When the same is kept in an ionic media, its polarity will be influenced. When the factors like temperature is changed it will be another value. At different temperatures it will have different values. Thus the polarity will change based on the influencing factors. When the same analyte is moving the influencing factors will be more. When it is moving over a charged surface it movement will be varying based on the total interactions between the sample, mobile phase and surface. If it is being moved by a mobile phase the movement will be further influenced. If the analyte is in a mixture the effects on the total polarity will be much different. Thus the retention of a molecule will depend on the other molecules present in the system.

When a molecule is surrounded by a group of molecules with different polarities the total polarity of the molecule will be different than when it is singly present. Thus the polarity of a molecule will vary when it is present in between a cluster of molecules having different polarities due to field effect. Even the separation pattern will change on a chromatographic media molecule is analyzed singly and in a mixture. Similar mechanism happens in the human body when a molecule of food or drug enters in to the body.

### The Detection

Along with the charge of the molecules, it is the energy of the molecules; which is it able to deal, plays an important role in the therapeutic property of the medicine. So when all of the molecules eluted from a separation media are sent in to a photodiode array detector, the detector will provide a specific spectrum of the constituent amounting to the total quantum of energy it can deal with, based on its mass, structure and functional groups indicating its conjugative properties. But this is being a band spectra where it gets exposed to a multiple set of wavelengths, the molecules will absorb at different wavelengths on either side of the absorbance maxima. So this absorbance of the constituents at other wavelengths should also be taken in to consideration while assessing the properties of the analyte molecules. Because the molecules respond/absorb at either side of the wavelengths. It would have been a line spectrum if it gets exposed to only one wavelength of radiation. Based on the chromophores and structure, the spectrum will have one or more absorbance maxima. When all spectra of all molecules are arranged in a specific order of the polarity of the molecules arranged, the data is indicating the chemical and therapeutic property of the medicine as a whole.

When a specific set of energy system is varied in a biological system the chemical and biochemical interactions do alter. A specific mechanism of drug action could be due to a specific energy-containing molecule. When the molecule is functioning with its specific energy and exposed to another wavelength of radiation then, the activity get influenced and changed. Thus addition of unwanted energies will lead to unwanted chemical and biochemical mechanisms leading to diseased conditions.

A spectrophotometric and conductivity measurements were used for the detection of the eluted constituents from the column at specified temperature or pH. The data of each 3-D chromatogram is animated showing the variation of absorption property with temperature or pH.

The polarity and absorption properties of analyte molecules with known or measured individual mass over a wavelength range of electromagnetic radiation were measured after separating over a chromatographic phase under different temperature and pH conditions.

The colors and the therapeutic efficacies of various medicines were given in the ancient to literature. The colors of the molecules are due to a specific chemical nature of the molecule. The colors of the flames were used for the quality control of metals and related products, which involves the basic spectrophotometric principles. Thus study and understanding of the interaction of the electromagnetic radiation will be useful to study the chemical nature and thus the therapeutic efficacy of the medicines. The same principle has been used in the present spectrophotometric method of Chromatographic Fingerprinting and standardization. In other terms an existing concept has been presented in the form of a novel analytical method, removing the error of human factor. All the medicines for which Chromatographic Fingerprints developed were given in different examples of Chromatographic Fingerprints of different samples. The technical details of the software are given in the release notes of the software.

### Step 3

### The Data Analysis

In PDA software there are four types of display of data. One window displays chromatogram at a selected wavelength, In another it displays the on line absorbance spectra of the selected molecule, in another it displays the contour chromatogram, which displays the retention time (run time) of the analysis on X-axis and the wavelength range on Y-axis. In another window it displayed the 3-D chromatogram of the sample where in it displayed the retention time (run time) of the analysis on X axis, the concentration range on Y axis and the wavelength range on Z axis. The 3-D and Contour chromatograms thus developed after decryption and encryption of the data file graphs by the system was converted into a data graph using imager/animation software features and systems. The data of analyte at different temperatures &pH are presented in a Contour, 3-D static and animated forms movable between 0-360 degrees on any axis.

The images thus generated were analyzed by the new software developed, which provides a novel chromatogram and the qualitative and quantitative analytical data of the in-gradients present in the medicines. The pixel values represented by different colors and energy from Violet, Indigo, Blue, Green, Yellow, Orange and Red attributed as a measure of the concentration (quantitative) of the constituents proportional to the color. Extracting the individual colors mentioned above and show in separate windows for each color. This is the basis of chemical standardization. The polarity of the molecule is measured using a devise for measuring conductivity after nullifying the effect of the mobile phase. The polarity of the mobile phase is related to the polarity of the constituent under study and elution. The energy of the initial beam of source at all wavelengths is measured before and after analysis. The variations at different quantum of energy at different pH and temperature conditions will be graphically presented as a 3-D energy box. A model was shown in mpeg Movie 1. FIG. 8 shows different stages of the energy levels, which will be fluctuating, in any state of the condition in a body or plant or medicine. When the icon of the Auto is clicked the three stages of energy will be presented. Individual icons will show the single stage energy of UV-Visible range of colors in which almost of the medicines respond.

The chromatogram developed after the analysis is divided in to three zones on X and Y-axis. The conjugative property (Absorption of a particular wavelength of radiation) is taken on Y-axis and polarity is taken on the X-axis as the elution of the constituents is controlled using the polarity of the mobile phase composition over a stationary phase with a specific polarity. Now as reported in our earlier patent, the X and Y-axis is scaled as per the therapeutic efficacy based on polarity (retention time) and conjugation (wavelength, color), Table 22. The entire image is divided in to nine chambers where in the chemical constituents have a specific conjugative and polarity property.

The image was divided in to three zones on X and Y-axis. The conjugative property (Absorption of a particular wavelength of radiation) is taken on Y-axis and polarity is taken on the X-axis as the elution of the constituents is controlled using the polarity of the mobile phase composition. Now as reported in literature the Y-axis is scaled as per the therapeutic efficacy based on wavelength (color). The entire image is divided in to six chambers where in the chemical constituents have a specific conjugative and polarity property. This in turn is proportional to the therapeutic efficacy of the constituents in the chamber. Thus when a medicine is Chromatographic Fingerprinted, based on the color represented for the absorption of a specific wavelength and having a specific polarity, the total colors in that zone is calculated and interpreted for the therapeutic efficacy of the constituents present in it. Thus the HOLISTIC therapeutic standardization, and chemical standardization is achieved using this method.

When the image is divided in to three zones based on the elution pattern of the molecules eluted. The Zone 1 indicated POLAR ZONE, as the column used is a reverse phase column. The Zone 2 is indicated as MEDIUM POLAR zone where in the medium polar molecules are eluted and finally the Zone3 is indicated as low or non-polar zone as the non-polar and very low polar molecules will elute in this zone. Thus the molecules eluted in zone 1 will be polar, the molecules eluted in the zone 2 will be of medium polar in nature and the molecules eluted in the zone 3 will be of very low or non polar in nature with decreasing order from starting to end of each zone. Hence the three zones of the images will give the polarity of all the constituents eluted.

But any method without quantification will be of no use. Hence the total colors of the constituents in the image of a particular zone are considered as a representation of the amount of the polar constituents present in the medicine. Thus the total constituents present in the Zone-1 Pitta zone, Zone-2 Kapha zone, and Zone-3 Vata zone are present in the form of a PIE diagram, which represents the ratio of the efficacy of the medicine on each of the disorder. Thus a medicines having constituents in the order of 50:20:30 will be a medicines of TRIDOSHAHARA of the order of 50%:20%:30%. This was done using the software developed. Thus the therapeutic efficacy is standardized quantitatively. The increase or decrease of any one or two of the other doshas can be done by formulating medicine by adding other medicines and prepare a suitable formulation needed to cure a specific individual.

This is made possible by special software prepared for this purpose. This is another novelty of the proposed method. Presently the 3-D chromatogram is viewed as 2-D image only. But when the same data is presented as a movie file of AVI or MPEG movable on all axis between 0-360 degrees, the hidden part of the chromatograms will be viewable and the data become more accurate.

Thus a Chromatographic Fingerprint developed having the chemical constituents with a specific conjugative property and arranged in the increased or decreased order of polarity will help to bring therapeutic generalizations about the medicines. This is another novelty of the proposed method.

The data was analyzed by software, which can analyze the energy represented by the image properties or presented as contour and 3-D chromatograms.

When the 3-d chromatograms of the medicine will be analyzed using all its 3 dimensional properties of the said image. Thus the matching of the three dimensional coordinates will provide a foolproof method of comparison and analysis. The coordinate it matched will give qualitative and the extent it matched will give the quantitative data of the sample understudy. This is made possible by special software prepared for this purpose. This becomes an ultimate method of quality control.

3-D & contour Spectra of the reported herbal medicines were developed using the reported analytical conditions. The thumb nail view of the medicines will show how the finger prints can be handled by a software as it is done in the software used in handling the human fingerprints. All the features like searching the similar and compare the similar fingerprints etc., can be done by inserting the necessary software features. The images were analyzed using image analysis software prepared for chemical and therapeutic generalizations.

The images of the fingerprints were given to Image Analysis software as said above. The analysis of images was done in which the constituents will be represented as peaks of the chromatogram and thus providing a novel presentation of chromatogram in the form of a colored bar chart as mentioned in our earlier patent. It shows the number of compounds and their conjugative properties (electromagnetic absorptive property) of all of the constituents eluted. The detailed description of the process involved in the analysis of the image is discussed in the technical features of the software.

The bar chart type of chromatogram thus developed gives a chromatogram having a scale of Retention time (o-α) on the X-axis and wavelength in the range of 200-800 nm or in the range of electromagnetic radiation used for the analysis, on the Y-axis. It gives the number of pixels occupied representing the amount of energy involved by each of the colors of each in-gradient in the image, facilitating the qualitative and quantitative analysis of the individual constituents present in it. Thus the chromatogram generated is presenting the number of constituents present in a medicine and their UV absorption range with quantity of pixels proportional to the concentration of the molecules.

Thus a Chromatographic Fingerprint having the scales of conjugation, absorbance and polarity along with molecular weight of each ingredient represented in the 3-D chromatogram will give information about the therapeutic efficacy of the medicine is increase or enhancement of the similar dosha. Even though the polarity is same the conjugative properties of the molecules are indicating the hara and vridhi properties. The reactivity of any molecule will depend upon the number of double and triple bonds existing in the molecules along with the Electrophlic and Nucleophilic sites on the molecule. The moieties donating electron and accepting electron will create difference in the total electrical charge of the molecule. This makes the molecule polar. Hence polarity of the molecules will provide information about the capability of a molecule to donate or accept the electron with another molecule. This will control the activity of a molecule. Thus the information of the polarity of a molecule will speak about the reactivity of the molecule. In the present method the chromatogram provided by the method will give the conjugative and polarity properties of the constituents present in a medicine in the Chromatographic Fingerprint. Thus this method can be used for the standardization of the medicines to know the therapeutic efficacy of a medicine using their conjugative and polarity properties of the medicines. This is the novelty of the proposed method. Thus molecules with same or different conjugation are arranged in the order of polarity with different efficacy. The arrangement of molecules having different tastes indicates the same.

When all the medicines having physico chemical properties like taste were studied and grouped it was observed that all medicines having the properties are eluting in the decreasing order of polarity from Kashaya to Madhura. Hence it is understood that the order of polarity is under stood in terms of taste in traditional philosophies. When the medicines with different colors having different efficacy were arranged in a group the medicines having red colour with astringent were classified as Pitta hara. When all medicines having yellow color and Bitter taste were observed they were all eluting in the kapha zone of the image. When the medicines with black color were studied they were having constituents in all of the three zones of the medicines. When the leaf or fruit are tender they will have astringent in taste and red in color. When the Chromatographic Fingerprints of the tender leaves were observed it is seen that they have these properties. Every living thing will have a status of biotransfomation of aging. The tender fruit will be astringent in taste in the beginning and it will be pungent, bitter, sour and sweet at its final stage. Fruits will become taste less when they are over ripened. Thus this transformation is related to change of polarity of the Analyzing it using all its 3 dimensional properties of the said image will do quantification of 3-D chromatograms of the medicine.

### Step 4

### The Interpretation

Thus arrangement of molecules in the specific order of polarity facilitating the assessment of the efficacy of the medicine in general and constituents in particular using any stationary phase and any mobile phase is the novelty of the method. The polarity of column, mobile phase and the constituents being separated will be controlled for such arranged and orderly elution. This facilitates the assessment of efficacy of any food or medicine. The details of the software are mentioned in our earlier patent.

The data thus provided by the analysis will give the information of conjugative (shown by the UV-VIS absorbance) and polarity properties of the individual constituents together along with polarity. The image is divided into three zones representing, Zone 1 (High polar zone or), Zone 2 (medium polar zone) and Zone 3 (low or non polar zone) scaled by retention times based on the elution pattern depending on the column used and the mobile phase. Reversing the analytical conditions can reverse the elution pattern.

The data generated was provided in the form of a database and generalizations were achieved based on the similarities and dissimilarities of the image properties based on the classification of the properties of the absorptive properties as seen in the images. The basis of the interpretation of the Chromatographic Fingerprints is based on the division of the Chromatographic Fingerprints in to nine parts on X-axis, Y-axis and Z-axis. The 3-D energy box was divided in to 27 components due to variation of the energy at different temperatures. Different X, Y, Z coordinates values indicating the respective coordinates will be used for analyzing the image and interprets the data in traditional parameters and terminology.

Most of the high polar molecules will be highly reactive chemically, thus biologically. When they enter into the first part of the digestive system. Then the constituents will enter into the stomach and intestine where they will under go different changes due to the digestive juices and their enzymes along with the influence of pathogens present in the digestive system. In the process of absorption the molecules of high activity (high polar) will immediately get absorbed by the biological system and show their therapeutic properties. This can be compared that in Ayurveda, the intestinal part of the human body is classified as PITTA zone, where the high polar molecules are playing a major role. The heat causing mechanism will play an important role in the diseases and biological mechanisms related to. It indirectly indicates the molecules of high reactive, the high polar molecules. All the constituents reported to have Agni (fire) property are eluting in this zone. The molecules of Astringent (Kashaya) are eluting in the first zone of the image.

In Ayurveda, the upper portion of the human body is defined as the KAPHA zone. Thus the molecules of medium polar molecules will play an important role in the mechanisms related to this zone. All the constituents reported to have Jala bhutas (water or liquid property like a Latex in plant and viscous constituents in blood etc.,) are eluting in this zone.

The low and non-polar constituents will be eluting in the last zone of the Chromatographic Fingerprint. Thus this zone (ZONE-3) is considered as VATA zone. Thus the basic humors of the molecules can be identified as per their polarity, which facilitates to know on what disorder (dosha) it is going to act upon. Thus the present method is useful for the therapeutic standardization of the medicines. Thus the total constituents present in the Zone-1 Pitta zone, Zone-2 Kapha zone, Zone-3 Vata zone are present in the form of a PIE diagram which represent the ratio of the efficacy of the medicine on each of the disorder. Thus a medicines having constituents in the order of 50:20:30 will be a medicines of TRIDOSHAHARA of the order of 50%: 20%:30%. Thus the therapeutic efficacy is standardized quantitatively. The increase or decrease of any one or two of the other doshas can be done by formulating medicine by adding other medicines and prepare a suitable formulation needed to cure a specific individual. Most of the immunomodulatory molecules are also have the same polarity eluting at the retention times

Thus the data will be able to give the information, how it is going to act chemically and so therapeutically. When the individual constituents present in each zone and represented graphically or by any means of data presentation, the total constituents of the respective zone will give the percentage it is going to act on the particular DOSHA. Thus the data will explain how it (medicine) is going to act therapeutically on the VITIATION of each dosha collectively based on the qualitative and quantitative properties of the constituents present in the medicine. For example if the medicines has 30% constituents in high polar zone (the pixel quantities of various colors like green, yellow, orange and red of a specific zone as quantities) 70% in medium polar zone it can be represented as a medicine acts 30% on Pitta and 70% on kapha, as the colors represent different concentrations in the Chromatographic Fingerprints. Hence a medicine can be assessed as of Pitta-Kapha hara (30-70%). Thus the vitiation of doshas are quantified. This helps the doctor to under stand the efficacy of the medicines and decide his dosage. These features are as mentioned in our earlier patent.

It was reported in our earlier patent (PCT No. PCT/IN00/00123) that the properties like Rasa (taste), Guna (physical property), Veerya (potency), Vipaka (post assimilation state), and Prabhava (specific property), and many of the physicochemical properties as to said in the Ayurveda and Siddha are based on chemical properties like polarity and conjugation of the chemical constituents and physical properties like viscosity, volatility etc.

While observing the Chromatographic Fingerprints developed for medicines reported to have traditional properties it was observed that molecules absorbing to words UV region are dosha Hara (Decreasing) in nature and molecules absorbing beyond 300 to 800 are dosha Vridhi (Increasing) in nature. The Hara is decrease of a dosha and vridhi is increase or enhancement of the similar dosha. Even though the polarity is same the conjugative properties of the molecules are indicating the hara and vridhi properties. The interpretation guidelines are provided in table 26.

Based on the polarity of the molecules eluted, the medicines are classified according to traditional system of therapeutic efficacy where in the polar compounds are found to be are acting on PITTA, the medium polar compounds are acting on KAPHA and the low or non polar compounds are acting on VATA. This is the basis of therapeutic standardization of the medicines. The polarity of the constituents is compared to a continuous spectrum of radiation, where in the dosha is classified as acute to chronic of each dosha. The starting of the zone will be acute and the end of the zone will represent the chronic. Thus the compounds present in the said zone will act on the said intensity of the disease.

While observing the Chromatographic Fingerprints developed for medicines reported to have traditional properties it was observed that molecules absorbing to words UV region are dosha Hara (Decreasing) in nature and molecules absorbing beyond 300 to 800 are dosha Vridhi (Increasing) in nature. The Hara is decrease of a dosha and vridhi is increase or enhancement of the similar dosha. Even though the polarity is same the conjugative properties of the molecules are indicating the hara and vridhi properties.

The reactivity of any molecule will depend upon the number of double and triple bonds existing in the molecules along with the Electrophlic and Nucleophilic sites on the molecule. The moieties donating electron and accepting electron will create difference in the total electrical charge of the molecule. This makes the molecule polar. Hence polarity of the molecules will provide information about the capability of a molecule to donate or accept the electron with another molecule. This will control the activity of a molecule. Thus the information of the polarity of a molecule will speak about the to reactivity of the molecule. In the present method the chromatogram provided by the method will give the conjugative and polarity properties of the constituents present in a medicine in the Chromatographic Fingerprint. Thus this method can be used for the standardization of the medicines to know the therapeutic efficacy of a medicine using their conjugative and polarity properties of the medicines. This is the novelty of the proposed method. Thus molecules with same or different conjugation are arranged in the order of polarity with different efficacy. The arrangement of molecules having different tastes indicates the same.

When all the medicines having physico chemical properties like taste were studied and grouped it was observed that all medicines having the properties are eluting in the decreasing order of polarity from Kashaya to Madhura. Hence it is understood that the order of polarity is under stood in terms of taste in traditional philosophies. When the medicines with different colors having different efficacy were arranged in a group the medicines having red colour with astringent were classified as Pitta hara. When all medicines having yellow color and Bitter taste were observed they were all eluting in the kapha zone of the image. When the medicines with black color were studied they were having constituents in all of the three zones of the medicines. When the leaf or fruit are tender they will have astringent in taste and red in color. When the Chromatographic Fingerprints of the tender leaves were observed it is seen that they have these properties. Every living thing will have a status of biotransformation of aging. The tender fruit will be astringent in taste in the beginning and it will be pungent, bitter, sour and sweet at its final stage. Fruits will become taste less when they are over ripened. Thus this transformation is related to change of polarity of the chemical constituents in the living things. The interpretation of the images with chemical constituents is explained in different example figures.

This in turn is proportional to the therapeutic efficacy of the constituents in the chamber. Thus when a medicine is fingerprinted, based on the color represented for the absorption of a specific wavelength and having a specific polarity, the total colors and energy with molecular weight of the constituent/s in that zone is calculated and interpreted for the therapeutic efficacy of the constituents present in it. Thus the holistic therapeutic standardization and chemical standardization is achieved using this method. For example the electron, neutron and proton are present in every atom. Positive and negative energies are present in every molecule due to which it has activity. Combinations of these different polarities in constituents in living and non-living things create activity in the system due to balance and imbalance in them.

If we observe this are explained in terms of Panchabhutas in the universe and living things. It is said that Agni (Fire) is related to Pitta property, Jala (Water, viscosity) is related to Kapha and Vayu (Air) is related to Vata property. The nature of the Panchabhutas is used to understand the prakrithi of the person. When it is observed the Panchabhutas is seen in every system of the universe. In an atom the proton, electron and neutron are the three polarities present. In a molecule there will be a combination of these properties due to which, based on the majority of any charge the action of the molecule depends.

When any molecule having these three properties are administered to a person or animal the three doshas in the body do respond. Based on the need the utilization of the energies will be done. The rest of the energies too will have their own impact on the other doshas. For example if the patient has a Pitta dosha which become excessive (Pitta vridhi) they he will be administered with a Pitta hara medicine. When a cationic molecule is added to the body first it will substantiate the required amount of the same property and what ever excess will hence forth will be bring a change in the equilibrium in the anionic and zwitter ionic moieties of the body. It is this reason when a medicine with Pitta Kapha hara medicines is added it will increase the vata. The same was explained in traditional texts. Hence addition of any ion will be influencing the equilibrium of the other two ionic systems or doshas in body.

### Movie 1

### The 3-D Energy Box:

The figure of 3-D energy box show a data graph generated for the same medicine analyzed under different analytical conditions like time, temperature, viscosity, and pH. It shows the change of polarity and thus the retention time, the spectrum influenced by bath chromic, hypsochromic, and hypo chromic and hyper chromic effects due to the same factors. Thus it will help to assess the efficacy of the medicine or a biological sample about its changes in the physico chemical properties due to the above factors. Thus an accurate standardization of the analyte samples will be possible.

The box is the container where in the matter is shown to be changing its properties. The deficient energy present in different molecules of all polarity groups is presented to be changing to sufficient and excessive levels of energy due to different influencing factors. Any extremes of this energy gained or lost will lead to an imbalance in the properties of the material. Thus fulfilling the deficiency and removing the excessive energy will be the methods of treatments to bring normalcy in the energy levels leading to a healthy condition. Thus maintaining harmony in all the three types of energies will bring a healthy condition. Some of the Treatment used in Indian System of medicines like yoga, meditation, and pranayama involves the same. They help in bringing harmony in the variations in the energy levels, which were disturbed. Bringing back to normalcy will bring health.

The energy box is presented in the form of software, which presents the qualitative and quantitative chemical and therapeutic qualities of a medicine or diseased and healthy conditions in a biological system. Some of the Chromatographic Fingerprints of the samples of biological nature are presented.

Level 1 show the deficient energy level of the molecule or a biological system. Thus the biochemical pathways that could not happen due to deficiency of sufficient energy for the said mechanism will not be triggered.

Level 2 show that the sufficient levels of energy of the sample under test due to which a status of healthy condition will prevail leading to a healthy system.

Level 3 show the excessive levels of energy of molecules present in a medicine or a biological system. The removal of the excessive energy of the system will bring the normalcy in the energy system and thus the health is achieved.

For example if the system is exposed to varying states of energy then it becomes unstable. Irregular breathing, irregular eating habits, irregular day to day activities, temperatures fluctuating from very low to very high etc. Many of the epidemics erupt during the intermediate stages of seasons of cold and hot climatic temperatures, humid and non humid conditions etc,. Even the fluctuating the moods of the mind also will influence the health. Hence maintaining equilibrium in every state of life is essential. The flexibility property of the human being will give tolerance against these variations hence person who possess this property will be usually healthy and happy.

Hence maintaining healthy levels of energy will lead to healthy condition for which different molecules with energy absorbing, conditioning and donating properties will be useful. The behavior of a molecule under different conditions like temperature, pH, viscosity, ionic nature of the media in which the molecule is present can be understood. The responsive (absorption/emission) property of molecules under experimental conditions at three different levels will indicate the qualitative and quantitative changes due to the influence of different conditions like pH, temperature, viscosity and ionic nature of the media where the reaction or activity is under going. It is this reason any medicine will not behave 100% similar in different human beings. In a set of animals, which are maintained under experimental conditions, may have some commonality in the response. But practically in an un controlled conditions the same response cannot be observed. Hence the medicine tested in controlled conditions may differ in the day-to-day life of the humans in uncontrolled conditions. The study of the response of the chemical and bio chemical reactions should be tested under practical conditions.

The polarity of a molecule is measured on the x-axis and the UV visible spectrum representing the conjugative properties are measured on Y-axis along with their quantitative properties on the z-axis. Thus in the 3-D box, a specific x, y and z coordinate indicates a specific quantum of energy able to be dealt by the molecule. Hence the energy of the molecule will be equivalent to the mass of the analyte sample having a specific charge (Polarity) and being able to deal a specific amount of energy equivalent to the radiation absorbed or emitted by the analyte matter. Thus the total energy dealt by the whole sample will be E=mc² where in the energy is the total energy of all the analytes present in the sample and the total white light (having all ranges of radiations). But a molecule absorbing at only specific wavelength cannot have the energy of a different molecule absorbing at a different wavelength. Hence the specific quantum of energy possessed by the sample will depend on the specific wavelength dealt by the molecule. Because, no matter will be active when it is neutral, particularly a medicine with many molecules. When the frequency and wavelength is different for different radiations the radiations what we see at a particular time have not started at the same time from the source. Hence time plays a very important role in every aspect including the activity of a medicine for a person. Thus this method facilitates standardization of matter and radiation for the assessment of the quantum energy they contain and arrange the matter in an order based on their physico chemical properties and kinetics for quantum chemical studies by using an equation E=m^{±p}C^{λ} Where in m is the mass, p is polarity of the analyte material at specific temperature, pH, pressure influenced by the ionic nature of the media in which it is present along with the viscosity and C is the speed of the respective radiation.

In the animated figure the same is shown. The radiations when moved with respect to time the quantum of energy will not be the same. Similarly a molecule having a particular quantum of energy will vary in its energy when it is exposed to different temperatures, pH and Ionic media and give different results from person to person and place to place, so on. Even though the medicine is consumed at single time various constituents in it will be moving in different speeds due to their interaction with the surface on it is moving, like a set of molecules get separated over a chromatographic surface. It is the final quantum of energy being able to be measured which actually brings a change in the chemical atmosphere. Thus measurement of the energy dealt by a molecule along with its electrical charge will help to understand the chemical and therapeutic property of the sample under test.

### Step 5

### The Applications

When the Chromatographic Fingerprints of different medicines, developed using the proposed method are studied some generalizations were observed about the therapeutic efficacies of the medicines. The same efficacy was reported in the traditional literature also i.e. the experimental and reported results are equal. Hence the method was validated by studying different medicines, having different therapeutic efficacies.

The Chromatographic Fingerprints generated are analyzed for their chemical and therapeutic properties. The basic features in a Chromatographic Fingerprint are found to be 1. The zone of the polarity in which the constituents have eluted. 2. The conjugative properties of the individual constituents present. 3. The total quantity of energy able to be absorbed by the molecule.

As described in the traditional standardization methods the colors of the medicines were standardized based on their colors and their therapeutic efficacy. It applies even in the case of any molecules. The structure, functional groups, conjugation, and the extent of unsaturation will influence the wavelength of absorption (absorbance maxima) of the molecule which is intern interpreted against the efficacy of the medicine. The more the molecule is conjugated the longer the wavelength of absorption will be. Hence the UV-VIS absorbance of any molecule is widely used in the qualitative and quantitative properties of the constituents.

For example if the samples are analyzed at three different temperature ranges like 22-27° C., 27-32° C., 32-37° C., 37-42° C. the polarity of the stationary phase, mobile phase and analyte will change. Thus the inter action will also change during the separation process. This can be correlated to the similar behavior in human being also when the drug action of molecules will change under different physico chemical conditions like temperature, viscosity, pH and ionic media existing in the body. A mixture of sample having a mixture of constituents with very little difference of polarity could not be separated at higher temperatures. But at lower temperatures it cur be achieved. Thus any parameter, which can influence the polarity of the three-component system (Separation media-Mobile phase-molecule), will be able to control the physico chemical properties of the analyte. Even the absorbance will be changing to any type of effects like bathochromic, hypsochromic shift etc., The similar behavior will occur when the body temperature or pH is changing due to different external and internal factors. The movement of the drug molecules will be influenced by the said factors due to which the drug action will change. Here the body matter over which the molecule is moving is compared to the stationary phase of the column. The polarity of the body, molecule and the factors will influence the energy of the molecule, which in turn will change the chemical and therapeutic behavior of the molecule. Thus due to the difference in the environment in different human beings the efficacy will vary.

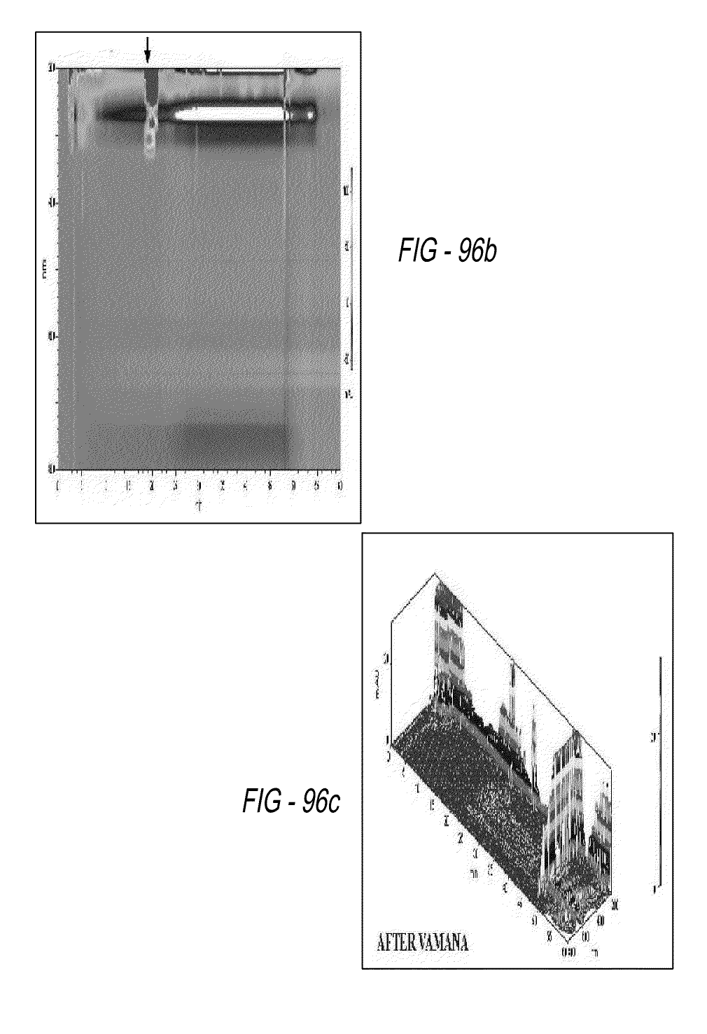

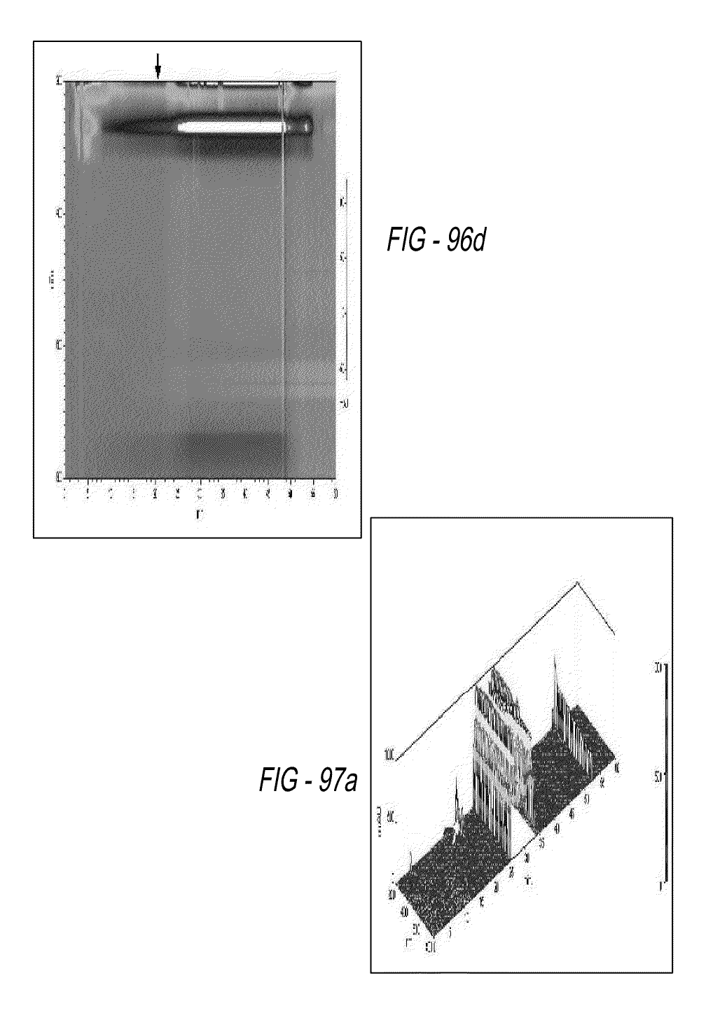

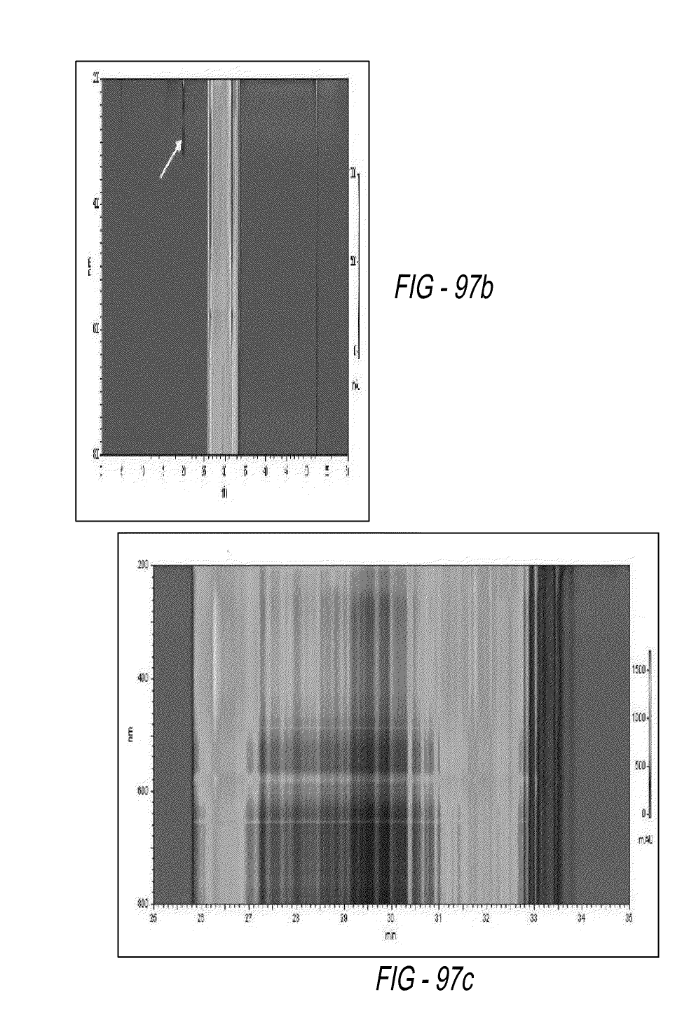

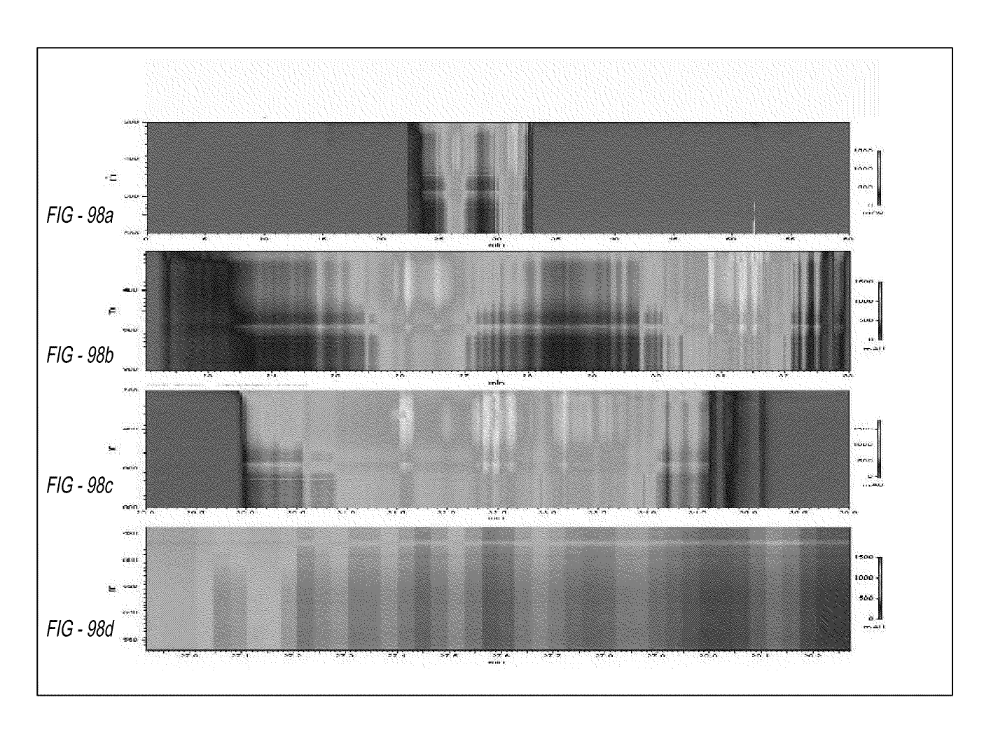

Different examples of Chromatographic Fingerprints of various medicines of different philosophies were given in FIGS. 10-129. The description of the figures is given below.

Thus in the present method of analysis, a mixture having different constituents was separated in to individual molecules/molecular fractions using a suitable analytical method, stationary and mobile phase conditions. When each of the molecules is exposed to a set of electromagnetic radiations of different wavelengths, specific spectra are generated. The spectra of all molecules eluted at different retentions become a 3-D chromatogram showing retention time on x-axis, spectra on y-axis and absorbance on z-axis. When the 3-D chromatogram is presented in a bird's, eye view at different levels, different contour chromatograms can be presented as data graphs.

This pattern of molecular absorption properties for the molecules arranged in a specific to order of polarity along with their spectra become a pattern of the figure like a fingerprint. As it was developed using a chromatograph it has been termed as chromatographic fingerprint, which was termed with a specific trademark. Only a pattern of fingerprints which can give an identification of the analyte can only be called as fingerprint, otherwise it become a pattern of line with out any meaning. Usually a human fingerprinting software will be able to give any confirmation of the identity of the source of the image based on the data base of such images already generated for a large group of persons, by searching for similar with out which it cannot infer any thing. In the present method the division of fingerprint in to 9 different therapeutic zones helps to understand the probable efficacy of the medicine under study. Thus it works independently for the assessment of the efficacy of any sample understudy with out a referral standard. Based on the deranged polarity and energy in the patient, the suitable medicine, which can balance the derrangement by polarity and energy, have been selected and used. The Tridoshas were found to have the basis of polarity. The constituents having these properties will bring disease and health in man and medicines. Thus the bases of Tridoshas in a disease and drug have been understood using the present method.

As it was developed using a chromatograph it has been termed as chromatographic fingerprint, which was termed with a specific trademark. A pattern of lines in a fingerprint which can give an identification of the source can only be called as fingerprint, otherwise it become a pattern of lines with out any meaning.

If a database of fingerprints developed having known about the data and commonality relating to a specific factor like efficacy or property then it helps to build a method as prescribed in the present invention. Usually a human fingerprinting software will be able to give any confirmation of the identity of the source of the image based on the data base of such images already generated for a large group of persons, by searching for similar with out which it cannot infer any thing. But in the present method the divisions of fingerprint in to 9 different therapeutic S zones help to understand the probable efficacy of the medicine under study. Thus the present method works independently for the assessment of the efficacy of any sample understudy.

Thus many of the behaviors of the molecules in a chromatographic column are correlated to the behavior of the molecules in the biological system. The food/medicines also undergo different changes due to different chemical and biochemical to conditions. Based on the pH and temperatures and other influencing factors also, alter the properties of the molecules in due course of time of their stay in the biological system, the medicinal molecules will do different actions. Thus when a high polar molecule enters in to a non-polar biological system some of the polarity will get adjusted and the behavior of the medicine differ from its action from out side the body. Same behavior can be seen due to factors like temperature of the medicine and body. Thus one should be able to assess the efficacy of the medicine at the site of action by simulation of the similar conditions prevail in the biological system. The time of extraction and conditions of extraction also influence the nature of the constituents and their help to assess the therapeutic efficacy of the medicines.

After analysis of the medicines, the healthy and disease profiles of different human blood samples were studied. They have showed what a disease profile is and the role of polarity in a disease pattern and drug pattern was understood. This facilitates to assess the disease profile and the constituents of specific polarity deranged and select suitable medicines for the said disease. The disease identification, drug selection, drug targeting and drug monitoring was made possible by using this method. When the blood samples of the humans were analyzed, based on the deranged polarity in the patient, the suitable medicine, which can balance the derangements, can be selected and used. Selection of suitable medicines for a patient, suffering with a specific disease needs understanding of all properties of all factors influencing or involved in the disease pathogenesis. The environment in which the patient living should also be taken into consideration with out which the treatment will be not be successful.

Thus having a method of assessing the disease, suitable medicines and apply on a suitable patient who is suffering with a specific disease needs the total understanding of the properties of all factors influencing or involved in the disease pathogenesis. But the environment in which the patient living should also be taken into consideration with out which the treatment will be unsuccessful.

Based on the deranged polarity in the patient the suitable medicine, which can balance the derrangement, have been selected and used. The Tridoshas were found to have the basis of polarity. The constituents having these properties will bring disease and health in man and medicines. Thus the basis of Tridoshas has been understood using the present method.

After working on different diseases and medicines used for, it was observed that most to of the medicines capable of absorbing the ultraviolet radiations are capable of decreasing the disease. The presence of Ultra violet radiations in the body are leading to all diseases by derrangement of biochemical and bio physical properties of the living beings. Hence increase of ultraviolet radiations is the causative factors for almost all diseases. But what is the source of these radiations in the human body deranging all components and the Gene is a million dollar question?

Thus it is understood that when the radiations of other side are decreased like the blood or mitochondria which are related to pitta got deranged, the radiations of the ultraviolet radiations dominate their effect leading to derrangement of biochemical and bio physical properties of the living beings. This correlates to the traditional concept of, maintaining the BALANCE of TRI DOSHAS leads to health. This also supports the traditional concept of the body is able to be healthy on its own by this balance of tridoshas. What we need to do is to provide the required material and hygienic conditions. So body can drive on its own, we need only to fuel it and clean it.

In addition, Table 27 shows interpretation rules of fingerprints for different therapeutic and chemical properties. A tool for identifying disease employing discussed method in view of table 27 and data processor is capable of interpreting diseased condition as anti viral for retention time of 0 to 5 minutes; as bio-enhancer for retention time of 5-10 minutes; as potency (vrishya) for retention time of 35 to 55 minutes; as anti helminthtic for retention time of 45 to 50 minutes; as channel obstruction for retention time of 45 minutes and 300 to 500 nm absorbance and as immunomodulatory for retention time of 32 to 50 minutes with a run time of 60 minutes. The range of retention time identifying the diseased condition varies by varying the said run time.

The separation, measurement of the absorbed/transmitted electromagnetic radiation by their individual constituents present at various conditions of temperature, pH and ionic media has helped to assess the chemical, biological and therapeutic properties of the material under test using the above method.

TABLE 1

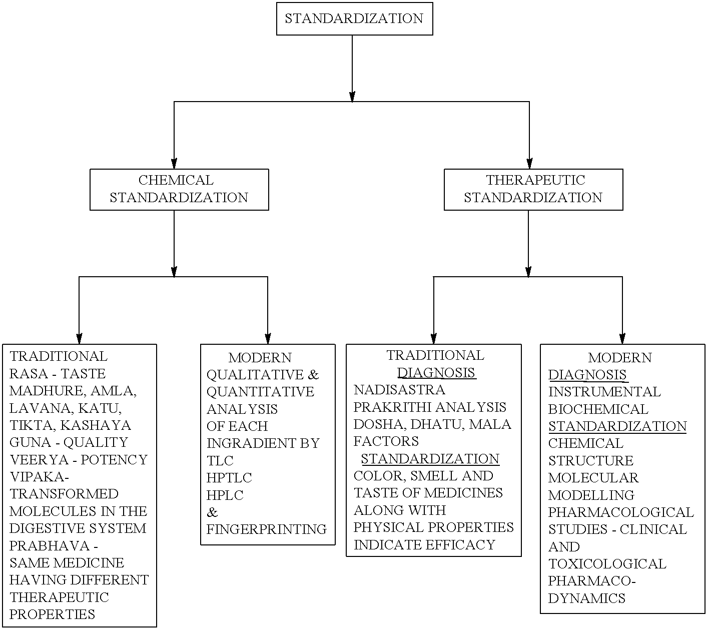

TABLE 2
Shadrasa Nigantu

| | | | | | Kashaya |
|---|---|---|---|---|---|
| Madhura skanda | Amla skanda | Lavana skanda | Tikta skanda | Katu skanda | skanda |
| Gritha | Thakra | Saindhava | Vasa | Naga kesara | Shyama |
| Madhu | Dadhi | Souvarchala | Kushta | Ela | Trivruth |
| Taila | Mastu | Bida | Patola | Bhrita ela | Musta |
| Dugda | Kanjika | Ushara | Parpataka | Tamala patra | Mustaka |
| Navaneetha | Danyamla | Oudbhida | Ativisha | Lavanga | Tilvaka |
| Jala | Rasamla | Samudraja | Prativisha | Lavanga pushpa | Lodhra |
| Vidaari | Tushodaka | Yava kshara | Patha | Ajaji | Akshi |
| | | | | | bheshaja |
| Ksheeravidari | Madya | Suvarchala | Guduchi | Krishna jeeraka | Laksha |
| | | kshara | | | |
| Indeevari | Kinwa | Tankana | Soma valka | Shunti | Peelu |
| Shatavari | Amlavethasa | Naga | Khadira | Shringa vera | Kupeelu |
| Kakoli | Koshamra | Vanga | Useera | Pippali | Shami |
| Ksheera kakoli | Vrikshamla | | Hribera | Maricha | Bilwa |
| Atmagupta | Dadima | | Katuki | Gaja pippali | Haritaki |
| Rishyaprokta | Amalaki | | Murva | Chitraka | Vibhitaki |
| Sariva | Chincha | | Haridra | Pippali mula | Amalaki |
| Gopavalli | Amra | | Darvi | Gandha trina | Rakta padi |
| | | | | | (lajjalu) |
| Utpala sariva | Amrataka | | Peeluparni | bhu trina | Vamsha |
| Meda | Kapithha | | Kiratatikta | Vidanga | Mayura shika |
| Maha meda | Chukrika | | Nimba | Talisa patra | Ambasta |
| Jeevanthi | Karamarda | | Maha nimba | Chavya | Jambu |
| Payasya | Katwanga | | Pushkarmula | Nakha | Kasa marda |
| Kharjuri | Kasheruka | | Agni mandha | Vyaghra nakhi | Varuna |
| Parushaka | Mathulunga | | Laghu | Sankha nakha | Chakra marda |
| | | | agnimandha | | |
| Lekyapathra | Lakucha | | Snuhi | Sarpa gandha | Asoka |
| Gudapaki | Rudraksha | | Vajri | Suvaha | Kramuka |
| Madhuka | Naranga | | Patra snuhi | Surasa | Manjista |
| Madhulika | Krishnaloha | | Karkata shringi | Deva dumdhubi | Yavasa |
| Kshudrasaha | Varthaloha | | Patala | Phanijjaka | Punnaga |
| Mudgaparni | Mandoora | | Kashmarya | Kalamala | Kovidara |
| Mashaparni | | | Kuberaksha | Lasuna | Asmantaka |
| Shalaparni | | | Syonaka | Palandu | Dhataki |
| Prishniparni | | | Bharangi | Vyaghri | Sirisha |
| Srigaalavinna | | | Madana phala | Bhrhati | Vrikshadani |
| Kusha | | | Ikshwaku | Mishi | Aswagandha |
| Draksha | | | Jeemutha | Shyleeya | Aparajitha |
| Mridweeka | | | Bimbi | Tilaparni | Asph0taka |
| Ikhuka | | | Shan pushpi | Drona pushpi | Vikamkata |
| Ikshwalika | | | Kutaja | Ati chatra | Sleshmataka |
| Mathsyandika | | | Indra yava | Mulaka | Tinisha |
| Sithothpala | | | Dhanyaka | Kshudra | Ashwa karna |
| | | | | mulaka | |
| Yavasa sharkara | | | Koshataki | Shobanjana | Kakubha |
| Vatyalika (bala) | | | Indra varuni | Grinjana | Prasarini |
| Vatyayani (atibala) | | | Eranda | Sweta maricha | Aswatha |
| Gangeruki | | | Rakta eranda | Sarpasha | Plaksha |
| Sahasraveerya | | | Aragvadha | Siddardhaka | Nyagrodha |
| Neela doorva | | | Vacha | Mundi | Kakodumbara |
| Maha doorva | | | Sireyaka | Maha sravani | Udumbara |
| Gokshura | | | Rasna | Punarnava | Bakula |
| Narikela | | | Trayamana | Varshabhu | Bandhuka |
| Akshota | | | Ajashringi | Rakta pushpa | Sphurjitaka |
| Rajadana | | | Neeli | Nikhumbha | Maha shaka |
| | | | | (danti) | |
| Paneeyavalli | | | Vishanika | Naga danti | Tumburu |
| Priyala | | | Bakuchi | Deva daru | Kadamba |
| Ikshu | | | Dhavana | Hingu | Maha |
| | | | | | kadamba |
| Parevatham | | | Khara patra | Aja moda | Shallaki |
| Thavaksheeri | | | Kamkushta | kachura | Arimeda |
| Panasa | | | Manduka parni | Taskari | Katphala |
| Mahaphala | | | Saptala | Harenuka | Dhanvana |
| Vriddi | | | Surya kantha | Lata kastoori | Kachura |
| Kadali | | | Priyangu | Ela patra | Japa pushpa |
| Jeevaka | | | Bhringa raja | Jati patra | Avartaki |
| | | | | | (hema pushpi) |
| Rishabhaka | | | Krishna agaru | Jati phala | Kumari |
| Tanduleeya | | | Nandi vruksha | Kastoori | Kambhoji |
| | | | | | (masha parni) |
| Padma | | | Bhramhini | Gandha marjara | Yuthika |
| Sithavaluka | | | Tagara | Kunduru | Kubjaka |
| Kokilaksha | | | Bola | Haritala | Verataru |
| Nalika | | | Sarala | Gandhaka | Ketaki |
| Dadhipushpa | | | Saileeya | Hingula | Matsyaadani |
| Nyagrodha | | | Mahisaksha | Manahshila | Pinditaka |
| Kharavriksha | | | Shilajit | Tutha | Putranjeeva |
| Sahadevi | | | Vrichikali | Bhallataka | Shala |
| Sunishannaka | | | Kampillaka | Rasaka | Sarja |
| Upodaki | | | Kataka | Ankola | Padmini |
| Mridupusha | | | Arka | Krishna nimba | Padma |
| Yastimadhu | | | Langali | Peelu | Pundareeka |
| Lakshmana | | | Dhatura | Champaka | Kokanada |
| Mathsyakshi | | | Krishna dhatura | nava mallika | Sougandhika |
| Karpasa | | | Elavaluka | Asta patrika | Indee vara |
| | | | | (malli) | |
| Agathsya | | | Ervaruka | Sada pushpi | Kinjalka |
| Vasthuka | | | Karaveera | Visha mushti | Asana |
| Anantha | | | Kakamachi | Harita manjati | Prapundarika |
| (amaravalli) | | | | | |
| Vishnukantha | | | Gunja | Surana | padmaka |
| Vathsadani | | | Swetha gunja | Hingu patri | Sourashtrika |
| Jeevanthika | | | Krishna gunja | Sukla kanda | Khatika |
| Kasheruka | | | Bhmyamalaki | vajra valli | Abhraka |
| Bhumikanda | | | Girikarni | Bhrma dandi | Bhoorja patra |
| Shringataka | | | Giri karnika | Eswari | Sreeveshtaka |
| | | | (black) | | |
| Sthouneyaka | | | Sarapunkha | Deeghangi | Shalmali |
| Kushmanda | | | Palasha | Nadi kanta | Shalmali |
| | | | | | niryas |
| Thrapusa | | | Sapta chada | Davagni (agni | Rajitha |
| | | | | jwala) | |
| Vyala puthrika | | | Badara | Pittala | Tamra |
| Ervraruka | | | Kakaadani | Gomutra | Rasanjana |
| Alabu | | | Varahi | | Souveeranjana |
| Dhamargava | | | Hamsapadi | | Srothanjana |
| Maha jalini | | | Jati | | Pushpanjana |
| Madhuchhista | | | Mushkaka | | Neelanjana |
| Swarna | | | Neela nirgundi | | Gairika |
| Shali dhanya | | | Shefalika | | Sindhura |
| | | | (white) | | |
| Neevara | | | Karanja | | Kasisa |
| Priyangu | | | Puti karanja | | Pushpa kasisa |
| Shyamaka | | | Angara valli | | Makshika |
| Kora doosha | | | Atasi | | Samudra |
| | | | | | phena |
| Kodrava | | | Tumburu | | Pashana bhedi |
| Yavanala | | | Avartani | | Sankha |
| Yava | | | Ingudi | | Vatsa nabhi |
| Mudga | | | Vetra | | Parada |
| Masha | | | Shankini | | |
| Chanaka | | | Guda manajari | | |
| Kuluthha | | | Kshavaka | | |
| Nispava | | | Kapitha patra | | |
| Rajamasha | | | Kakajngha | | |
| Adhaki | | | Sarapunkhi | | |
| Chakshushya | | | Trivruth patra | | |
| | | | gadida gadapa | | |
| Kalaya | | | Visha musti | | |
| Tila | | | Trivruth | | |
| | | | Kakandha | | |
| | | | Prasarini | | |
| | | | Raja bala | | |
| | | | paribhdra | | |
| | | | Suka nala | | |
| | | | Madhu parni | | |
| | | | Nimba | | |
| | | | Karkotaki | | |
| | | | Kara vellaka | | |
| | | | Surya valli | | |
| | | | Rajika | | |
| | | | Uttama varuni | | |
| | | | Tilvaka | | |
| | | | Kamsya | | |

TABLE 3
ABBRIVIATIONS FOR SHADRASA NIGHANTU

| S. | SANSKRIT TERM | ENGLISH/MEDICAL |
|---|---|---|
| No. | USED IN TEXT | EQUIVALENT TERM |
| 1. | ADHMANA | Flatulent colic |
| 2. | AGNI MANDYA | Indigestion |
| 3. | AMATISARA | Mucous diarrhoea |
| 4. | AMAVATA | Arthritic conditions |
| 5. | AMLA PITTA | Hyper acidity |
| 6. | ANAHA | Flatulency |
| 7. | ANULOMANA | Epistssis/Flatulency |
| 8. | APACHI | Adenitis |
| 9. | APASMARA | Epileptic conditions |
| 10. | APATANTRAKA | Convulsions |
| 11. | ARBUDA | Tumours |
| 12. | ARDITA VATA | Facial paralysis |
| 13. | AROCHAKA | Distaste |
| 14. | ARSHAS | Haemorroides |
| 15. | ARUCHI | Anorexia |
| 16. | ASMARI | Renal calculus |
| 17. | ASMARI BHEDANA | Lithno - triptic |
| 18. | ASTHI | Related to bone |
| 19. | ATISARA | Diarrhoea |
| 20. | AVRUSHYA | Causes infertility/impotency |
| 21. | BALA ROGA | Paediatric diseases |
| 22. | BALYA | Tonic |
| 23. | BHADIRYA | Deafness |
| 24. | BHAGNA SANDHANA | The one which heals the bone fracture |
| 25. | BHEDANEEYA | Mass breaking |
| 26. | BHOOTA VYADHI | Phychic disorders |
| 27. | BHRAMA | Giddiness |
| 28. | BRIMHANEEYA | Bulk promoting |
| 29. | CHAKSHUSHYA | Ophthalmic - good for eyes |
| 30. | CHARDI | Vomiting |
| 31. | CHEDHANEEYA | Expectorant |
| 32. | DAHA | Burning sensation |
| 33. | DAHA PRASAHMANA | Refrigerant |
| 34. | DANTA ROGA | Diseases pertaining to teeth |
| 35. | DEEPANA | Stomachic |
| 36. | DOUBALYA | Weakness |
| 37. | DUSHTA VRANA | Chronic ulcer |
| 38. | GALA GANDA | Goiter |
| 39. | GALA ROGA | Diseases pertains to throat |
| 40. | GANDA MALA | Cervical lymph adenitis |
| 41. | GARBHA PATAKA | Abortifacient - which induces abortion |
| 42. | GARBHA SRAVA | Abortion |
| 43. | GARBHASHAYA | Induces Uterine contraction |
| | SAMKOCHA | |
| 44. | GARBHASHAYA | Which improve the functions of uterus |
| | VISHODHANA | |
| 45. | GLANI | Fatigue |
| 46. | GRAHA ROGA | Diseases caused by infections to the |
| | | infants/children |
| 47. | GRAHANI | Tropical sphrue/ulcerative colitis |
| 48. | GRAHI | Astringent |
| 49. | GUDA ROGA | Diseases related to anus |
| 50. | GULMA | Abdominal lump |
| 51. | HARA | Pacify |
| 52. | HIKKA | Hiccough |
| 53. | HRIDROGA | Ailment of heart |
| 54. | HRIDYA | Cardio-tonic - good for heart |
| 55. | HRILLASA | Nausea |
| 56. | JALA SHUDHI KARA | The one which purify water |
| 57. | JEERNA JWARA | Chronic fever |
| 58. | JEEVANEEYA | Vitalizing |
| 59. | JWARA | Types of Fever |
| 60. | KANDU | Pruritic conditions |
| 61. | KAMALA | Jaundice |
| 62. | KANTI PRADA | Improves glow |
| 63. | KANTYA | Good for throat |
| 64. | KAPHA | One of the Tri doshas |
| 65. | KARA/VRUDHI | Vitiated |
| 66. | KARNA ROGA | Diseases related to ear |
| 67. | KARSHYA | Emaciation |
| 68. | KASA | Cough |
| 69. | KATI SHOLLA | Lumbago |
| 70. | KESHYA | Trichogeneous- |
| 71. | KHALITYA | Alopecia |
| 72. | KITHIBHA | Psoriasis |
| 73. | KLEDA | Liquefying |
| 74. | KRIMI | Worm infestation |
| 75. | KRIMIGHNA | Anthelmintic |
| 76. | KSHAYA | Degenerative conditions |
| 77. | KUSHTA | Diseases of skin and involvement |
| | | of other tissues |
| 78. | LEKHANA, | Emaciating |
| 79. | MADA KARA | Syncope |
| 80. | MAJJA DATHU | Bone marrow |
| 81. | MAMSA DHATU | Muscular tissue |
| 82. | MEDHYA | Intellect promoting |
| 83. | MEDO DHATU | Adipose tissue |
| 84. | MEDO ROGA | Adipose tissue disorders |
| 85. | MOHA | Delusion |
| 86. | MOORCHA | Fainting |
| 87. | MOOSHIKA DAMSA | Rat bite |
| 88. | MUTRALA | Diuretic |
| 89. | MUDHA GARBHA | Obstructed labour |
| 90. | MUKHA ROGA | Ailments of oral cavity |
| 91. | MUTRA GHATA | Urinary obstruction |
| 92. | MUTRA KRICHRA | Dysuria-painful micturition |
| 93. | MUTRA | Urinary astringent/anti-diuretic |
| | SAMGRAHANEEYA | |
| 94. | MUTRA | Urinary de pigmenter |
| | VIRAJANEETA | |
| 95. | NETRA ROGA | Ailments of eye |
| 96. | NETRA AHITA | Not good for eyes |
| 97. | NIDRA JANANA | Soporific - which induces sleep |
| 98. | OUSHTA ROGA | Diseases of lips |
| 99. | PACHANA | Digestive |
| 100. | PALITYA | Premature graying of hair |
| 101. | PAMA | Scabies |
| 102. | PANDU | Anemic conditions |
| 103. | PARSHWA SHOOLA | Auxiliary pain, Pleurisy |
| 104. | PEENASA | Nasal catarrh |
| 105. | PHIRANGA | Syphilis |
| 106. | PITTA | One of the Tri doshas |
| 107. | PLEEHODARA/ | Spleeno - megaly/Spleenopathy |
| | PLEEHA VRUDHI | |
| 108. | POUSHTIKA | Nutritive |
| 109. | PRAMADHI | Cleansing |
| 110. | PRAMEHA | Diabetes |
| 111. | PRASEKA | Any kind of liquid oozing out |
| 112. | PRATISHYAYA | Common cold |
| 113. | PRAVAHIKA | Dysentery |
| 114. | PREENANA | Nourishing |
| 115. | PURISHA | Intestinal astringent |
| | SAMGRAHANEEYA | |
| 116. | PURISHA | Faecal depigmenter |
| | VIRAJANEETA | |
| 117. | RAJA YAKSHMA | Tuberculosis |
| 118. | RAKSHOGHNA | Which prevents mental disorders |
| 119. | RAKTA DHATU | Blood tissue |
| 120. | RAKTA PITTA | Bleeding disorders |
| 121. | RAKTA PRADARA | Menorrhagia |
| 122. | RAKTA | Styptic |
| | SAMGRAHAKA | |
| 123. | RAKTA VIKARA | Diseases related to blood |
| 124. | RAKTA ARSHAS | Bleeding haemorrides |
| 125. | RAKTATISARA | Dysentery |
| 126. | RASA, DHATU | Lymphoid tissue |
| 127. | RASAYANA | Rejuvenating |
| 128. | RECHANA | Purgative |
| 129. | ROCHANA/RUCHYA | Improves taste |
| 130. | SAMSRANA | Mild laxative |
| 131. | SANDHANEEYA | Healing |
| 132. | SANJNA STHAPANA | Resuscitative |
| 133. | SANNIPATAJA | Typhoid fever |
| | JWARA | |
| 134. | SARPA DAMSA | Snake bite |
| 135. | SHAMANA | Procedure involved |
| 136. | SHODHA HARA | Anti phlogistic/anti inflammatory |
| 137. | SHODHA | Inflammation |
| 138. | SHODHANA | Procedure involved in removal of |
| | | vitiated doshas out of the body |
| 139. | SHONITA STHAPANA, | Haemostatic |
| 140. | PRAJA STHAPANA | Anti abortifacient |
| 141. | SHOOLA | Colic |
| 142. | SHOOLA HARA | Anti spasmodic |
| 143. | SHOSHA | Emaciation |
| 144. | SIRO ROGA | Cephalopathy |
| 145. | SLEEPADA | Filariasis |
| 146. | SMRITHI KARA/ | Increases memory |
| | PRADA | |
| 147. | SNEHANA | Oleation |
| 148. | SOMA ROGA | Poly urea |
| 149. | SRAMA HARA | Energy compensator |
| 150. | STHAMBANA | Restriction |
| 151. | STHANYA | Galactogogue |
| | KARA/VRUDHI | |
| 152. | STHANYA | Galacto purifier |
| | SHUDHIKARA | |
| 153. | SUGHANDHA | Aromatic |
| 154. | SUKRA DHATU | Reproductive tissue |
| 155. | SUKRA SHODHANA | Tissue depurative |
| 156. | SUKRALA | Increases quantity of semen |
| 157. | SWARYA | Good for throat and voice |
| 158. | SWASA | Respiratory diseases |
| 159. | SWEDALA/SWEDA | Sudorific |
| | JANANA | |
| 160. | SWETA PRADARA | Leucorrhoea |
| 161. | SWITRA | Vitiligo |
| 162. | TAMAKA SWASA | Bronchial Asthma |
| 163. | TANDRA | Excessive yawning |
| 164. | TARPANA | Passification |
| 165. | TIMIRA | Numb ness |
| 166. | TRIDOSHA | Three physiological principles of body |
| 167. | TRISHNA | Hyperdipsia |
| 168. | TRUPTI KARA | Saturative |
| 169. | TRUPTIGHNA | Anti saturative |
| 170. | TWACHYA | Which keeps the skin healthy and soft. |
| 171. | UDARA ROGA | Abdominal distension |
| 172. | UDARDA | Wheals (Urticarial) |
| | PRASHAMANA | |
| 173. | UDAVARTHA | Intestinal and other kinds of obstruction |
| 174. | UNMADA | Mental disorders |
| 175. | UTTEJAKA | Stimulant |
| 176. | VAJIKARANA/ | Aphrodisiac |
| | VRISHYA | |
| 177. | VAMAKA | Induces Vomiting |
| 178. | VARNYA | Improves complexion |
| 179. | VASTI SHOOLA | Cystalgia - pain in bladder region |
| 180. | VATA | One of the tri doshas |
| 181. | VATA RAKTA | Arthritic condition |
| 182. | VAYAH STHAPANA | Anti aging |
| 183. | VEDANA STHAPANA | Anodyne-allays pain |
| 184. | VIBHANDA | Obstruction |
| 185. | VISARPA | Erysipelas |
| 186. | VISHAMA JWARA | Malarial fever |
| 187. | VISHTAMBHA | Abdominal |
| 188. | VISPHOTA | Eruptive skin disorders |
| 189. | VISUCHIKA | Cholera |
| 190. | VRANA | Vulnerary |
| | SHODHANA/ROPANA | |
| 191. | YAKRIT VRUDHI | Hepatomegaly |
| 192. | YOGA VAHI | Carrier, Anupana |
| 193. | YONI ROGA | Vaginopathy - diseases related to vagina |

TABLE 4
KASHAYA SKANDA

| SR | | ENGLISH/LATIN | |
|---|---|---|---|
| NO | SANSKRIT NAME | NAME | THERAPEUTIC EFFICACY |
| 1. | SHYAMA | Operculina turpethum | Kapha pitta hara, rechana |
| 2. | TRIVRUTH | Operculina turpethum | Jwara, shodha, udara, pandu, kamala, arshas |
| 3. | MUSTA | Cyperus rotundus | Kapha pitta hara, deepana, pachana, grahi |
| 4. | MUSTAKA | Cyperus scarious | lekhana |
| | | | Jwara, daha, aruchi, krimi, medo roga |
| 5. | TILVAKA | Lodhra bheeda | Kapha pitta hara, grahi, chakshushya, |
| 6. | LODHRA | Symplocos racemosus | Rakta pitta, atisara, pravahika, shodha, |
| | | | jwara, pradara |
| 7. | AKSHI BHESHAJA | Strychnos potatorum | Kapha vata hara, lekhana, chakshushya, |
| | | | vamaka, visha hara |
| | | | Mutra krichra, asmari, sarkara, kamala, |
| | | | pandu, shodha, prameha |
| 8. | LAKSHA | Laccifera lacca | Kapha pitta hara, |
| | | | Hikka, swasa, kasa, jwara, vrana, kshata, |
| | | | visarpa, krimi, kushta |
| 9. | PEELU | Salvadora percisa | Kapha vata hara, rechana |
| | | | Gulma, arshas, udara, raktapitta, mutra |
| | | | krichra, shodha |
| 10. | KUPEELU | Strychnos nux-vomica | Kapha vata hara, grahi, vishaghna |
| | | | Kushta, kandu, arshas, vrana, vata roga |
| 11. | SHAMI | Prosopis specigera | Kapha pitta hara, kesha hara |
| | | | Kasa, swasa, kushta, krimi, arshas, |
| | | | raktatisara, raktaarshas |
| 12. | BILWA | Aegel marmelos | Vata kapha hara, deepana, pachana, grahi |
| | | | Shodha, atisara, grahani |
| 13. | HARITAKI | Terminalia chebula | Tridosha hara, deepana, pachana, grrahi, |
| | | | rasayana, anulomana, praja sthapana |
| | | | Kushta, prameha, arshas, shodha, hridroga, |
| | | | swasa, kasa, hikka, netra roga, grahani, |
| | | | kamala, pandu |
| 14. | VIBHITAKI | Terminalic belerica | Kapha pitta hara, bhedana, chakshushya, |
| | | | keshya, mada kari |
| | | | Kasa, swasa, krimi, trishna, chardi |
| | | | Asmari, atisara |
| 15. | AMALAKI | Phyllanthus emblica | Tridosha hara, deepana pachana, netrya, |
| | | | vayah sthapana, rasayana |
| | | | Rakta pitta, prameha, kushta, atisara, |
| | | | shoola, somaroga, sweta pradara, rakta |
| | | | pradara, netra roga |
| 16. | RAKTA PADI | Mimosa pudica | Kapha pitta hara, sandhaneeya, purisha |
| | (LAJJALU) | | samgrahaneeya |
| | | | Atisara, rakta pitta, yoni roga, swasa, |
| | | | kushta, shodha, vrana |
| 17. | VAMSHA | Bambusa arundinaecium | Kapha pitta hara chedana, vasti shodhana |
| | | | Kushta, prameha, mutra krichra, shodha |
| 18. | MAYURA SHIKA | Actinopteres radiata | Kapha pitta hara, visha hara |
| | | | Atisara, pravahika, prameha |
| 19. | AMBASTA | ? Quercus infectoria | Kapha pitta hara, grahi, deepana |
| | | | Atisara, grahani, pravahika, sweta pra dara, |
| | | | mukha danta roga |
| 20. | JAMBU | Euginea jambolana | kapha pitta hara, vata kara, grahi, mutra |
| | | | samgrahaneeya |
| | | | Chardi, atisara, swasa, kasa, daha |
| 21. | KASA MARDA | Cassia occidentalis | Tridosha hara, pachana, vrishya |
| | | | Kasa.sa, hikka, sidhma, kushta, vicharchika, |
| | | | sleepada |
| 22. | VARUNA | Crataeva religiosa | Kapha vata hara, deepana, |
| | | | Asmari, vidradhi, gulma, krimi, ganda mala |
| 23. | CHAKRA MARDA | Cassia tora | Kapha vata hara, medo hara |
| | | | Dadru kushta, kandu, krimi, gulma, kasa, |
| | | | swasa |
| 24. | ASOKA | Saraca indica | Pitta hara, grahi, varnya, hridya |
| | | | Rakta pradara,, shoola, gulma, adhmana, |
| | | | krimi, daha, trishna |
| 25. | KRAMUKA | Areca catechu | Kapha pitta hara, deepana |
| | | | Krimi, atisara, pravahika, prameha |
| 26. | MANJISTA | Rubia cordifolia | Kapha pitta hara, swarya, varnya, visha hara |
| | | | Jwara, kushta, visarpa, prameha, shodha |
| 27. | YAVASA | Alhagi camelorum | Kapha pitta hara, balya, deepana |
| | | | Jwara, daha, chardi, trishna, kushta visarpa |
| 28. | PUNNAGA | Callophyllum inophyllum | Kapha pitta hara |
| | | | Raktatisara, rakta pradara, rakta pitta, |
| | | | amavata, mutra krichra |
| 29. | KOVIDARA | Bauhunia purpurea | Kapha pitta hara grahi, |
| 30. | ASMANTAKA | Kovidara bheda | Krimi, kushta, guda bhramsha, ganda mala, |
| | | | vrana |
| 31. | DHATAKI | Woodfordia fruitcosa | Kapha pitta hara mada kari |
| | | | Ati sra, rakta pitta, trishna, visarpa, vrana |
| 32. | SIRISHA | Albezzia lebbeck | Tridosha hara, varnya, visha hara, vedana |
| | | | sthapana |
| | | | Kushta, kandu, visarpa, kasa, swasa |
| 33. | VRIKSHADANI | Vanda roxburgianam | Vata hara |
| | | | Amavata, karna srava visha hara |
| 34. | ASWAGANDHA | Withania somnifera | Vata kapha hara, balya, rasayana, sukrala |
| | | | Kshaya, kasa, swasa, grandhi, apachi, |
| | | | vrana, vandhytwa, nidra nasha |
| 35. | APARAJITHA | Clitoria terneta | Tri dosha hara Medhya, chakshushya, |
| 36. | ASPH0TAKA | Aparajita bheda | kantya, |
| | | | Kushta, shodha vrana, visha |
| 37. | VIKAMKATA | Flocurita romantchii | Vata pitta hara, deepana, pachana, mutrala |
| | | | Kamala, pleeha vridhi |
| 38. | SLESHMATAKA | Cordia dichotoma | Kapha pitta hara, keshya, vishaghna |
| | | | Raktapitta, visphota, visarpa, kushta,, krimi, |
| | | | shoola |
| 39. | TINISHA | Ougeinia dalbergiodes | Kapha pitta hara, medo hara |
| | | | Kushta, prameha, switra, pandu, krimi, |
| | | | vrana |
| 40. | ASHWA KARNA | Dipterocarpous turbinatus | Puya rakta nashaka |
| | | | Jwara, visphota, kandu, siro roga |
| 41. | KAKUBHA | Terminalia arjuna | Kapha pitta hara, hridya, udarda |
| | | | prasamana, rasayana |
| | | | Hridroga, kshta kshaya, raktapitta, |
| | | | raktatisara, arsghas, vrana |
| 42. | PRASARINI | Paederia foetida | Vata hara, sara, |
| | | | Vata vyadhi, amavata, mutra krichra, |
| | | | arshas, shodha |
| 43. | ASWATHA | Ficus religiosa | Kapha pitta hara, varnya, vrishya, yoni |
| | | | shodhana, vrana shodhana ropana |
| | | | Vata rkta, kushta, yoni roga, dushta vrana, |
| | | | daha |
| 44. | PLAKSHA | Ficus lacor | Kapha pitta hara, mutra samgrahaneeya |
| | | | Daha, vrana, yoni roga, bhrama, rakta pitta |
| 45. | NYAGRODHA | Ficus bengalensis | Kapha pitta hara, mutra samgrahaneeya, |
| | | | varnya, sthambhana |
| | | | Trishna, chardi, rakta pitta, visarpa, yoni |
| | | | roga, vyangya, vandhyt\wam |
| 46. | KAKODUMBARA | Ficus hispida | Kapha pitta hara, grahi, sukrala, bhrimhana, |
| | | | Switra, kushta, pandu, kamala, arshas, vrana |
| 47. | UDUMBARA | Ficus racemosus | Kapha pitta hara, varnya, Vrana shodhana, |
| | | | ropana, |
| | | | Rakta pitta, daha, moorcha, trishna, |
| | | | bhasmkagni, atisara, rakta pradara |
| 48. | BAKULA | Mimusops elengi | Kapha pitta hara, dantya, grahi, hridya |
| | | | Danta roga, atisara, switra, |
| 49. | BANDHUKA | Pentapetes phoenicea | Vata pitta hara, kapha kara, grahi, vamaka, |
| | | | snehaka |
| | | | Visarpa, |
| 50. | SPHURJITAKA | Diospyros embryopteris | Vata kara, kapha pitta kara, grahi, |
| | | | Prameha |
| 51. | MAHA SHAKA | ?Tectona grandis | Pitta hara, sthambaka, krimighna, |
| | | | Rakta pitta |
| 52. | TUMBURU | Zanthoxylum alatum | Vata kapha hara Deepana, ruchya, vidahi |
| | | | Akshi karna, oushta, siro roga, krimi, kushta, |
| | | | shoola, aruchi, swasa, pleeha |
| 53. | KADAMBA | Anthocephalus cadamba | Vata kapha kara, pitta hara, saraka, sthnya |
| 54. | MAHA KADAMBA | | kara, shopha vrana daha kasa, |
| 55. | SHALLAKI | Boswelia serrata | Pitta kapha hara poushtika, |
| | | | Atisara, arshas, kushta, rakta pitta vrana |
| 56. | ARIMEDA | Acacia farnesiana | Kapha vata shamaka, pachana, |
| | | | Kushta, kandu, shodha, prameha, kasa, |
| | | | vrana, mukha danta roga |
| 57. | KATPHALA | Myrica nagi | Vata kapjha hara, veedana sthapana |
| | | | Sukra shodhana, sandhaneeya |
| | | | Aruchi, jwara, udara, raktapitta, swasa, |
| | | | kasa, pratishaya, kandu, arshas |
| 58. | DHANVANA | Grewia tiliafolia | Kapha pitta hara, bhrimhana, balya |
| | | | Vrana ropana, |
| | | | Atisara, pravika, rakta pitta, vrana, kasa,. |
| 59. | KACHURA | Hedychium spicatum | Ka[ha vata hara, hgrahi, |
| | | | Kasa, swasa, pratishayahikka, shoola, jwara |
| 60. | JAPA PUSHPA | Hibiscus rosa sinensis | Vata kapha hara samgrahini, keshya, hridya |
| | | | Pradara, p[rameha, jwara |
| 61. | AVARTAKI | Cassia auriculata | Kaphapitta hara, varnya |
| | (HEMA PUSHPI) | | Prameha, visha, raktatisara |
| 62. | KUMARI | Aloe vera | Kapha vata hara, bhrimhana, balya, vrishya, |
| | | | visha hara |
| | | | Gulma, pleeha, yakrit vrudhi, jwara, |
| | | | agnidagdha, visphota, raktapitta, twak roga |
| 63. | KAMBHOJI | Teramnus labialis | Vata pitta hara, sukrala, kapha kara, grahi, |
| | (Masha parni) | | Shodha, jwara, rakta vikara |
| 64. | YUTHIKA | Jasminium auriculatum | Kapha vata kara, pitta hara, varnya, |
| | | | hridya, vishaghna |
| | | | Vrana, rakta, mukha danta, akshi roga |
| 65. | KUBJAKA | Rosa moschatta | Tridosha hara, vrishya, saraka, |
| | | | Daha, netra roga |
| 66. | VERATARU | Dichrostachys cinerea | Vata kapha hara |
| | | | Mutra ghata, asmari, yoni shoola, mutra |
| | | | krichra |
| 67. | KETAKI | Pandanus tectorius | Kapha hara, chakshushya, hridya |
| | | | Dourgandhya hara |
| | | | Jwara, siro shoola, amavata |
| 68. | MATSYAADANI | Picrorhiza kurroa | Kapha piytta hara, bhedhana, deepana, |
| | | | Jwara, prameha, swasa, kasa, daha, kushta, |
| | | | krimi |
| 69. | PINDITAKA | Randia dumatorium | Kapha hara, vamaka, lekhana, |
| | | | Vidradhi, pratishaya, vrana, kushta, anaha, |
| | | | shodha, gulma, vrana |
| 70. | PUTRANJEEVA | Putranjeeva | Kapha vata hara, vrishya, garbhada, mutrala |
| | | roxbhurgianum | Jwara, praatishaya, sira shoola |
| 71. | SHALA | Shorea robusta | Kapha hara, |
| | | | Vrana, sweda hara, krimi, vidradhi, |
| | | | bhadirya, yonikarna roga |
| 72. | SARJA | Vateria indica | Kapha hara |
| | | | Pandu, meha, kushta, visha, vrana |
| 73. | PADMINI | Nelumbo species | Kapha pitta hara, daha prashamana, hridya, |
| 74. | PADMA | ″ | balya, rakta samgrahaka, mutrala, grahi, |
| 75. | PUNDAREEKA | ″ | mutra virajaneeya |
| 76. | KOKANADA | Kamala (Red) | |
| 77. | SOUGANDHIKA | ? Sulphur | Deepana, pachana, vishghna |
| | | | Rasayana, dadru, kushta, visarpa, krimi, |
| | | | pleeha vrudhi |
| 78. | INDEE VARA | Kamala (Blue) | Kapha pitta hara, daha prashamana, hridya, |
| | | | balya, rakta samgrahaka, mutrala, grahi, |
| | | | mutra virajaneeya |
| 79. | KINJALKA | Kamala kesara | Kapha pitta hara, vrishya, grahi |
| | | (Nelumbo speciosum) | Trishna, daha, raktarshas, visha, shodha, |
| 80. | ASANA | Pterocarpus marsupium | Kapha pityta hara, twachya, keshya, |
| | | | rasayana |
| | | | Kushta, visarpa, switra, meha, krimi |
| 81. | PRAPUNDARIKA | Sweta Kamala | Kapha pitta hara, netrya, varnya, sukrala |
| | | ?cassia absus | |
| 82. | PADMAKA | Prunus puddum | Kapha pitta hara, garbha samsthapana, |
| | | | ruchya |
| | | | Visarpa, daha, visphota, kushta, chardi, |
| | | | vrana, trishna |
| 83. | SOURASHTRIKA | Double sulphate of | Vrana ropana, grahi, lekhana, keshya, danta |
| | | potassium and aluminum | dardhyakara, vishahara, rakta sthambaka |
| | | | Switra, visarpa, raktapitta, vishama jwara, |
| | | | kandu, netra roga, mukha roga |
| 84. | KHATIKA | | Pitta kapha hara, grahi, |
| | | | Daha vrana, rakta srava, netra roga |
| 85. | ABHRAKA | Mica | Vata pitta hara, rasayana, medhya, balya, |
| | | | deepana |
| | | | Prameha, hridroga, jwara, vata roga dristimandya |
| 86. | BHOORJA PATRA | Betula utilis | Tridosha hara, medo hara, vishaghna |
| | | | Apasmara, unmada, raktapitta, vrana |
| 87. | SREEVESHTAKA | Sarala niryasa | Pittakara, vata kapha hara, saraka, |
| | | Oleo-resin of | rakshoghna, |
| | | Pinus longifolia | Siro, akshi, swara, roga hara, sweda |
| | | | dougandhya, kandu, vrana |
| 88. | SHALMALI | Bombax ceiba | Kapha vrudhi, pitta vata hara, rasayana, |
| | | | vrishya |
| | | | Raktapitta, grahani, pravahika, |
| 89. | SHALMALI NIRYAS | Oloe resin of | Pravahika, atisara, rakta vikara |
| | | Bombax ceiba | |
| 90. | RAJITHA | Silver | Vata kapha hara, saraka, lekhana, deepana, |
| | | | balya, medhya, |
| 91. | TAMRA | Copper | Pitta kapha hara, lekhana, kushtaghna |
| | | | Nertrya |
| | | | Kushta, krimi, sthouly, arshas, kshaya, |
| | | | pandu, srama |
| 92. | RASANJANA | Yellow oxide of Mercury | Vata pitta hara, vishaghna |
| | | | Muklha roga, swasa, hidma |
| 93. | SOUVEERANJANA | Stybnitis | Pitta hara, vishaghna, |
| | | | Hidma, akshi roga |
| | | | Vrana shodhana, ropana |
| 94. | SROTHANJANA | Antimony sulphide | Kapha piotta hara, lekhana, netrya, |
| | | | Hidma, visha, chardi, rakat vikara |
| 95. | PUSHPANJANA | Zinc oxide | Sarva akshi roga, visha jwara |
| 96. | NEELANJANA | Lead sulphide | Tridosha hara, netrya, rasayana |
| 97. | GAIRIKA | Ochre | Pitta hara, netrya, vishaghna |
| | | | Chardi, hidma, rakta vikara |
| 98. | SINDHURA | | Tridosha hara, netrya, bhedana |
| 99. | KASISA | | Vata kapha hara, keshya, |
| 100. | PUSHPA KASISA | | rasayana, netrya, visha, vrana, kshaya, switra |
| 101. | MAKSHIKA | Copper pyrite | Vrishya, rasayana, |
| | | Iron pyrite | |
| | | Arsano pyrite | |
| 102. | SAMUDRA PHENA | Sepia officinalis | Kapha Pitta hara, vishaghna, karna roga |
| | | (cuttle fish bone) | hara, lekhana, |
| 103. | PASHANA BHEDI | Saxifra ligulata | Vasti shodhana, bhedana, arshas, gulma,, |
| | | | asmari, yoni rogaa, pleeha |
| | | | Shoola, |
| 104. | SANKHA | Turbinella rappa | Kapha vata hara, deepana, pachana, grahi |
| | | | Gahani, netra roga, amlapitta, parinama |
| | | | shoola, yavani pidika |
| 105. | VATSA NABHI | Aconitum ferox | Vata kapha hara, rasayana, sweedala, |
| | | | vishaghna, |
| | | | Jwara, kushta, madhu meha, agnimandya, |
| | | | swasa, kasa, sannipata jwara, pleehodara, |
| | | | apachi, shodha |
| 106. | PARADA | Mercury | Tridosha hara, rasayana, balya, vrishya, |
| | | | yoga vahi, |
| | | | Kushta, grahani, atisara, agnimandya, |
| | | | kshaya |

CHARAKA'S MAHA KASHAYA DASHAIMANI
(THERAPEUTIC CLASSIFICATION OF DRUGS)

| | NAME OF THE | | |
|---|---|---|---|
| S. NO. | DASHAIMANI | ACTION | Names Of The Plants |
| 1. | JEEVANEEYA | VITILIZER | Jeevaka, Rushabhaka, Meda, Maha Meda, |
| | | | Kakoli, Ksheera Kakoli, Mudga Parni, |
| | | | Masha Parni, Jeevanthi, Madhuka. |
| 2. | BRUMHANEEYA | BULK PROMOTING | Ksheerini, Rajashavaka, Avagandha, |
| | | | Kakolee, Ksheera Kakoli, Vaatayani, |
| | | | Bhadroudani, Bhaardwaaja, Payasyaa, |
| | | | Rushya Gandha. |
| 3. | LEKHANEEYA | EMACIATING | Musta, Kushta, Haridra, Daru Haridra, |
| | | | Vachaa, Ativisha, Katurohine, |
| | | | Chithraka, Chira Bilwa, Himavathee. |
| 4. | BHEDHENEEYA | MASS BREAKING | Suvahaa,, Arka, Urubooka, Agni Mukhi, |
| | | | Chitra, Chitrka, Chirabilwa,, Sankhini, |
| | | | Sakuladeena, Swarna-Kshrerine. |
| 5. | SANDHANEEYA | HEALING | Madhuka, Madhuparni, Prisna Parni, |
| | | | Ambastakee, Samanga, Mocharasa, |
| | | | Dhatakee, Lodhra, P[Riyangu, Katphala. |
| 6. | DEEPANEEYA | APPETISER | Pippali, Pippali Moola, Chaya, Chitraka, |
| | | | Nagara, Maricha Ajamoda, Hingu, |
| | | | Bhallataka, Amla Vetasa. |
| 7. | BALYA | TONIC | Indree, Rushabhio, Athirasa, Rushya |
| | | | Proktha, Payasyaa, Aaswagandha, Sthira, |
| | | | Rohinee, Balaa, Atibala. |
| 8. | VARNYA | COMPLEXION | Chandana, Padmaka, Tunga, Useera, |
| | | PROMOTING | Manjista, Saribaa, Payasyaa, Sithaa, Latha, |
| | | | Madhuka. |
| 9. | KANTHYA | BENEFICIAL FOR | Saribaa, Ikshumoola, Madhuka, Pippali, |
| | | THROAT | Draksha, Vidaare, Kaidarya, Hamsapadi, |
| | | | Brihati, Kantakarika. |
| 10. | HRDYA | CARDIAC TONIC | Aamra, Amraataka, Lakucha, Karamarda, |
| | | | Vrukshamla, Amlavetasa, Kuvala, Badara, |
| | | | Dadima, Maatulunga. |
| 11. | THRUPTHIGNA | ANTI SATURATIVE | Naagra, Chavya, Chitraka, Vidanga, |
| | | | Moorva, Guduchi, Vacha, Mustha, Pippali, |
| | | | Patola. |
| 12. | ARSHOGNA | ANTI | Kutaja, Bilwa, Chitraka, Nagara, Athivisha, |
| | | HAEMMORHOIDAL | Abhaya, Dhanvayavasaka, Daruharidra, |
| | | | Vaca, Chavya. |
| 13. | KUSTAGHNA | ANTI DERMATOSIS | Khadira, Abhaya, Amalaki, Hatidra, |
| | | | Arushkara, Sapthaparna, Aragvadha, |
| | | | Karaveera, Vidanga, Jaathe. |
| 14. | KANDUGHNA | ANTI PRURITIC | Chandana, Nalada, Kruthamalajka, Naktha |
| | | | Mala, Nimba, Kutaja, Sarshapa, Madhuka, |
| | | | Daruharidra, Mushtha. |
| 15. | KRIMIGHNA | ANTHELMINTIC | Aksheeva, Maricha, Gandeera, Kebuka, |
| | | | Vidanga, Nirgundee, Kinkhee, |
| | | | Swadamstraa, Vrusha |
| | | | Parnika, Aakhuparnika. |
| 16. | VISHAGNA | ANTI POISION | Haridra, Manjista, Suvaha, Sookshma Ela, |
| | | | Palindee, Chandana, Kathaka, Sireesha, |
| | | | Sindhuvara, Sleshmataka. |
| 17. | STHNYA JANANA | GALACTOGOUGE | Veerana, Saali, Shastika, Ikshuvalika, |
| | | | Darbha, Kusa, Kasa, Gundra, Itkata, |
| | | | Kathuranmoola. |
| 18. | STHNYA | GALACTO | Paatha, Mahaushadha, Suradaru, Musthaa, |
| | SHODHANA | DEPURATIVE | Moorva, Guduchi, Vatsaka Phala, |
| | | | Kirathatiktha, Katukarohini, Saariva. |
| 19. | SUKRA JANANA | PROMOTING | Jeevaka, Rushabhaka, Kakolee, Ksheera |
| | | REPRODUCTIVE | Kakoli, Mudga Parni, Masha Parni, Meda, |
| | | TISSUE | Vrudhaaruhaa, Jatila, Kalinga. |
| 20. | SUKRA SHODHAKA | TISUE DEPURANT | Kushta, Elavaluka, Katphala, Samudra |
| | | | Phena, Kadamba Niryasa, Ikshu, |
| | | | Kandeekshu, Iskhuraka, Vasuka, Useera. |
| 21. | SNEHOPAGA | SUB OLEATIVE | Mrudweeka, Madhuka, Madhuparnee, |
| | | | Medaa, Maha Medaa, Vidaree, |
| | | | Ksheerakakoli, Jeevaka, Jeevanthi, |
| | | | Saalparnee. |
| 22. | SWEDOPAGA | SUB DIA PHORETIC | Shobhanjana, Eranda, Arkka, Vrucheera, |
| | | | Punarnava, Yava, Thila, Kulatha, Maasha, |
| | | | Badara. |
| 23. | VAMANOPAGA | SUB EMETIC | Madhu, Madhuka, Kovidara, Karbudara, |
| | | | Neepa, Vidula, Bimbee, Sanapushpee, |
| | | | Sadapushpee, Prathyak Pushpee. |
| 24. | VIRECHANOPAGA | SUB PURGATIVE | Drakshaa, Kasmeera, Parooshka, Abhayaa, |
| | | | Aamalaka, Vibheetaki, Kuvala, Badara, |
| | | | Karkandu, Peelu. |
| 25. | ASTHAPANOPAGA | SUB CORRECTIVE | Thrivruth, Bilwa, Pippali, Kushta, |
| | | ENEMA | Sarshapa, Vacha, Vatsakaphala, |
| | | | Sathapushpa, Madhuka, Madanaphala. |
| 26. | ANUVASANOPAGA | SUB UNCTOUS | Raasna, Suradaru, Bilwa, |
| | | ENEMA | Madanaphala, Sathapushpa, Vrusheera, |
| | | | Punarnava, Swadamstraa, Agnimantha, |
| | | | Syonaaka. |
| 27. | SIROVIRECHANOPAGA | SUB ERRHINES | Jyothishmati, Kshavaka, Maricha, Pippali, |
| | | | Vidanga, Sigru, Sarshapa, Apamarga |
| | | | Thandula, Sweetha, Mahaswetha. |
| 28. | CHARDI NIGRAHAN | ANTI EMETIC | Jamboo Pallva, Amra Pallva, |
| | | | Mathulunga, Dadimaa, Yava, Shastika, |
| | | | Useera, Mruth, Lajja. |
| 29. | HIKKA NIGRAHANA | ANTI DYPSIC | Nagara, Dhanvayaasaka, Mustha, |
| | | | Parpataka, Chandana, Kirathatiktha, |
| | | | Guduchi, Hreebera, Dhanyka, Patola. |
| 30. | TRISHNA | ANTI HICCOUGH | Sati, Pushakara Moola, Badarabeeja, |
| | NIGRAHANA | | Kantakaarika, Brihati, |
| | | | Vruksharuhaa, Abhaya, Pippali, Duralabha, |
| | | | Kuleerashringi. |
| 31. | PUREESHA | INTESTINAL | Priyangu Anata, Aamraasthi, Katwanga, |
| | SANDHANEEYA | ASTRIGENTS | Lodhra, Mocharasa, Samanga, Dhathakee- |
| | | | Pushpa, Padmaa, Padma. |
| 32. | PUREESHA | FEACAL | Jamboo Twak, Sallkaa Twak, Kacchura, |
| | VIRAJANEEYA | DEPIGMENTER | Madhuka, Saalmale, Sreeveshtaka, |
| | | | Bhrishtamrutha, Payasyaa, Uthapal, Thila. |
| 33. | MOOTRA | ANTI DIURETIC | Jambu, Aamra, Plksha, Vata, Kapeethana, |
| | SAMGRAHANEEYA | | Udambra, Aswatha, Bhallataka, |
| | | | Asmanthaka, Somavalkala. |
| 34. | MUTRA | DIURETIC | Padma, Nalini, Saughandhika, |
| | VIRECHANEEYA | | Pundareeka,, Sathapathra, Utphala, |
| | | | Kumuda, Madhuka, Priyangu. |
| 35. | MUTRA | URINARY | Vrishadaanee, Swadamstra, Vasuka, |
| | VIRAJANEEYA | DEPIGMENTER | Vaseera, Pashanabheda, Darbha, Kusa, |
| | | | Kaasa, Gundra, Ithakata. |
| 36. | KASA HARA | ANTI TUSSIVES | Drakshaa, Abhaya, Aamalaka, Pippalli, |
| | | | Duralabha, Srungee, Kantakaarikaa, |
| | | | Vruscheera, Punarnava, Thamalaki. |
| 37. | SWASA HRA | ANTI DYSPONEIC | Sati, Pushkarmoola, Amlavetasa, Ela, Hingu, |
| | | | Aguru, Surasa, Thaamalki, Jeevanthi, |
| | | | Chandana. |
| 38. | JWARA HARA | ANTI PYRETIC | Sariba, Sarkara, Pathaa, Manjista, Draksha, |
| | | | Peelu, Parooshaka, Abhaya, |
| | | | Aamalaka, Vibhetaki. |
| 39. | SRAMA HARA | ENERGY | Draksha, Khajoora, Priyala, Badara, |
| | | COMPONSETOR | Dadima, Phalgu, Parooshaka, Ikshu, Yava, |
| | | | Acopic Shastika. |
| 40. | SWAYADHU HARA | ANTI PHLOGISTIC | Paatala, Agnimantha, Syonaka, Bilwa, |
| | | | Kaasmarya, Kantakarika, Brihati, |
| | | | Saalparne, Prisnaparni, Gokshura. |
| 41. | DAHA PRAMASANA | REFRIGERANT | Lajja, Chandana, Kaasmarya, Madhuka, |
| | | | Sarkkara, Uthpala, Useera, Saariva, |
| | | | Guduchi, Hreebera. |
| 42. | SEETHA | CALEFACIENT | Thagara, Aguru, Dhanyaka, Srungavera, |
| | PRASAMANA | | Bhootheka, Vachaa, Kantakari, Agnimantha, |
| | | | Syonaka, Pippali. |
| 43. | UDARDA | ANTI ALLERGIC | Tinduka, Priyala, Badara, Khadira, Kadara, |
| | PRASAMAN | | Arimeda, Sapthaparna, Awsakarna, Arjun, |
| | | | Asana. |
| 44 | ANGA MARDA | ANTI BODYACHE | Vidarigandha, Prushniparni, Brihati, Kanta |
| | PRASAMANA | | Karika, Eranda, Kaakolee, Chandana, |
| | | | Useera, Elaa, Asoka. |
| 45 | SOOLA | ANTI SPASMODIC | Pippali, Pippalimoola, Chavya, Chitraka, |
| | PRASAMANA | | Srungaveera, Maricha, Ajamoda, |
| | | | Ajagandha, Ajaji, Gandeera. |
| 46 | SONITHA | HAEMOSTATIC | Madhu, Madhuka, Rudhira, Mocharasa, |
| | PRASAMAN | | Mruthkapala, Lodhra, Gairika, Priyangu, |
| | | | Sarkkar, Lajja. |
| 47 | VEEDANA STHAPAN | ANALGESIC | Saala, Katphala, Kadamba, Padmaka, |
| | | | Thumba, Mocharasa, Sireesha, Vanjjula, |
| | | | Elavaluka, Asoka. |
| 48 | SAMGNA | RESUCIATIVE | Hingu, Kaidarya, Arimeda, Vacha, |
| | STHAPANA | | Choraka, Vayahrustha, Golomee, Jatila, |
| | | | Palankasha, Asokarohine. |
| 49 | PRAJA STHAPANA | ANTI | Aindree, Bramhee, Sathavari, |
| | | ABORTIFICIENT | Sahasraveerya, Amogha, Avyatha, |
| | | | Sivaa, Arishtaa, Vatya Pushpee, |
| | | | Vishwaksenakanthaa. |
| 50. | VAYAH STHAPANA | REGULATING | Amrutha, Abhaya, Dhathree, Yuktha, |
| | | AGING PROCESS | Swetha, Jeevanthi, Athirasa, |
| | | | Mandookaparni, Sthira, Punarnava. |

TABLE 6
GANOUSHADHA VARGA

Amla Panchaka - (I) Kola, Dadima, Vrikshamla, Chukrika, Amlavetasa.
Amla Panchaka (Ii) - Beejapuraka, Jambeera, Naranga, Amlavetasa,
Anjana Trayam - Pushpanjanam, Kala Anjanam, Rasaanjanam,
Ashtadhatu - Swarna, Rajata, Kamsya, Seesam, Tamra, Vanga, Loha, Parada
Ashtagandha - Karpura, Chandana, Musta, Kumkuma (Saffron), Devadaru, Gorochana,
Kesari, Useera
Ashta Kshara - Palasa, Mushaka, Apamarga, Tilanalakshara, Yava Kshara, Sarja Kshara,
Arka, Snuhi.
Ashtavarga - Jeevaka, Rushabhaka, Meda, Mahameda, Kakoli, Ksheera Kakoli, Vriddhi,
Buddhi.
Abhava Pratinidhi Dravayas
Medha - Aswagandha
Mahameda - Scribal
Jeevaka, Rushabhaka - Guduchi, Vamsalocvhana
Buddhi - Bala
Vriddhi - Mahabala
Upavisha Trayam - Nirvisha, Ativisha, Langali
Upavisha Saptaka - Arka Ksheeram, Snuhi Ksheeram, Langali, Karaveeraka, Gunja,
Ahiphena, Dattura
Kantaka Trayam - Dushsparsha, Brihati, Agnidamana.
Kantaka Trayam (II) Sunthi, Guduchi, Dushsparsha
Kantakari Trayam - Gokshura, Vakudu, Mulaka
Chaturjataka - Twak, Ela, Dalchini, Nagakesara
Katu Chaturjataka - Ela, Twak, Patram, Maricha
Chaturshanas - Shunti, Pippali, Maricha, Pippalimoola
Chaturbeeja - Methika, Chandrasoora, Kalajaji, Yavanika,
Chaturbhradaka - Sunthi, Ativisha, Musta, Guduchi,
Chaturgranthi - Sunthi, Lasuna, Ardraka, Pippalimoola,
Chatusama - Jatifala, Lavanga, Jeeraka, Tankanakshara,
Triksharas - Sajjikshara, Yavakshara, Tankanakshara.
Trikatu - Sunthi Pippali, Maricha.
Trikatuushanas - Pippali, Pippalimoola, Sunthi
Trikarshikas - Sunthi, Ativisha, Musta.
Trijatakas - Ela, Lavanga, Dalchini (Twak)
Triphala - Hareetaki, Bibhitaki, Amalaki.
Madhuratriphalas - Draksha, Kashmarya, Kharjura.
Sugandha Triphala - Jayaphala, Ela, Lavanga.
Trimadhura - Ghuta, Guda, Madhu.
Tirsama - Hareetaki, Sunthi, Guda.
Trisugandha - Twak, Patra, Ela.
Trisarkara - Sugar From Sugarcane, Sugar From Madhu, And Seeta.
Dasakshara - Sheegru, Moolaka, Chincha, Chitraka, Ardraka, Nimba, Ikshu, Apamarga,
Kadali, Palasa
Dasamootras - Hasthi, Mahisha, Unstra, Go, Aja, Avika, Ashwa, Khara, Purusha, Stree.
Dasamoolas - Bilva, Agnimantha, Shyonaka, Patala, Kashmari, Shaliparni, Prushniparni,
Brihati, Kantakari, Gokshura.
Dashangadhoopa - Madhu, Musta, Ghrita, Gandha, Guggulu, Agaru, Shilajit, Devadaru,
Silhaka.
Navadhatus - Swarna, Rajata, Tamra, Naga, Vanga, Teekshna Loha, Kanthaloha,
Kamsya.
Navaratna - Manikya, Amukta, Vidruma, Tarkshya, Pushparaga, Neela, Gomedika,
Vaidurya, Vajra.
Panchakolas - Pippali, Pippalimoola, Chavya, Chitraka, Nagara.
Panchakolas (2) - Hareetaki, Ajamoda, Souvarchalalavana, Maricha, Sunthi.
Panchaksharas - Palasha, Moolaka, Yavakshara, Souvarchika, Tilanala.
Panchaganas - Prushniparni, Brihati, Kantakari, Veedari, Gokshura,
Panchagavya - Gomootra, Gomaya, Goksheera, Godadhi, Goghrita..
Panchatwaka - Vata, Mahavata, Udumbara, Vetasa, Ashwattha,
Panchatwaka - Nyagrodha, Udumbara, Ashwttha, Parisha, Plava.
Panchapallava - Amra, Jambu, Kapittha, Beejapuraka, Bilva.
Panchapllava - Vata, Ashwattha, Pareesha, Jamboo, Udumbara.
Panchapittas - Varaha, Aja, Mahisha, Matsya, Mayura
Panchabeejas - Sarshapa, Ahiphena, Ajamoda, Jeeraka, Yavani.
PanchaMahavishas - Gauripashana, Talaka, Manaasheela, Vatsanabhha, Naja.
(Sarpavisha).
PanchaMahisha - Mahishamaya, Mootra, Ksheera, Dadhi, Ghrita.
Laghu Panchamoola - Shaliparni, Prushniparni, Brihathi, Kantakari, Gokshura.
Brihatpanchmopolas - Bilva, Agnimantha, Shyonaka, Patala, Kashmari.
Madhyampanchmoolas - Mudgaparni, Mashaparni, Eranda, Punarnava, Bala.
Balapanchmoolas - Haridra, Guduchi, Punarnava, Vidarikanda, Oddichettu
Jeevaka Panchamoola - Jeevaka, Rushabhaka, Shatavari, (Small & Big) Manubala.
Trinapanchmoola - Kusha, Kasa, Darbha, Nala, Kandekshuka
Pancha Mootra - Go, Aja, Avika, Mahisha, Khara.
Pancharatna - Kanakam, Hirakam, Nilam, Padmaragam, Mouktika,
Panchlavana - Saindhvam, Sarja, Bidala, Audbhid, Samudra.
Panchasama - Sunthi, Pippali, Sauvarchala, Hareetaki,
Panchasama (Ii) - Saindhava, Chitrakamoola, Hareetaki, Pippali, Amalaki.
Pancha Siddh Oushadh - Tailakanda, Sudhakanda, Kroudakanda, Dirasena Matsyakshi.
Panchasugandha - Kumkuma, Agaru, Karpura, Kasturi, Chandana.
Panchasurana, - Vanya & Gramya Surana, Mala Kanda,
Panchang - Patra, Pushpa, Kanda, Moola, Phala
Panchang (Ii) - Sunthi, Daruharidra, Shigru Phala, Sarshapa, Bhringaraja.
Panchamrita - Go - Dugdha, Dadhi, Ghrita, Madhu, Sarkara,
Panchamrita (Medicinal) - Guduchi, Sunthi, Gokshura, Kalimushali, Shatavari
Panchustikanjikam - Shali, Yava, Chanaka, Kala, Kullattha.
Shad Rasa's - Madhura, Amla, Lavana, Katu, Tikta, Kashaya.
Shat Kshara -
Shat Sugandha - Jatiphala, Karpura, Lavanga, Sugandha Bala, Kankola, Kraramuka.
Shadganas - Pranakara - Sadhyocooked Meat & Rice (Hot), Rice With Milk, Coitus With Young
Women, Drinking Ghritam, Hot Water Bath.
Pranahara - Spoiled Meat, Coitus With Aged Women, Sitting Opposite To Morning Sun,
Tatuna Dadhi (New Curd), Coitus With Women In The Evening (Asurasandhya).
Early Morning Sleep.
Shad Ushana - Pippali, Pippalimoola, Chavya, Chitraka, Sunthi.
Uapvisha Saptakam -
Sapta dhatu - Rasa, Rakta, Mamsa, Meda, Asthi Majja, Shukra.
Sapta dhatu - (Loha, Or Dhatus) Swarna, Rajata., Tamra, Vanga Yashada, Loha, Naga.
Sapta uapadhatus - (Related To Shareera) Stanya, Rajas, Vasa, Sweda, Danta, Kasha, Ojas.
(Related To Dhatus) - Swarna Makshika, Tara Makshika, Tuttha, Kankushta, Rasaka,
Sindoora, Lohakitta.
Shat Kwatha - Pachana. Shodhana, Kledana, Shamana, Deepana, Shoashana,
Sapta Santarpanas - Draksha, Dadima, Khurjura, Triturated With Sarkara Panaka, And Added
With Laja, Ghrita, Madhu.
Sapta Uparatnas - Vaikranta, Suryakanta, Chandtrakanata, Karpura, Sphatika, Pheroja
Kachamani.

TABLE 7
DOSHA BHEDAS

| | |
|---|---|
| 1. | VRUDHA VATA, KAPHA PITTA SAMA |
| 2. | VRUDHA PITTA, KAPHA VATA SAMA |
| 3. | VRUDHA KAPHA, VATA PITTA SAMA |
| 4. | VRUDHA VATA KAPHA, PITTA SAMA |
| 5. | VRUDHA KAPHA PITTA, VATA SAMA |
| 6. | VRUDHA VATA PITTA, KAPHA SAMA |
| 7. | VRUDHA VATA, VRUDHATARA KAPHA SAMA PITTA |
| 8. | VRUDHA PITTA, VRUDHATARA KAPHA SAMA VATA |
| 9. | VRUDHA KAPHA, VRUDHATARA VATA. SAMA PITTA |
| 10. | VATA PITTA VRUDHATARA, KAPHA VRIDHI |
| 11. | VRUDHATARA KAPHA PITTA, VRUDHA VATA |
| 12. | VRUDHATARA KAPHA VATA, VRUDHA PITTA |
| 13. | VRUDHATARA VATA PITTA KAPHA |
| 14. | VATA PITTA ATI VRUDHI, KAPHA SAMA VRUDHI |
| 15. | VATA KAPHA ATI VRUDHI, PITTA SAMA VRUDHI |
| 16. | PITTA KAPHA ATI VRUDHI, VATA SAMA VRUDHI |
| 17. | VATA, KAPHA SAMA VRUDHI, PITTA ATI VRUDHI |
| 18. | VATA PITTA SAMA VRUDHI, KAPHA ATI VRUDHI |
| 19. | PITTA KAPHA SAMA VRUDHI, VATA ATI VRUDHI |
| 20. | VRUDHA VATA VRUDHA TARA PITTA VRUDHA TAMA |
| | KAPHA |
| 21. | VRUDHA VATA VRUDHA TARA KAPHA VRUDHA TAMA |
| | PITTA |
| 22. | VRUDHA PITTA VRUDHA TARA KAPHA VRUDHA TAMA |
| | VATA |
| 23. | VRUDHA PITTA VRUDHA TARA VATA VRUDHA TAMA |
| | KAPHA |
| 24. | VRUDHA KAPHA VRUDHA TARA VATA VRUDHA TAMA |
| | PITTA |
| 25. | VRUDHA KAPHA VRUDHA TARA PITTA VRUDHA TAMA |
| | VATA |
| 26. | KSHEENA VATA, KAPHA PITTA SAMA |
| 27. | KSHEENA PITTA, KAPHA VATA SAMA |
| 28. | KSHEENA KAPHA, VATA PITTA SAMA |
| 29. | KSHEENA VATA KAPHA, PITTA SAMA |
| 30. | KSHEENA KAPHA PITTA, VATA SAMA |
| 31. | KSHEENA VATA PITTA, KAPHA SAMA |
| 32. | KSHEENA VATA, KSHEENATARA KAPHA SAMA PITTA |
| 33. | KSHEENA PITTA, KSHEENATARA KAPHA SAMA VATA |
| 34. | KSHEENA KAPHA, KSHEENATARA VATA. SAMA PITTA |
| 35. | VATA PITTA KSHEENATARA, KAPHA VRIDHI |
| 36. | KSHEENATARA KAPHA PITTA, KSHEENA VATA |
| 37. | KSHEENATARA KAPHA VATA, KSHEENA PITTA |
| 38. | KSHEENATARA VATA PITTA KAPHA |
| 39. | VATA PITTA ATI KSHEENA, KAPHA SAMA KSHEENA |
| 40. | VATA KAPHA ATI KSHEENA, PITTA SAMA KSHEENA |
| 41. | PITTA KAPHA ATI KSHEENA, VATA SAMA KSHEENA |
| 42. | VATA, KAPHA SAMA KSHEENA, PITTA ATI KSHEENA |
| 43. | VATA PITTA SAMA KSHEENA, KAPHA ATI KSHEENA |
| 44. | PITTA KAPHA SAMA KSHEENA, VATA ATI KSHEENA |
| 45. | KSHEENA VATA KSHEENA TARA PITTA KSHEENA TAMA |
| | KAPHA |
| 46. | KSHEENA VATA KSHEENA TARA KAPHA KSHEENA TAMA |
| | PITTA |
| 47. | KSHEENA PITTA KSHEENA TARA KAPHA KSHEENA TAMA |
| | VATA |
| 48. | KSHEENA PITTA KSHEENA TARA VATA KSHEENA TAMA |
| | KAPHA |
| 49. | KSHEENA KAPHA KSHEENA TARA VATA KSHEENA TAMA |
| | PITTA |
| 50. | KSHEENA KAPHA KSHEENA TARA PITTA KSHEENA TAMA |
| | VATA |
| 51. | VRUDHA VATA SAMA PITTA, KSHEENA KAPHA |
| 52. | VRUDHA VATA, SAMA KAPHA, KSHEENA PITTA |
| 53. | VRUDHA PITTA, SAMA VATA KSHEENA KAPHA |
| 54. | VRUDHA PITTA, SAMA KAPHA KSHEENA VATA |
| 55. | VRUDHA KAPHA, SAMA VATA KSHEENA PITTA |
| 56. | VRUDHA KAPHA, SAMA PITTA KSHEENA VATA |
| 57. | VATA KSHAYA, VRUDHA KAPHA PITTA |
| 58. | KSHEENA PITTA, VRUDHA KAPHA VATA |
| 59. | KSHEENA KAPHA, VRUDHA VATAPITTA |
| 60. | KSHEENA VATA PITTA VRUDHA KAPHA |
| 61. | KSHEENA VATA KAPHA, VRUDHA PITTA |
| 62. | KSHEENA PITTA KAPHA, VRUDHA VATA |
| 63. | SAMA VATA PITTA KAPHA |

TABLE 8
PHYSICO CHEMICAL PROPERTIES OF THE MEDICINES
LIKE TASTE ARE CORRELATED TO CHEMICAL AND
THERAPEUTIC PROPERTIES OF THE TRADITIONAL
MEDICINES.

GUNA (PROPERTIES)

| | | Uttama | Madhyama | Avara |
|---|---|---|---|---|
| S. No | RASA | BEST | MEDIUM | LEAST |
| 1. | Rooksha | Kashaya | Katu | Tikta |
| | (DRY) | | | |
| 2. | Snigdha | Madhura | Amla | Lavana |
| | (VISCOUS) | | | |
| 3. | Usna | Lavana | Amla | Katu |
| | (HOT) | | | |
| 4. | Sheeta | Kashaya | Madhura | Tikta |
| | (COLD) | | | |
| 5. | Guru | Madhura | Kashaya | Lavana |
| | (HEAVY) | | | |
| 6. | Laghu | Tikta | Katu | Amla |
| | (LIGHT) | | | |

TABLE 9
PHYSICO CHEMICAL PROPERTIES OF THE MEDICINES LIKE TASTE
ARE USED TO UNDERSTAND THE CHEMICAL AND THERAPEUTIC
PROPERTIES OF THE MEDICINES BUT THE CHEMICAL PROPERTIES
IN THE MODERN PROPERTIES NEEDS TO BE ESTABLISHED

| | | GUNA (PROPERTIES) | | | | | |
|---|---|---|---|---|---|---|---|
| | | Rooksha | Snigdha | Sheetha | Usna | Guru | Laghu |
| S. No | RASA | DRY | VISCOUS | COLD | HOT | HEAVY | LIGHT |
| 1. | Madhura | | * | * | | * | |
| 2. | Amla | | * | | * | | * |
| 3. | Lavana | | * | | * | * | |
| 4. | Katu | * | | | * | | * |
| 5. | Tikta | * | | * | | | * |
| 6. | Kashaya | * | | * | | * | |

The traditional philosophies always use PANCHABHUTAS as the basis
Derivation Of Shadrasas From Pancha Maha Bhootas

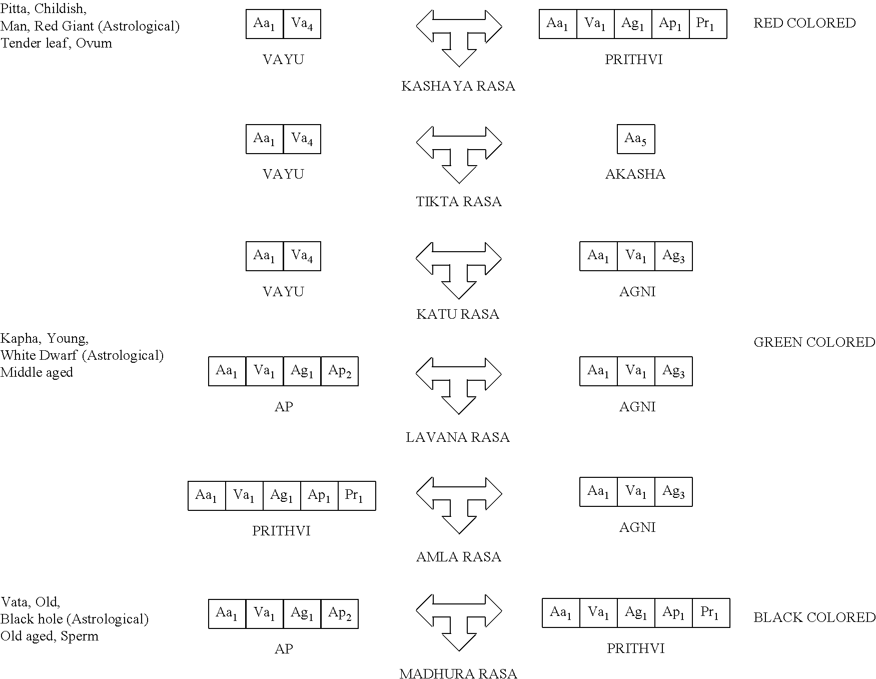

TABLE 11

| | | | | | |
|---|---|---|---|---|---|
| S. | | | | | |
| NO. | AKASHA | VAYU | AGNI | JALA | PRITHVI |

GUNA (PHYSICAL PROPERTIES)

| | | | | | | |
|---|---|---|---|---|---|---|
| 1 | Laghu (light) | * | * | * | | |
| 2 | Guru (heavy) | | | | | * |
| 3 | Seetha (cold) | | | | * | |
| 4 | Usna (hot) | | | | | |
| 5 | Snigdha | | | | * | |
| | (unctous) | | | | | |
| 6 | Rooksha | | | * | | * |
| | (dry) | | | | | |
| 7 | Manda | | | | * | * |
| | (slow) | | | | | |
| 8 | Teekshna | | | * | | |
| | (sharp) | | | | | |
| 9 | Sthira (inert) | | | | | * |
| 10 | Sara | | | | * | |
| | (mobile) | | | | | |
| 11 | Mrudu (soft) | * | | | * | |
| 12 | Kathina | | | | | * |
| | (rough) | | | | | |
| 13 | Vishada | * | * | * | | |
| | (clear) | | | | | |
| 14 | Picchila | | | | * | |
| | (slimy) | | | | | |
| 15 | Slakshna | | | * | | |
| | (yeilding) | | | | | |
| 16 | Khara | | * | | | |
| | (rough) | | | | | |
| 17 | Sookshma | * | * | * | | |
| | (subtle) | | | | | |
| 18 | Sthoola | | | | | * |
| | (gross) | | | | | |
| 19 | Sandra | | | | | * |
| | (dense) | | | | | |
| 20 | Drava (fluid) | | | | * | |
| | Sushka | | * | * | | |
| | Vyavaee | * | * | | | |

VEERYA (POTENCY)

| | | | | | | |
|---|---|---|---|---|---|---|
| 1 | Laghu (light) | * | * | * | | |
| 2 | Guru (heavy) | | | | * | * |
| 3 | Seetha (cold) | | | | * | * |
| 4 | Usna (hot) | | | * | | |
| 5 | Snigdha | | | | * | |
| | (unctous) | | | | | |
| 6 | Rooksha | | * | | | |
| | (dry) | | | | | |
| 7 | Manda | * | | | | |
| | (slow) | | | | | |
| 8 | Teekshna | | | * | | |
| | (sharp) | | | | | |

TABLE 12

| | | | | | |
|---|---|---|---|---|---|
| S. | | | | | |
| NO. | AKASHA | VAYU | AGNI | JALA | PRITHVI |

RASA (TASTE)

| | | | | | | |
|---|---|---|---|---|---|---|
| 1 | Madhura | | | | * | * |
| | (Sweet) | | | | | |
| 2 | Amla (Sour) | | | *• | * | • |
| 3 | Lavana | | | *• | • | * |
| | (Salt) | | | | | |
| 4 | Tikta(Bitter) | * | * | | | |
| 5 | Katu | | * | * | | |
| | (Pungent) | | | | | |
| 6 | Kashaya | * | | | | * |
| | (Astringent) | | | | | |

MANASIKA DOSHA

| | | | | | | |
|---|---|---|---|---|---|---|
| 1 | Satwa | * | | | | |
| 2 | Rajo | | * | | | |
| 3 | Satwa + | | | * | | |
| | Rajo | | | | | |
| 4 | Satwa + | | | | * | |
| | Tamo | | | | | |
| 5 | Tamo | | | | | * |

* SUSRUTHA
• CHARAKA

TABLE 13
NAKSHATRA VANA

| | | | PADA | SANSKRIT | |
|---|---|---|---|---|---|
| S. NO. | ZODIAC SIGN | NAKSHTRA | (CHARANA) | NAME | BOTANICAL NAME |
| 1. | ARIES | Aswini | 1, 2, 3, 4 | Kupilu | Strychnos nuxvomica |
| | | Bharani | 1, 2, 3, 4 | Amalaki | Emblica officinalis |
| | | Krithika | 1 | Oudumbara | Ficus glomerulata |
| 2. | TAURUS | Krithika | 2, 3, 4, | Oudumbara | Ficus glomerulata |
| | | Rohini | 1, 2, 3, 4 | Jambu | Syzygium cumini |
| | | Mrigashira | 1, 2, | Khadira | Acacia catechu |
| 3. | GEMINI | Mrigashira | 3, 4, | Khadira | Acacia catechu |
| | | Arudra | 1, 2, 3, 4 | Kasmari | Gmelina arborea |
| | | Punarvasu | 1, 2, 3 | Vamsha | Dendrocalamus strictus |
| 4. | CANCER | Punarvasu | 4 | Vamsha | Dendrocalamus strictus |
| | | Pushya | 1, 2, 3, 4 | Aswatha | Ficus religiosa |
| | | Ashlesha | 1, 2, 3, 4 | Nagakesara | Mesua ferrea |
| 5. | LEO | Magha | 1, 2, 3, 4 | Nygrodha | Ficus bengalensis |
| | | Pubba | 1, 2, 3, 4 | Plaksha | Butea monosperma |
| | | Uttara | 1 | Plaksha | Ficus infectoria |
| 6. | VIRGO | Uttara | 2, 3, 4 | Plaksha | Ficus infectoria |
| | | Hasta | 1, 2, 3, 4 | Amrataka | Spondias mangifera |
| | | Chitta | 1, 2 | Bilwa | Aegle marmelos |
| 7. | LIBRA | Chitta | 3, 4 | Bilwa | Aegle marmelos |
| | | Swathi | 1, 2, 3, 4 | Arjuna | Terminalia arjuna |
| | | Vishaka | 1, 2, 3 | Swadukantaka | Flacourita indica |
| 8. | SCORPIO | Vishaka | 4 | Swadukantaka | Flacourita indica |
| | | Anuradha | 1, 2, 3, 4 | Bakula | Mimusops elengi |
| | | Jesta | 1, 2, 3, 4 | Shalmali | Salmalia malabarica |
| 9. | SAGITTARIUS | Moola | 1, 2, 3, 4 | Chandana | Santalum album |
| | | Purvashada | 1, 2, 3, 4 | Tinisa | Ougenia dalbegioides |
| | | Uttarashada | 1 | panasa | Artocarpus integrifolia |
| 10. | CAPRICON | Uttarashada | 2, 3, 4, | Panasa | Artocarpus integrifolia |
| | | Sravana | 1, 2, 3, 4 | Arka | Calotropis procera |
| | | Dhanishta | 1, 2, | Shami | Acacia ferruginia |
| 11. | AQUARIUS | Dhanishta | 3, 4, | Shami | Acacia ferruginia |
| | | Shatabhisha | 1, 2, 3, 4, | Kadamba | Anthocephalus cadamba |
| | | Purvabhadra | 1, 2, 3 | Nimba | Azadirachta indica |
| 12. | PISCES | Purvabhadra | 4 | Nimba | Azadirachta indica |
| | | Uttarabhadra | 1, 2, 3, 4 | Amra | Mangifera indica |
| | | REVATHI | 1, 2, 3, 4 | Madhuka | Madhuka indica |

TABLE 14
RASI VANA

| | | LORD | | SANSRIT | |
|---|---|---|---|---|---|
| S. NO. | ZODIAC SIGN | (PLANET) | ELEMENT | NAME | BOTANICAL NAME |
| 1. | ARIES | KUJA | AGNI | RAKTA | Pterocarpus santalinus |
| | | | | CHANDANA | |
| 2. | TAURUS | SHUKRA | JALA | SAPTA PARNA | Alstonia scholaris |
| 3. | GEMINI | BUDHA | PRITHVI | PANASA | Artoarpus longifolius |
| 4. | CANCER | CHANDRA | JALA | PALASHA | Butea monosperma |
| 5. | LEO | RAVI | AGNI | PATALA | Stereospermum |
| | | | | | chelenoides |
| 6. | VIRGO | BUDHA | PRITHVI | AMRA | Mangifera indica |
| 7. | LIBRA | SHUKRA | JALA | BAKULA | Mimusops elengi |
| 8. | SCARPIO | KUJA | AGNI | KHADIRA | Acacia catechu |
| 9. | SAGITTARIUS | GURU | AKASHA | ASWATHA | Ficus religiosa |
| 10. | CAPRICORN | SHANI | VAYU | SHIMSHIPA | Dalbergia latifolia |
| 11. | AQUARIUS | SHANI | VAYU | SHAMI | Acacia ferruginea |
| 12. | PISCES | GURU | AKASHA | NYGRODHA | Ficus benghalensis |

TABLE 17
In the traditional philosophies the diseases are due to vitiation
(Imbalance) Of the Basic properties of Tri Doshas

| S. NO. | DISEASE | VITIATED DOSHA |
|---|---|---|
| 1. | JWARA | VATAPITTA/KAPHA/TRIDOSHA |
| 2. | ARSHAS | TRIDOSHA |
| 3. | VISARPA | TRIDOSHA |
| 4. | UNMADA | TRIDOSHA RAJO AND TAMO |
| 5. | APASMARA | TRIDOSHA RAJO TAMO |
| 6. | TRISHNA | TRIDOSHA PITTA PRADHANA |
| 7. | SHEETA PITTA | TRIDOSHA AND VATA PRADHANA |
| 8. | UDARDA | TRIDOSHA KAPHA PRADHANA |
| 9. | MUTRA KRICHRA | TRIDOSHA |
| 10. | ASMARI | TRIDOSHA |
| 11. | PRAM EHA | TRIDOSHA |
| 12. | SHODHA | TRIDOSHAJA |
| 13. | KUSHTA | TRIDOSHAJA |
| 14. | PANDU | PITTA PRADHANA |
| 15. | KAMALA | PITTA PRADHANA |
| 16. | RAKTA PITTA | PITTA AND RAKTA |
| 17. | VATA RAKTA | PITTA AND RAKTA |
| 18. | AMLAPITTA | PITTA |
| 19. | NEELIKA | PITTA |
| 20. | KAKSHAYA | PITTA |
| 21. | MEDO ROGA | KAPHA |
| 22. | SWASA | KAPHA, VATA |
| 23. | KASA | KAPHA VATA |
| 24. | HIKKA | KAPHA, VATA |
| 25. | GALAGANDA | KAPHA VATA |
| 26. | ARDITHA | VATA |
| 27. | VATA VYADHI | VATA |
| 28. | PAKSHAGHATA | VATA |
| 29. | EKANGA VATA | VATA |
| 30. | GRIDRASI | VATA |
| 31. | UDAVARTHA | VATA |
| 32. | AKSHEPAKA | VATA |

TABLE 18
Table 18: Relation Of Humors, Properties,
And Different Parts Of The Human Body - An Ayurvedic Approach Approach

| | TRI | | PANCHABHUTA | | |
|---|---|---|---|---|---|
| | DOSHA | TRI | (PHYSICAL | SAPTA | CHEMICAL |
| Sl. No | (Hara) | MALAS | PROPERTIES) | DHATUS | PROPERTIES |
| | Vata, | 1. Purisha | 1. Prithivi | 1. Rasa | 1. Rasa |
| | Pitta, | 2. Mutra | 2. Ap | 2. Rakta | (Shadruchi's) |
| | Kapha. | 3. Sweda | 3. Teja | 3. Mamsa | a. Madhura |
| | | | 4. Vayu | 4. Medas | b. Amla |
| | | | 5. Akasha | 5. Asthi | c. Lavana |
| | | | | 6. Majja | d. Katu |
| | | | | 7. Shukra | e. Tikta |
| | | | | | f. Kashaya |
| | | | | | 2. Guna-: Broadly classified into 3 |
| | | | | | groups |
| | | | | | 1. Vaisheshik 2. Samanya 3. Atma |
| | | | | | Mostly used are: |
| | | | | | Guru (Heavy) |
| | | | | | Laghu (Light) |
| | | | | | Sheeta (Cold) |
| | | | | | Ushna (Hot) |
| | | | | | Snigdha (Soft, Lubricated, Supple) |
| | | | | | Rooksha (Dry) |
| | | | | | Manda (Slow) |
| | | | | | Teekshna (Sharp) |
| | | | | | 3. Veerya-2 |
| | | | | | 4. Vipaka-3 |
| | | | | | 5. Prabhava-innumerable |

| | | EFFECT ON | | |
|---|---|---|---|---|
| | | DOSHAS | | |
| | | (DECREASING | | RELATION |
| | MAHABHUTA | THE | | ON VIPAKA |
| | RELATIONS | DOSHA) | | (POST |
| | WITH | DUE TO | | ASSIMILATIVE |
| Sl. No | DHATUS | DHATUS | RELATION ON GUNA | EFFECT) |
| | a. | a. Pitta Vata | a. Guru, Sheeta, Snigdha | a. Madhura |
| | Prithivi + Ap | Hara | b. Ushna, Laghu, Snigdha | b. Amla |
| | b. Agni + | b. Vata Hara | c. Ushna, Laghu, Snigdha | c. Madhura |
| | Prithive | c. Vata Hara | d. Ushna, Laghu, Ruksha | d. Katu |
| | c. Jala + Agni | d. Kapha Hara | e. Sheeta, Laghu, Ruksha | e. Katu |
| | d. Aksha + Vayu | e. Kapha Pitta | f. Sheeta, Guru, Ruksha | f. Katu |
| | Eagni + Vayu | Hara | | |
| | f. Prithive + Vayu | f. Kapha Pitta | | |
| | | Hara | | |

TABLE 19
PROPERTIES OF THE DRUGS USED FOR VRANA SHODHANA AND ROP PROPERTIES OF THE
DRUGS USED FOR VRANA SHODHANA AND ROPANA

| | | | | | GUNA | | | | | DRAVYA |
|---|---|---|---|---|---|---|---|---|---|---|
| S. | SANSKRIT | | BOTANICAL | FAMILY | (PROPERTIES) | | | | DOSHA | PRAYOGARHA |
| NO. | NAME | | NAME | NAME | Guna | Rasa | Veerya | Vipaka | KARMA | VYADHI |
| 1. | Triphala | Amalaki | Phyllanthus | Euphorbiaceae | Sara | All six | | Madhura | Kapha | Meha, Kushta, |
| | | | emblica | | | Rasas | | | Pitta hara, | Vishamajwara |
| | | Hareethaki | Terminalia | Combretaceae | | | | | Chaksusya, | nashaka |
| | | | chebula | | | | | | Deepana, | (BP. |
| | | Vibheethaki | Terminalia | Combretaceae | | | | | Ruchya | Harrethakyadi/ |
| | | | bellerica, | | | | | | | 42) |
| 2. | Apamarga | | Achyranthes | Amaranthaceae | Laghu, | Katu, | Ushna | Katu | Kapha | Shoola, |
| | | | aspera | | Rookshna | Tikta | | | Vata hara | Adhmana, |
| | | | | | Teekshma | | | | Deepana | Chardi, arsas, |
| | | | | | | | | | Pachana | Udara, |
| | | | | | | | | | Shiro- | Vishoochika, |
| | | | | | | | | | virechana | Krimi, Kandu, |
| | | | | | | | | | | Sadyovrana |
| 3. | Guggulu | | Commiphora | Burseraceae | Sookshma, | Tikta, | Ushna | Katu | Kapha | Amavata, Vrana, |
| | | | mukkul | | Sara, | Kashaya | | | Vata hara, | Apachi, Meha, |
| | | | | | Pichchila, | | | | Rasayana, | Kusta, Grandhi, |
| | | | | | Laghu, | | | | Balya, | Shopha, |
| | | | | | Rooksha | | | | Bhagna | Gandamala, |
| | | | | | | | | | sandhana | Krimi |
| | | | | | GUNA | | | | | Dravya |
| S. | SANSKRIT | | BOTANICAL | FAMILY | (PROPERTIES) | | | | DOSHA | Prayogarha |
| NO. | NAME | | NAME | NAME | Guna | Rasa | Veerya | Vipaka | KARMA | Vyadhi |
| 4. | Bhallathaka | | Semecarpus | Anacardiaceae | Teekshna, | Madhura, | Ushna | Madhura | Kapha Vata | Vrana, Udara, |
| | | | anacardium | | Laghu, | Kashaya | | | hara, Chedana, | Kusta, Arshas, |
| | | | | | Snigdha | | | | Bhedhana, | Grahani, Gulma, |
| | | | | | | | | | Medhya, | Shopha, Anaha, |
| | | | | | | | | | Vata Pitta hara | Jwara, Krimi |
| | | | | | | | | | (Majja) | |
| 5. | Karanja | | Pongamia | Fabaceae | Laghu, | Tikta, | Ushna | Katu | Kapha Vata | Arsas, kusta, |
| | | | pinnata | | Teekshna | Katu, | | | hara | Prameha |
| | | | | | | Kashaya | | | Deepana | Visarpa, Gulma |
| | | | | | | | | | Pachana | Dusta Vrana |
| | | | | | | | | | Krimigna | Krimi, Unmada |
| 6. | Karaveera | | Nerium | Apocynaceae | Laghu, | Katu | Ushna | Katu | Kapha Vata | Kusta, Krimi |
| | | | indicum | | Rooksha | Tikta | | | hara | Kandu, Asmari |
| | | | | | Teekshna | | | | Kustghna | Dusta Vrana |
| | | | | | | | | | Vrana shodhana | Upadamsa |
| | | | | | | | | | Vrana ropana | Palithya |
| | | | | | | | | | | Nethra kopa |
| 7. | Kanchanara | | Bauhinia | Caesalpinaceae | Laghu | Kashaya | Sheetha | Katu | Kapha pitta | Raktapitta |
| | | | racemosa | | Rooksha | | | | hara | Raktapradara |
| | | | | | | | | | Grahi | Kusta, Krimi |
| | | | | | | | | | Muthrala | Gandamala |
| | | | | | | | | | Deepana | Vrana, Masurika |
| | | | | | | | | | Vrana ropana | |
| 8. | Kumari | | Aloe | Liliaceae | Guru | Tikta | Sheetha | Katu | KaphaVata hara | Yakrith vridhhi |
| | | | barbadens | | Snigdha | | | | Bhedana, | Pleeha vridhhi |
| | | | | | Pichhila | | | | Rasayana | Gulma, Kusta |
| | | | | | | | | | Brimhana | Shoola |
| | | | | | | | | | Balya, Vrishya | Vibhanda |
| 10. | Haridra | | Curcuma | Zinziberaceae | Laghu | Katu, | Ushna | Katu | Vata Kapha | Varnya, Lekhana, |
| | | | longa Linn. | | Rooksha | Tikta | | | hara | Vishghna |
| | | | | | | | | | | Prameha, Kushta, |
| | | | | | | | | | | Kandu, Krimi, |
| | | | | | | | | | | Aruchi, |
| | | | | | | | | | | Vrana, Kamala, |
| | | | | | | | | | | Pandu. |
| 11. | Nimba | | Azadirachta | Meliaceae | Laghu, | Tikta | Sheetha | katu | Pitta Kapha | Shrama, |
| | | | indica | | Grahi, | | | | hara Ahridya | Thrishna, Kasa, |
| | | | | | | | | | | Jwara, aruchi, |
| | | | | | | | | | | Krimi, Vrana, |
| | | | | | | | | | | Chardi, |
| | | | | | | | | | | Prameha, |
| | | | | | | | | | | Hrillasa |
| | | | | | | | | | | (BP. Guduchyadi/ |
| | | | | | | | | | | 89-92) |
| | | | | | GUNA | | | | | DRAVYA |
| S. | SANSKRIT | | BOTANICAL | FAMILY | (PROPERTIES) | | | | DOSHA | PRAYOGARHA |
| NO. | NAME | | NAME | NAME | Guna | Rasa | Veerya | Vipaka | KARMA | VYADHI |
| 1. | Triphala | Amalaki | Phyllanthus | Euphorbiaceae | Sara | All six | | Madhura | Kapha | Meha, Kushta, |
| | | | emblica | | | Rasas | | | Pitta hara, | Vishamajwara |
| | | Hareethaki | Terminalia | Combretaceae | | | | | Chaksusya, | nashaka |
| | | | chebula | | | | | | Deepana, | (BP. |
| | | Vibheethaki | Terminalia | Combretaceae | | | | | Ruchya | Harrethakyadi/ |
| | | | bellerica | | | | | | | 42) |

| 2. | Apamarga | Achyranthes | Amaranthaceae | Laghu, | Katu, | Ushna | Katu | Kapha | Shoola, |
|---|---|---|---|---|---|---|---|---|---|
| | | aspera | | Rookshna | Tikta | | | Vata hara | Adhmana, |
| | | | | Teekshma | | | | Deepana | Chardi, arsas, |
| | | | | | | | | Pachana | Udara, |
| | | | | | | | | Shiro- | Vishoochika, |
| | | | | | | | | virechana | Krimi, Kandu, |
| | | | | | | | | | Sadyovrana |
| 3. | Guggulu | Commiphora | Burseraceae | Sookshma, | Tikta, | Ushna | Katu | Kapha | Amavata, Vrana, |
| | | mukkul | | Sara, | Kashaya | | | Vata hara, | Apachi, Meha, |
| | | | | Pichchila, | | | | Rasayana, | Kusta, Grandhi, |
| | | | | Laghu, | | | | Balya, | Shopha, |
| | | | | Rooksha | | | | Bhagna | Gandamala, |
| | | | | | | | | sandhana | Krimi |
| | | | | GUNA | | | | | Dravya |
| S. | SANSKRIT | BOTANICAL | FAMILY | (PROPERTIES) | | | | DOSHA | Prayogarha |
| NO. | NAME | NAME | NAME | Guna | Rasa | Veerya | Vipaka | KARMA | Vyadhi |
| 4. | Bhallathaka | Semecarpus | Anacardiaceae | Teekshna, | Madhura, | Ushna | Madhura | Kapha Vata | Vrana, Udara, |
| | | anacardium | | Laghu, | Kashaya | | | hara, Chedana, | Kusta, Arshas, |
| | | | | Snigdha | | | | Bhedhana, | Grahani, Gulma, |
| | | | | | | | | Medhya, | Shopha, Anaha, |
| | | | | | | | | Vata Pitta hara | Jwara, Krimi |
| | | | | | | | | (Majja) | |
| 5. | Karanja | Pongamia | Fabaceae | Laghu, | Tikta, | Ushna | Katu | Kapha Vata | Arsas, kusta, |
| | | pinnata | | Teekshna | Katu, | | | hara | Prameha |
| | | | | | Kashaya | | | Deepana | Visarpa, Gulma |
| | | | | | | | | Pachana | Dusta Vrana |
| | | | | | | | | Krimigna | Krimi, Unmada |
| 6. | Karaveera | Nerium | Apocynaceae | Laghu, | Katu | Ushna | Katu | Kapha Vata | Kusta, Krimi |
| | | indicum | | Rooksha | Tikta | | | hara | Kandu, Asmari |
| | | | | Teekshna | | | | Kustghna | Dusta Vrana |
| | | | | | | | | Vrana shodhana | Upadamsa |
| | | | | | | | | Vrana ropana | Palithya |
| | | | | | | | | | Nethra kopa |
| 7. | Kanchanara | Bauhinia | Caesalpinaceae | Laghu | Kashaya | Sheetha | Katu | Kapha pitta | Raktapitta |
| | | racemosa | | Rooksha | | | | hara | Raktapradara |
| | | | | | | | | Grahi | Kusta, Krimi |
| | | | | | | | | Muthrala | Gandamala |
| | | | | | | | | Deepana | Vrana, Masurika |
| | | | | | | | | Vrana ropana | |
| 8. | Kumari | Aloe | Liliaceae | Guru | Tikta | Sheetha | Katu | KaphaVata hara | Yakrith vridhhi |
| | | barbadens | | Snigdha | | | | Bhedana, | Pleeha vridhhi |
| | | | | Pichhila | | | | Rasayana | Gulma, Kusta |
| | | | | | | | | Brimhana | Shoola |
| | | | | | | | | Balya, Vrishya | Vibhanda |
| 10. | Haridra | Curcuma | Zinziberaceae | Laghu | Katu, | Ushna | Katu | Vata Kapha | Varnya, Lekhana, |
| | | longa Linn. | | Rooksha | Tikta | | | hara | Vishghna |
| | | | | | | | | | Prameha, Kushta, |
| | | | | | | | | | Kandu, Krimi, |
| | | | | | | | | | Aruchi, |
| | | | | | | | | | Vrana, Kamala, |
| | | | | | | | | | Pandu. |
| 11. | Nimba | Azadirachta | Meliaceae | Laghu, | Tikta | Sheetha | katu | Pitta Kapha | Shrama, |
| | | indica | | Grahi, | | | | hara Ahridya | Thrishna, Kasa, |
| | | | | | | | | | Jwara, aruchi, |
| | | | | | | | | | Krimi, Vrana, |
| | | | | | | | | | Chardi, |
| | | | | | | | | | Prameha, |
| | | | | | | | | | Hrillasa |
| | | | | | | | | | (BP. Guduchyadi/ |
| | | | | | | | | | 89-92) |

TABLE 20
LEKHANEEYA DRAVYAS (1)

| | SANSKRIT | | | | GUNA | | | | | DRAVYA |
|---|---|---|---|---|---|---|---|---|---|---|
| | NAME | BOTANICAL | FAMILY | PART | (PROPERTIES) | | | | DOSHA | PRAYOGARHA |
| S. NO. | (CHARAKA) | NAME | NAME | USED | Guna | Rasa | Veerya | Vipaka | KARMA | VYADHI |
| 1. | Chitraka | Plumbago | PLumbaginaceae | Root | Laghu, | Katu | Ushna | Katu | Vata Kapha | Grahani, Kushta, |
| | | zelanica | | Bark | Ruksaha, | | | | hara, | Sotha, Arsa, |
| | | | | | Ushna, | | | | Deepana, | Krimi, Kasa, |
| | | | | | | | | | Grahi, | |
| | | | | | | | | | Pachana, | |
| 2. | Nagara | Cyperus | Cyperaceae | Rhizome | Sita, | Katu, | Seeta | | Kapha Pitta | Trishna, Jwara, |
| | | rotundus | | | Grahi, | Kashaya | | | hara, | Aruchi, |
| | | | | | | | | | Deepana, | Janthuhara, |
| | | | | | | | | | Pachana, | |
| | | | | | | | | | Grahi, | |
| 3. | Kushta | Sassurea lappa | Compositae | Rhizome | Laghu, | Katu, | Ushna | Katu | Vata Pitta | Vata Rakta, |
| | | | | | Ushna, | Tikta | | | hara, Kapha | Visarpa, Kasa, |
| | | | | | | | | | hara, | Kushta |
| | | | | | | | | | Sukrala, | |
| 4. | Haridra | Curcum long a | Zinziberaceae | Rhizome | Laghu, | Katu, | Ushna | Katu | Kapha | Twak Dosha, |
| | | | | | Rooksha, | Tikta | | | Pittahara, | Meha, Sotha, |
| | | | | | Ushna | | | | Varnya, | pandu, |
| 5. | Daru Haridra | Berberis | Berberidaceae | Rhizome | Laghu, | Katu, | Ushna | Katu | Kapha | Twak Dosha, |
| | | aristata | | | Rooksha, | Tikta | | | Pittahara, | Meha, Sotha, |
| | | | | | Ushna | | | | Varnya, | pandu, Netra |
| | | | | | | | | | | Karna roga. |

LEKHANEEYA DRAVYAS (2)

| | SANSKRIT | | | | GUNA | | | | | Dravya |
|---|---|---|---|---|---|---|---|---|---|---|
| | NAME | BOTANICAL | FAMILY | PART | (PROPERTIES) | | | | DOSHA | Prayogarha |
| S. NO. | (CHARAKA) | NAME | NAME | USED | Guna | Rasa | Veerya | Vipaka | KARMA | Vyadhi |
| 6. | Vacha | Acorus | Araceaae | Rhizome | Ushna, | Katu, | Ushna | Katu | Vatahara, | Apasmara, |
| | | Calamus | | | | Tikta | | | Kaphahara | Unmada, Soola, |
| | | | | | | | | | Vantihrit, | Vibanda, |
| | | | | | | | | | | Admana |
| 7. | Ativisha | Aconitum | Ranunculaceaea | Rhizome | Ushna | Katu, | Ushna | | Kapha | Atisara, Visha, |
| | | heterophylum | | | | Tikta, | | | Pittahara, | Kasa, Krimi |
| | | | | | | | | | Deepana | |
| | | | | | | | | | Pachana, | |
| 8. | Katurohini | Andrographis | Scrophulariaceae | Rhizome | Rooksha | Tikta | Seeta | Katu | Kapha Pitta | Jwara, Prameha, |
| | | paniculata | | | Seeta, | | | | Hara, | Swasa Kasa, |
| | | | | | Laghu, | | | | Bedana, | Daha, Kushta, |
| | | | | | | | | | Deepan | Krimi |
| 9. | Chirabilwa | Holoptelia | Ulmaceaae | Patra | Ushna, | Tikta, | Ushna | Katu | Pittahara, | Vamanahara, |
| | | integrifolia | | | | Kashaya | | | Stambana, | Arsa, Krimi, |
| | | | | | | | | | | Kushta, Prameha |
| 10. | Himavathee | Acorus | Araceaae | Rhizome | Ushna, | Katu, | Ushna | Katu | Vatahara, | Apasmara, |
| | | Calamus | | | | Tikta | | | Kaphahara | Unmada, Soola, |
| | | | | | | | | | Vantihrit, | Vibanda, |
| | | | | | | | | | | Admana |

TABLE 21
DEEPANEEYA DRAVYAS (1)

| | SANSKRIT | BO- | | | GUNA | | | | | DRAVYA |
|---|---|---|---|---|---|---|---|---|---|---|
| Sl. | NAME | TANICAL | FAMILY | PART | (PROPERTIES) | | | | DOSHA | PRAYOGARHA |
| NO. | (CHARAKA) | NAME | NAME | USED | Guna | Rasa | Veerya | Vipaka | KARMA | VYADHI |
| 1. | Maricha | Piper | Piperaceae | Fruit | Ruksha | Katu | Ushna | Katu | Kapha Vata | Swasa, Shoola, |
| | | nigrum | | | Ushna | | | | hara, | Krimi, |
| | | | | | Teekshna | | | | Pittakara, | |
| 2. | Pippali | Pippali | Piperaceae | Fruit | Anushna, | Katu | Anushna | Madhura | Vata Kapha | Swasa, |
| | | longum | | | snigdha, | | | | hara, | Kasa. Udara, |
| | | | | | laghu, | | | | Rsayana | Jwara, Kushta, |
| | | | | | | | | | Rechana, | Prameha, Gulma |
| 3. | Bhallathaka | Semecarpus | Anacardiaceae | Seeds | Teekshna, | Madhura, | Ushna | Madhura | Kapha Vata | Vrana, Udara, |
| | | anacardium | | | Laghu, | Kashaya | | | hara, | Kusta, Arshas, |
| | | | | | Snigdha | | | | Chedana, | Grahani, Gulma, |
| | | | | | | | | | Bhedhana, | Shopha, Anaha, |
| | | | | | | | | | Medhya, | Jwara, Krimi |
| | | | | | | | | | Vata Pitta | |
| | | | | | | | | | hara (Majja) | |
| 4. | Pippalimool | Pippali | Piperaceae | Root | Ushna, | Katu | Ushna | — | Kapha Vata | Anaha, |
| | | longum | | | laghu, | | | | hara, | PleehaSwasa, |
| | | | | | | | | | Bedhana, | Gulma, Kshaya |
| 5. | Chavya | Piper chaba | Piperaceae | Stem | Ushna, | Katu | Ushna | — | Kapha Vata | Anaha, |
| | | | | | laghu, | | | | hara, | PleehaSwasa, |
| | | | | | | | | | Bedhana, | Gulma, Kshaya |

DEEPANEEYA DRAVYAS (2)

| | | | | | GUNA | | | | | Dravya |
|---|---|---|---|---|---|---|---|---|---|---|
| S. | SANSKRIT | BOTANICAL | FAMILY | PART | (PROPERTIES) | | | | DOSHA | Prayogarha |
| NO. | NAME | NAME | NAME | USED | Guna | Rasa | Veerya | Vipaka | KARMA | Vyadhi |
| 6. | Chitraka | Plumbago | PLumbaginaceae | Root | Laghu, | Katu | Ushna | Katu | Vata Kapha | Grahani, Kushta, |
| | | zelanica | | Bark | Ruksaha, | | | | hara, | Sotha, Arsa, |
| | | | | | Ushna, | | | | Deepana, | Krimi, Kasa, |
| | | | | | | | | | Grahi, | |
| | | | | | | | | | Pachana, | |
| 7. | Nagara | Cyperus | Cyperaceae | Rhizome | Sita, | Katu, | Seeta | | Kapha Pitta | Trishna, Jwara, |
| | | rotundus | | | Grahi, | Kashaya | | | hara, | Aruchi, |
| | | | | | | | | | Deepana, | Janthuhara, |
| | | | | | | | | | Pachana, | |
| | | | | | | | | | Grahi, | |
| 8. | Ajamoda | Apium | Umbelliferae | Fruit | Laghu, | Katu | Ushna | Katu | KaphaVata | Hridya, Krimi, |
| | | graveolens | | | Ushna, | | | | hara, | Hikka, Chardi |
| | | | | | Vidahi, | | | | Deepani, | |
| | | | | | | | | | Balya, | |
| | | | | | | | | | Vrishya | |

DEEPANEEYA DRAVYAS (3)

| | | | | | GUNA | | | | | Dravya |
|---|---|---|---|---|---|---|---|---|---|---|
| S. | SANSKRIT | BOTANICAL | FAMILY | PART | (PROPERTIES) | | | | DOSHA | Prayogaha |
| NO. | NAME | NAME | NAME | USED | Guna | Rasa | Veerya | Vipaka | KARMA | Vyadhi |
| 9. | Hingu | Ferula | Umbelliferaee | Resin | Ushna, | | Ushna | | Vata Kapha | Soola, Gulma |
| | | foetida | | | Teekshna, | | | | hara, Pitta | Udara, Krimi, |
| | | | | | | | | | vardaka, | Anaha, |
| | | | | | | | | | Pachana, | |
| 10. | Amlavetasa | Smilax china | Liliaceae | Rhizome | | | Ushna | | Vata hara, | Vata Vyadhi, |
| | | | | | | | | | Agni- | Muthra |
| | | | | | | | | | deepana | Shodhana, |
| | | | | | | | | | | Adhmana, |
| | | | | | | | | | | Shoola |

### Fingerprint Divided in to Tri Doshas

### Based on Polarity and Conjugation

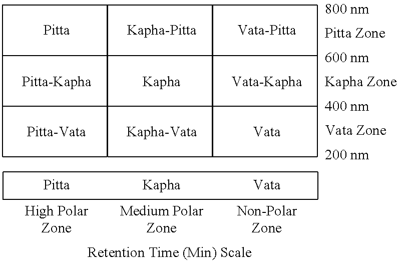

Based On The Color Reported, The Entire Fingerprint Image Is Divided In To 3 Zones On X Axis And 3 Zones On Y Axis. X Axis Shows The Polarity Scale Due To The Mobile Phase Composition. Y Axis Shows Conjugation Due To Uv-Vis Absorbance. Thus Constituents Present In The Respective Zones Will Act As Shown In The Figure In The Respective Therapeutic Zones Will Be Providing Respective Therapeutic Efficacy. Quantification Of These Constituents Was Done Using The Uv-Vis Absorptive Property Which Is Directly Proportional To The Quantity Of The Constituent.

### Disease Pathology in Ayurveda

1. HEPATITIS

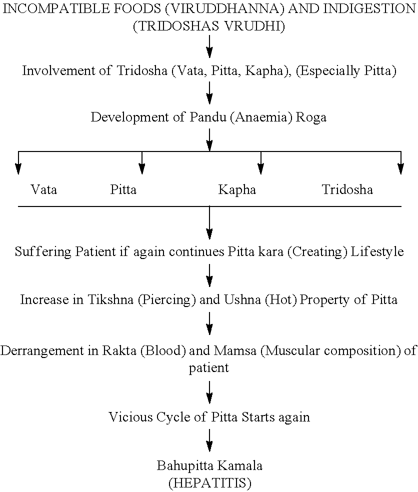

### Common Symptoms of PITTA VRIDHI—

Feeling Yellowish (Pitavabhasata), Irritation (Santapa), Feeling Requirement of cold Atmosphere (Sheeta Kamitwam), Insomnia (Alpanidrata), Vertigo (Murchha), Weakness (Balahani), Yellow coloration of stool, Urine and Eyes (Peetavinmutranetratwa), Increase in Appetite (Kshudha), Increase in Thirst (Trushna), Hot Feeling of Body (Daha).

### Common Symptoms of KAPHA VRIDHI—

White coloration of Body (Shaitya), Heaviness of Body (Gouravatwam), Laziness (Tandra), Oversleeping (Atinidra), Feeling looseness of joints and bones (Sandhi-Asthi Shaithilya), Looseness of Body (Shlathangatwam), Asthma (Shwasa), Cough (Kasa),

### Common Symptoms of VATA VRIDHI—

Hoarseness of Voice (Vakparushya), Thinness (Karshya), Black coloration in Body (Karshnya), Breaking Pain in Body (Gatrasphutana), Feeling Requirement of Hot Atmosphere (Ushnalamitwam), Sleeplessness (Nidranasha), Decreasing Strength (Alpabalatwam), Hardness of Stool (Gadhavarchasa), Tremors (Kampa), Involuntary Talking (Pralapa), Vertigo (Bhrama), Decrease in Excitation (Deenata).

2. DIABETES

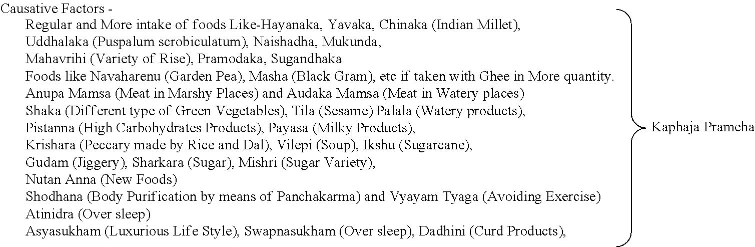

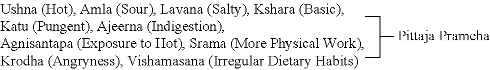

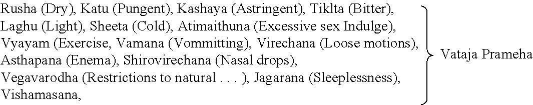

Disease Pathology of Prameha (Diabetes)

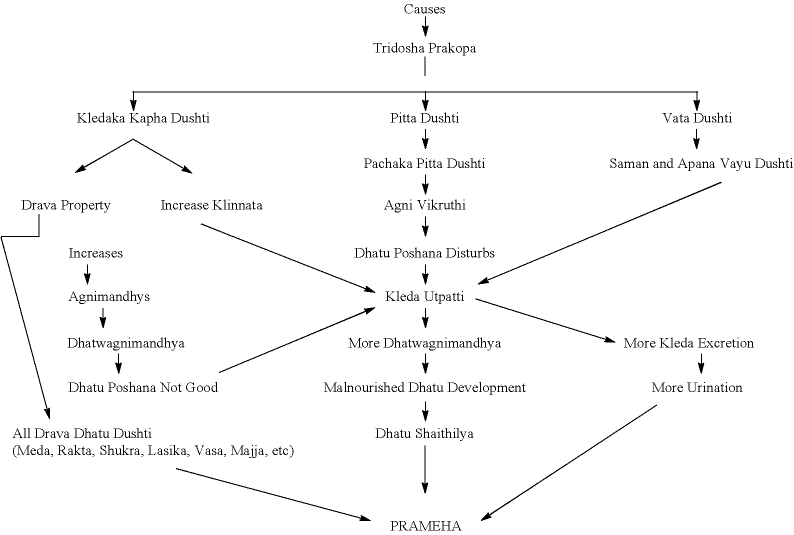

3. AMAVATA

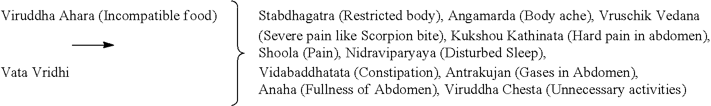

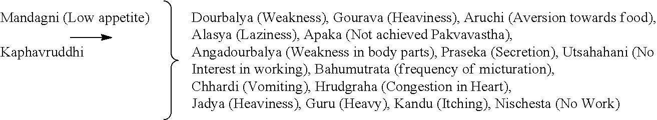

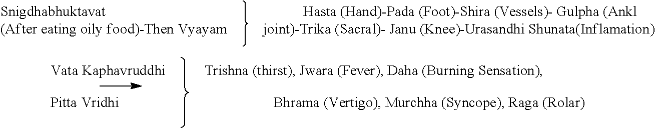

Disease Pathology of Amavata

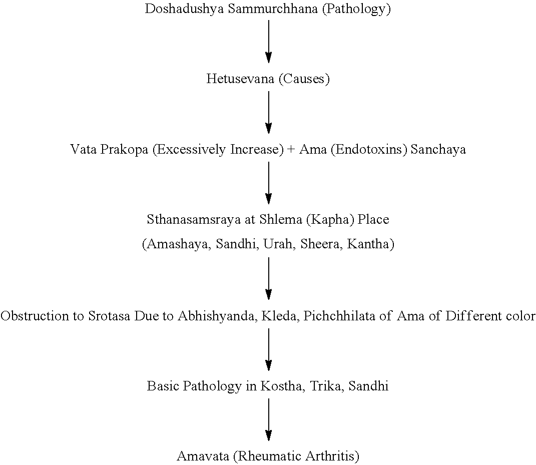

4. RAKTAPITTA

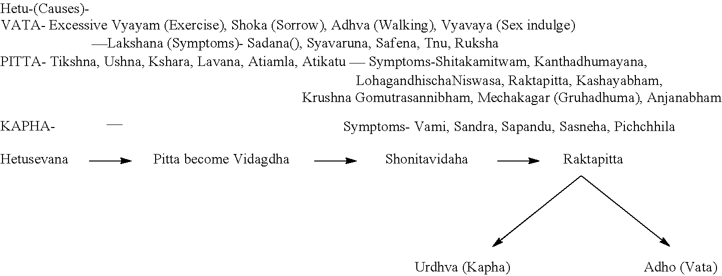

5. SHOSHA

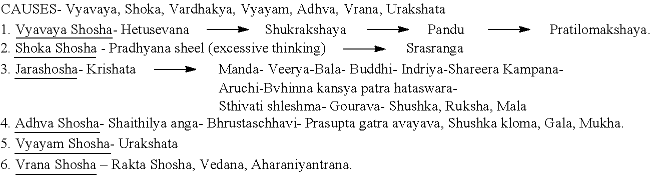

6. RAJAYAKSHMA

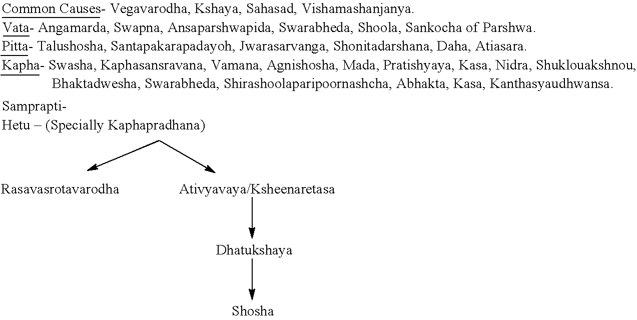

7. ATISARA

```
VATA-
Causes-Ruksha, Atisheetala, Adhyashana, Vishamabhojana, Bhaya, Shoka, Atijalakrida, Vegavarodha.
    Lakshana-Hrudaya, Niche, Payu, Udara, Kukshi, -Todavedana, Gatravasada, Anilavarodha, Vitsanga, Adhmana, Avipaka.
        Arian, Ruksha, Alpalpa, Muhrmuha, Shakrudama, Sashabda
PITTA-Causes-Ushna, Drava
    Lakshana-Pitam, Nilam, Raktam, Trishna, Murchha, Daha, Gudapaka.
KAPHA-Causes-Guru, Atisnigdha, Drava, Sthoola, Krimi.
    Lakshana-Shukla, Sandra, Shleshmana, Vinsra, Sheeta, Drustaroma.
TRIDOSHAJA-Causes-Viruddha, Ajeerna, Snehadipoorvakarma, Panchakarma Ati/Hina/Ayoga,Vishaprayoga,Dusheetajala,
            Madyaatipana, Ritu/Satmya Viparyaya
        Lakshana-Varahasnehamamsa, Ambusadrusha, Sarvaroopina
Disease pathology of Atisara

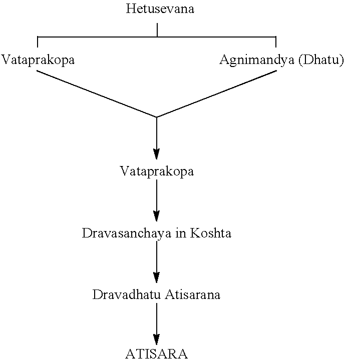

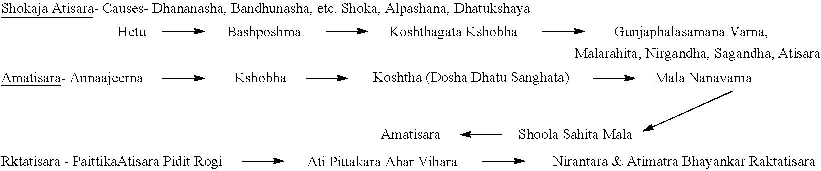


```

8. PRAVAHIKA-

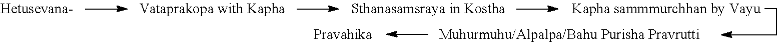

Vata-Shoola, Ruksha padartha janya
Pitta-With Daha
Kapha-Mala oravrutti with Shlesma
Raktaja-Raktayukta Malapravrutti.

9. GRAHANI

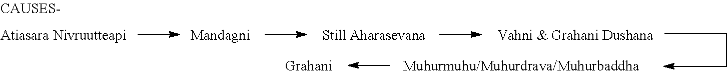

Vata-Balakshaya, Anna pachayetdukhh, Vairasya
Pitta-Trishna, Vidaha Annasya, Pakascha, Shuktapaka, Kanthasyashosha, kshudha trushna, Katu, Vidahi, Ajeerna, Amla,
Kshara—Pachakagninasta, Neelapitabham, Pitabham, Saryatedravam, Purti, Amla udgara, Hrutkanthadaha, Aruchi, Trud, Ardita.
Kapha-Alasya, Kayasya Gauravam, Kharangata, Timira, Karnayoswana, Parshwa, Uru Vankshana, Greeva, Vak, Visuchika,
Hritpida, Karshya, Dourbalya, Parivartika, Adhmana. Guru, Atisnigdha, Sheeta, Atibhojana, Swapna just after Bhojana,
Annapachyate dukham, Hrillasa, Chhardi, Arochaka, Madhurya, Kasanisthjivan, Peenasa, Udaragauravam, Dustamadhooraudgasra,
Sadanam, Strishvaharshanam, Bhinnaamapravrutti, Bhinnamapravrutti, Akrusasyadurbalata
Tridoshaja-Gruddhi Sarvarasanam, Manasa ch Sadanam, Chiradookham, Drava-Shushka tanvam, Shabdafenavat, Shwasa,
Kasa, Ardita Anila. Combined symptoms of tridoshaja.
Sangrahani-Antrakujana, Alasya, Dourbalya, Sadana. drava, Sheeta, Ghana, Snigdha, Kativedana, Sahkrutaama, , Bahu
Paichhilya, Sasabada, Mandavedana, after every interval of 10-15-30 days, Divaprakopa, Ratri Shanti, Chirakali
Ghatiyantra Sangrahani-Swapat Parshwashoola, Glajjalaghatidhwani.

10. ARSHA

Causes-
VATA-Kashaya, Katu,Tikta, Ruksha, Sheeta, Laghu, , Pramita, Alpa,
Tikshna, Madya, Maithuna, Langhana, Deshakala, Sheeta, Vyayama karma,
Shoka, Atapasparsha, Hetu,
Symptoms-Shushkagudankura, Chimachimayana, Mlana, Shyava, Aruna,
Stabdha, Vishada, Parusha, Khara, Vakra, Tikshna,Visphutita, Bimbi,
Kharjura, Karkandhu, Karpasa, Kadambapushpa, Sharsapa samana, Shira
parshwa, Katiuru, vankshana Ativyatgha, Kshavathu, Atiudgara,
Vistambha, Hrudgraha, Arochaka, Shwasa-kasa, Agnivaishamya, Karnanada,
Bhrama, Sasabda, Rukphena, Krishnatwaka, Nakha, Vinmutra,
Netra twaka, Gulma, Pleeha, Udara, Ashtheela.
PTTA-Katu, Amla, Lavana, Ushna, Vyayama, Agni, Atapasevana,
Deshakala, Krodha, Madya, Irshya, Vidahi, Tikshan, Ushana Guna.
Symptoms-Neelamukha, Rakta, Pita, Seetaprabha, Tanvastra, Shookajeevha,
Yakritkhanda, Jalouka, Vaktrasannibha, Daha, Paka, Jwara, Sweda, Trit,
Murchha, Aruchi, Moha, Ushna, Dravaneela, Ushna, Pita, Raktavarchasa.
KAPHA-Madhura, Snigdha, Sheeta, Lavana, Amla, Guru, Avyayam,
Divaswapna, Shayyamutra, Vayusevana, Always Nischinta
Symptoms-Mahamoola, Ghana, Mandaruja, Seeta, Utsanna, Apachita,
Sneegdha, Stabdha, Vrutta, Guru, Stheera, Pichchila, Stimita, Shlakshna,
Kandu, Sparshanapriya, Gostanasannibha, Kareera, Panasa
Vankshana, Guda, Vasthi, Nabhi Peeda, , Shwasa, Kasa, Hrillasa, Parseka,
Aruchi, Peenasa, Mrutrakruchchha, Sheetagaurava, Sheetajwara, Klaibya,
Agnimardava, Chhardi, Ama, Vasa, Kapha purisha.
TRIDOSHAJA-All mixed Sapravahika, Na Sravati, Na Bhidyante,
pandu Sneegdha, Twaka.
RAKTARSHA-Raktoulbana, Gudakeela, Pittakriti, Vataprarohasadrusha,
Gunjavidruma, dUsta, Ushna, Gadhvidh, Prapidita, Sravanti, Sahasa Rakta,
Atipravruttyi, Bhekabha, Dookha, Shonitakshaya, Sambhava,
Heenavarna bala, Utsaha, Hatouja, Kalushendriya.

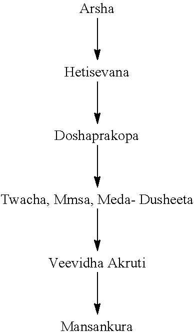

### 11. AROCHAKA

### VATA—Dantaharsha, Kashayavaktra, Hrichchhula

### PITTA—Katu, Amla, Lavana, Virasa, Puti, Trisha, Daha, Chosha.

### KAPHA—Madhurya, Paichhilya, Guru Shaitya, Vibaddha, Sambaddha, Srava

### AGANTUJA—Shoka, Bhaya, Atilobha, Atikrodha, Manaviparita, Apavitra, Durgandha, Normal Mukhaswada, Moha, Jadata, Vaigunya

TRIDOSHAJA—All symptoms and all Rasa Anubhava, Bahurujam.

### 12. CHHARDI

### Causes—

Atidrava, Atisnigdha, Ahrudya, Atilavanai. Akale/Atimatre Bhojane/Asatmya Bhojane, Srama, Bhaya, Udvega, Ajeerna, Krimi, Garbhavanti Stree, Atisheeghra Bhojanai, Bhibhitsa Hetu.

### VATA—Hrud, Parshwa Peeda, Mukhashosha, Shirsha Nabhi Peeda, Kasa, Swarabheda, Toda, Udgarshabdaprabal, Saphena, Vichchhinna, Krishna, Tanu, Kashayam, Krichchhena, Alpa/Mahata Vega

### PITTA—Murchha, Pipasa, Mukhashosha, Murdhwa Talu-Akshi-Santapa, Bhrama, Pita, Ushna, Hareetha, Satikta, Dhooma, Vamana.

KAPHA—Tandra, Mukhamadhurya, Kaphasrava, Tripti, Needra, Aruchi, Shirogaurava, Vamit Dravya Is like-Snigdha, Guru, Madhoora, Shweta Varna, Romaharsha, Alparujam.

### TRIDOSHAJA—Shoola, Avipaka, Aruchi Daha, Trishna, Shwasa, Pramoha, Chhardi Tridoshaja LakshanaLavana, Amla, Nila, Sandra, Ushna, Raktavamana,

### AGANTUJA CHHARDI—

Bibhitsa, Douhrudaja, Amaja, Asatmyaj, Krimija

### KRIMIJA—

Udarashoola, Hrullasa, Hridroga

13. TRISHNA

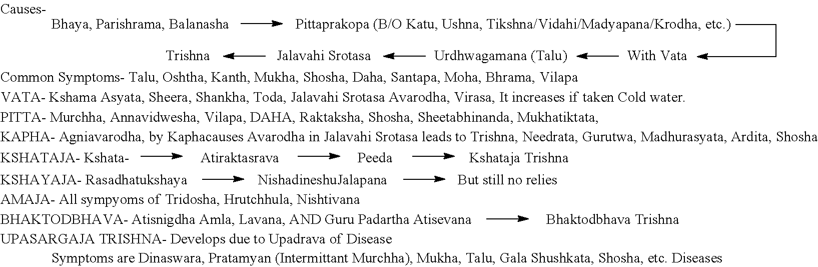

14. MURCHHA

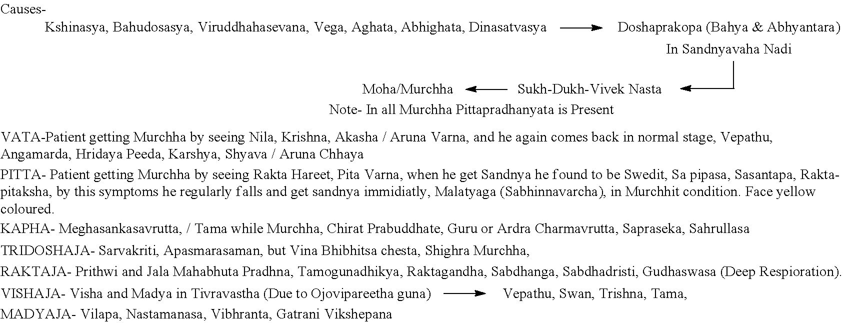

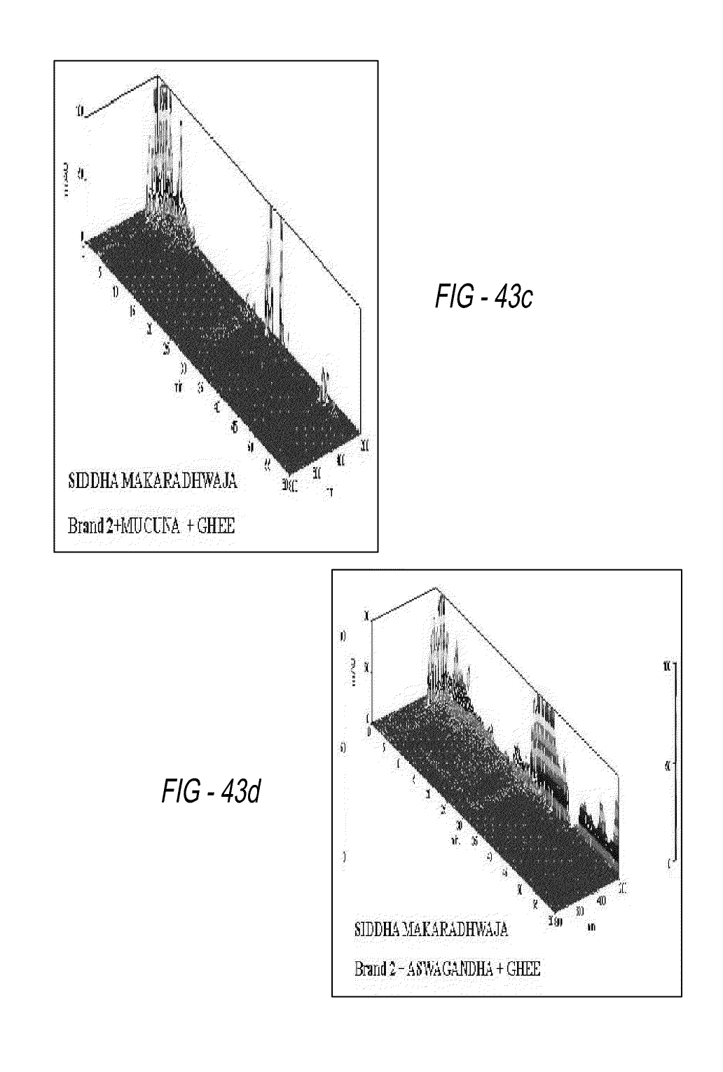

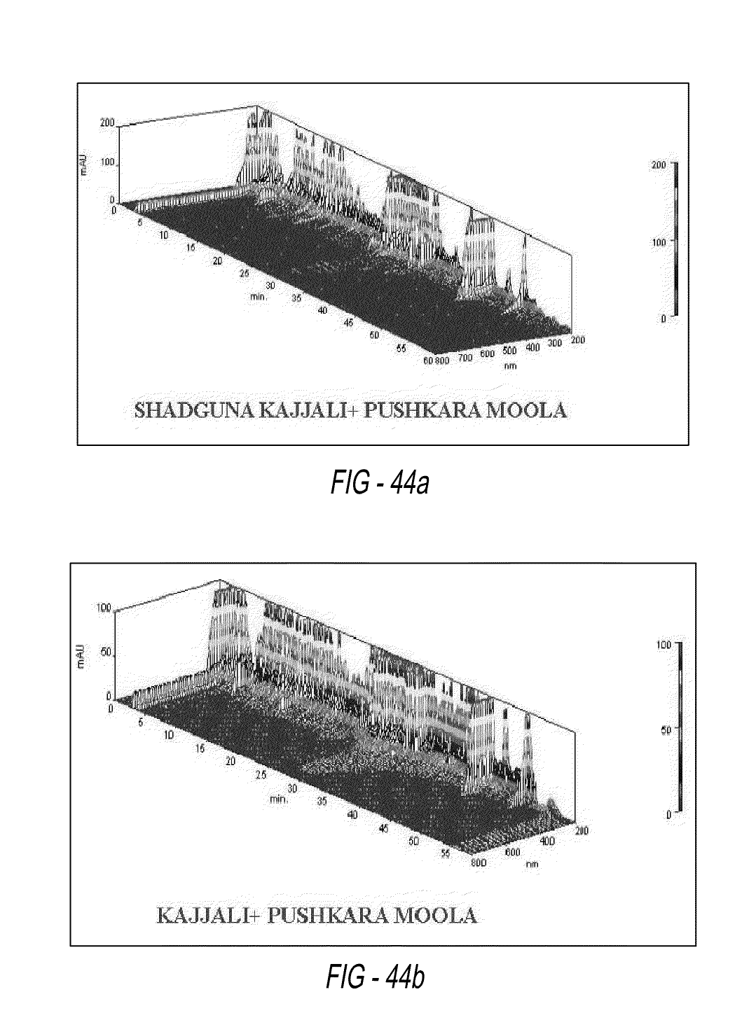

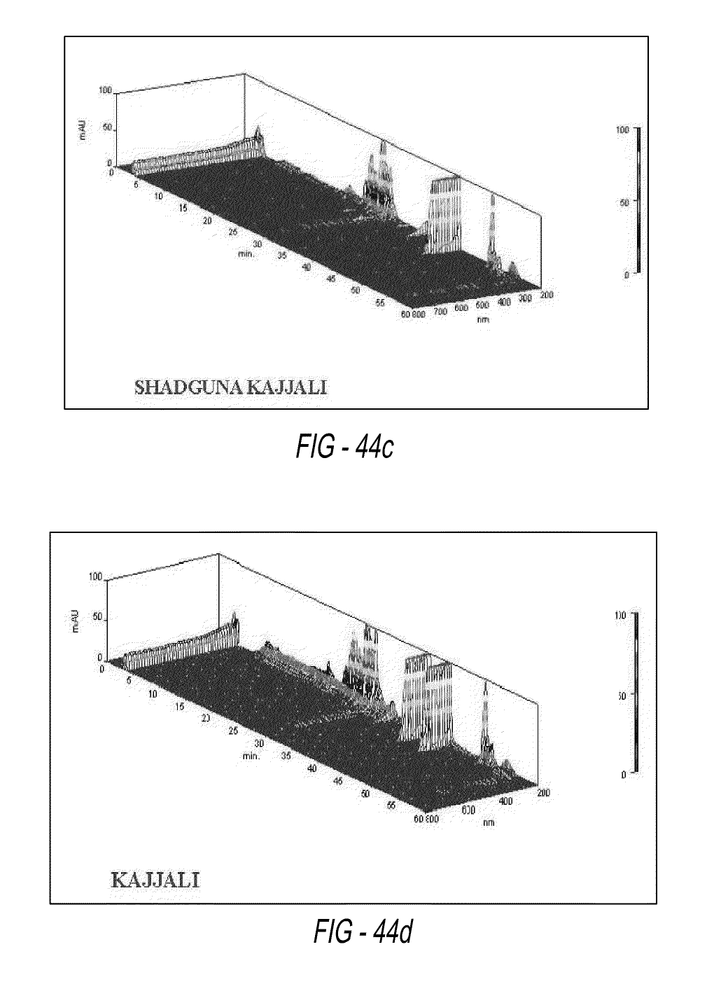

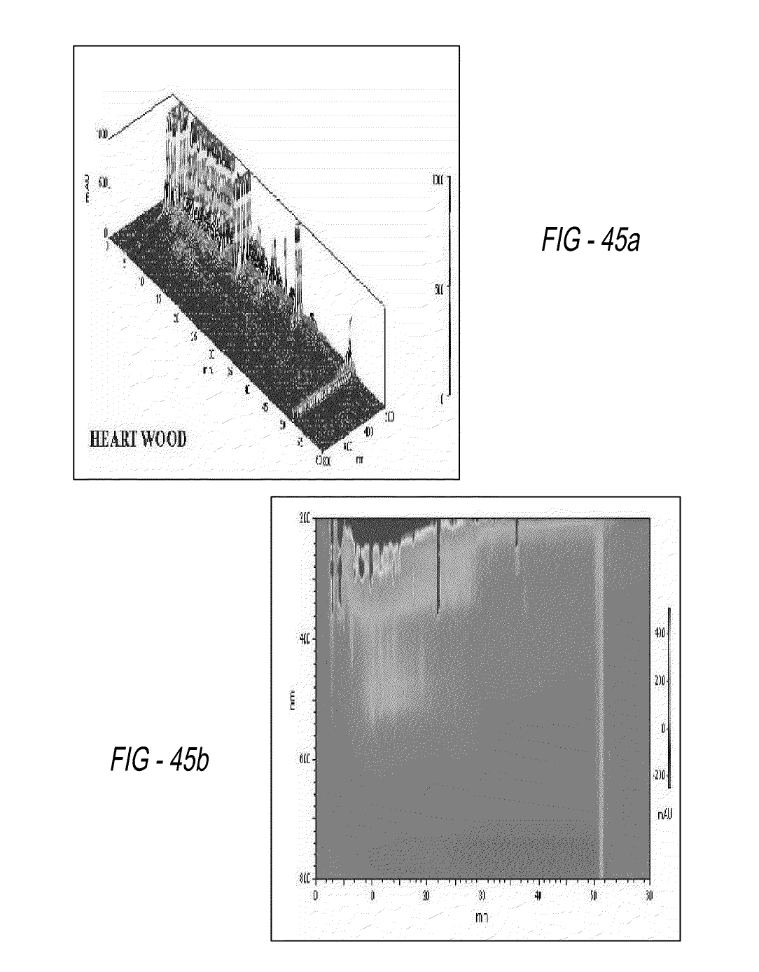

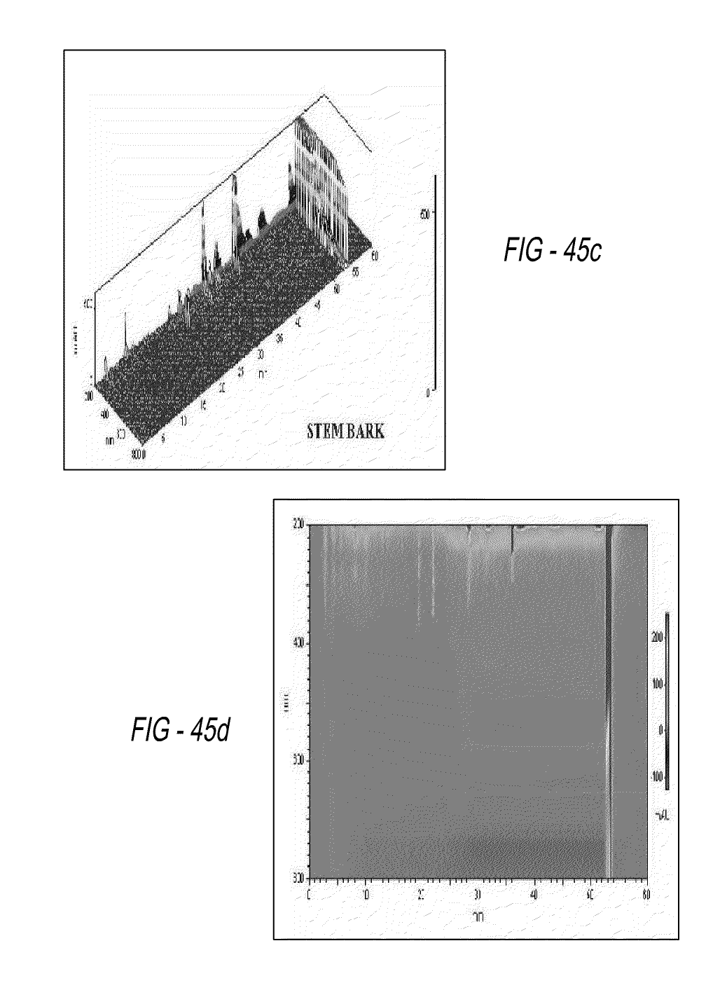

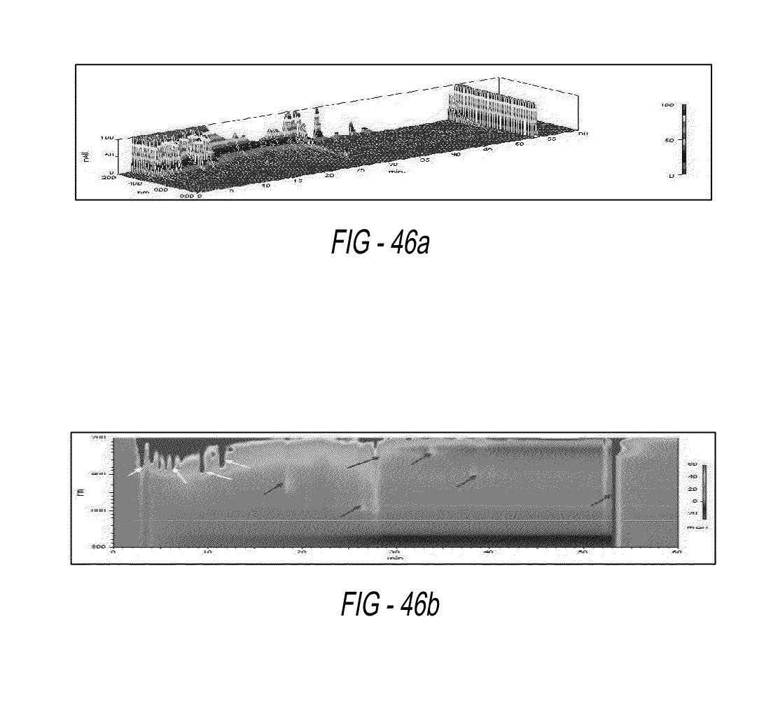

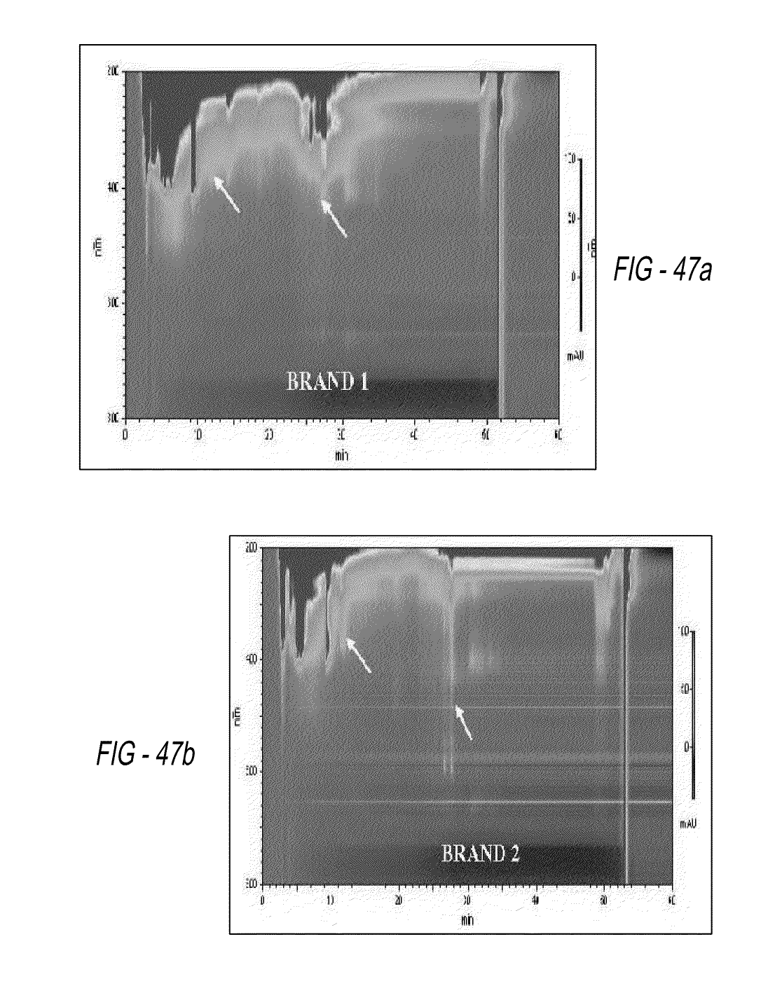

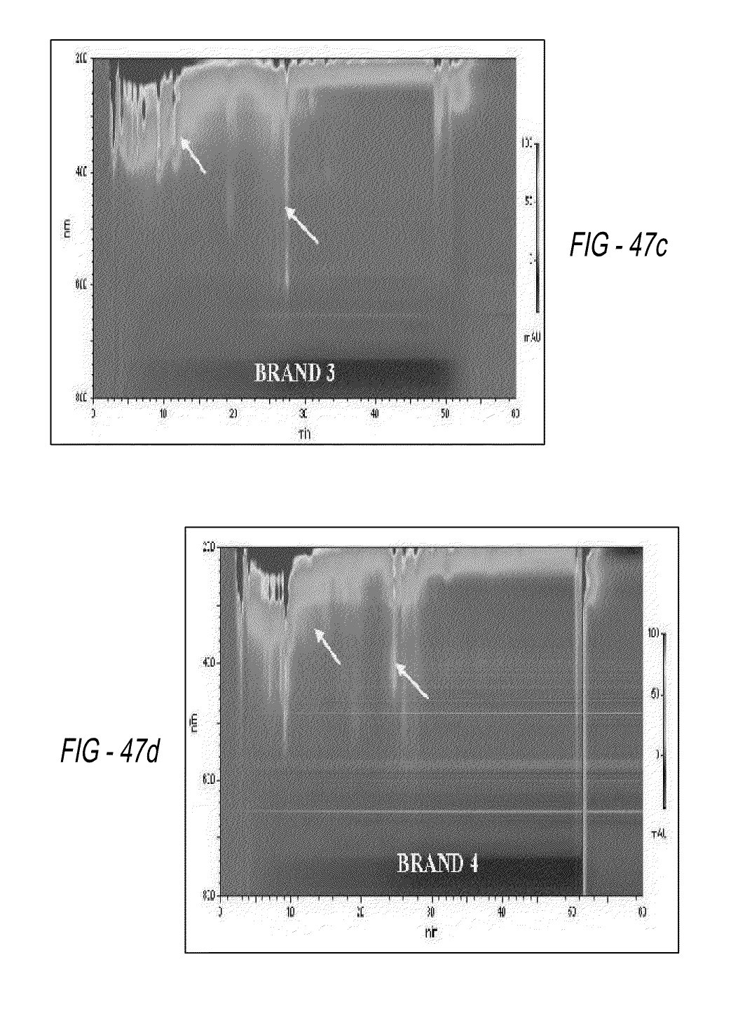

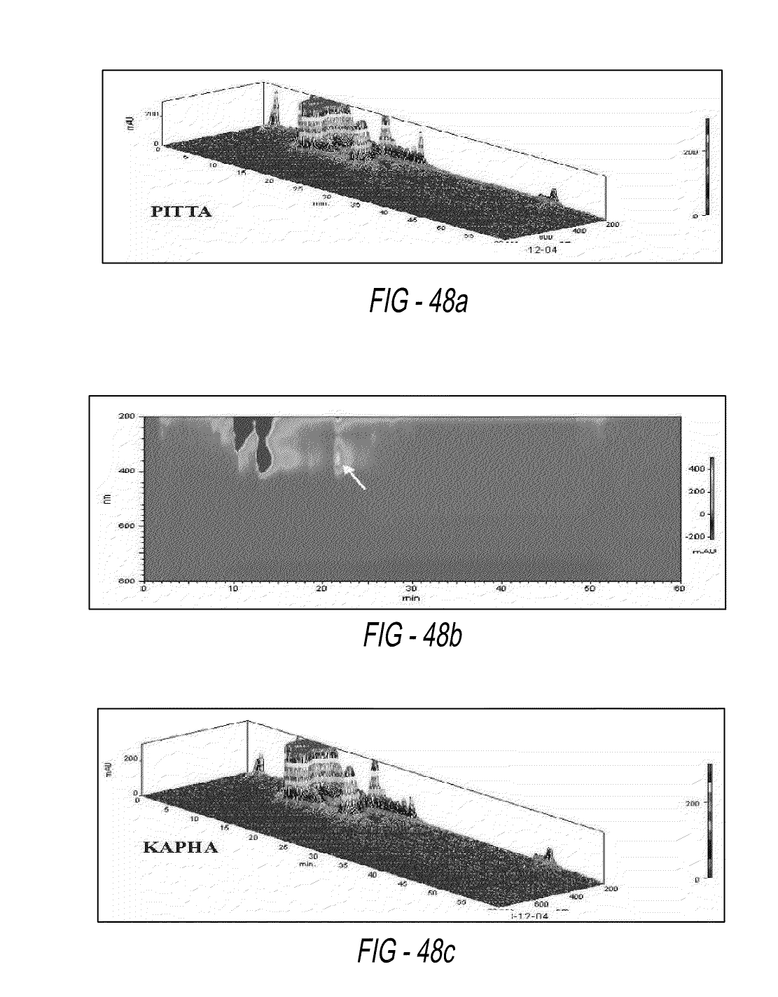

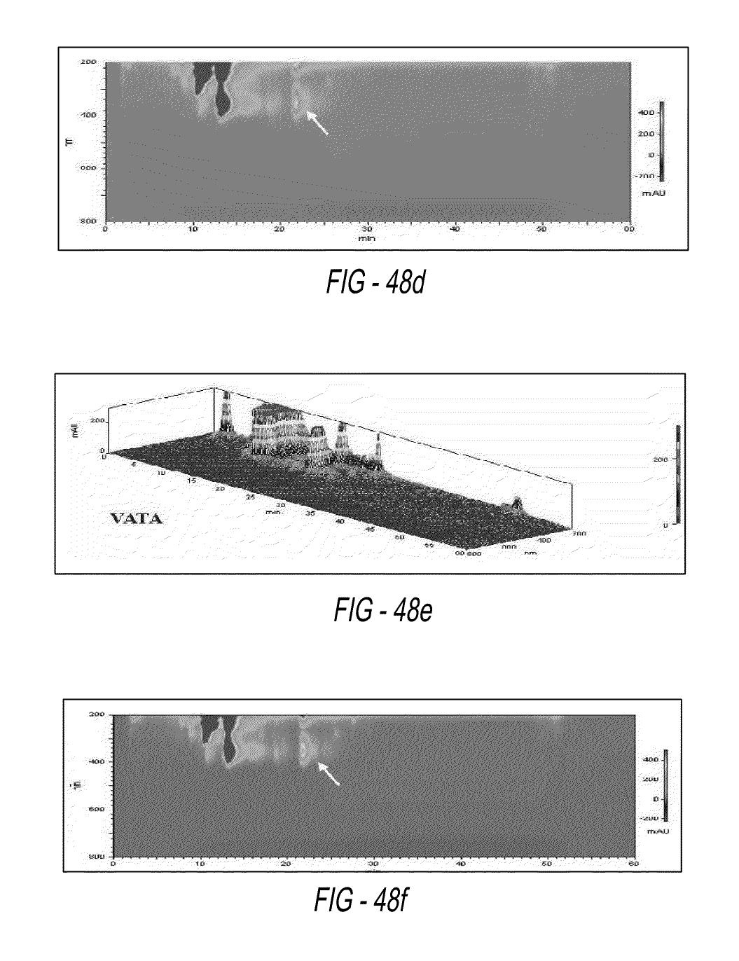

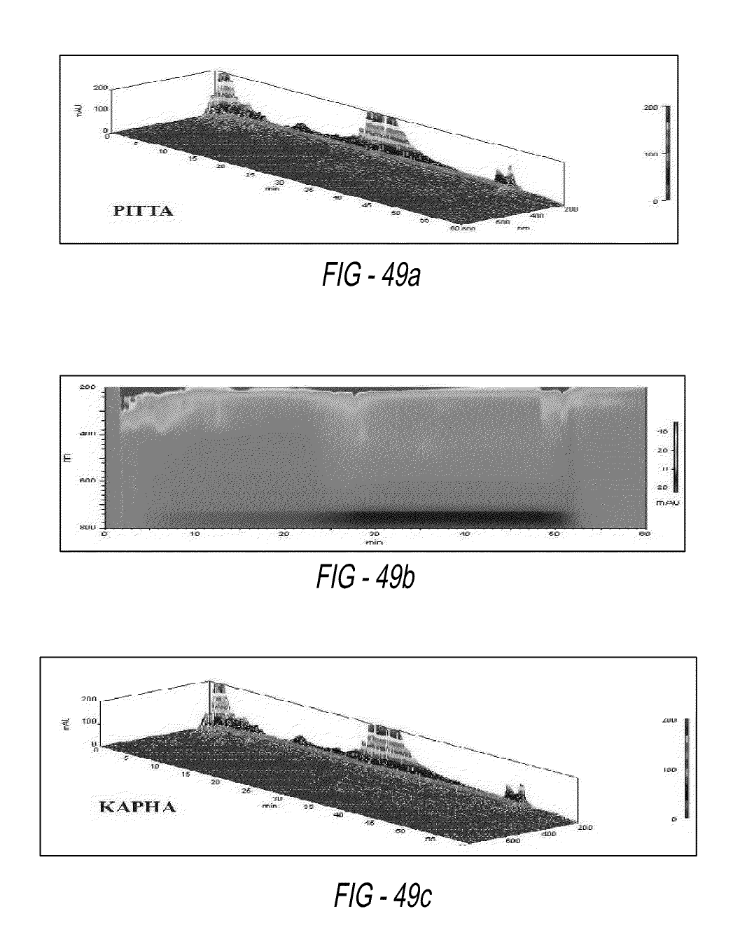

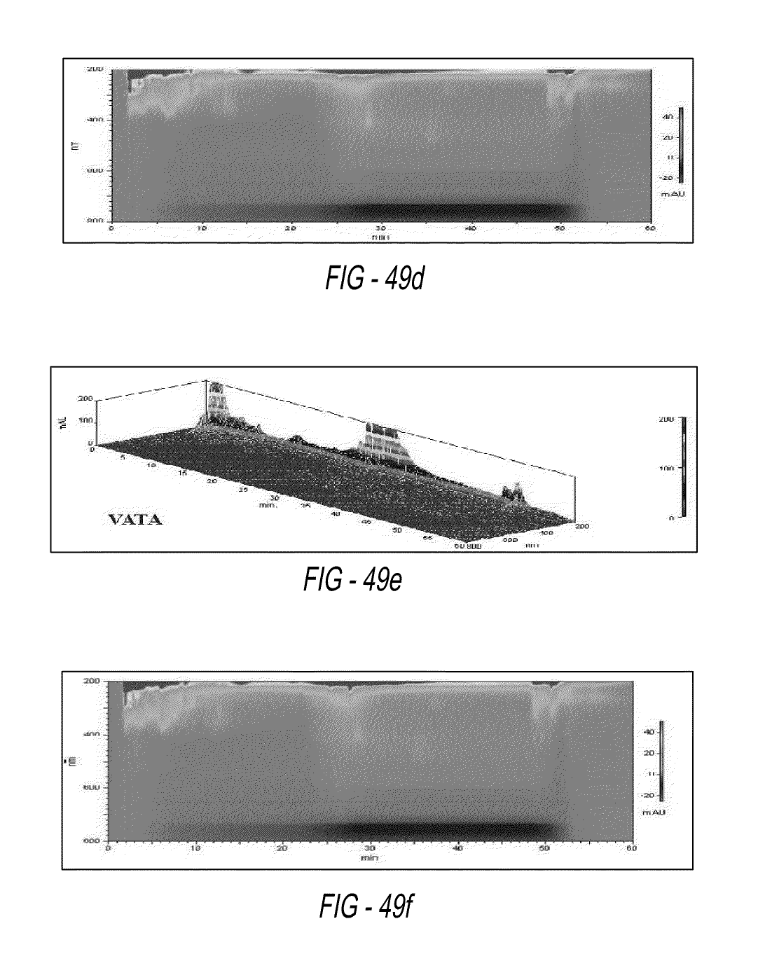

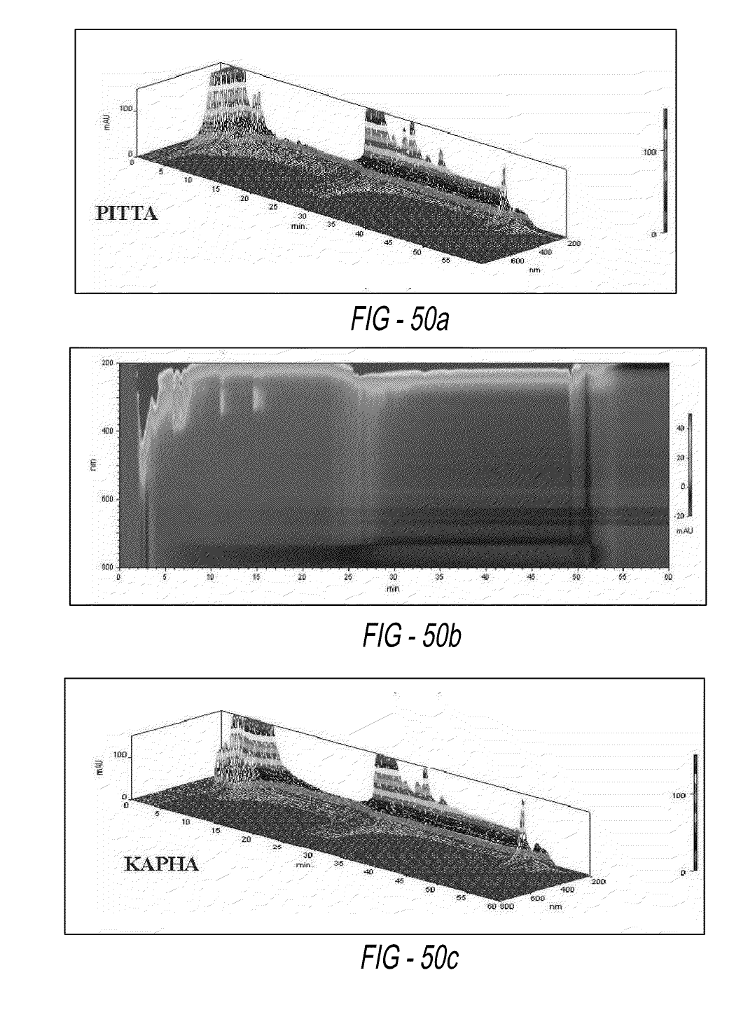

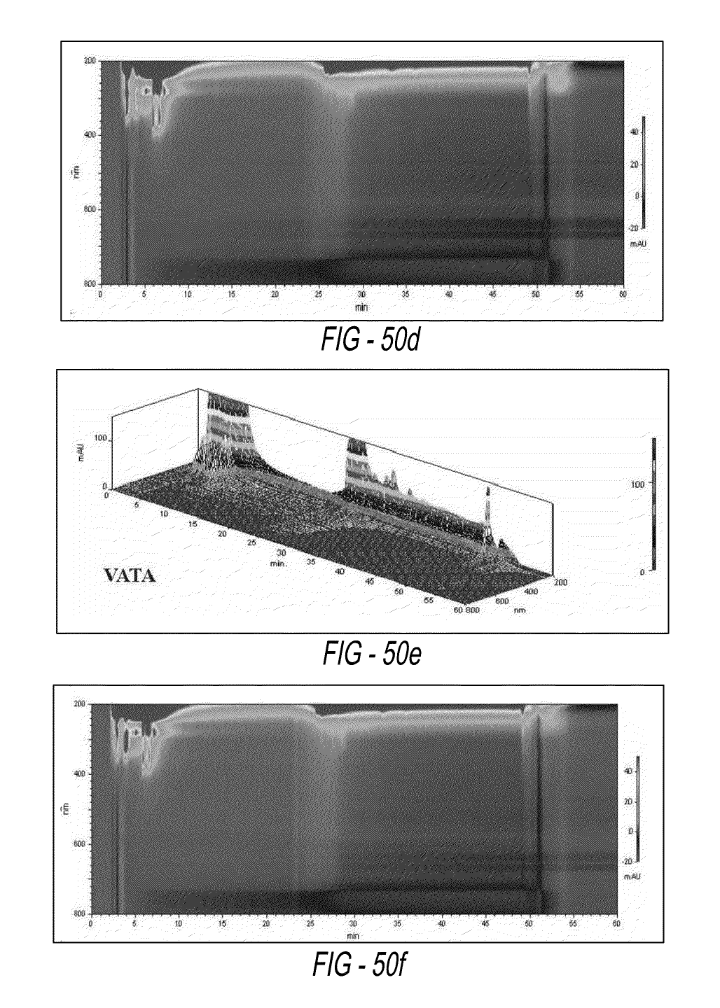

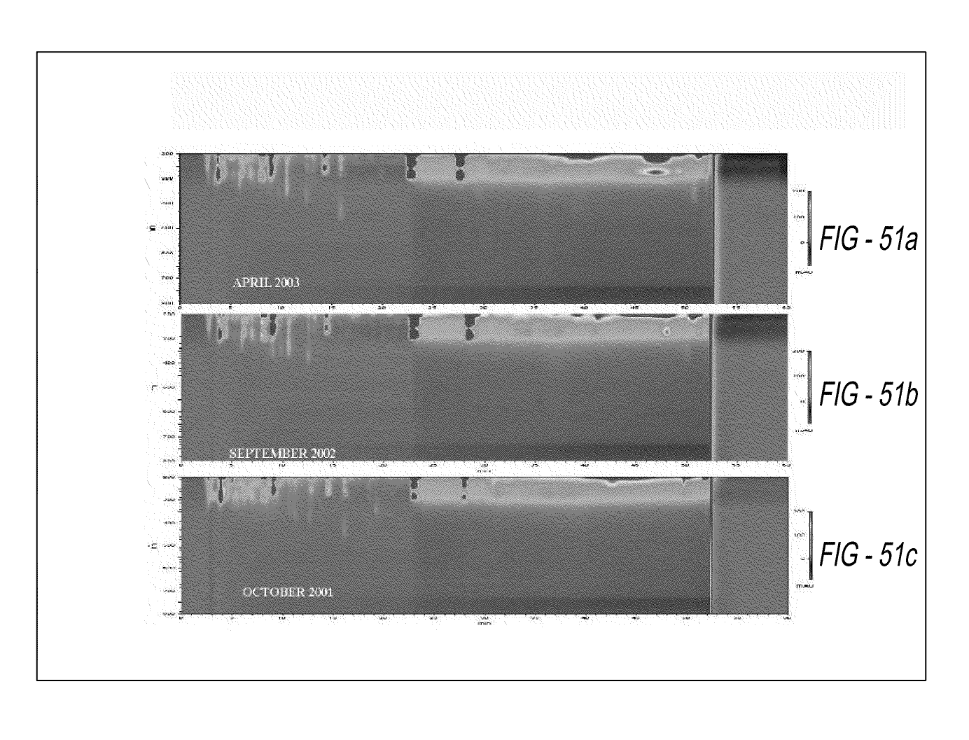

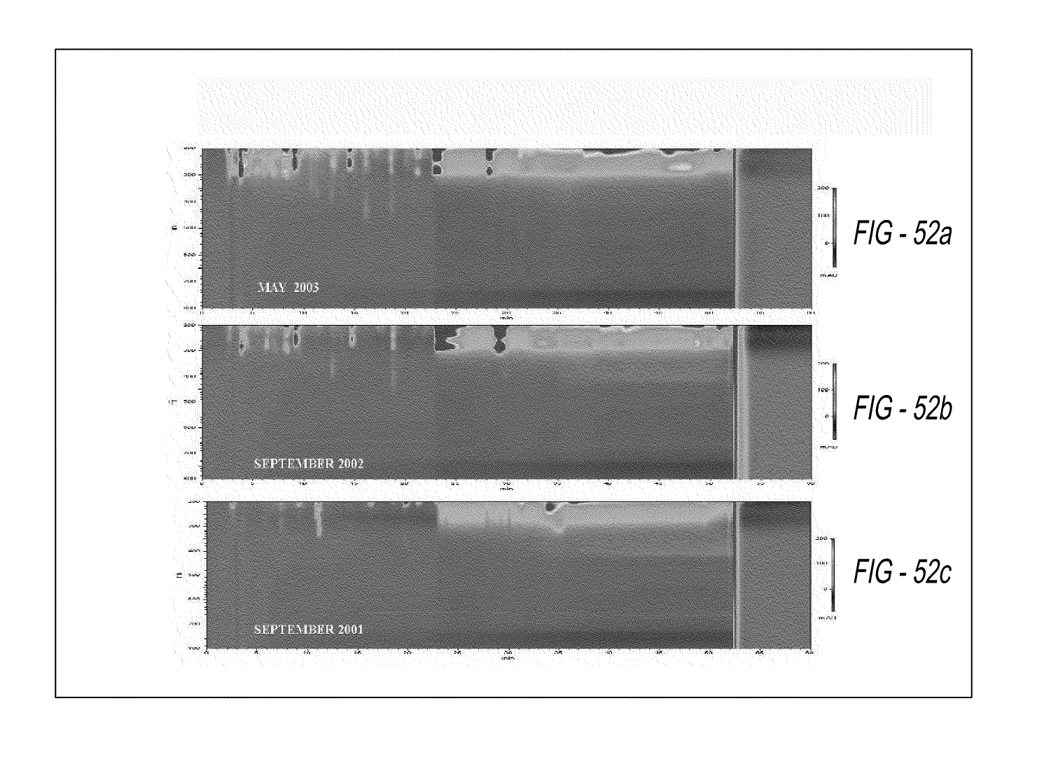

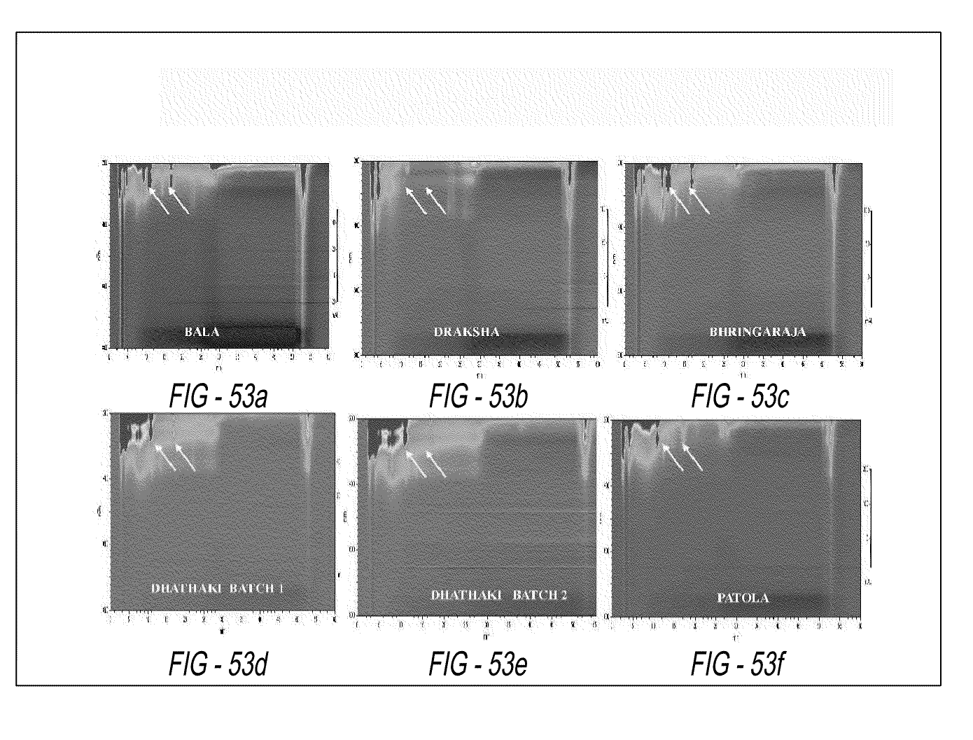

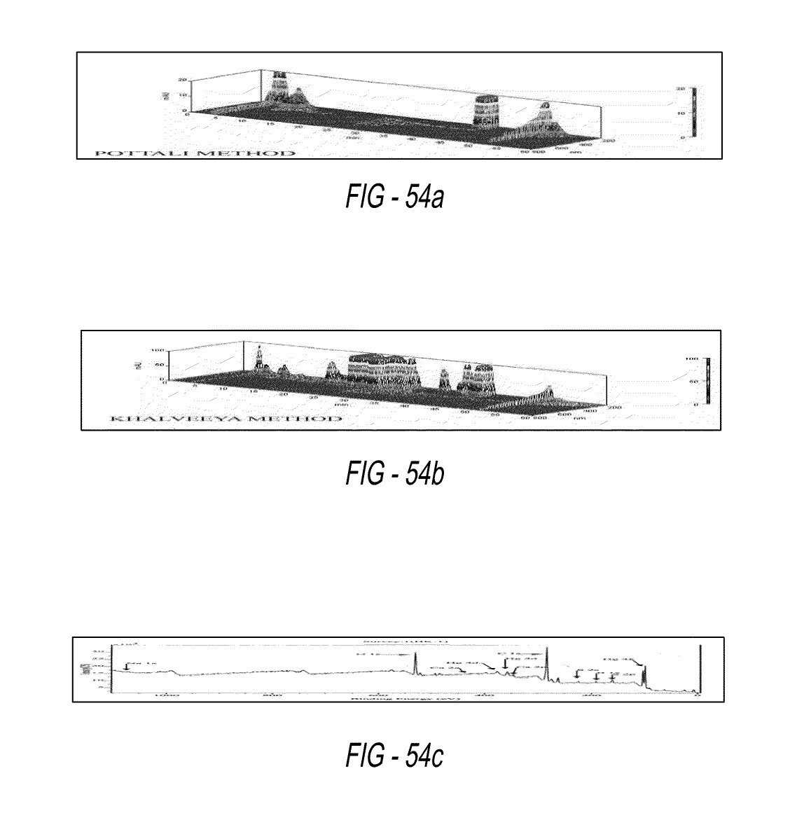

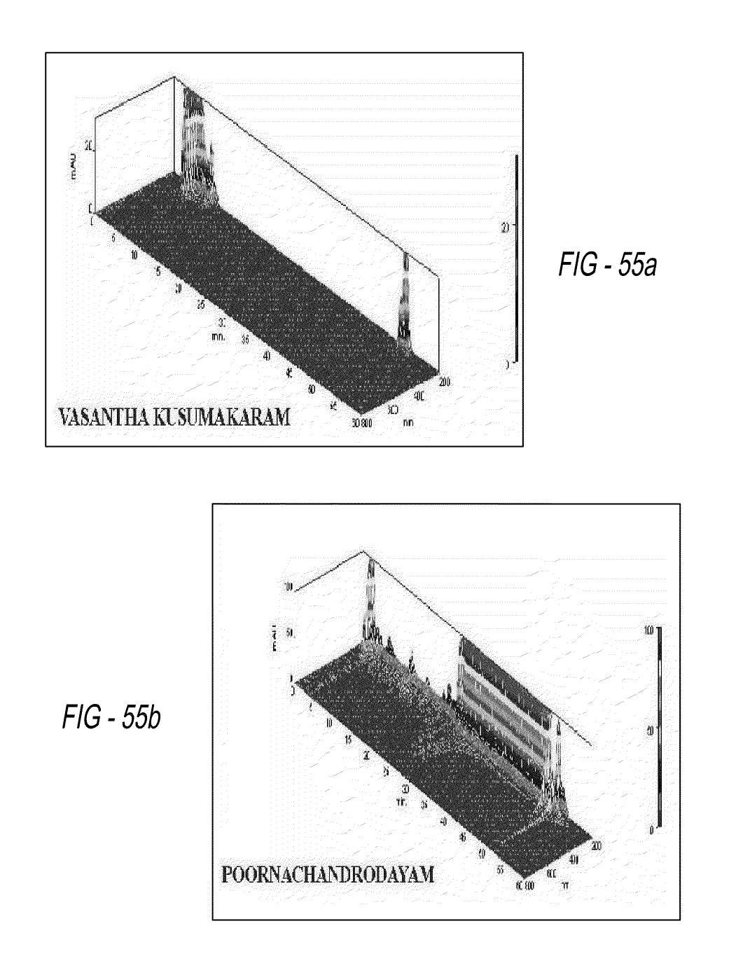

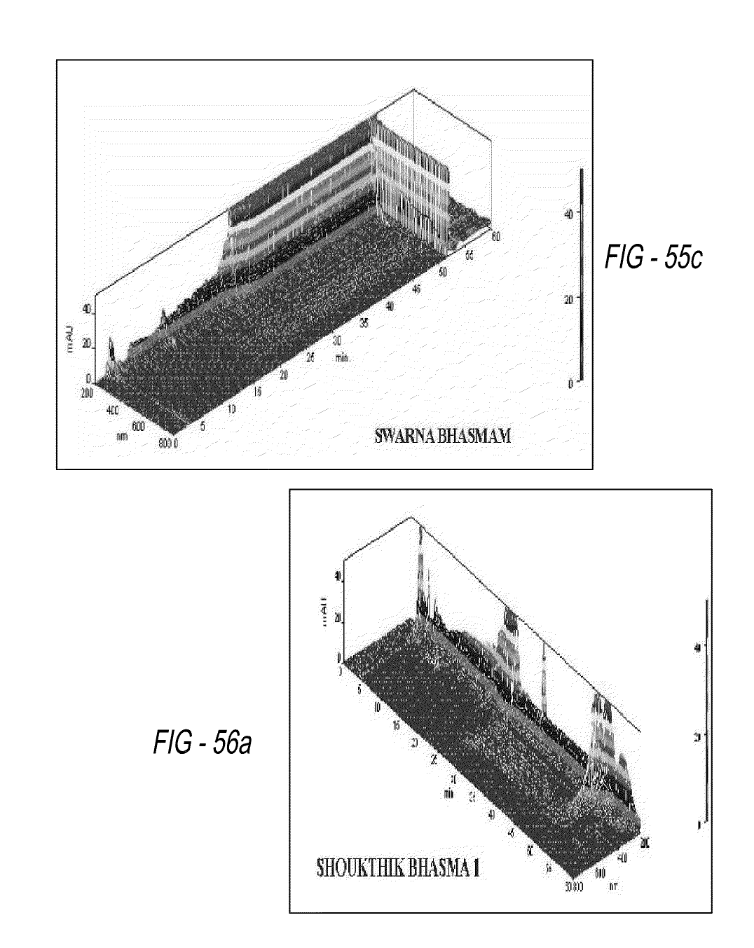

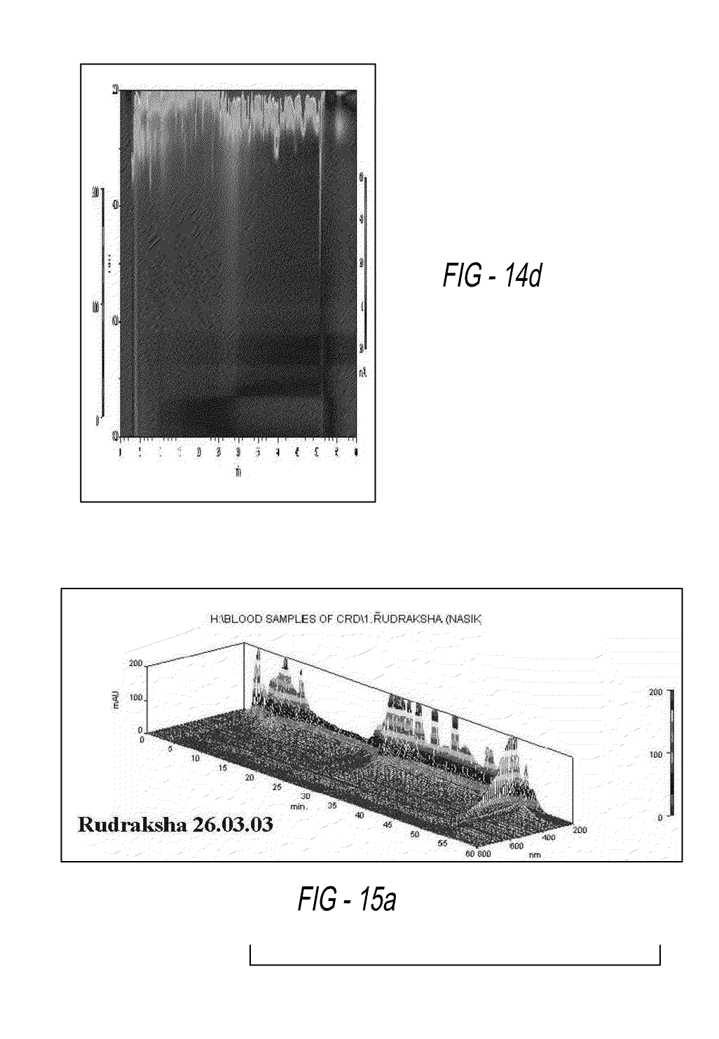

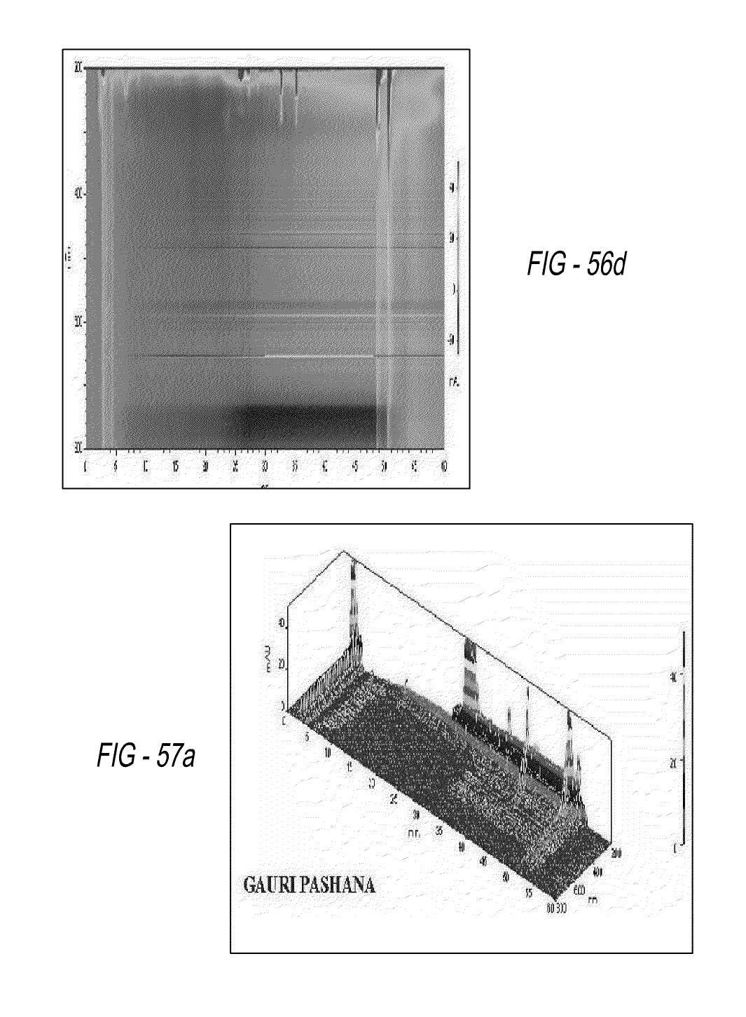

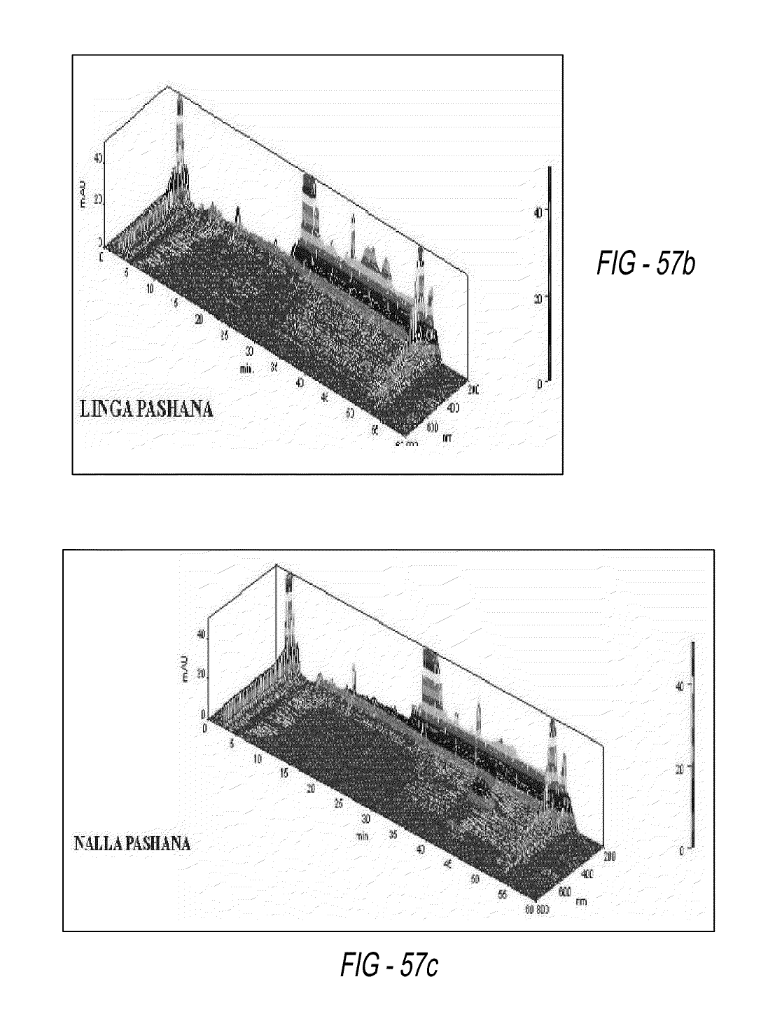

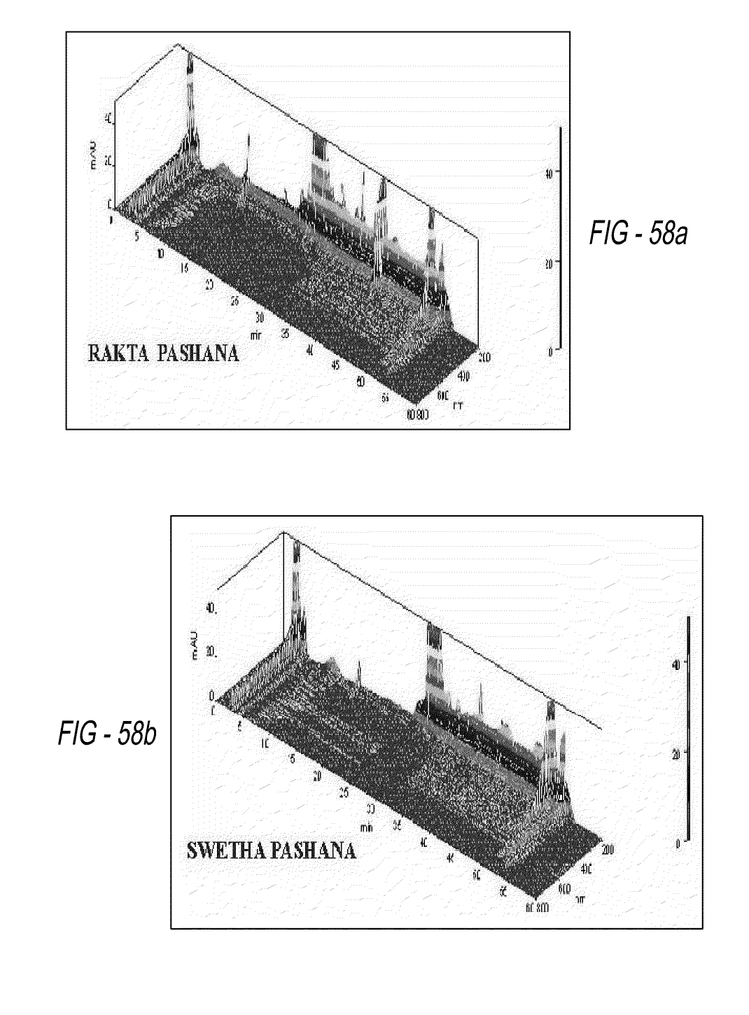

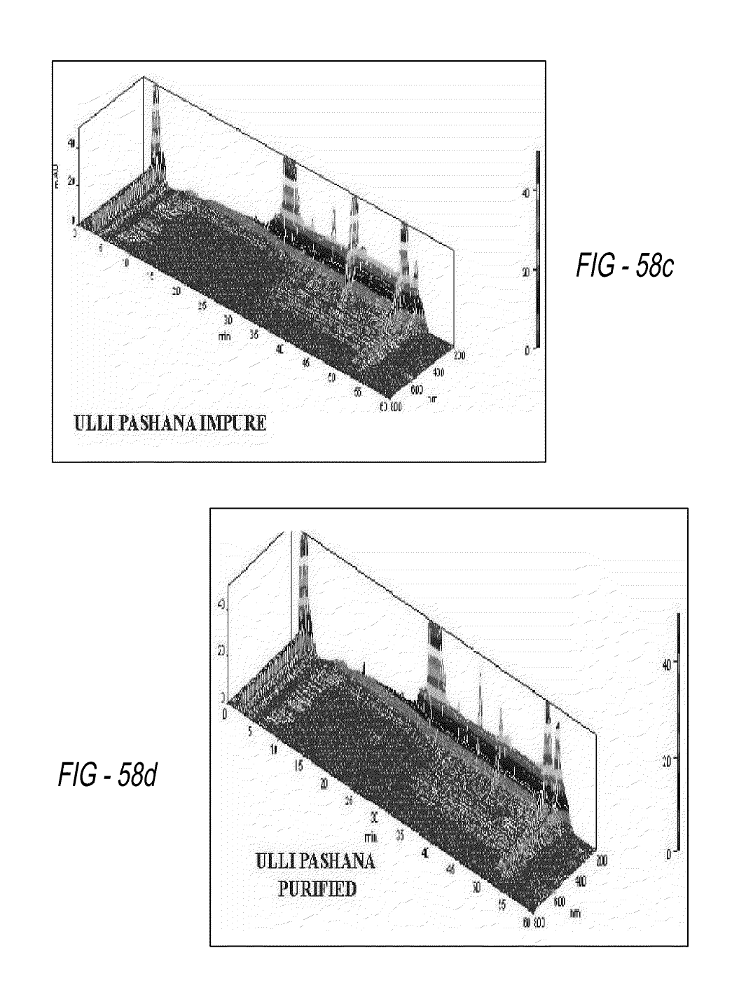

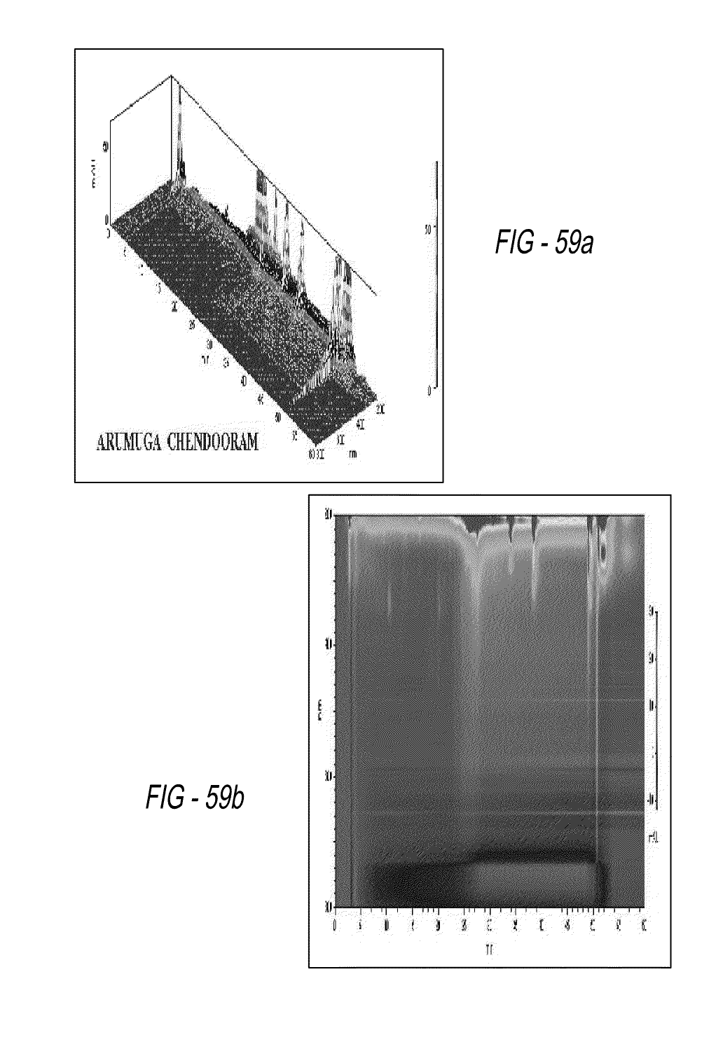

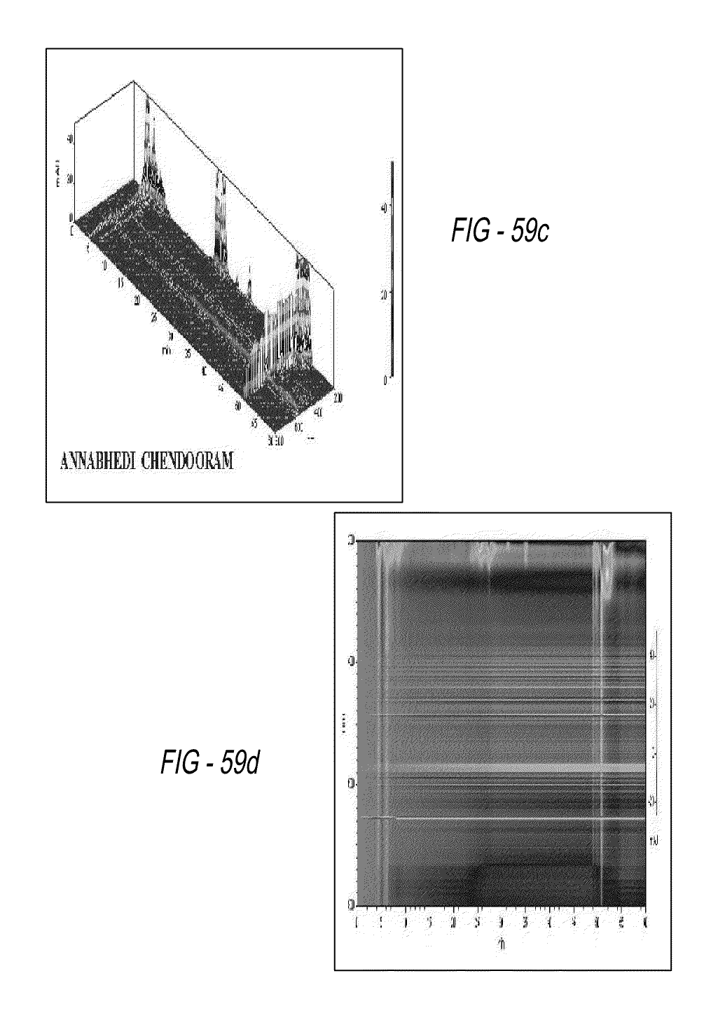

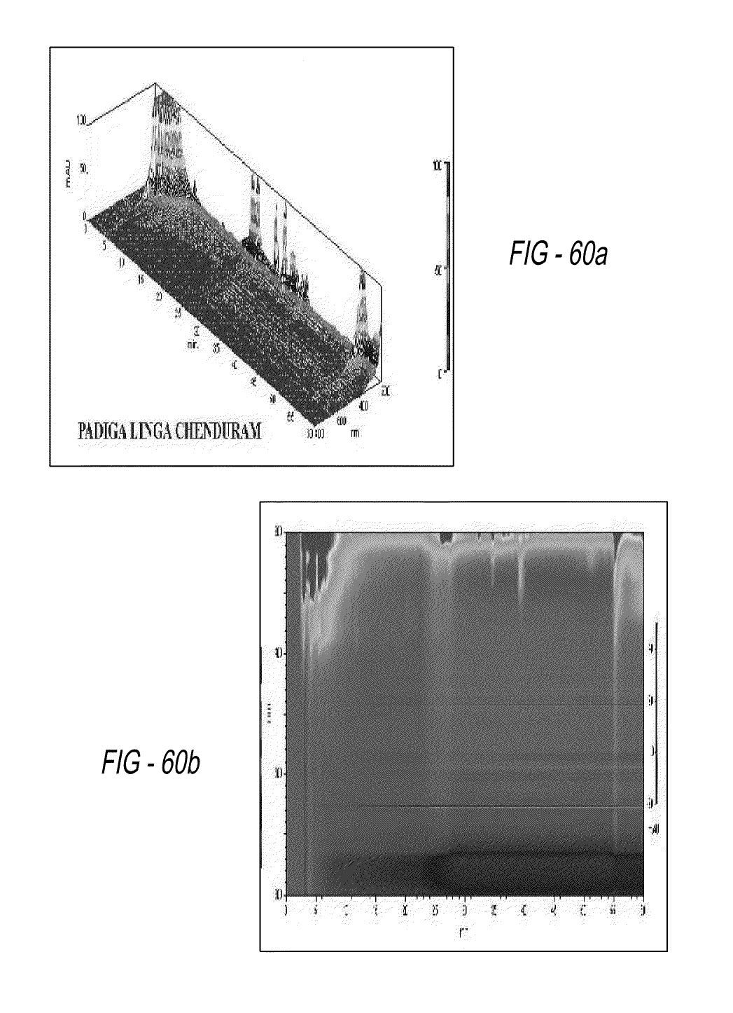

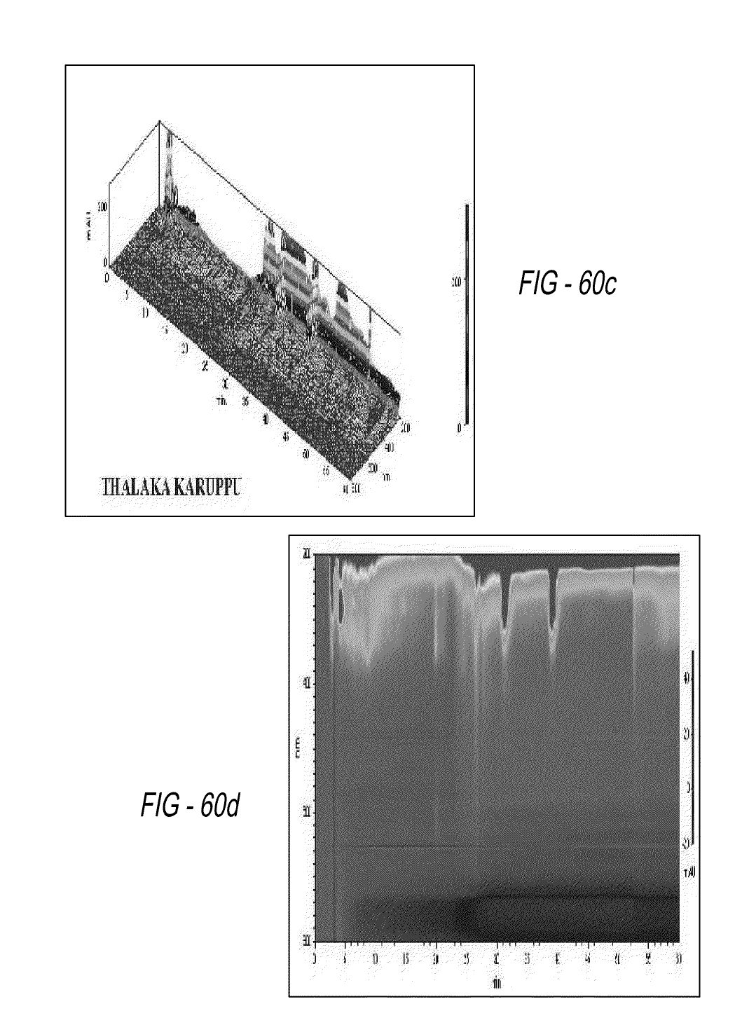

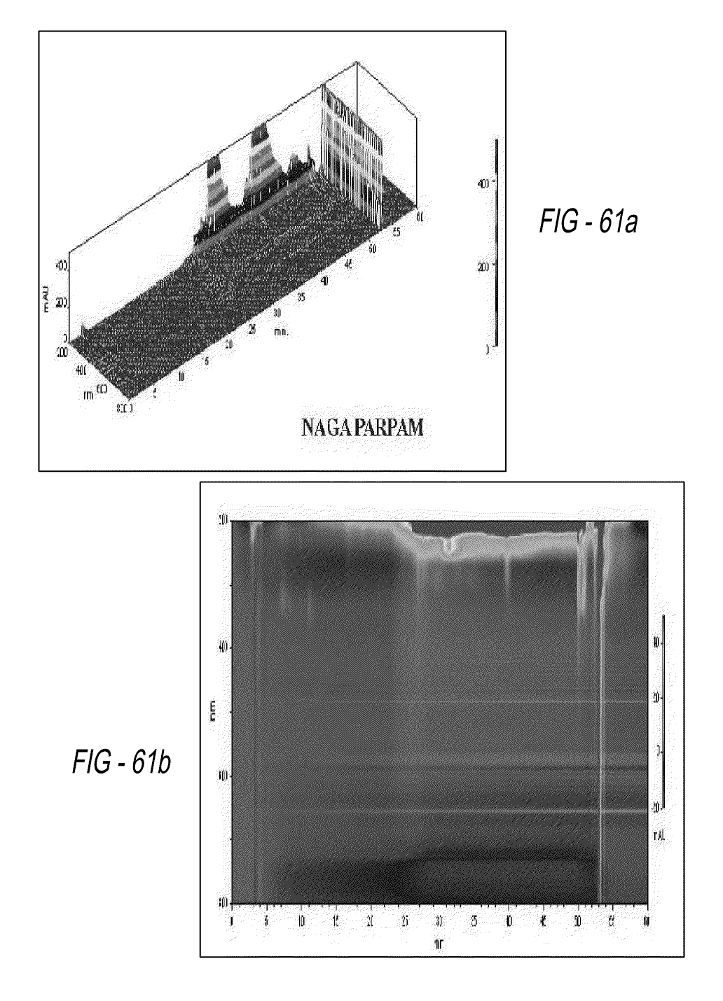

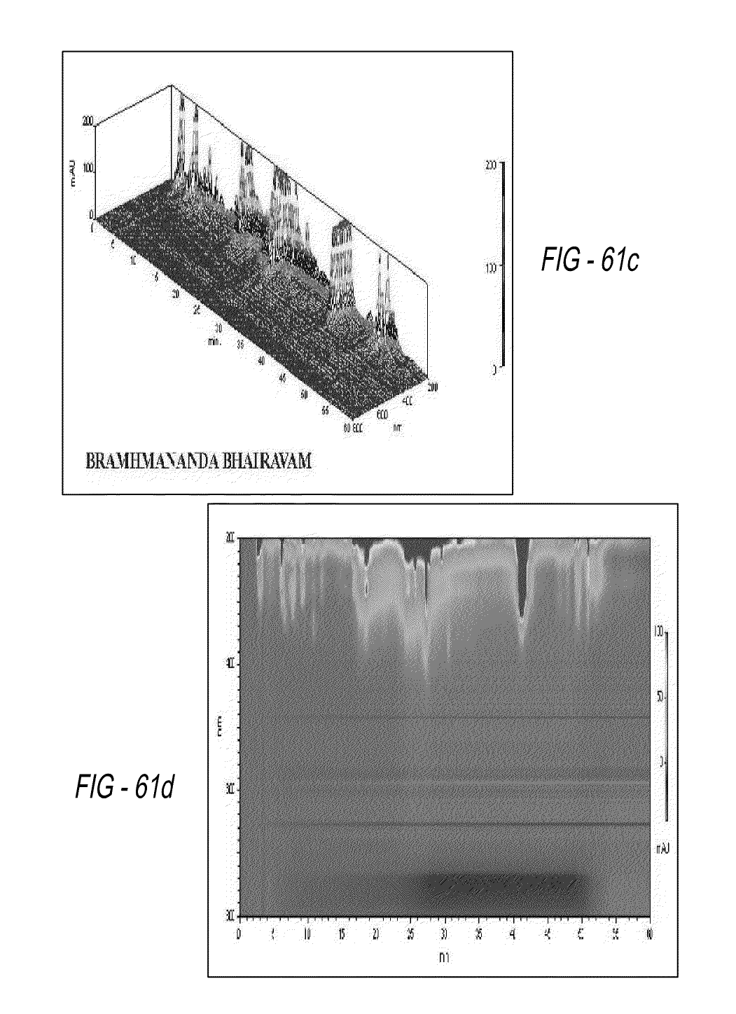

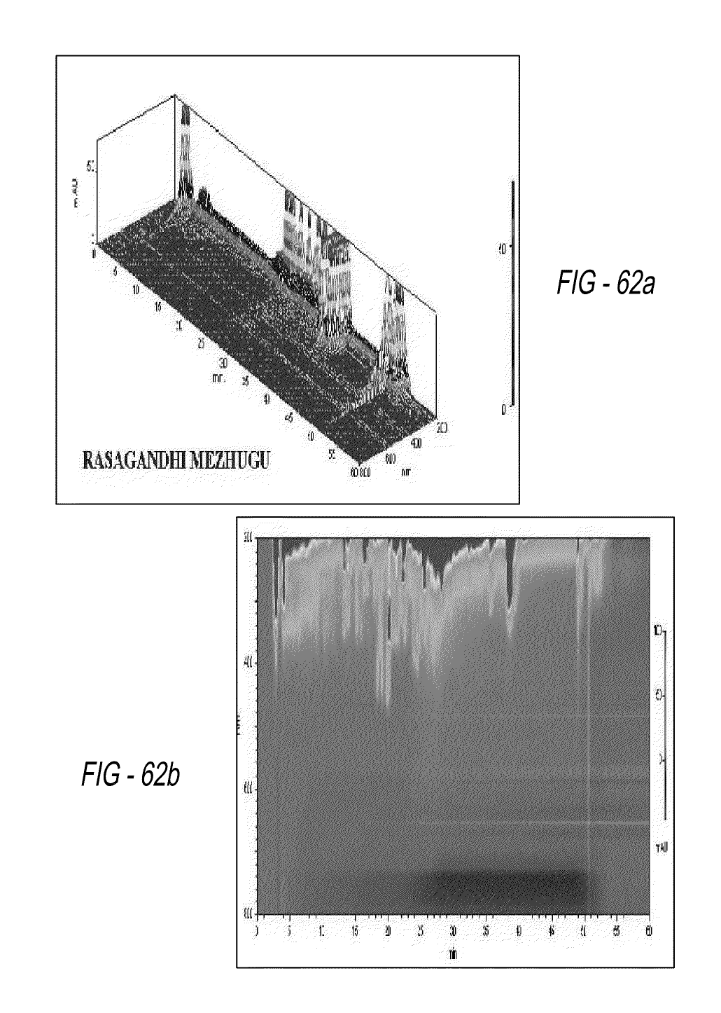

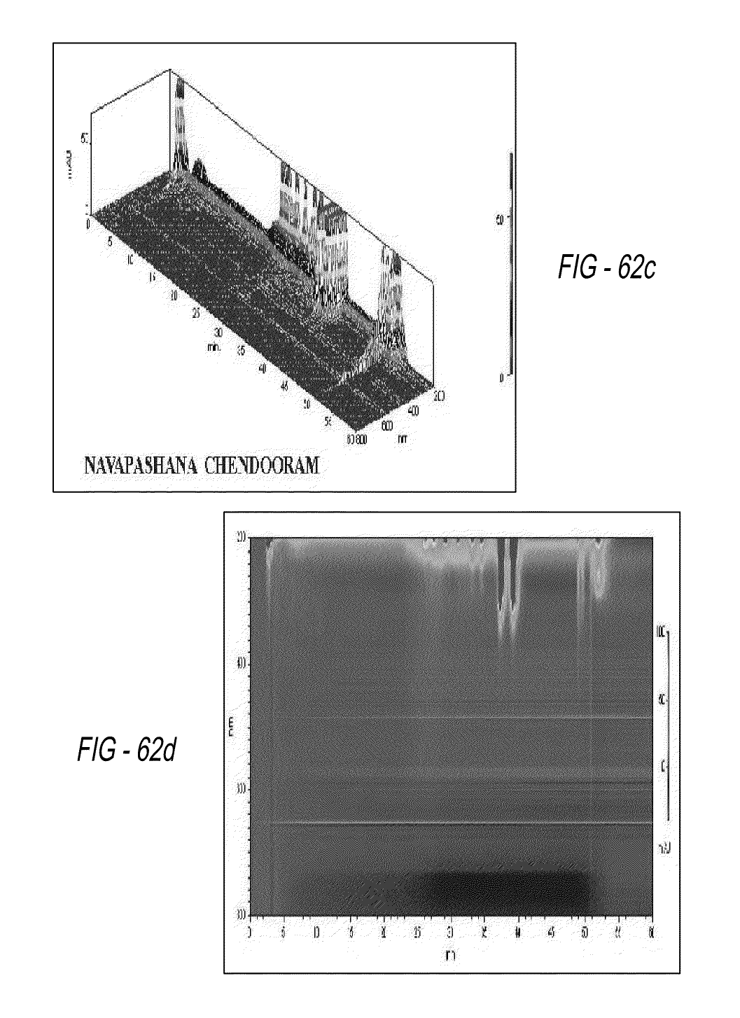

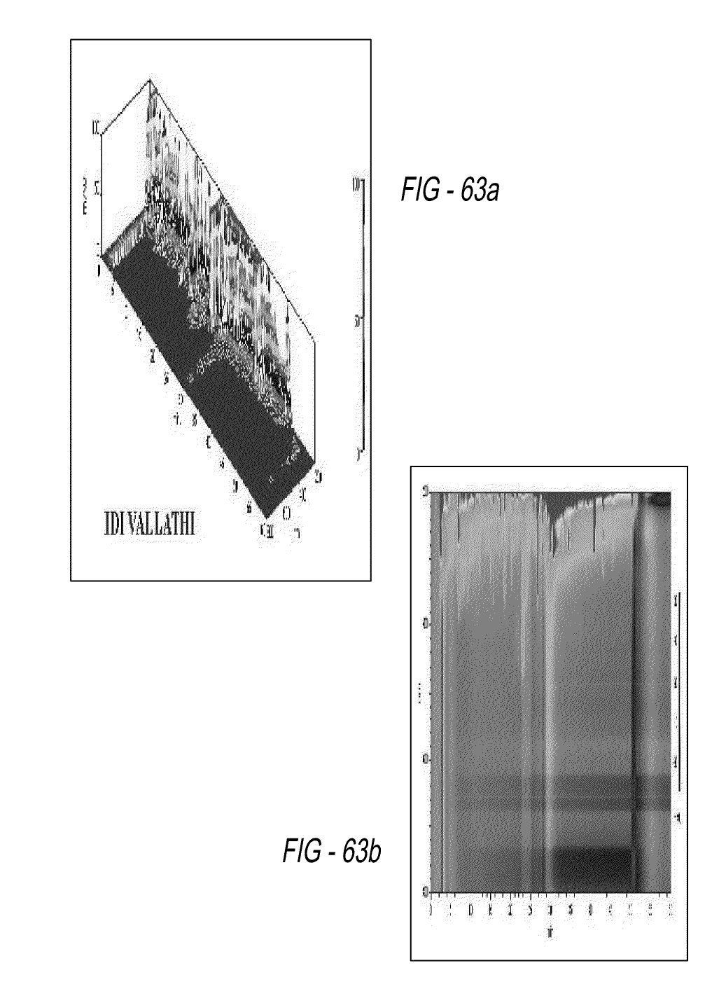

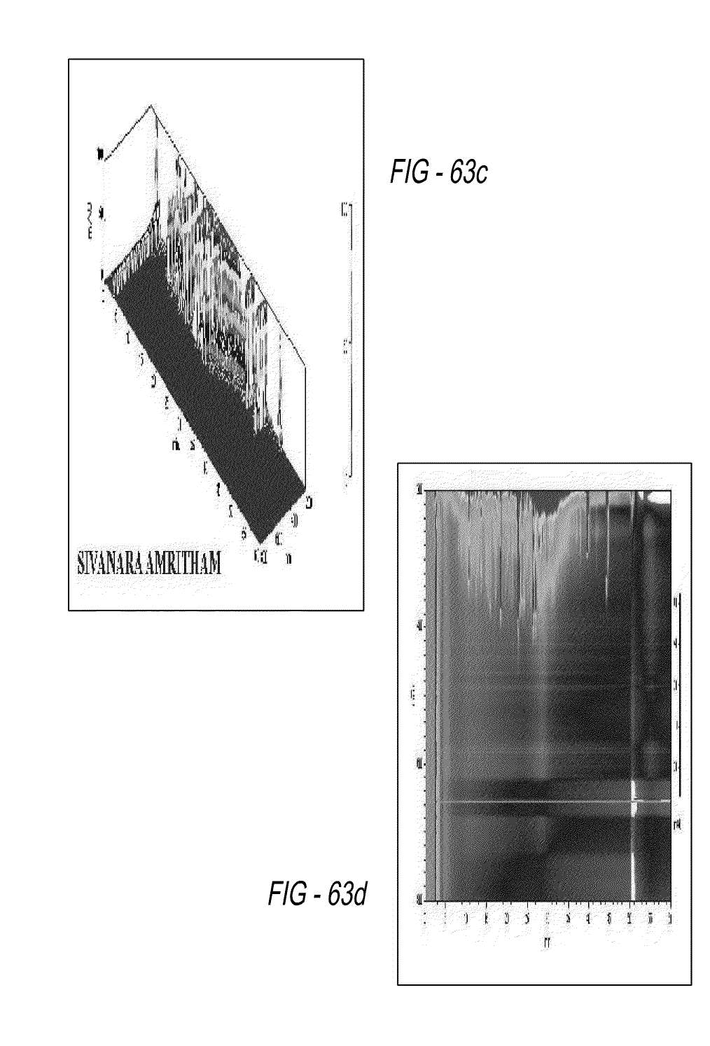

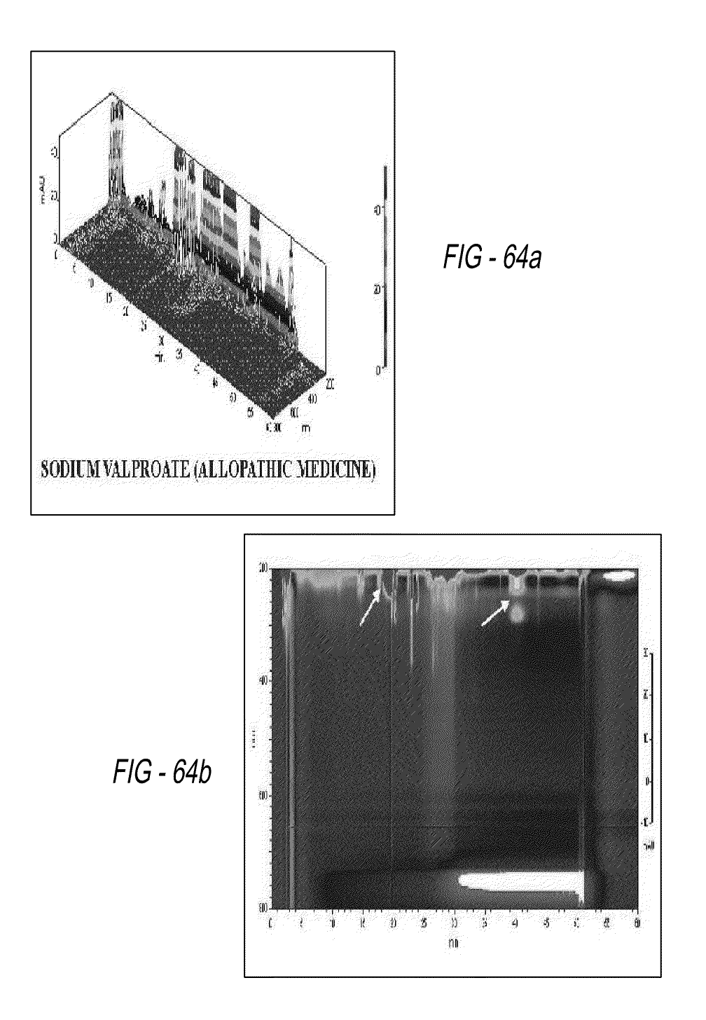

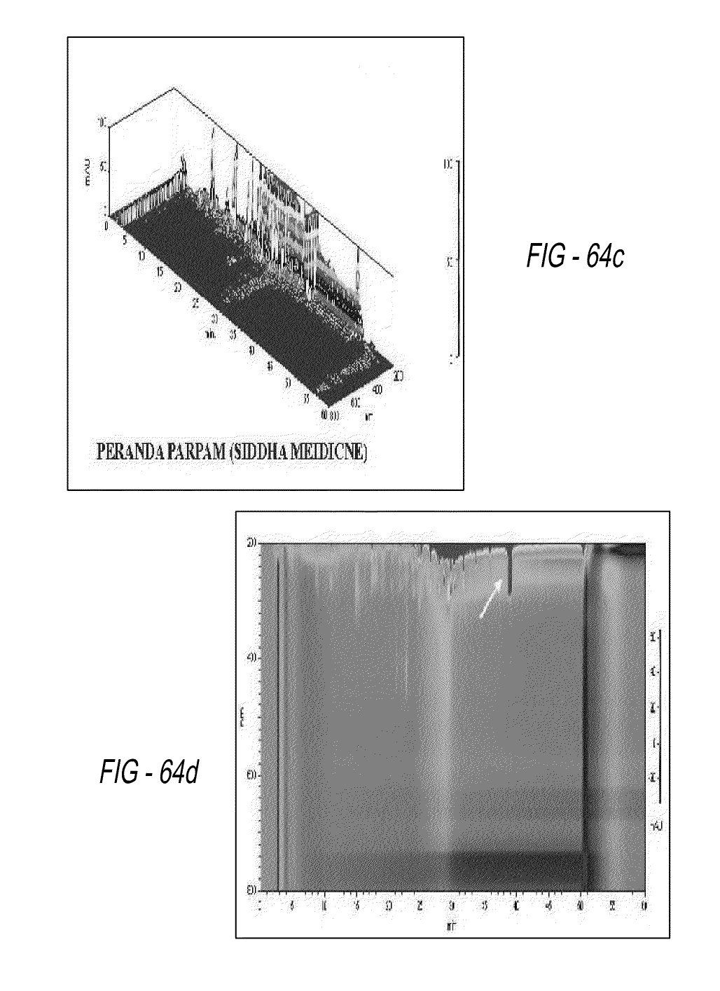

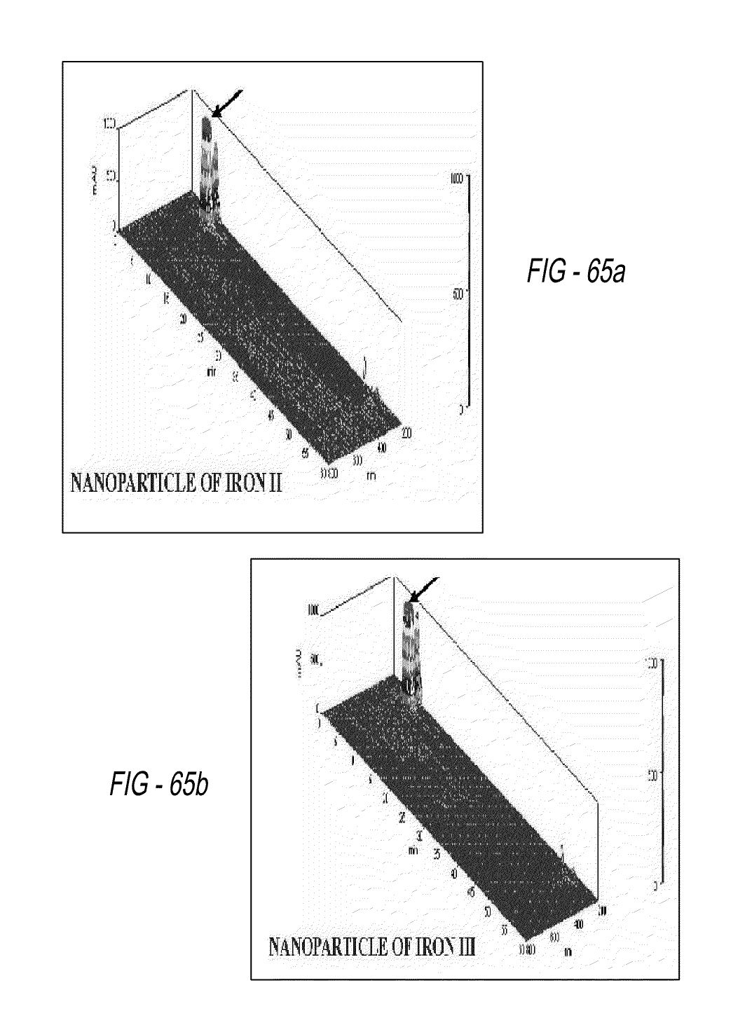

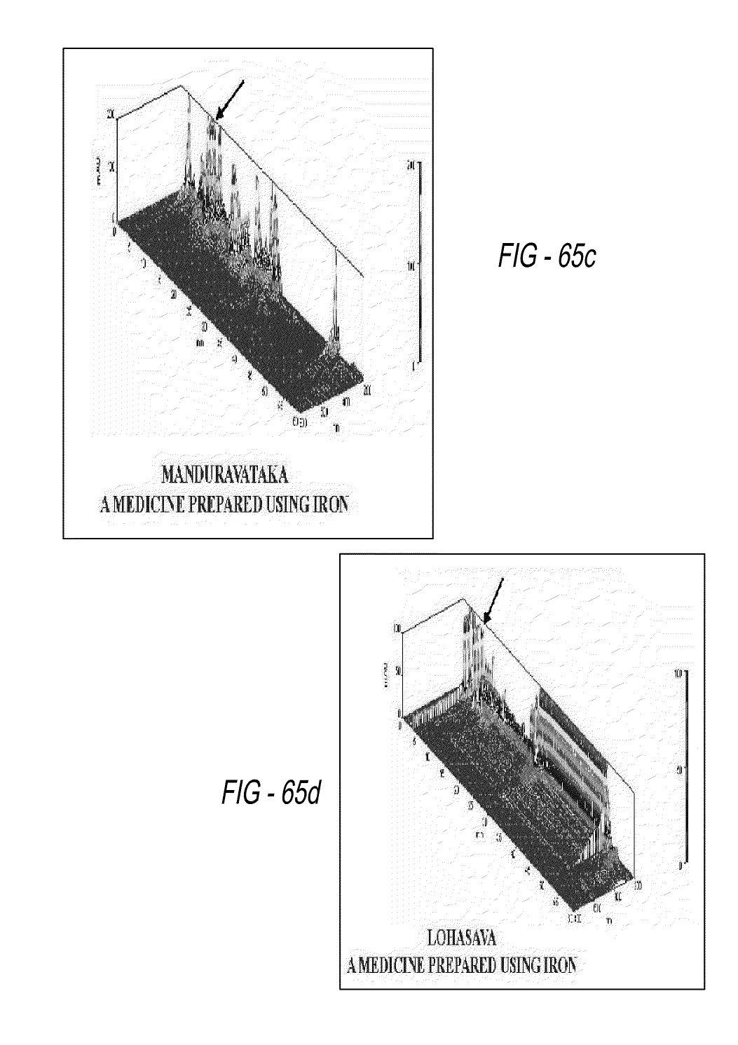

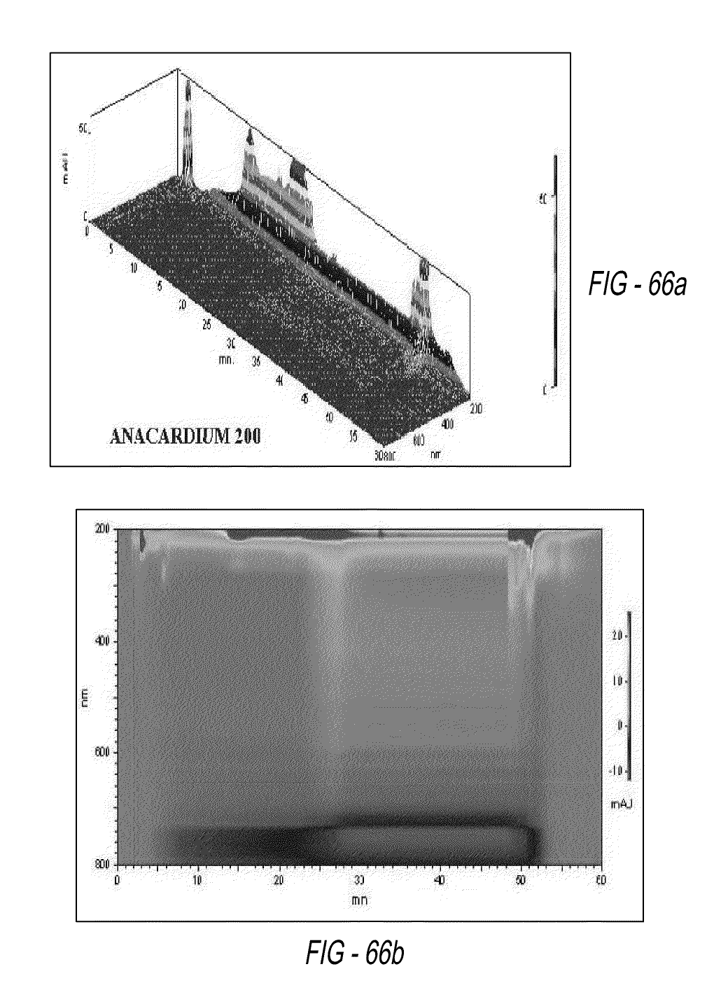

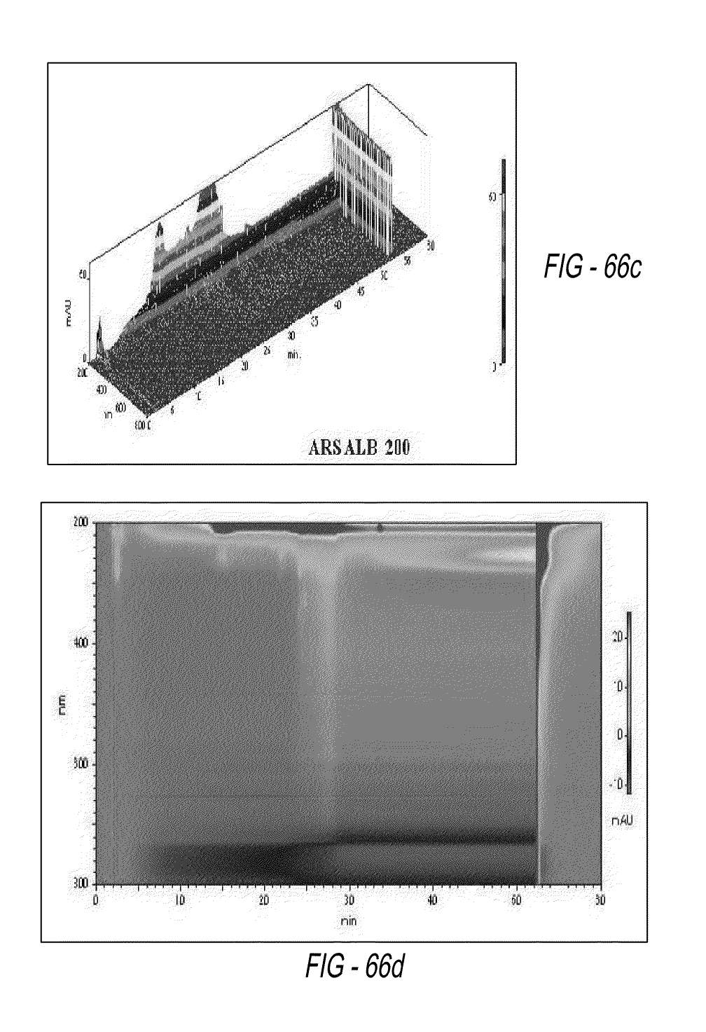

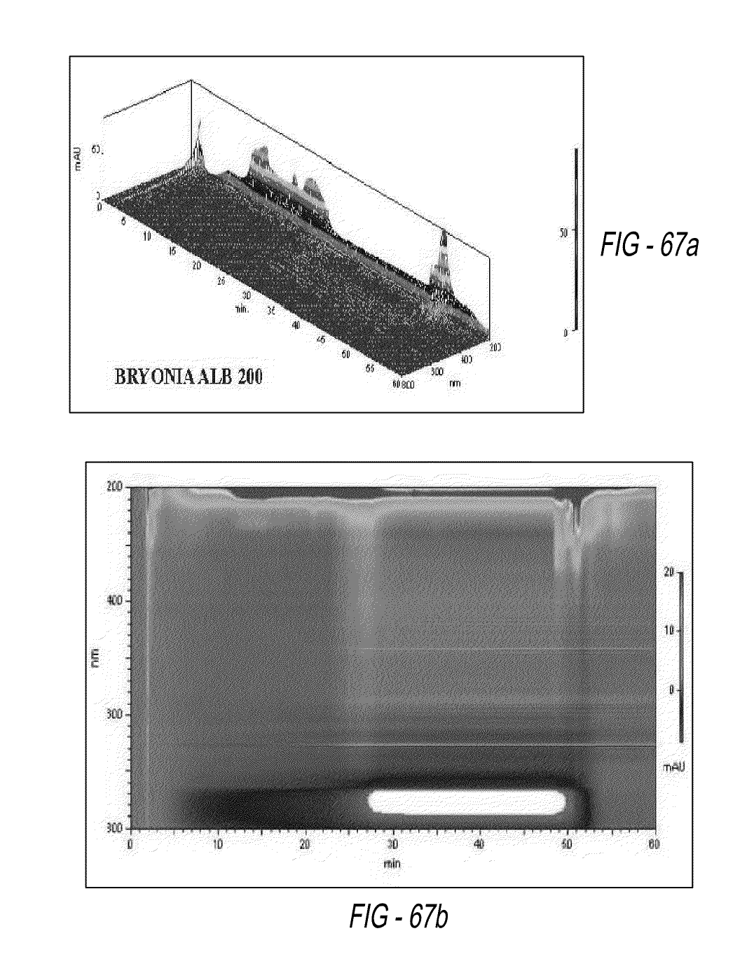

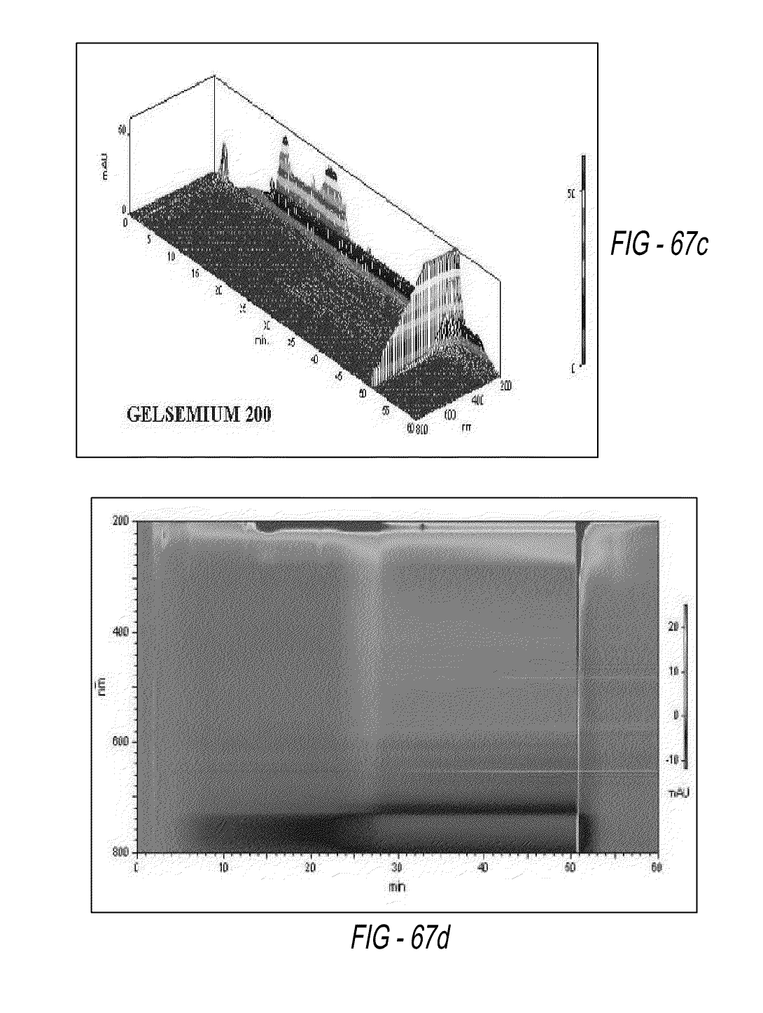

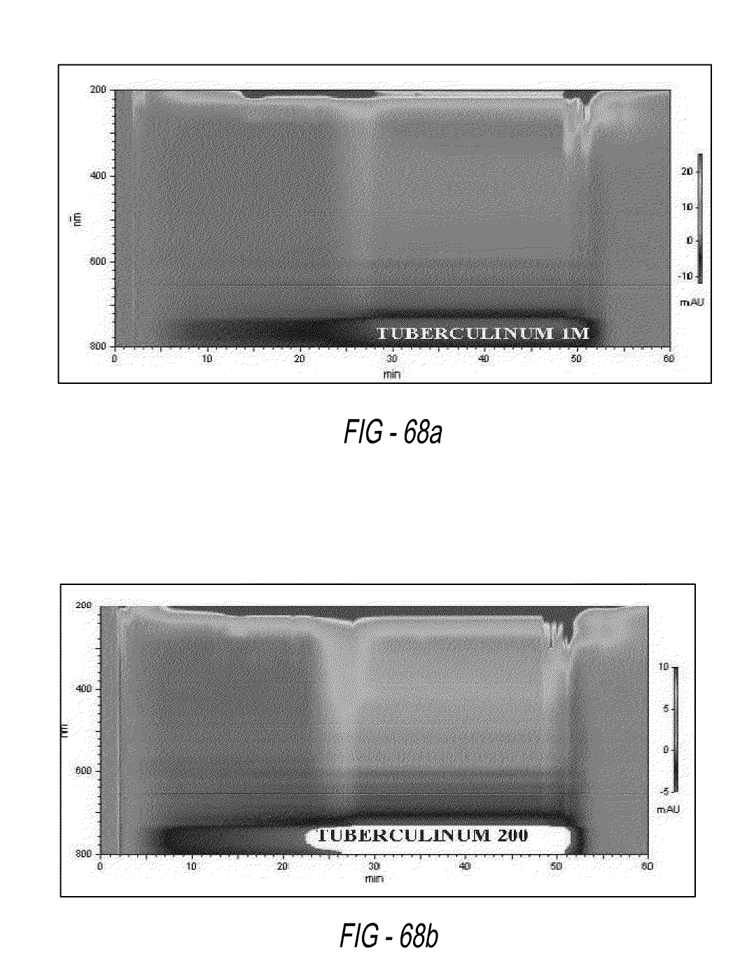

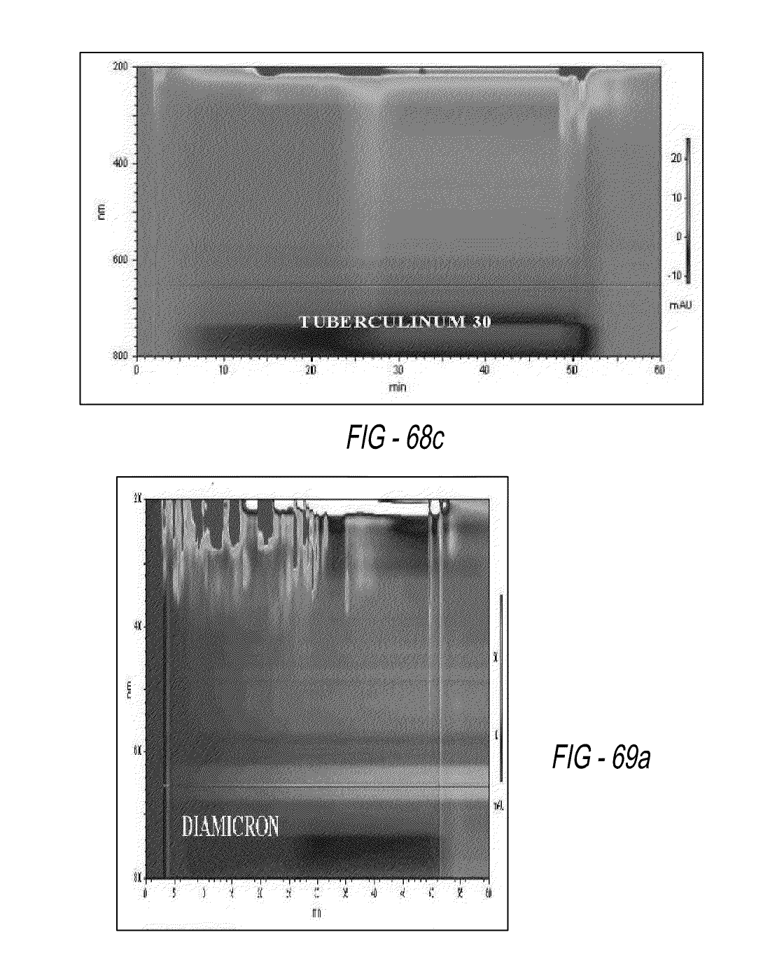

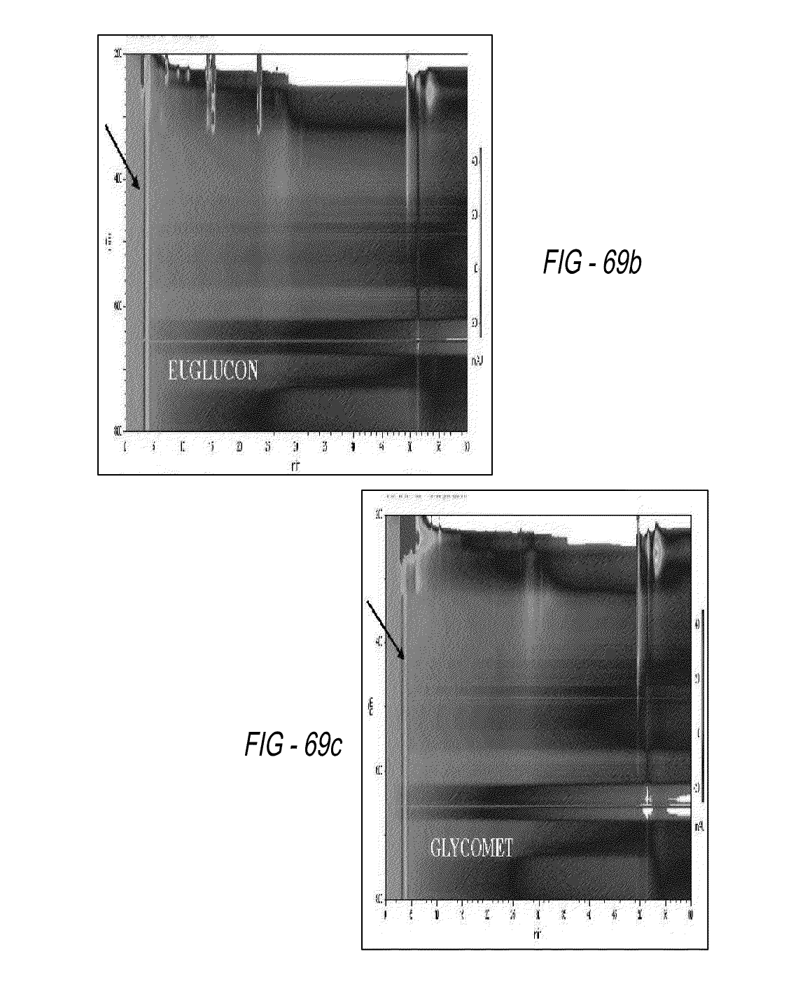

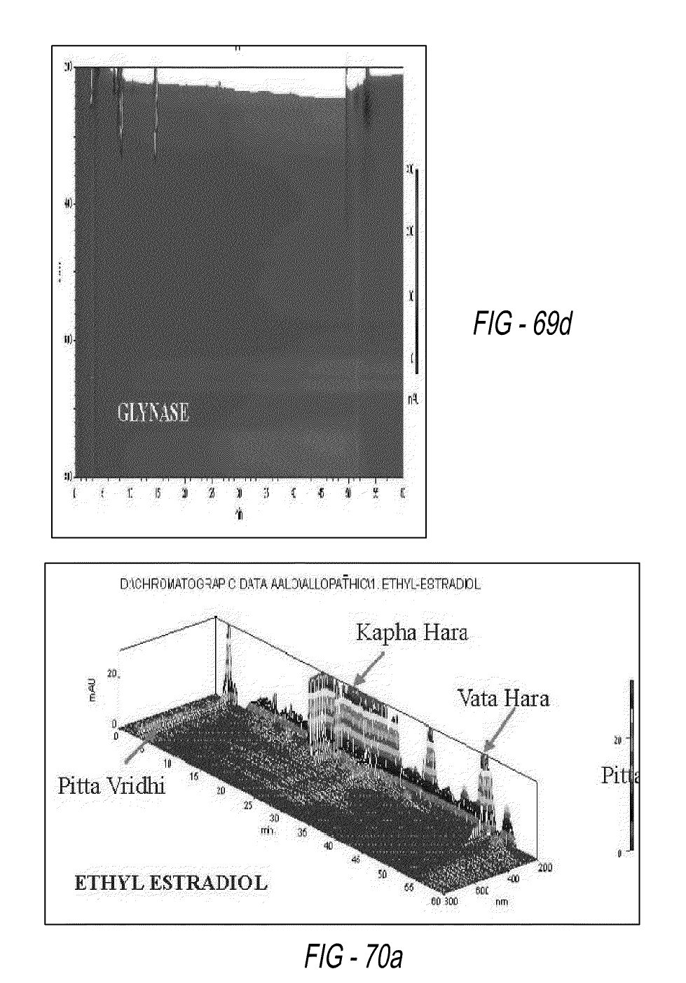

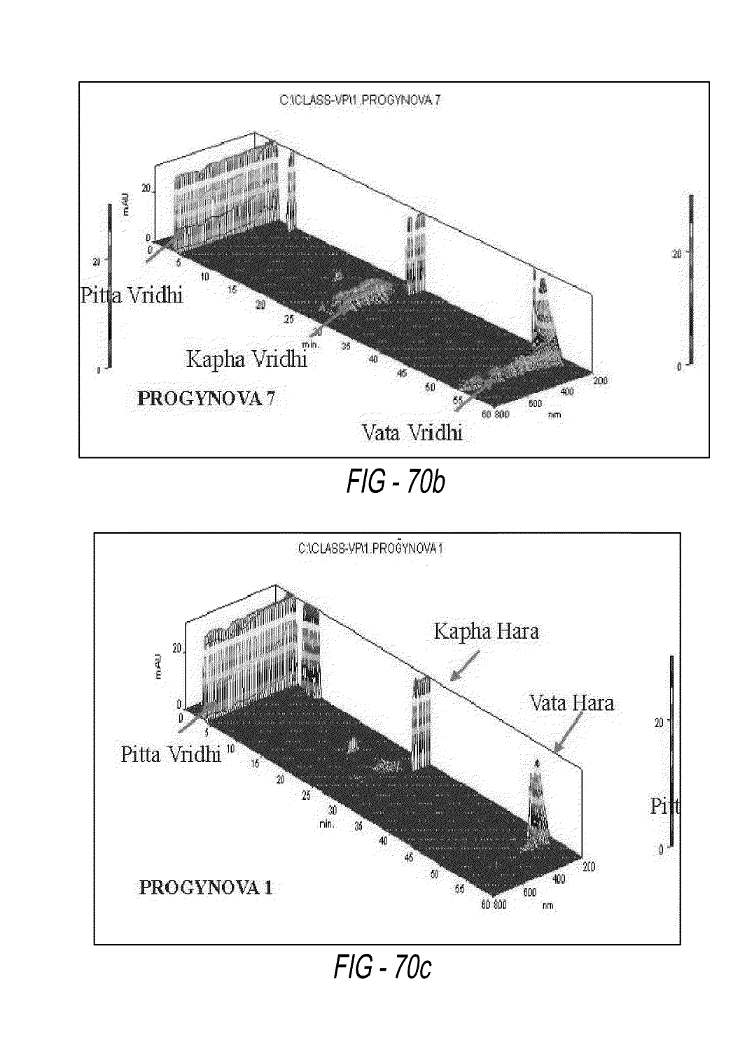

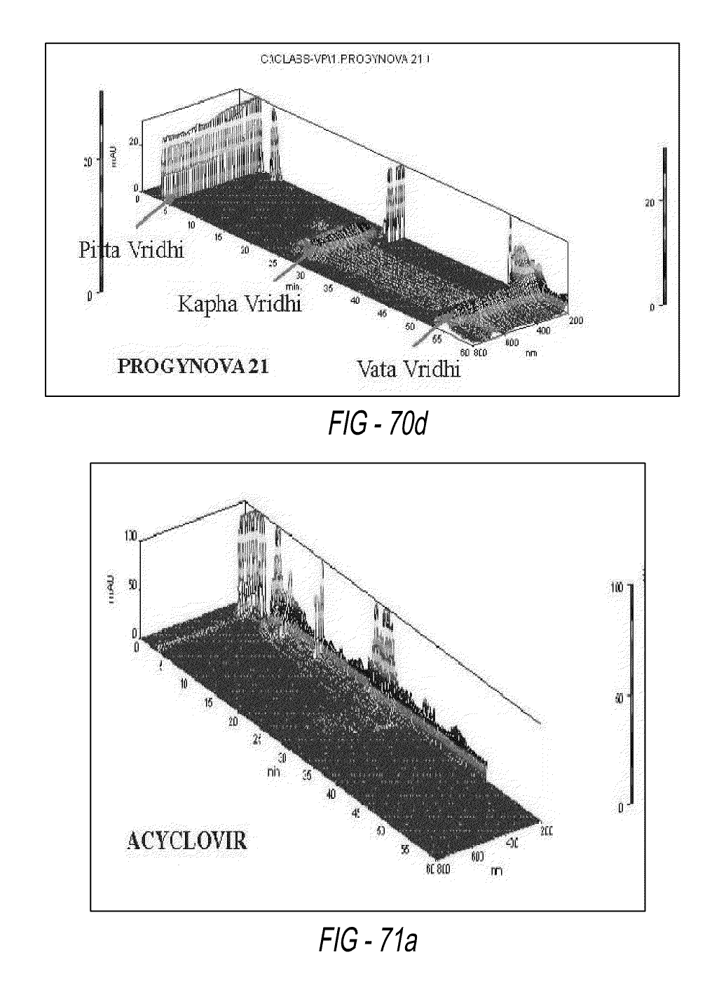

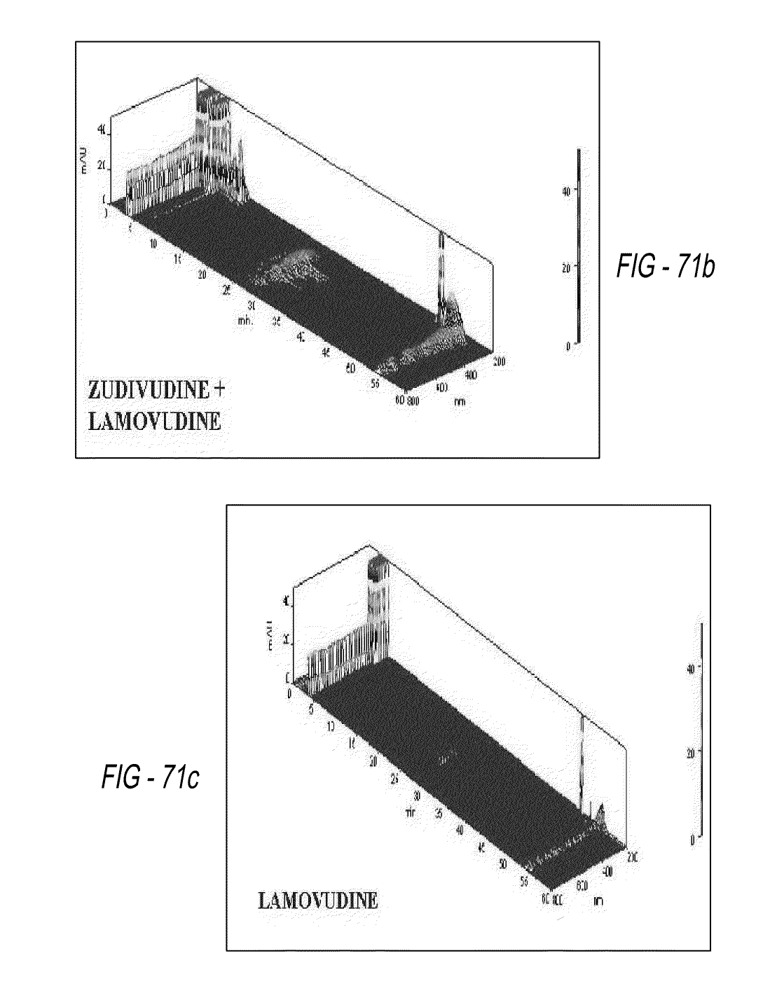

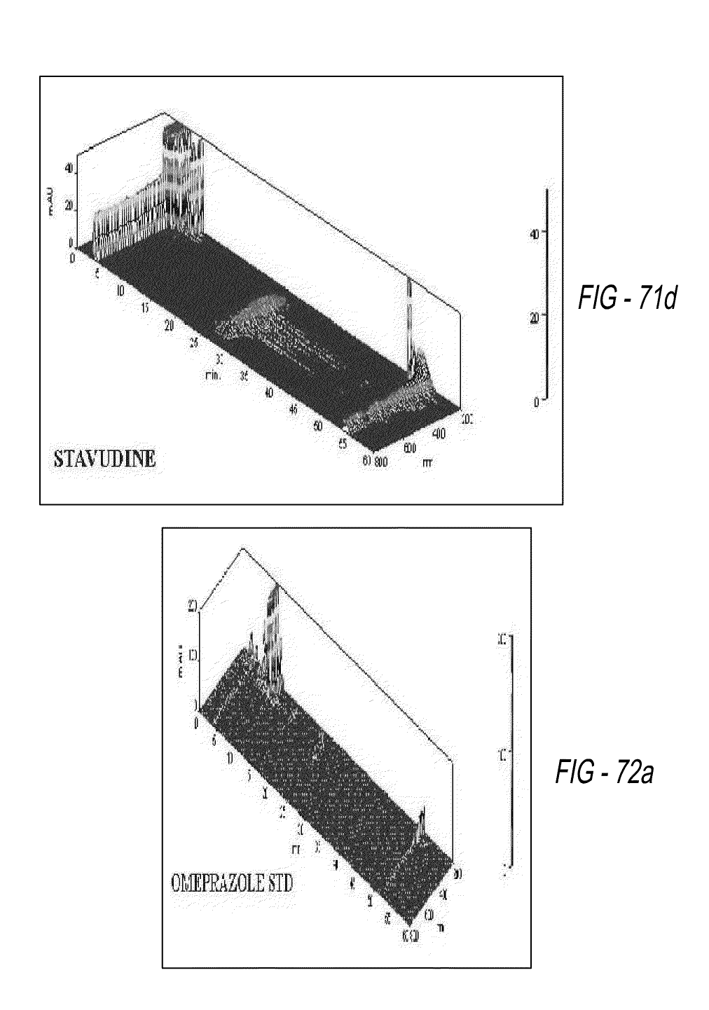

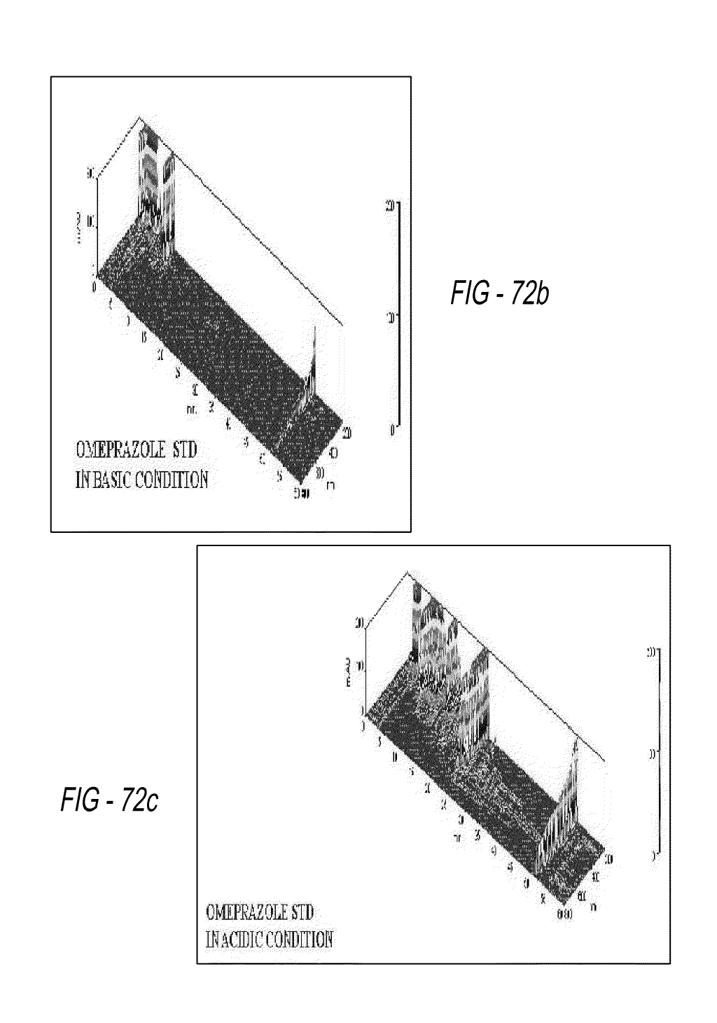

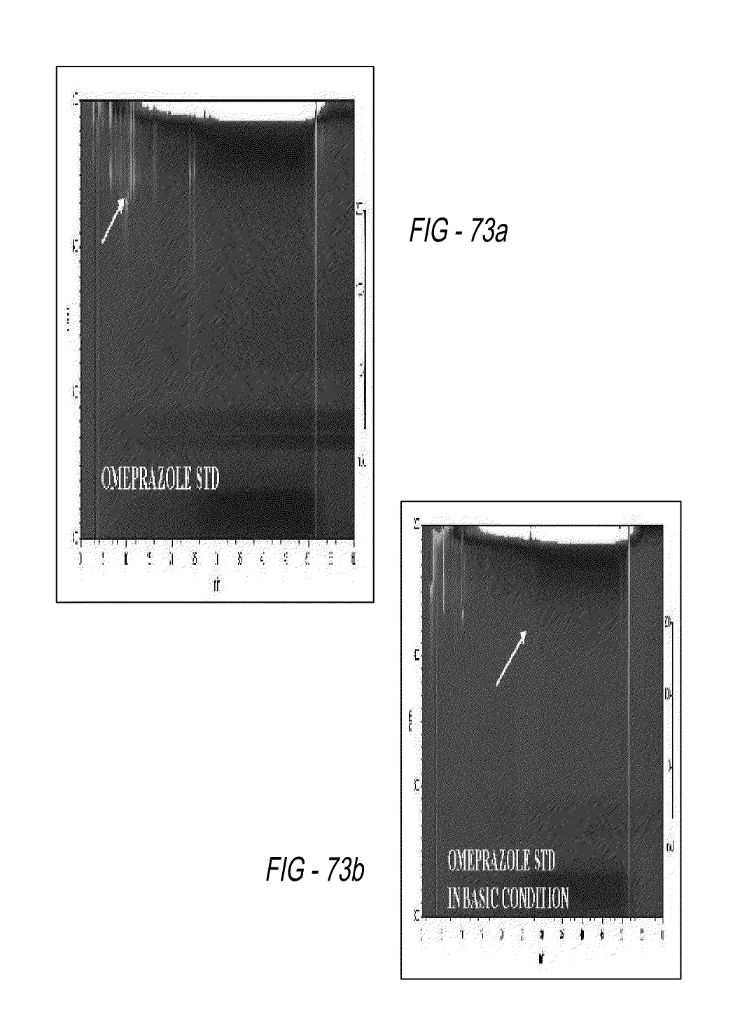

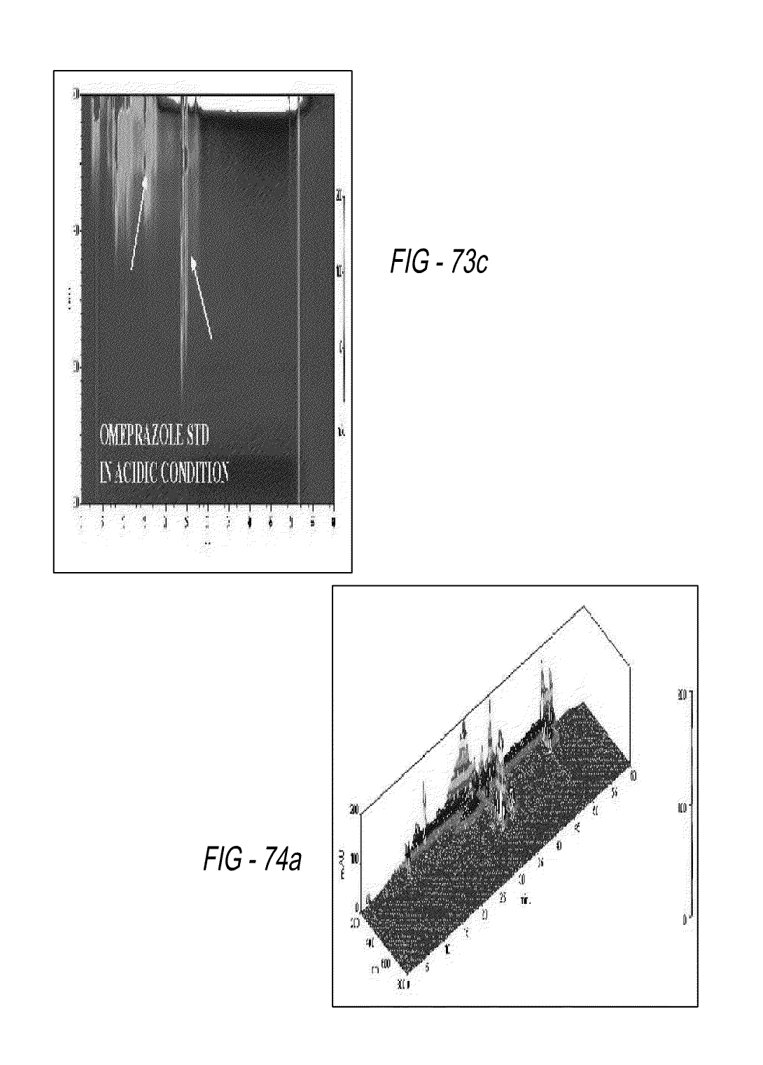

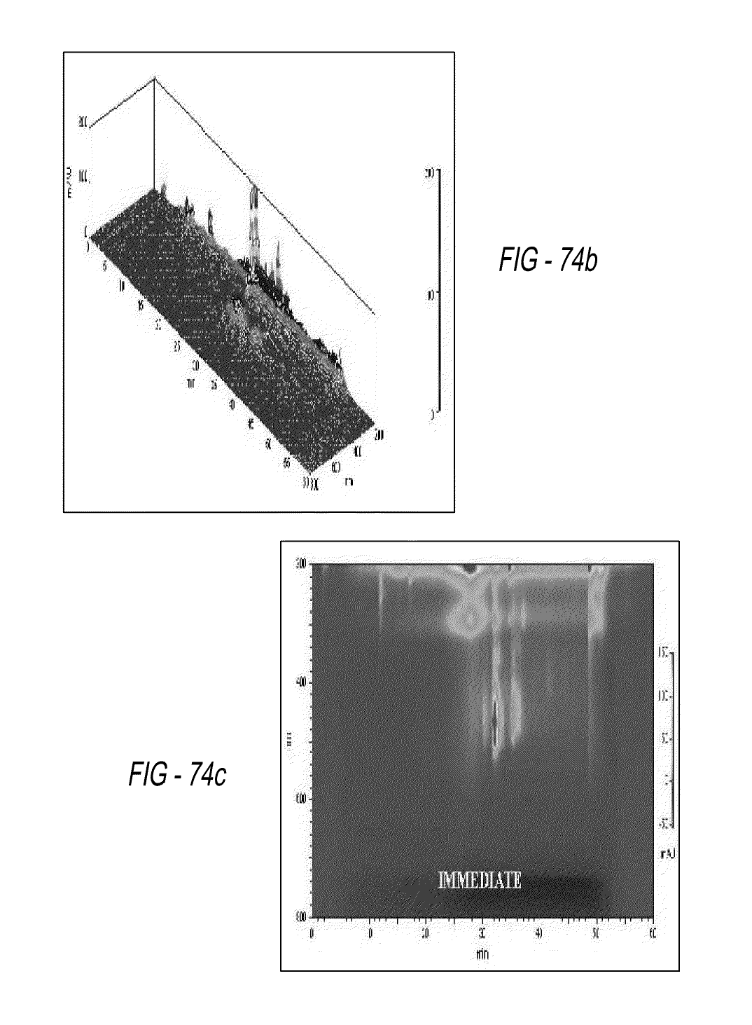

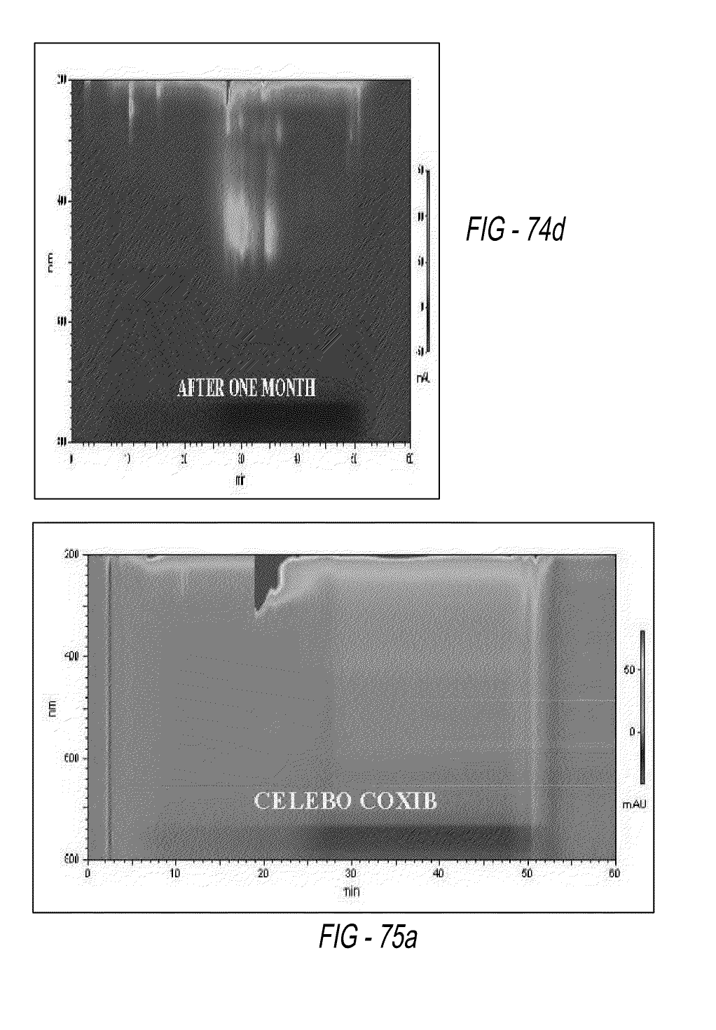

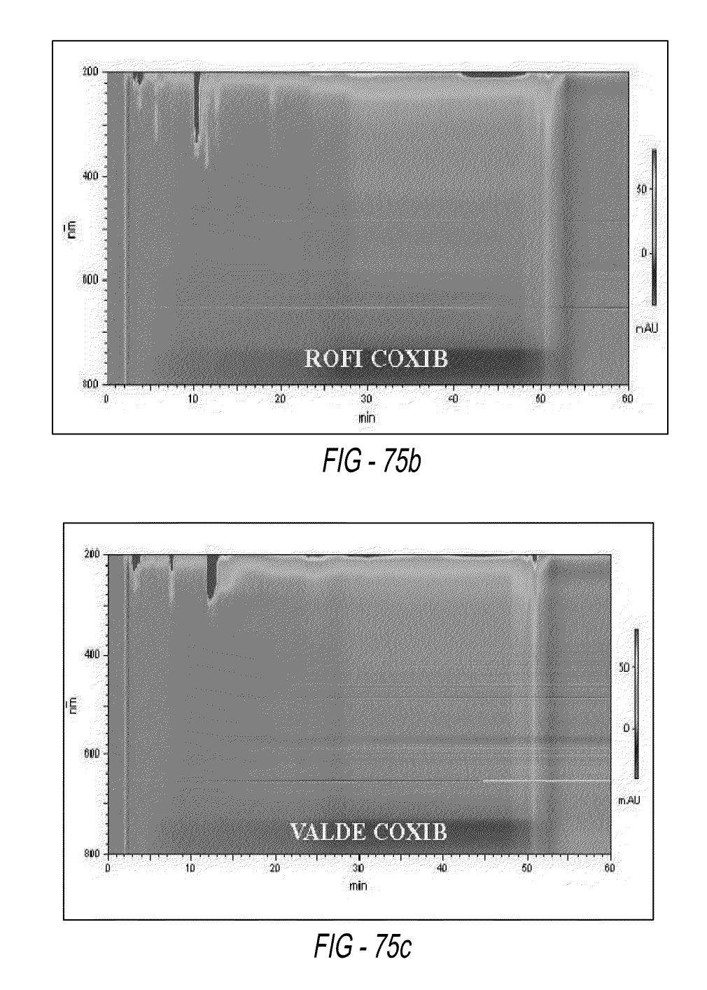

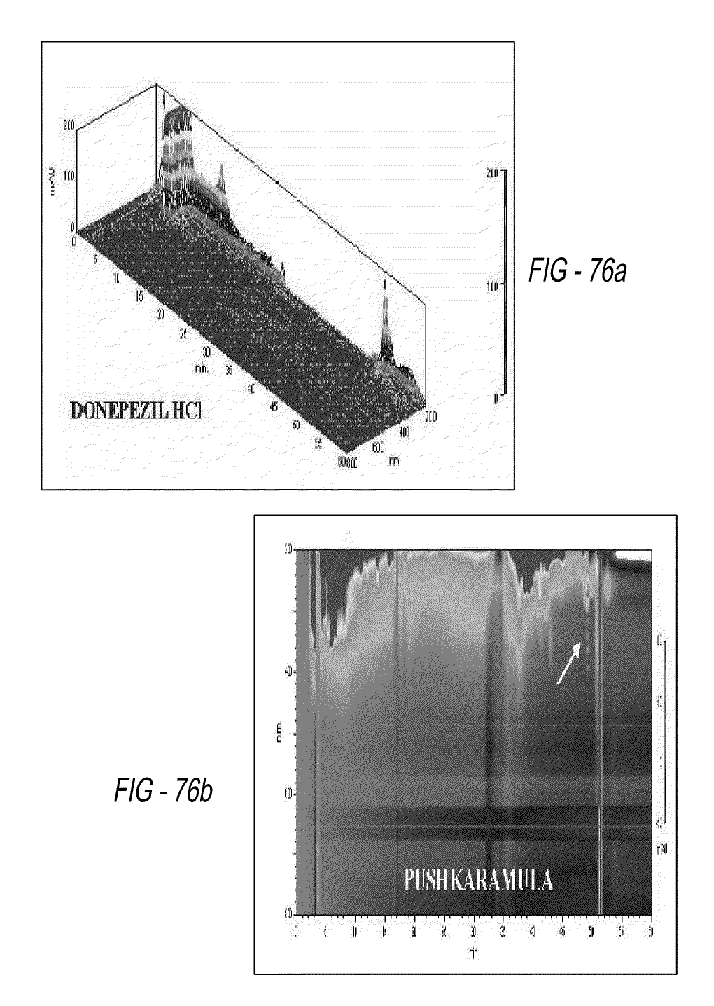

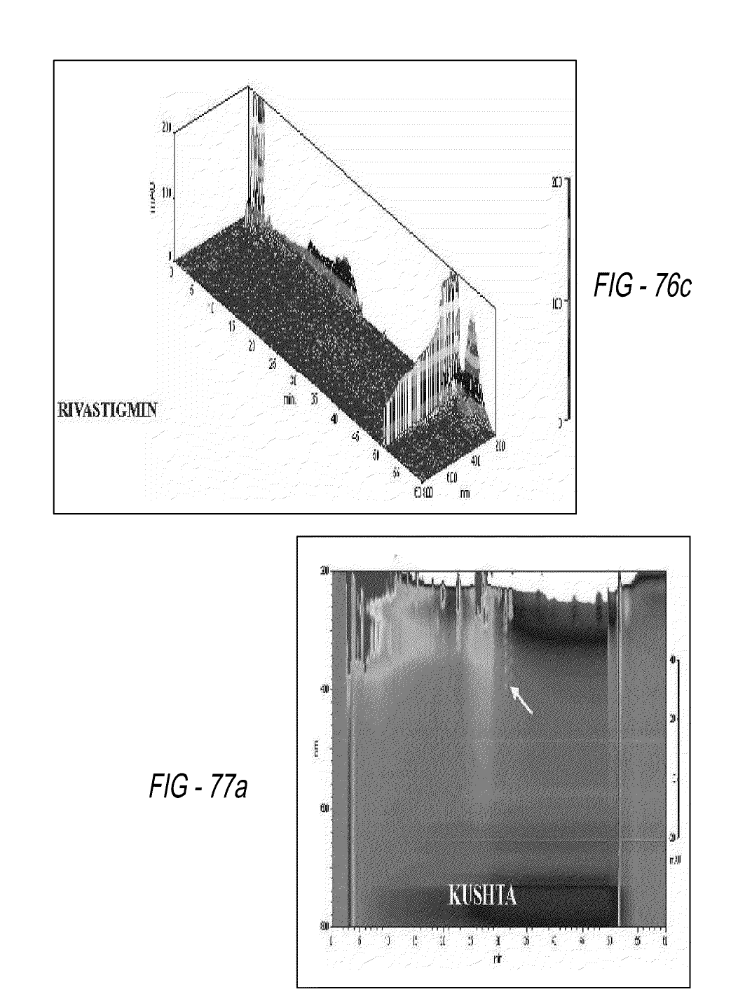

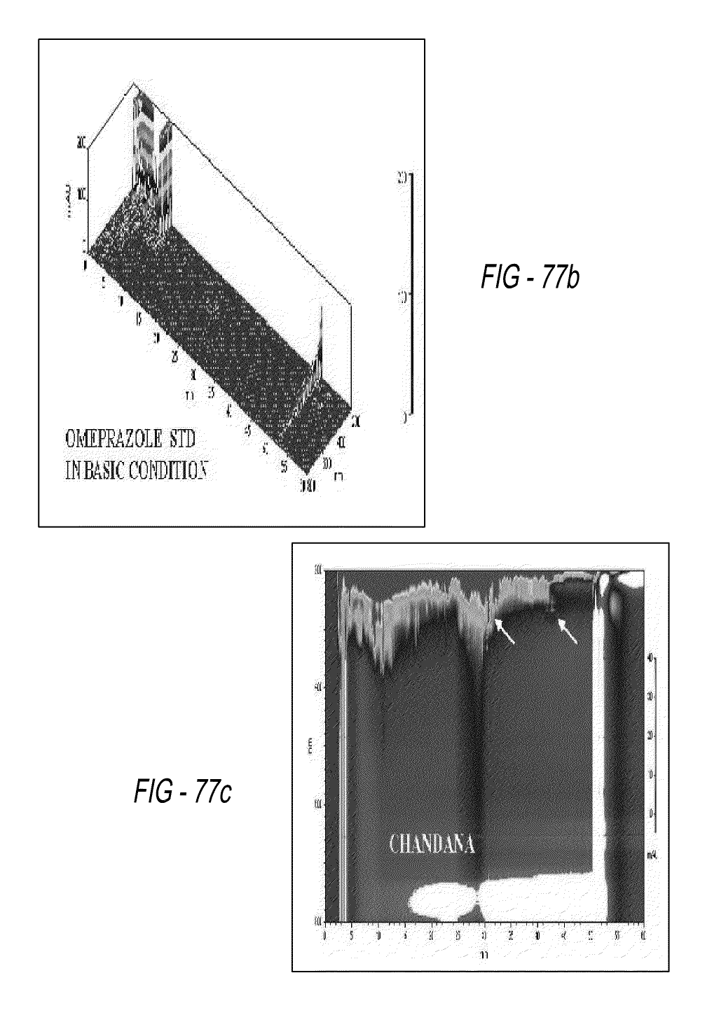

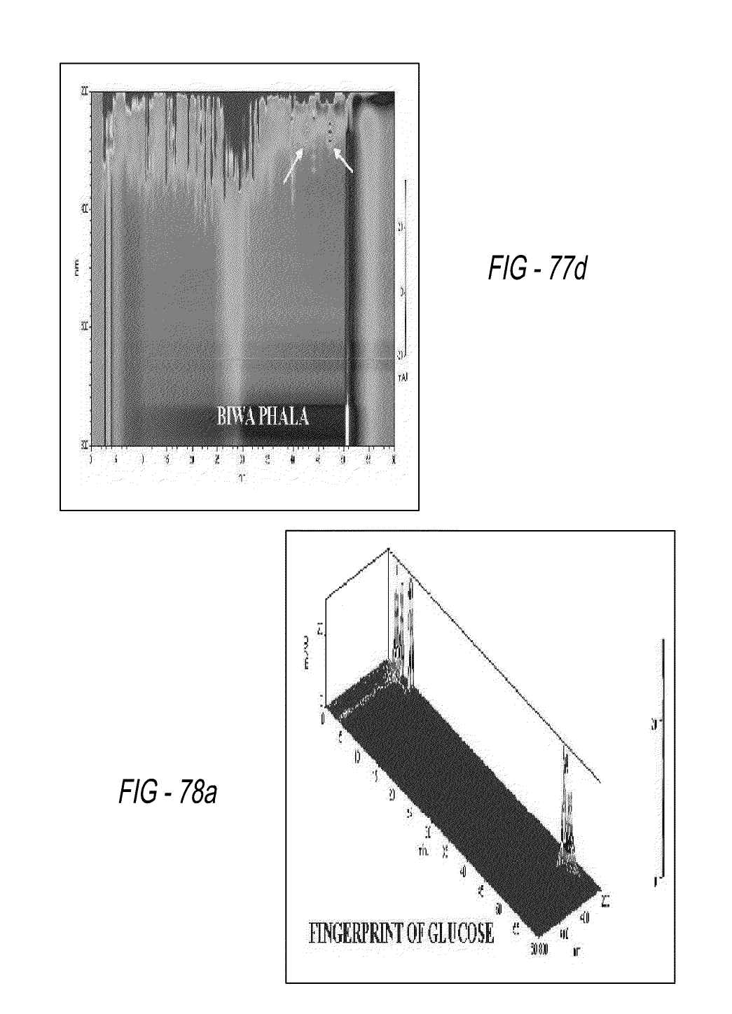

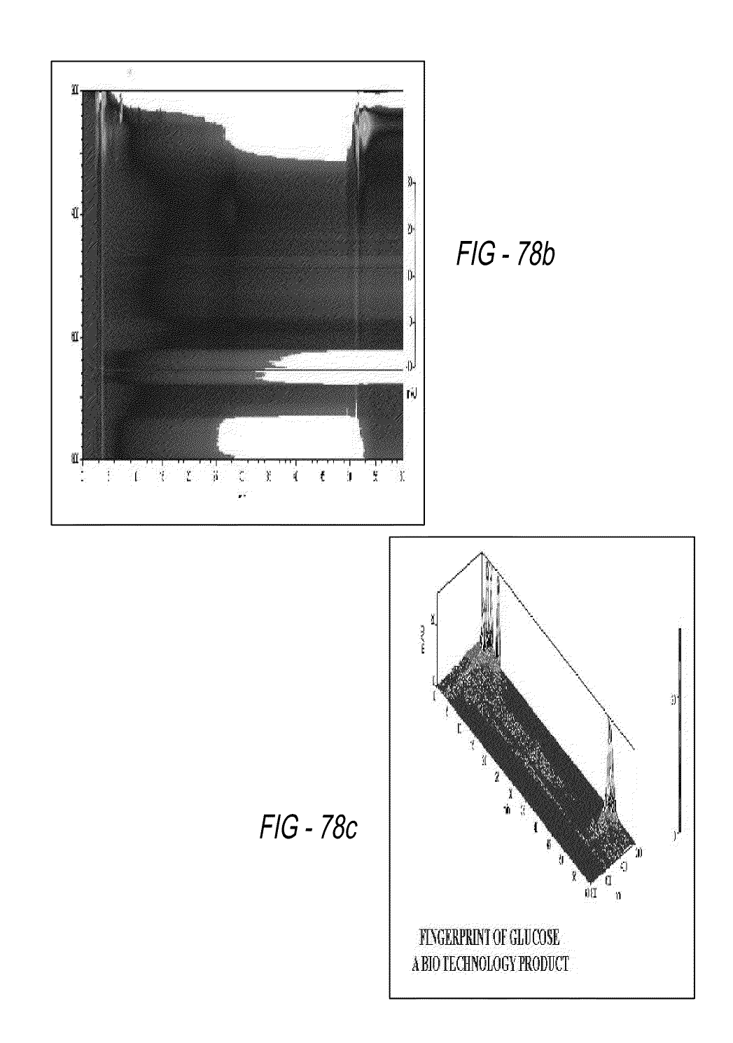

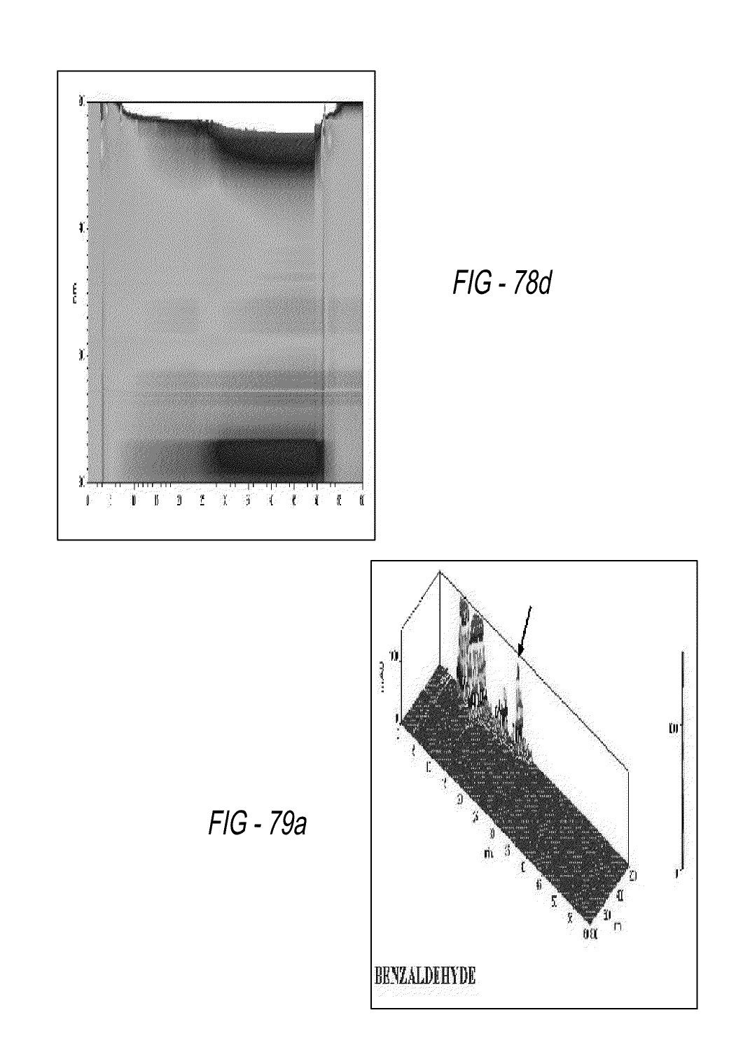

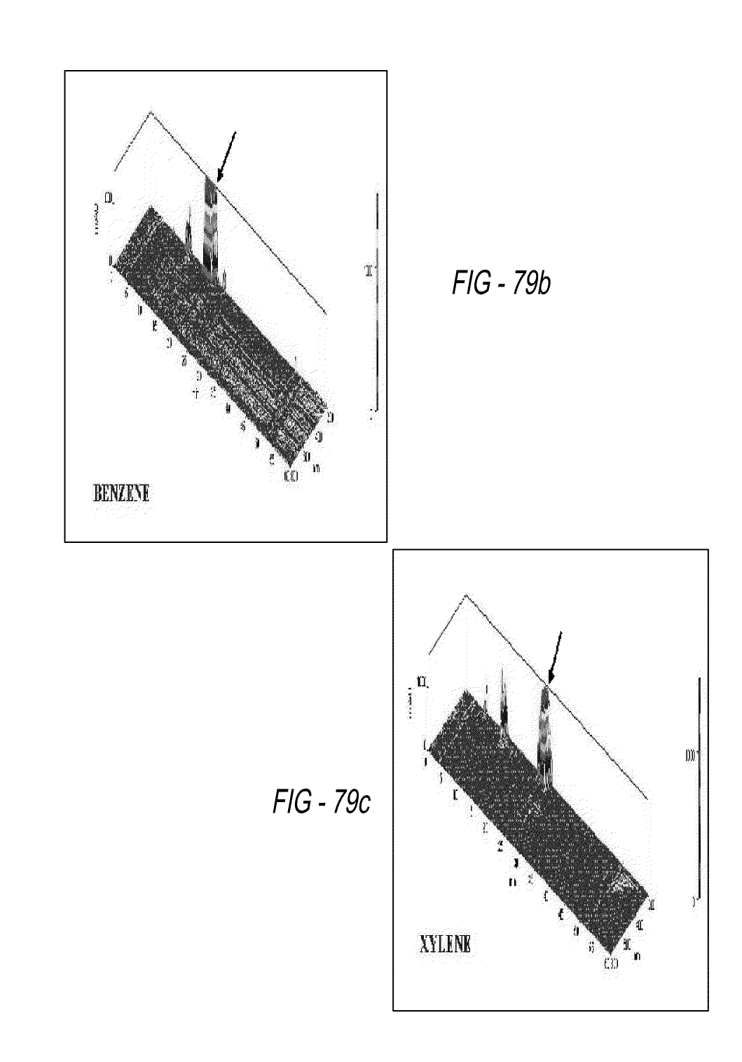

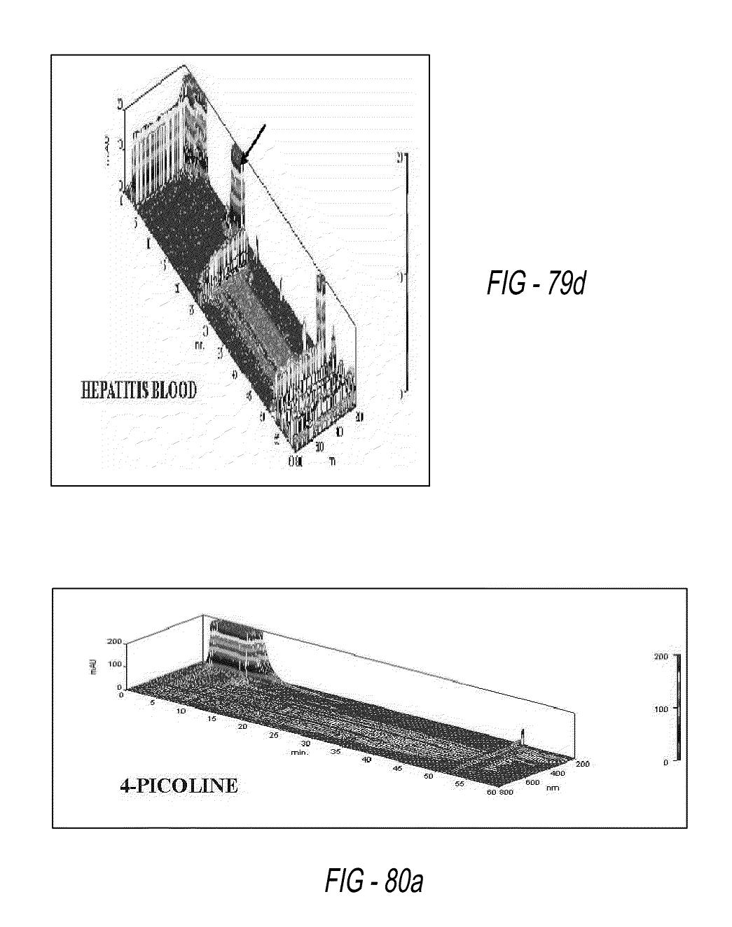

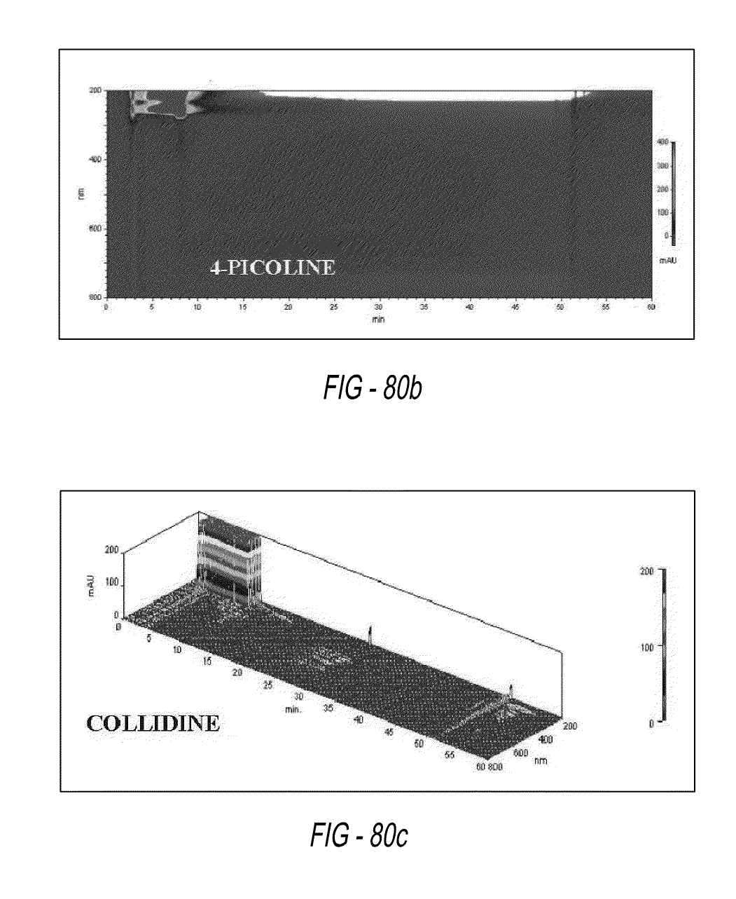

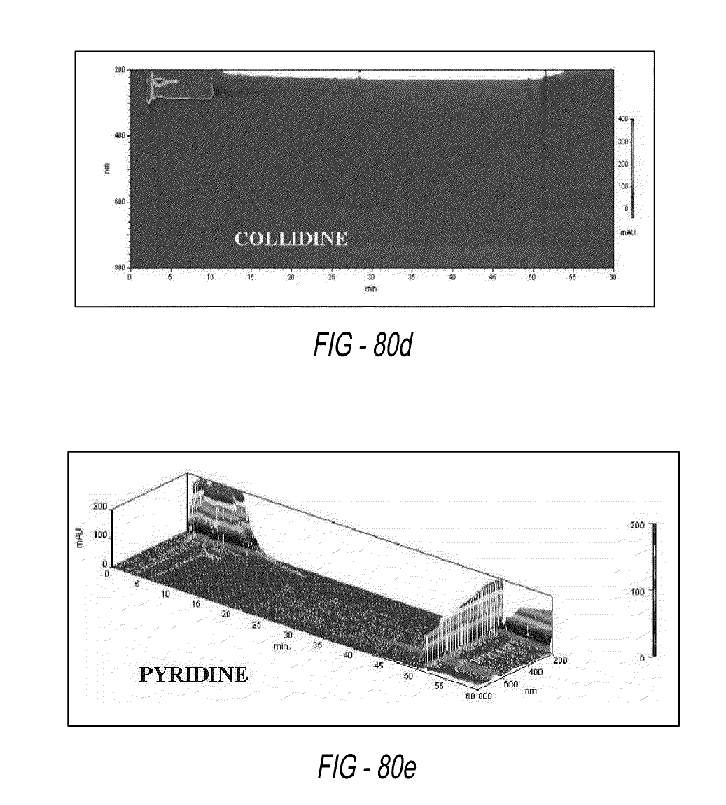

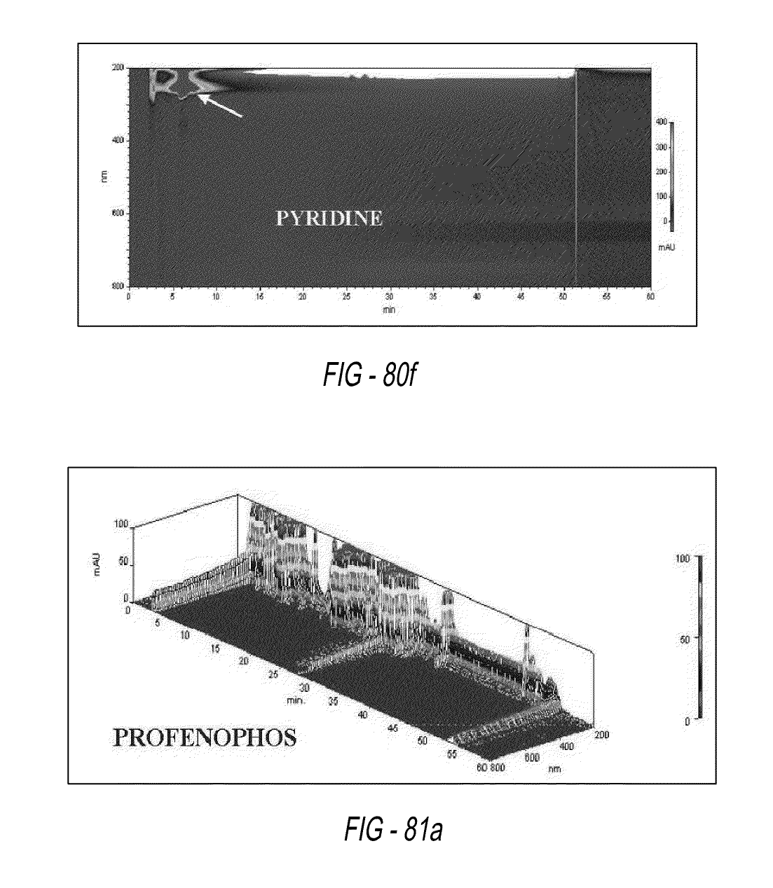

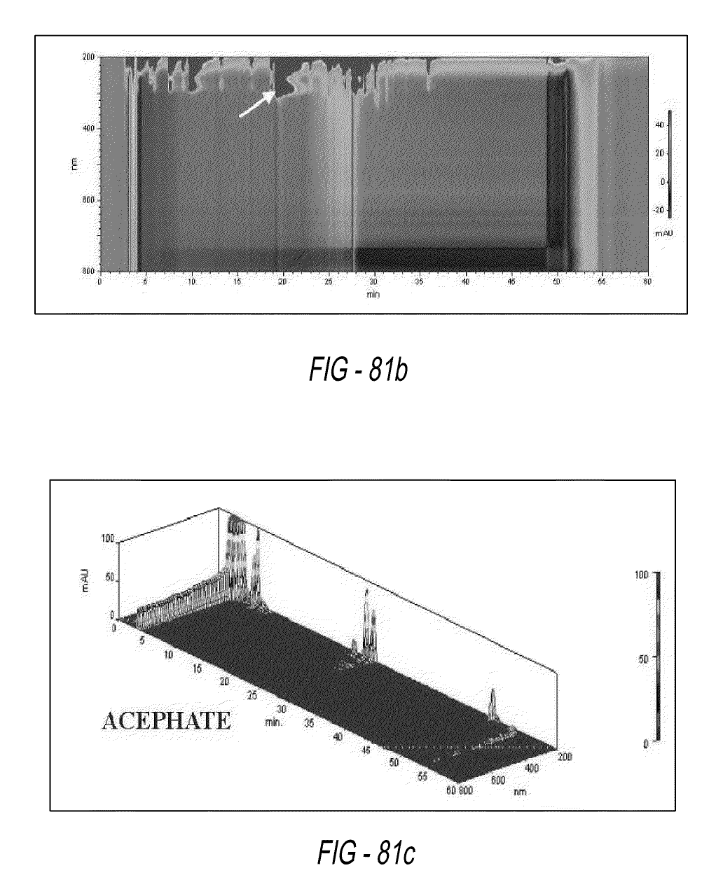

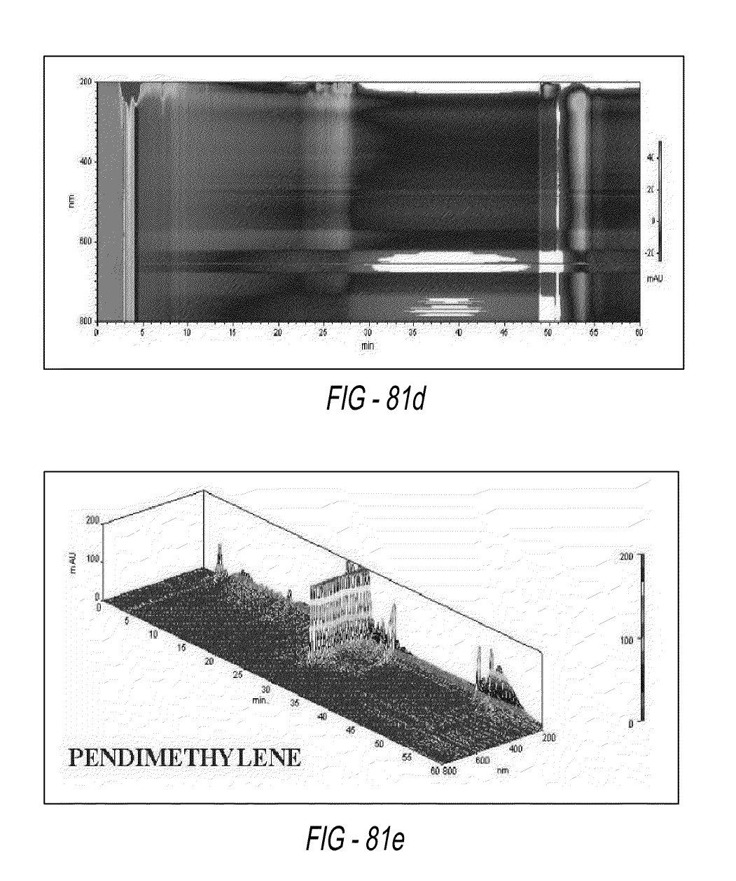

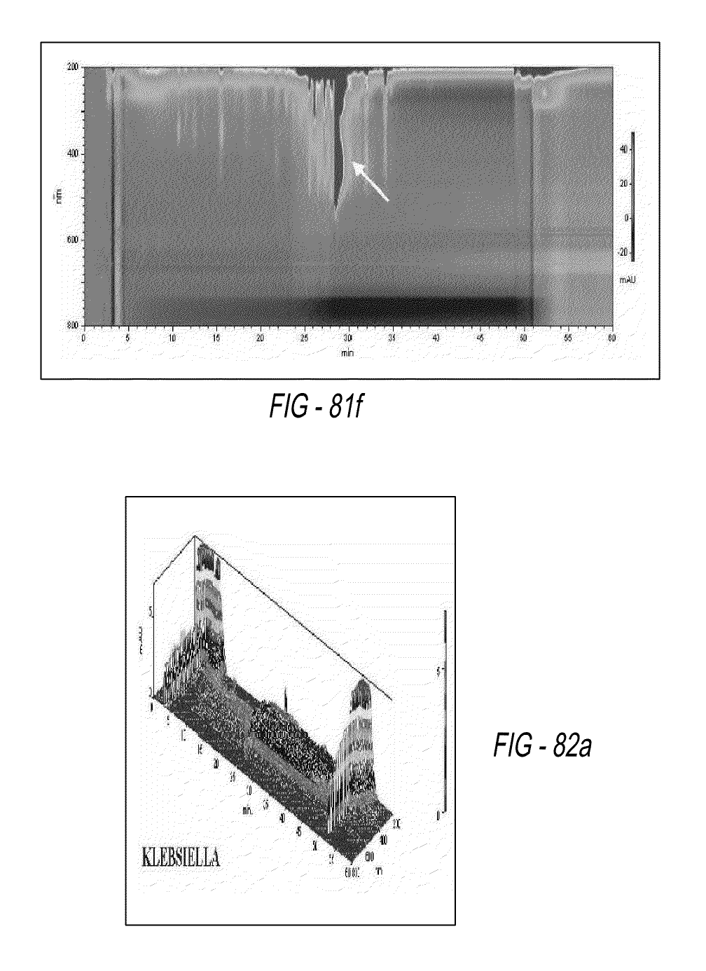

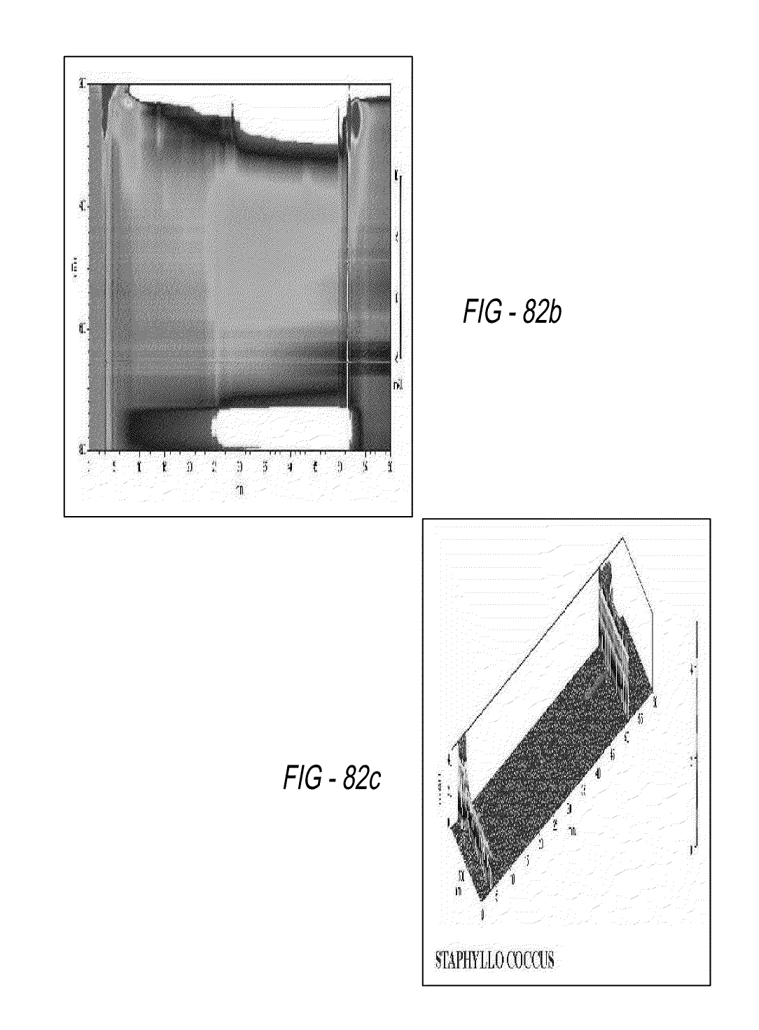

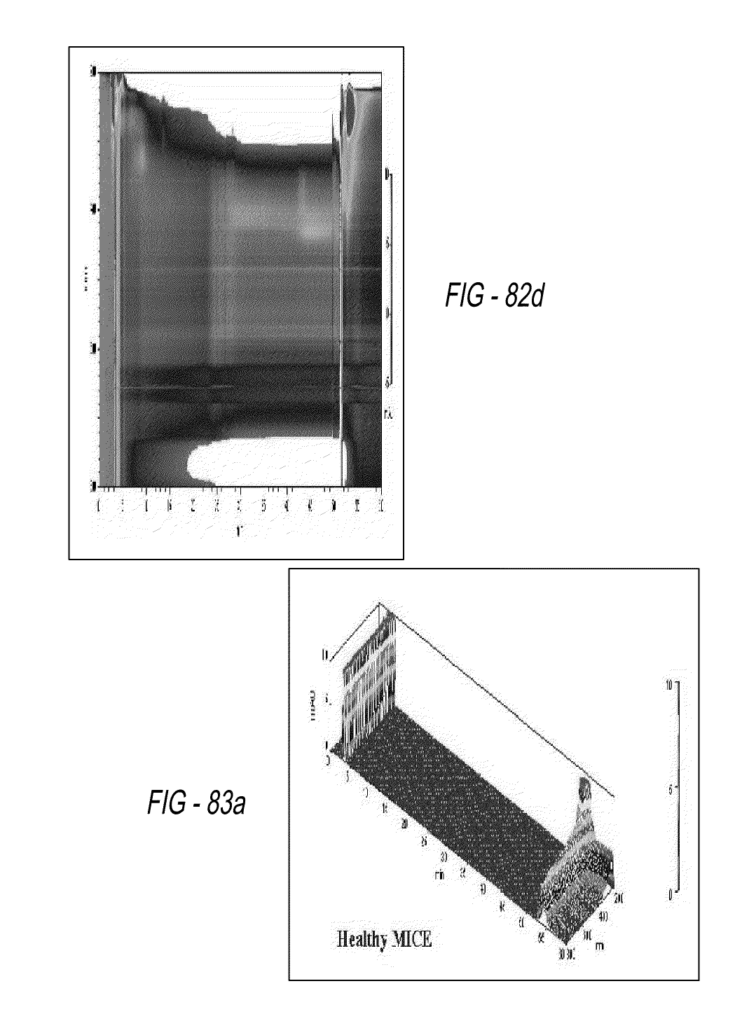

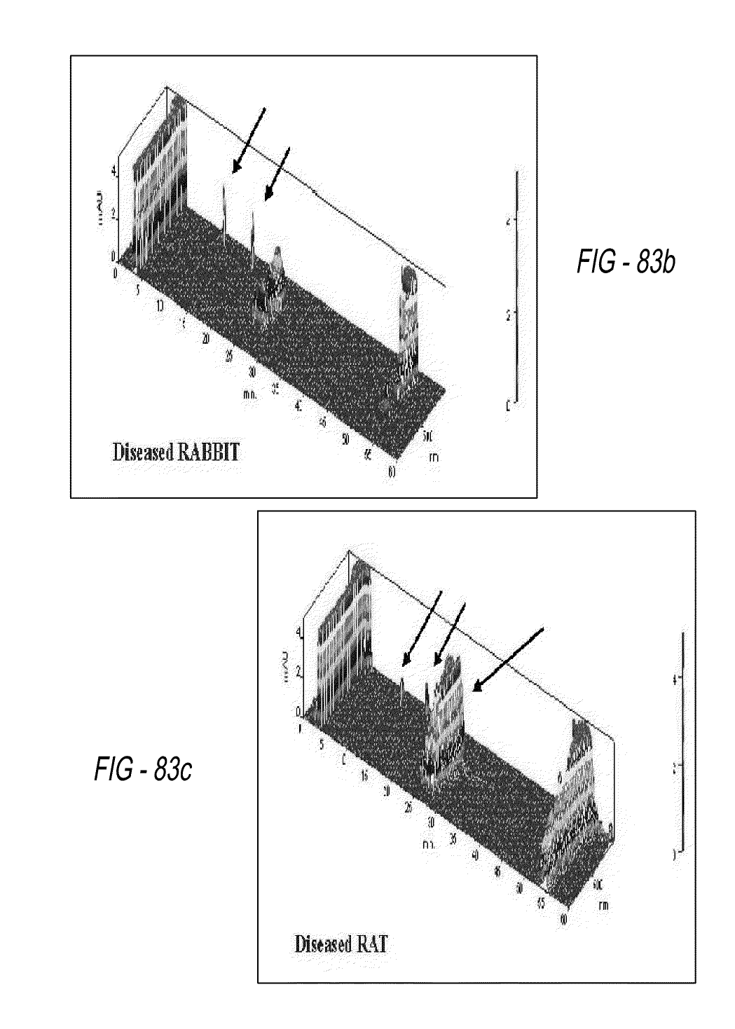

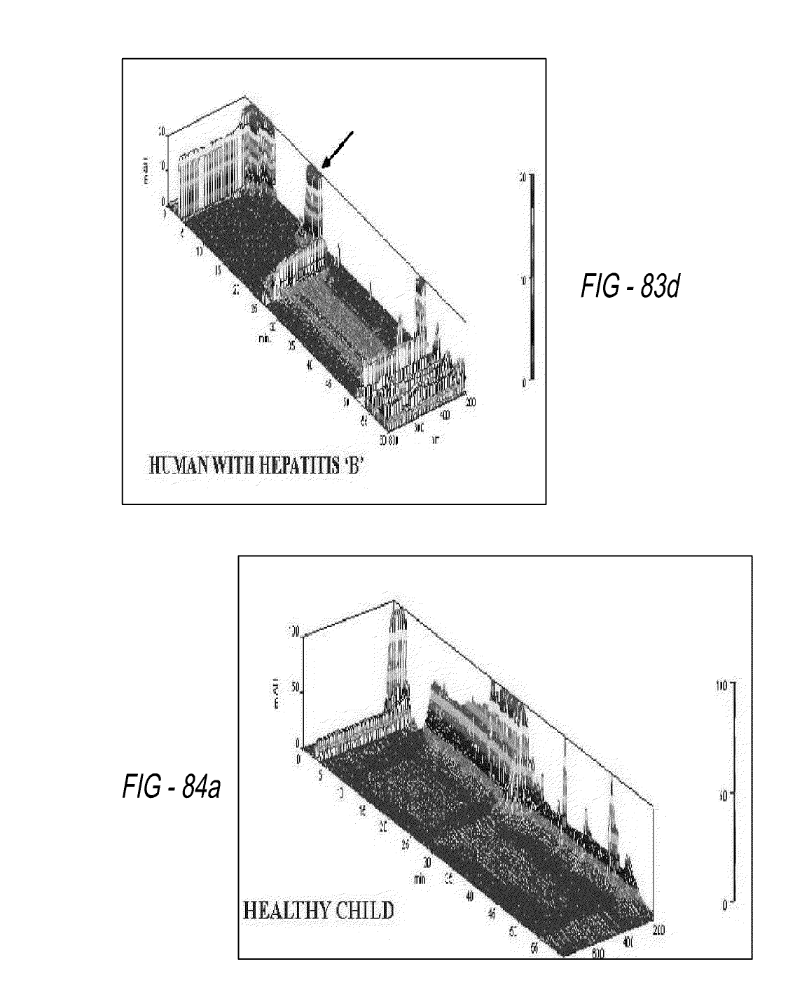

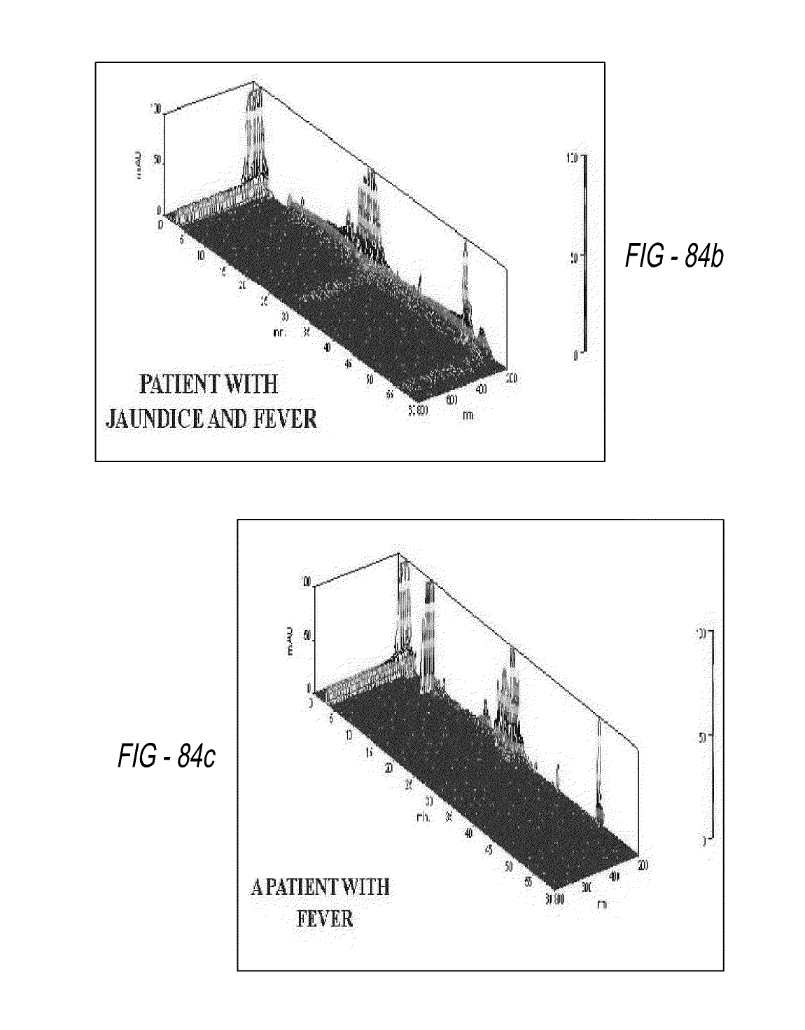

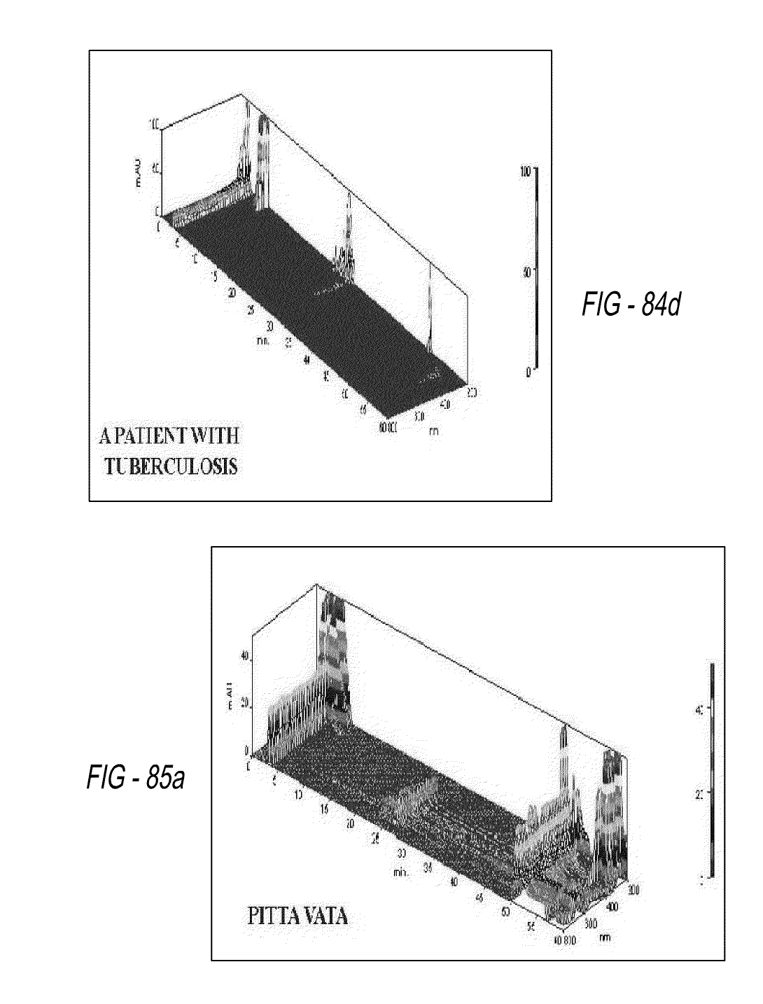

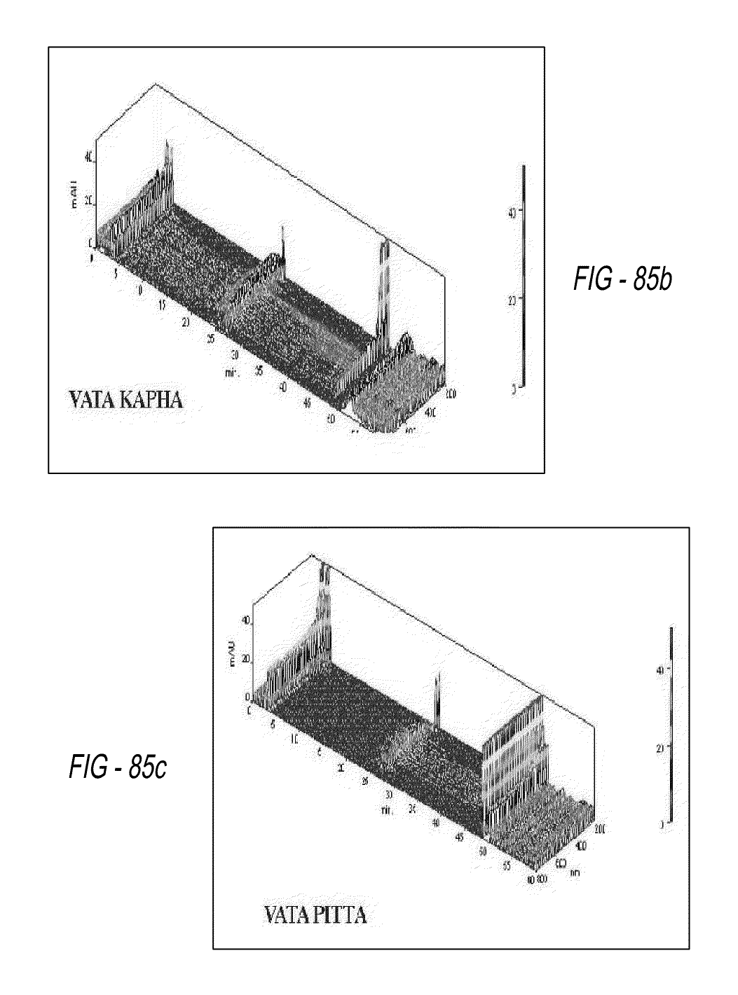

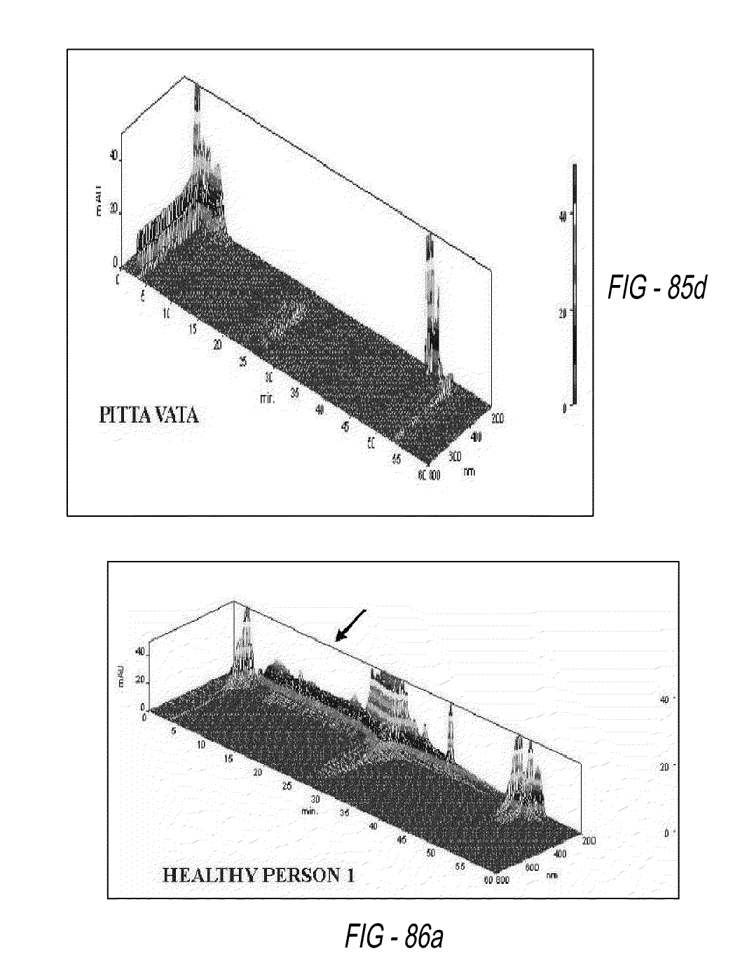

15. SANDHIVATA-

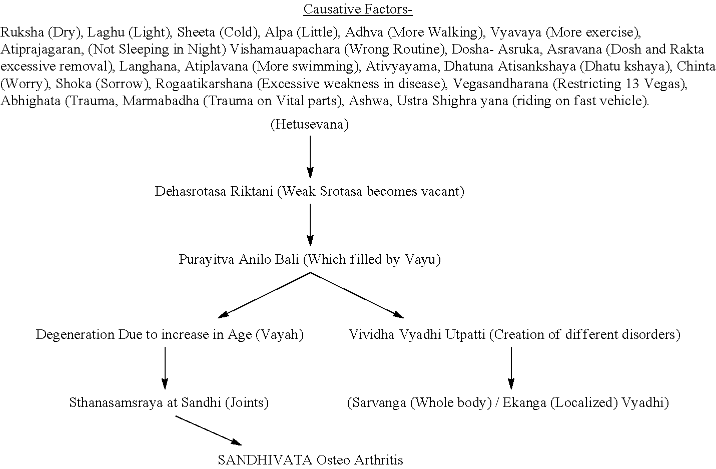

| Sr. No | TRADITIONAL TERMS | DESCRIPTION |
|---|---|---|
| 1. | Ayurveda | Traditional Indian system of medicine. It gives |
| | | equal importance to both preventive as well as |
| | | curative aspects. |
| 2. | Siddha | Traditional Indian system of medicine.. It gives |
| | | equal importance to both preventive as well as |
| | | curative aspects. |
| 3. | Unani | Traditional Indian system of medicine |
| 3. | Tridosha | Three basic humors present in the body, the |
| | | balance of which leads to healthy state and |
| | | imbalance to diseases. |
| 4. | Vata | The first and the most important of the three |
| | | humors that regulates all movements in the body, |
| | | visible and invisible to the naked eye. Vatha |
| | | Dosha is the one that provides movement to the |
| | | Dhathus, Malas, Pittha and Kapha. |
| 5. | Pitta | The second of the three humors and is responsible |
| | | for all the metabolic activities going on in the |
| | | body. In its normal state it is responsible for |
| | | proper digestion, normal vision, maintaining |
| | | normal body temperature, giving normal colour |
| | | and complexion to the skin, mental strength and |
| | | intelligence |
| 6. | Kapha | The third humor which gives strength and |
| | | stability to the body. In its normal state Kapha |
| | | holds the body together, gives strength and |
| | | stability to the body, resistance power to the body |
| | | and helps in the smooth and frictionless |
| | | movement of joints |
| 7. | Oushadhi suktha | A part of Atharva veda |
| 8. | Rigveda | One of the four Vedas |
| 9. | Atharva veda | One of the four Vedas |
| 10. | Upaveda | A branch or addition to the main veda. Ayurveda |
| | | is said to be the upaveda of Atharvaveda |
| 11. | Charaka | The greatest author of an Ayurvedic treatise |
| | | known as Charaka samhitha. Charaka represents |
| | | the Atreya school of physicians. |
| 12. | Sushrutha | The great surgical expert of historical times and |
| | | the author of the treatise known as Susrutha |
| | | samhitha. He is credited for developing the |
| | | science of Surgery |
| 13. | Samhitha | Samhitha is a compendium or a treatise. |
| 14. | Prakruthi | Individual body constitution is what is called as |
| | | Prakruti of an individual. Ayurveda lays great |
| | | emphasis on the determination or fixing up of an |
| | | individual's Prakruti before the treatment is advised. |
| 16. | Yin-yang | The basic humors in Chinese system of medicine |
| 17. | Dinacharya | Daily regimen given in Ayurveda that guides |
| | | regarding the things to be done and how throughout |
| | | the day starting from getting upto going to sleep. |
| 18. | Rithucharya | Seasonal regimen given in Ayurveda that gives advise |
| | | regarding the lifestyle to be adopted and the food |
| | | to be partaken during different seasons so as to |
| | | prevent the aggravation of the three basic humors. |
| 19. | Charaka samhitha | The great Ayurvedic treatise and the first one to |
| | | be written by the sage Charaka |
| 20. | Rasa | Taste. According to Ayurveda there are six of them |
| 21. | Guna | The basic characteristics of a material based on |
| | | which its therapeutic activity is determined |
| 22. | Veerya | This is the potency of a medicine. There are |
| | | basically two veerya; one is Ushna i.e. of hot |
| | | potency and the other sheetha i.e. of cold potency. |
| 23. | Vipaka | The metabolic change that occurs in the consumed |
| | | food or medicines, after coming into contact with |
| | | the digestive power (Agni) is defined as the Vipaka. |
| 24. | Prabhava | Prabhava is the specific action of a Dravya, which |
| | | cannot be explained using the parameters of Rasa |
| | | (taste), Veerya (potency) or Vipaka (metabolic changes). |
| 25. | Dhathus | The seven tissues of the human body |
| 26. | Dravyaguna | The characteristics of a medicinal plant are called |
| | | Dravyaguna. This is Charka's classification. |
| 27. | Dashemani | Classification of medicinal plants based on their |
| | | action into ten drugs each. |
| 28. | Ganoushadhi Varga | Grouping of few medicinal plants together to |
| | | achieve a particular medicinal result. This is |
| | | Sushrutha's classification |
| 29. | Madhura rasa | Sweet taste |
| 30. | Amla rasa | Sour taste |
| 31. | Lavana rasa | Salty taste |
| 32. | Katu rasa | Pungent taste |
| 33. | Tiktha rasa | Bitter taste |
| 34. | Kashaya rasa | Astringent taste |
| 35. | Pradhana rasa | Main taste which is felt immediately after tasting |
| | | the substance |
| 36. | Anu rasa | Taste which is felt a few minutes after tasting the |
| | | substance |
| 37. | Tara | Excessive |
| 38. | Tama | Deficient |
| 39. | Sama | Sufficient |
| 40. | Panchabhuthas | Five elements which are space, air, fire, water and earth. |
| 41. | Nadi shasthra | The science of reading a pulse of the human being |
| | | based on traditional methods |
| 42. | Ashta Sthana pareeksha | The examination of a patient at eight parts of the |
| | | body as per traditional methods |
| 43. | Samavayi karanam | An aggravating factor, which resembles the |
| | | property, it is aggravating. |
| 44. | Arogya | Healthy state of human being |
| 45. | Agni | It is Fire, one of the Pancha mahabhootas |
| 46. | Jala | It is water, one of the Pancha mahabhootas |
| 47. | Prithvi | It is earth, one of the Pancha mahabhootas |
| 48. | Vayu | It is air, one of the Pancha mahabhootas |
| 49. | Akasha | It is space, one of the Pancha mahabhootas |
| 50. | Doshakara/vridhi | That which aggravates by increasing the doshas |
| | | i.e. the three humors |
| 51. | Sheeta veerya | Cold potency |
| 52. | Ushna veerya | Hot potency |
| 53. | Sookshma | Minute property of a drug |
| 54. | Sthoola | Opposite of Sookshma i.e. bulky |
| 55. | Laghu | Light or absence of heaviness property of a drug |
| 56. | Guru | Heavy property of a drug |
| 57. | Rooksha | The drying property of a drug |
| 58. | Snigdha | The viscous property of a drug |
| 59. | Sandra | Thick |
| 60. | Drava | The liquid |
| 61. | Kashaya skandha | The grouping of medicinal plants for preparation |
| | | of different decoctions of different medicinal values. |
| 62. | Lekhaneeya | That property of a medicine which helps eliminate |
| | | or scrape the waste material adhering or blocking |
| | | different body channels |
| 63. | Jeevaneeya | That property of a medicinal plant which provides life |
| 64. | Pittha kaphahara | That which has the property to alleviate the |
| | | aggravation of pitha and kapha |
| 65. | Kapha Vatahara | That which has the property to alleviate the |
| | | aggravation of kapha and vatha |
| 66. | Medhya dravya | That medicinal plant which helps promote the intellect |
| 67. | Swasa | Breathlessness or dyspnoea |
| 68. | Sthoulya | Obesity |
| 69. | Pumsavana | The procedure in Ayurveda wherein medicine is |
| | | administered to the pregnant lady on a particular |
| | | stage of the pregnancy to influence the sex of the child |
| 70. | Vata vridhi | That which aggravates vatha dosha |
| 71. | Pitta vridhi | That which aggravates pitha dosha |
| 72. | Anupana | The substance that is given as a part of the main |
| | | medicine to enhance the potency and drug |
| | | delivery of the main drug. For e.g. honey |
| 73. | Rasakriya | It is the process of getting an extract from a crude |
| | | drug in multiple steps. |
| 74. | Kajjali | The mixture of mercury and sulphur, which acts |
| | | as a base for all mineral based drugs |
| 75. | Parpati | Mixture of mercury and sulphur prepared in a |
| | | specific process and wafer thin layers of medicine |
| | | is produced. This is later powdered and used in |
| | | malabsorpive conditions |
| 76. | Srothovarodha | Obstruction of body channels leading to |
| | | deprivation of nutrition to the further body parts. |
| 77. | Panchakarma | The five cleansing procedures advocated by |
| | | Ayurveda, which include emesis, purgation, nasal |
| | | errhines, administration of medicines through the |
| | | rectal route for cleansing the intestines. |
| 78. | Ama | Undigested or partially digested food. |
| 79. | Asoka | Saraca asoka |
| 80. | Amalaki | Emblica officinalis |
| 81. | Punnaga | Calliopfiylluminophyllum |
| 82. | Sarkara | Sugar |
| 83. | Shalmali | Salmalia malabarica |
| 84. | Haritaki | Terminalia chebula |
| 85. | Khadira | Acacia catechu |
| 86. | Kramuka | Areca catechu |
| 87. | Rasna | Pluchea lanceolata |
| 88. | Nagavalli | Pier betel |
| 89. | Agasthya Rasayana | Herbal finished formulation |
| 90. | Sigru | Moringa oleifera |
| 91. | Harirlra | Curcuma longa |
| 92. | Trikatu | Herbal formulation consisting of three |
| | | ingredients, piper longum, piper nigrum and |
| | | Zingiber officinale |
| 93. | Bhunimba | Andrographis paniculata |
| 94. | Sarpagandha | Rauwolfia serpentina |
| 95. | Avartaki | Cassia auriculata |
| 96. | Vasa | Adhatoda vasica |
| 97. | Nimba pallava | Tender leaves of neem(Azadirachta indica) |
| 98. | Brahmi | Bacopa monnieri |
| 99. | Arogyapachha | Tricopus zeylanicum |
| 100. | Kachalavana | A type of salt used in Ayurvedic formulations |
| 101. | Kala Lavana | A type of salt used in Ayurvedic formulations |
| 102. | Souvarchala Lavana | Black salt |
| 103. | Vida Lavana | A type of salt used in Ayurvedic formulations |
| 104. | Saindhava Lavana | Rock salt |
| 105. | Amlika | Tamarind |
| 106. | Apakwa amra | Unripe mango |
| 107. | Nimbula swarasa | Juice of citrus lemon |
| 108. | Vrikshaamla | Garcinia indica |
| [symbol] | [symbol] | Honey |
| 112. | Kiratatiktha | Andrpgraphis paniculata |
| 113. | Bhunimba | Swertia Chirayata |
| 114. | Chitraka | Plumbago zeylanica |
| 115. | Rudraksha | Eleocarpus ganitus |
| 116. | Sahadevi | Vernonia cineria |
| 117. | Mustha | Cyperus rotundus |
| 118. | Aswagandha | Withania somnifera |
| 119. | Chakshushya | Cassia abssus |
| 120. | Yeshtimadhu | Glycirrhiza glabra |
| 121. | Tankana | Borax |
| 122. | Navasagara | Ammonium chloride |
| 123. | Yavakshara | Formulation prepared from hordeum vulgare |
| 124. | Thavaksheeri | East Indian arrowroot, curcuma angustifolia |
| 125. | Pottali | Method of preparation of herbomineral formulation |
| 126. | Khalveeya method | Method of preparation of herbomineral formulation |
| 127. | Vasantha kusumakaram | Herbomineral formulation |
| 128. | FIG. 82-84 | Siddha herbomineral formulations |
| 129. | Bahmani safed | Raw material used in Unani medicinal system |
| 130. | Salab misri | Raw material used in Unani medicinal systemv |
| 131. | Arka murakkab musafdirkhoon | Unani finished formulation |
| 132. | Mandookaparni | Centella asiatica |
| 133. | Goghritham | Cow's ghee |
| 134. | Mahisha ghritham | Buffalo ghee |
| 135. | Pippali | Piper longum |
| 136. | Kushmanda | Benincasa hispida |
| 137. | Bhallathaka | Senecarpus anacardium |
| 138. | Guduchi | Tinospora cordifolia |
| 139. | Murabba of ginger | Preparation using ginger |
| 140. | Shilajith | Black bitumen |
| 141. | Mahaishaksha Guggulu | Commiphora mukul |
| 142. | Rasasindhoora + Pippali + honey | Combination of a herbomineral drug with piper longum and honey |
| 143. | Vidarigandha | Ipomea digitata |
| 144. | Bhallathaka processed with Ishtika chooma | Semecarpus anacardium processed with brick powder |
| 145. | Akarakarabha | Anacyclus pyrethrum |
| 146. | Vata | Ficus bengalensis |
| 147. | Lala nagakeshara | Red variety of Mesua ferrea. |
| 148. | Jeemutha | Luffa echinata |
| 149. | Shivalingi | |
| 150. | Bhumyamalaki | Phyllanthus amarus |
| 151. | Methika leaves | Leaves of Foenoculum vulgare |
| 152. | Pushkaramoola | Inula racemosa |
| 153. | Shatavari | Asparagus racemoses |
| 154. | Krishna thulasi | Black variety of Ocimum sanctum |
| 155. | Lakshmana | Ipomea sepiaria |
| 156. | Lakshmana lauha | An ayurvedic finished formulation |
| 157. | Kantakari | Solanum xanthocarpum |
| 158. | Jeeraka + guda | Combination of jaggery and black caraway seeds |
| 159. | Shunti + guda | Combination of Zingiber officinale with jaggery |
| | | [symbol] |
| 161. | Haridra + lime | Com [symbol] tion of curcuma longa and lime |
| 162. | Hingu + karpoora | Combination of ferula narthex and cinnamomum camphor |
| 163. | Gomutra | Cow's urine |
| 164. | Daruharidra | Berberis aristata |
| 165. | Chopacheenyadi churna | Formulation with smilax china as the main ingredient |
| 166. | Mandoora Vataka | Herbomineral formulation |
| 167. | Arogyavardhini | Herbomineral formulation |
| 170. | Talisadi churna | Herbal formulation |
| 171. | Sitopaladi churna | Herbal formulation |
| 172. | FIG. 69-79 | Herbomineral formulations of Ayurveda |

[symbol]

indicates data missing or illegible when filed

### Meanings of Traditional Terminology used in the Document

### 1. Tikshna (Piercing)

### 2. Ushna (Hot)

### 3. Rakta (Blood)

4. Mamsa (Muscular composition)

### 5. Pitavabhasata (Feeling Yellowish),

### 6. Santapa (Mental Irritation),

7. Sheeta Kamitwam (Feeling Requirement of cold Atmosphere),

### 8. Alpanidrata (Insomnia),

### 9. Murchha (Vertigo),

### 10. Balahani (Weakness),

11. Peetavinmutranetratwa (yellow discoloration of stool, Urine and Eyes),

### 12. Kshudha (Appetite),

### 13. Trushna (Thirst),

### 14. Daha (Hot Feeling of Body).

15. Shaitya (White coloration of Body),

### 16. Gouravatwam (Heaviness of Body),

### 17. Tandra (Laziness),

### 18. Atinidra (Oversleeping),

19. Sandhi-Asthi Shaithilya (Feeling looseness of joints and bones),

### 20. Shlathangatwam (Looseness of Body),

### 21. Shwasa (Asthma),

### 22. Kasa (Cough),

### 23. Vakparushya (Hoarseness of Voice),

### 24. Karshya (Thinness),

25. Karshnya (Black coloration in Body),

### 27. Ushnalamitwam (Feeling Requirement of Hot Atmosphere),

### 28. Nidranasha (Sleeplessness),

### 29. Alpabalatwam (Decreasing Strength),

### 30. Gadhavarchasa (Hardness of Stool),

### 31. Kampa (Tremors),

### 32. Pralapa (Involuntary Talking),

### 33. Bhrama (Vertigo),

### 34. Deenata (Decrease in Excitation).

35. Hayanaka, Yavaka, Naishadha, Mukunda Pramodaka, Sugandhka (Food. Items)

### 36. Chinaka (Indian Millet),

37. Uddhalaka (Puspalum scrobiculatum)

### 38. Mahavrihi (Variety of Rise),

### 39. Navaharenu (Garden Pea),

### 40. Masha (Black Gram),

### 41. Anupa Mamsa (Meat in Marshy Places)

42. Audaka Mamsa (Meat in Watery places)
43. Shaka (Different type of Green Vegetables),

### 44. Tila (Sesame)

45. Palala (Watery products),

### 46. Pistanna (High Carbohydrates Products),

### 47. Payasa (Milky Products),

48. Krishara (Peccary made by Rice and Dal),

### 49. Vilepi (Soup),

### 50. Ikshu (Sugarcane),

### 51. Gudam (Jiggery),

### 52. Sharkara (Sugar),

### 53. Mishri (Sugar Variety).

### 54. Nutan Anna (New Foods)

### 56. Vyayam Tyaga (Avoiding Exercise)

### 57. Asyasukham (Luxurious Life Style),

58. Swapnasukham (Over sleep),

### 59. Dadhini (Curd Products),

### 60. Amla (Sour),

### 61. Lavana (Salty),

### 62. Kshara (Basic),

### 63. Katu (Pungent),

### 64. Ajeerna (Indigestion),

### 65. Agnisantapa (Exposure to Hot),

### 66. Srama (More Physical Work),

### 67. Krodha (Angryness),

### 68. Vishamasana (Irregular Dietary Habits)

### 69. Rusha (Dry),

### 70. Kashaya (Astringent),

### 71. Tiklta (Bitter),

### 72. Laghu (Light),

### 73. Sheeta (Cold),

### 74. Atimaithuna (Excessive sex Indulge),

### 75. Vyayam (Exercise),

### 76. Vamana (Vomiting),

77. Virechana (Loose motions),

### 78. Asthapana (Enema);

79. Shirovirechana (Nasal drops therapy),
80. Vegavarodha (Restrictions to natural urges),

### 81. Jagarana (Sleeplessness),

### 82. Vishamasana,

83. Viruddha Ahara (Incompatible food)
85. Angamarda (Body ache),
86. Vruschik Vedana (Severe pain like Scorpion bite),
87. Kukshou Kathinata (Hard pain in abdomen),

### 88. Shoola (Pain),

### 89. Nidraviparyaya (Disturbed Sleep),

### 90. Vidabaddhatka (Constipation),

### 91. Antrakujan (Gases in Abdomen),

92. Anaha (Fullness of abdomen),
93. Viruddha Chesta (Unnecessary activities)
94. Mandagni (Low appetite)

### 95. Dourbalya (Weakness),

### 96. Gourava (Heaviness),

97. Aruchi (Aversion towards food),

### 98. Alasya (Laziness),

99. Apaka (Not achieved Pakvavastha),
100. Angadourbalya (Weakness in body parts),

### 101. Praseka(Secretion),

102. Utsahahani (No Interest in working),
103. Bahumutrata (frequency of micturation),

### 104. Chhardi (Vomiting),

### 105. Hrudgraha (Congestion in Heart),

### 106. Jadya (Heaviness),

### 107. Guru (Heavy),

### 108. Kandu (Itching),

### 109. Nischesta (No Work)

110. Snigdhabhuktavat (After eating oily food)—Then Vyayam

### 112. Pada (Foot)

### 113. Shira (Vessels)

114. Gulpha (Ankl joint)

### 115. Trika (Sacral)

### 116. Jam (Knee)

### 117. Urasandhi Shunata (Inflamation)

118. Trishna (thirst),

### 119. Jwara (Fever),

### 120. Daha (Burning Sensation),

### 121. Bhrama (Vertigo),

### 122. Murchha (Syncope),

### 123. Raga (Rolar)

### 124. Doshadushya Sammurchhana (Pathology)

### 125. Hetusevana (Causes)

### 126. Ama (Endotoxins)

### 127. Sanchaya (Accumulations)

128. Sthanasamsraya (At one position)

### 129. Shlema (Kapha)

### 130. Amashaya (Stomach),

### 131. Sandhi (Joints),

### 132. Urah (Chest),

### 133. Sheera (Vessels),

### 134. Kantha (Throat)

### 135. Srotasa (Channels)

### 136. Abhishyanda,

### 137. Kleda,

### 138. Pichchhilata

139. Kostha (Hollow organs),

### 142. Raktapitta (Bleeding Disorders)

### 143. Hetu-(Causes)—

### 144. Shoka (Sorrow),

### 145. Adhva (Walking),

146. Vyavaya(Sex indulge)

### 147. Lakshana (Symptoms)—

### 148. Sadana( ),

### 149. Syavaruna (Black-Red Color),

### 150. Safena (Frothy),

### 151. Tnu (Thin),

152. Kanthadhumayana (Feeling like—fumes through throat
153. Lohagandhischa Niswasa (Exhales having irony smell),
154. Kashayabham (looks like decoction)

### 155. Krushna (Black)

### 156. Gomutrasannibham. (Like Cow Urine),

### 157. Mechakagar (Like Frog)

### 158. Anjanabham

### 159. Vami (Vomit)

### 160. Sandra (Thick),

### 161. Sapandu (Whitish),

### 162. Sasneha (Oily),

### 163. Pichchhila (Slimy)

### 164. Vidagdha (Burned)

### 165. Shonitavidaha (Burned Blood)

### 166. Urdhva (Upper)

### 167. Adho (Lower)

168. Shosha (Dryness disease)

### 169. Vardhakya (Old Age),

### 172. Shukrakshaya (Semen Deficiency)

### 173. Pratilomakshaya (Reverse Degenerations)

174. Pradhyana sheel (excessive thinking)

### 175. Srasranga (Involvement)

### 176. Jara (Old)—

### 177. Krishata (Thinness)

### 178. Manda (Slow)

### 179. Veerya (Potency)

180. Bala (energy/Power)

### 181. Buddhi (Memory)

### 182. Indriya (Sense Organs)

### 183. Shareera (Body)

### 184. Kampana (Tremers)

### 185. Aruchi (Dislike of Food)

186. Bhinna kansya patra hataswara (Voice like broken Bronze pot)
187. Sthivati shleshma (Coughing expectorant)

### 188. Gourava (Heavy)

### 189. Shushka (Dry),

### 190. Mala (Waste)

### 191. Shaithilya (Loose)

### 192. Anga (Body Part)

### 193. Bhrustaschhavi (Disturbed Image)

### 194. Prasupta (Numbness)

### 195. Gatra (Body Part)

### 196. Avayava (Body Part),

### 197. Kloma (Bronchus),

### 198. Gala (Neck),

### 199. Mukha(Mouth)

### 201. Aharaniyantrana (Control of Diet)

### 202. Rajayakshma (Tuberculosis)

203. Vegavarodha (Restriction of natural urges),

### 204. Kshaya (Degeneration/Loss),

### 205. Sahasad (Adventure),

206. Angamarda (Body ache),

### 207. Swapna (Sleep/dreams),

208. Ansaparshwapida (Pain at scapular and lateral part of chest),

### 209. Swarabheda (Voice Disease),

### 210. Shoola (Pain),

### 211. Sankocha (Contraction),

### 212. Parshwa (Lateral)

### 213. Talu (Palate),

### 214. Santapa (Burning),

### 215. Karapadayoh (Hands and Legs),

### 216. Shonita (Blood),

### 217. Darshana (Look/Appearance),

### 218. Atiasara (Diarrhoes)

### 219. Swasha (Asthama),

### 220. Sansravana (Secretion),

### 221. Agni (Fire),

### 222. Mada ( )

### 223. Pratishyaya (Rhinitis),

### 224. Kasa (Cough),

### 225. Nidra (Sleep),

### 226. Bhaktadwesha (Hate for Food),

### 227. Shira (Head),

### 228. Paripoornashcha (Complete),

### 229. Abhakta (Without Food),

### 232. Kledaka Kapha (Type of Kapha)

### 233. Dushti (Derrangement)

### 234. Saman Type of Vata)

### 235. Apana (Type of Vata)

### 236. Pachaka Pitta (Type of Pitta)

### 237. Agnimandya (Anorexia)

### 238. Meda (Fat),

### 239. Lasika (Chyle),

### 240. Vasa,

241. Majja (Bone marrow),
242. Dhatwagnimandhya (Anorexia at the level of Dhatu)
243. Dhatu (Body building structure)

### 244. Klinnata (Wateriness)

245. Srotavarodha (Obstruction to the channels)
246. Ksheenaretasa (Less semen)

### 247. Kshaya (Degeneration)

### 248. Atisheetala (Excessive Cold),

### 249. Kukshi (Abdomen)

### 250. Todavedana (Pricking Pain),

### 251. Gatravasada (Body Ache),

### 252. Anilavarodha (Flatulence),

### 253. Vitsanga (Constipation),

### 254. Adhmana (Fullness of Abvdomen),

### 255. Avipaka (Indigestion),

### 256. Fenila (Frothy),

### 257. Muhrmuha (Frquently),

258. Shakrudama (Fecal Material Mixed with Ama),

### 261. Pitam (Yellow),

### 262. Nilam (Blue),

### 263. Raktam (Red),

264. Gudapaka (Inflammation of rectum)

### 265. Krimi (Worms)

### 266. Vinsra

### 267. Visha(Poison)

### 268. Dusheeta (Infected)

### 269. Jala (Water),

### 270. Madya (Wine)

### 271. Satmya (Compatible)

### 272. Varaha (Pig),

### 273. Ambu (Water)

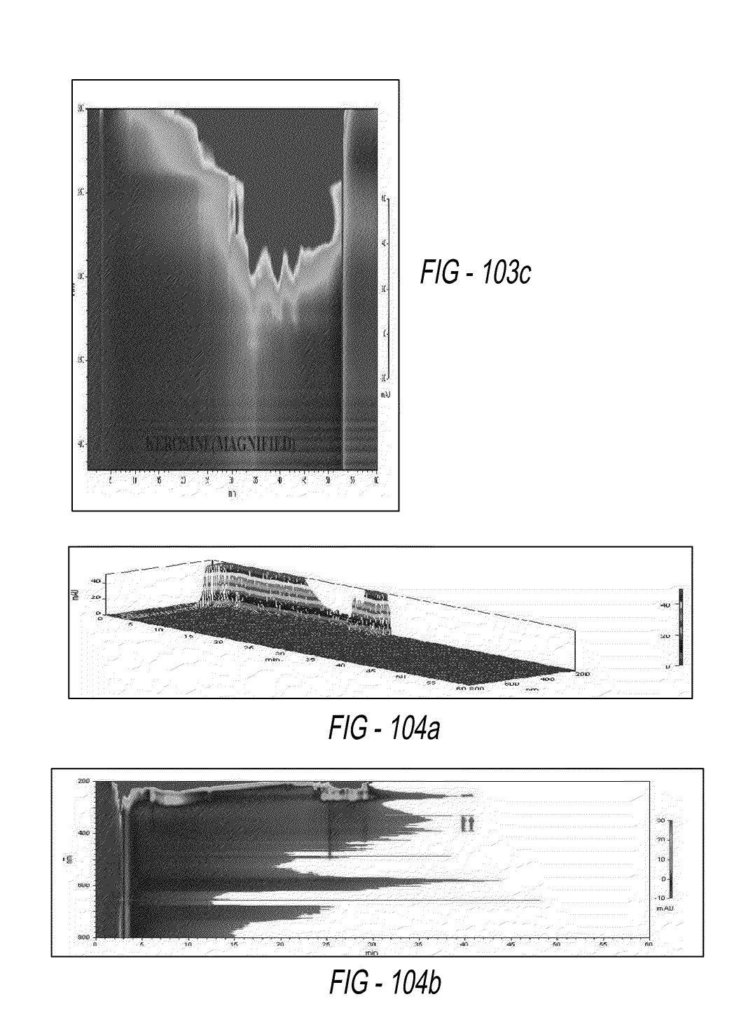

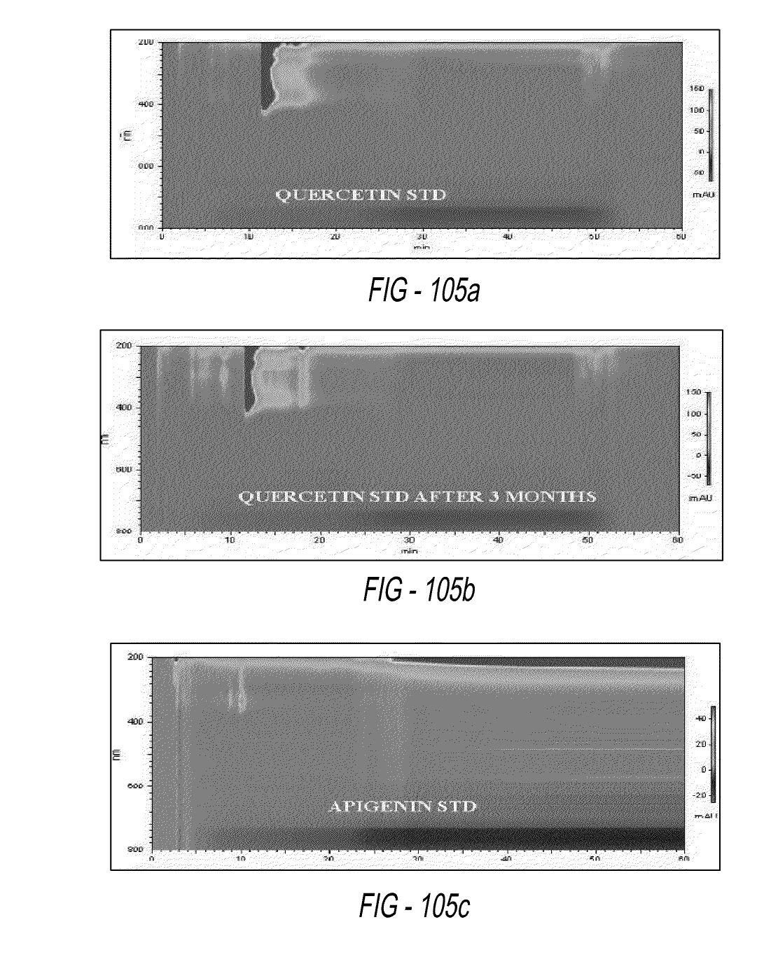

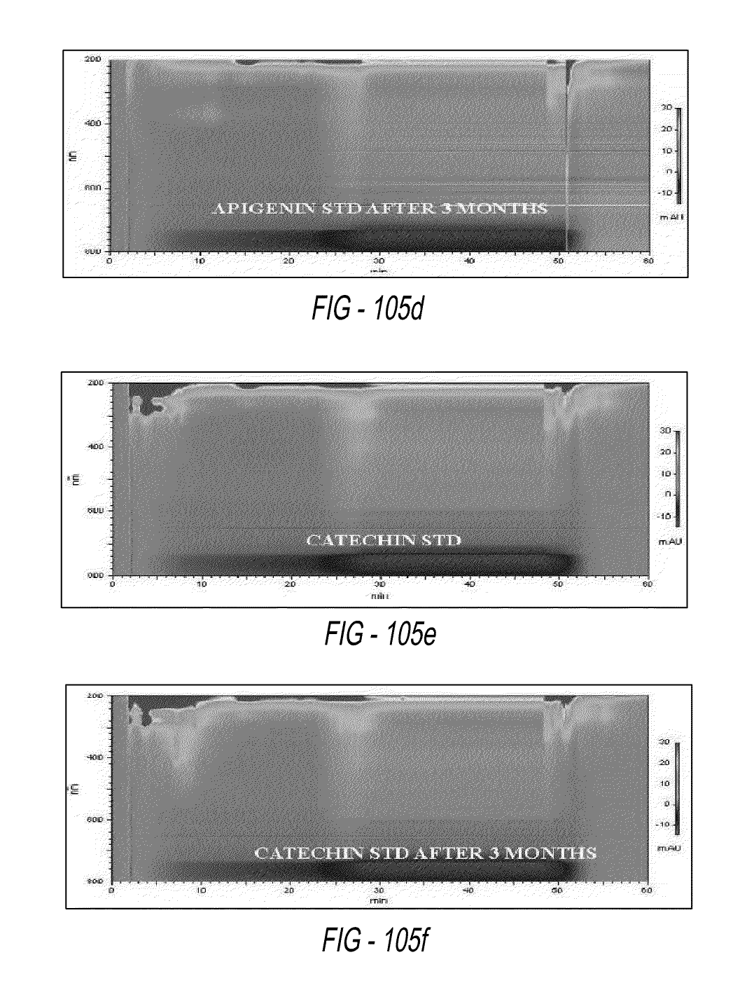

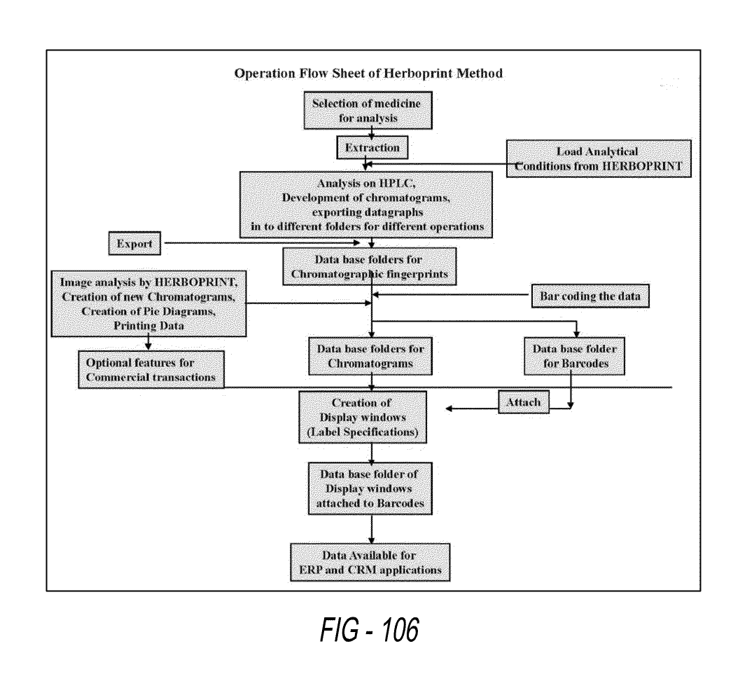

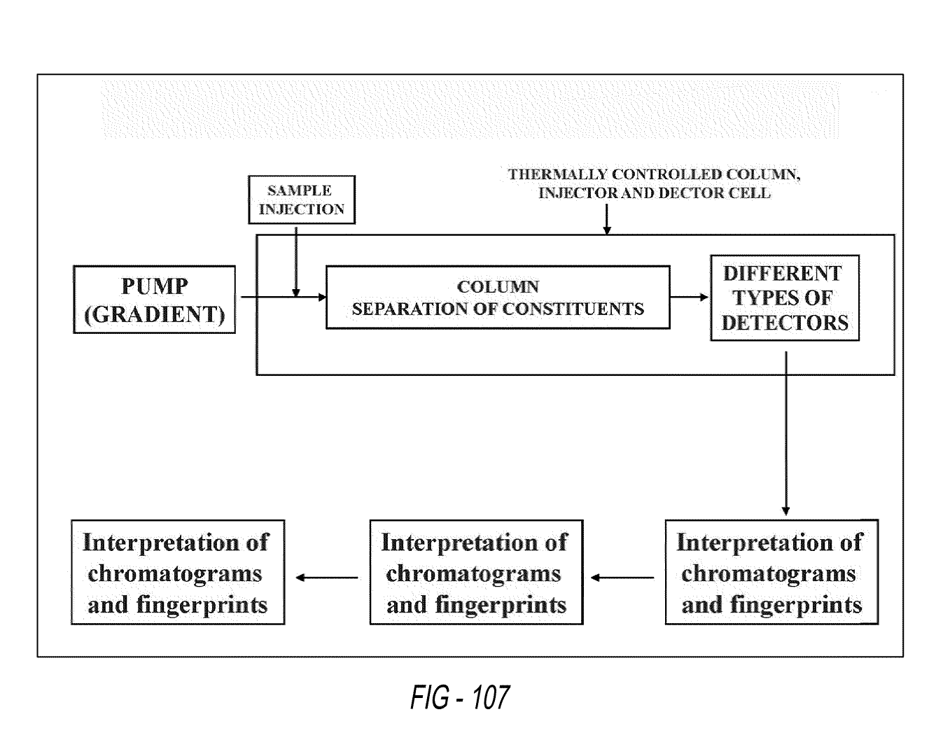

TABLE 26
Comparisons of technical features of PCT/IN00/00123 and present invention

| Sl No. | PCT/IN00/00123 | Present invention |
|---|---|---|
| 1. | In this patent the concept of chemical | In this patent the basic claim of chemical and therapeutic |
| | and therapeutic standardization by the | standardization based on the arrangement of the molecules |
| | arrangement of molecules in a specific | remains the same. But the variation of these absorbance/emission |
| | order of polarity and measuring the | properties due to different influencing factors on the separation |
| | absorbance properties has been claimed | mechanism and the absorption/emission properties on Z-axis has |
| | | been added. |
| | | It this reason it has become an animated data graph. The data of |
| | | the analysis of the same sample will be generated and the varying |
| | | values will be graphed in an animated form. That is how it is a |
| | | different tool than the earlier. |
| 2. | In the flow chart (FIG. 115) of first | Flow chart (FIG. 182) of the second patent shows how right from |
| | patent the main claim of analyzing | the selection of medicine to final stage of creation of databases |
| | the image for a contour chromatogram | for different data is working with each operation. The image |
| | has been claimed. All the components | analysis (Shown with arrow) is the component, which has been |
| | of the flow chart indicate the same. | claimed, in the first patent. |
| | This facility was not available in | The network operations were not claimed again in this patent. |
| | any of the commercial HPLC'S | The data availability for these operations has been clearly |
| | available now. This was our novelty | mentioned in this patent, which were not claimed in |
| | claimed. | the first patent. |
| | In FIG. 116 of network it has been | |
| | shown how the network operations will | |
| | happen after the data is generated | |
| 3. | Basically the use and analysis of | The use and analysis of 2-D and 3-D static data graphs, whose |
| | 2-D and 3-D static images whose | properties are changing and hence presented in the form of |
| | properties are not changing have | a movie, due to the influencing properties on the analytes |
| | been claimed | have been claimed. The energies are moving on the Z-axis, |
| | | absorbance scale of the data graphs. |

INTERPRETATION RULES OF FINGERPRINTS FOR DIFFERENT THERAPEUTIC PROPERTIES

| | | Retenti time in the Fingerprint with a run time of 60 minutes. | |
|---|---|---|---|
| | | The values will be applicable with an average of retention time | |
| | | of ±5 minutes variation. | |
| Sl No. | Property | (The values changes respectively when the run time changes) | |
| 1. | Anti Viral | 0-5 | minutes |
| 2. | Bio enhancers | 5-10 | minutes |
| 3. | Blood purifiers | 8 | minutes |
| 4. | Stress and pain reliever | 12 | minutes |
| 5. | Acting on spleen | 15 | minutes |
| 6. | Acting on Liver | 20 | minutes |
| 7. | Acting on Thyroid | 22 | minutes |
| 8. | Acting on Insulin mechanism | 27 | minutes |
| | and HDL cholesterol mechanism | | |
| 9. | Mass making and breaking | 30 | minutes |
| | (Sandhaneeya and bhedaneeya) | | |
| 10. | Fat metabolism | 32 | minutes |
| 11. | Immunomodulatory | 32-50 | minutes |
| 12. | Immunomodulatory, Energy | 40 | minutes |
| | giving (Jeevaneeya) | | |
| 13. | Potency, Vrishya | 35-55 | minutes |
| 14. | Anti helminthtic | 45-50 | minutes |

| | | |
|---|---|---|
| 15. | Channel obstruction | 45 minutes and 300-500 nm absorbance |

INTERPRETATION RULES OF FINGERPRINTS FOR DIFFERENT CHEMICAL PROPERTIES

| | | How And Where It Appears In The Fingerprint with a run |
|---|---|---|
| | | time of 60 minutes. The values will be applicable with an |
| | | average of retention time of ±5 minutes variation. |
| Sl. No. | Property | (The values changes respectively when the run time changes). |
| Dosha | Pitta | Constituents in the range of retention times 0-20, |
| | | Zone 1 where in 0 is acute and 20 is chronic |
| | Kapha | Constituents in the range of retention times 20-40, |
| | | Zone 2 where in 20 is acute and 40 is chronic |
| | Vata | Constituents in the range of retention times 40-60, |
| | | Zone 3 where in 40 is acute and 60 is chronic |
| Rasa | Kashaya | Constituents in the range of retention times 5-15 Mins |
| | Katu | Constituents in the range of retention times 15-25 Mins |
| | Tikta | Constituents in the range of retention times 25-35 Mins |
| | Lavana | Constituents in the range of retention times 25-35 Mins |
| | Amla | Constituents in the range of retention times 30-40 Mins |
| | Madhura | Constituents in the range of retention times 30-55 Mins |
| Dosha Kara/Vridhi | Pitta, Kapha, Vata | Constituents in individual Zones having an absorbance |
| (Increasing of property) | | from 200-800 nm |
| Dosha Hara (Decreasing | Pitta, Kapha, Vata | Constituents having an absorbance in the range of |
| of property) | | 200-400 nm, The more they absorb beyond 200 to |
| | | 800 the hara property will decrease and the vridhi |
| | | property will increase. |
| Veerya | Sheeta | Constituents having an absorbance range of 200-800 in Zone 1 |
| | Usna | Constituents in the absorbance range of 200-800 in Zone 2 |
| Vipaka | Madhura, Katu etc | As the properties of the tastes have already been |
| | | mentioned, a medicine/biological fluid analyzed after |
| | | Vipaka (Natural or artificially created) will be seen |
| | | at the same time. |
| Guna | Sookshma (Smaller molecules | Smaller molecules in size elute in any zone with an |
| | or absorbing sharply at | absorbance between 200-300 nm |
| | lesser wave lenghths) | |
| | Rooksha (Volatile) | Volatile high polar molecules elute in Zone 1 |
| | Snigdha (Viscous) | The Viscous extracts elute in the Zone 2 |
| | | from 200-800 nm |
| | Guru (Heavy) | The Viscous extracts are heavy and elute in the same Zone 2 |
| | Sandra (Dense) | Highly dense oil samples elute in Zone 3 |
| | Sthoola (Large) | Very Big molecules by size (Parada Gandhaka, Kajjali) |
| | | elute in zone 3 in the range of 35-45 mins Vata zone |

1. A method for determination of chemical and therapeutic properties of constituents of extracts from plants or animals or natural or synthetic sources possessing chemical and medicinal values and to study the variations in chemical and therapeutic properties of analytes of the said extracts capable of responding (absorb or emit) to Electro Magnetic radiation using a 2-D and a 3-D static and animated chromatographic finger printing and generated data chromatogram that are movable from 0-360 degrees in any axis divided into 27 zones or further partitions there of, for chemical and therapeutic standardization where in said, method comprising the steps of: a. generating a 3-D animated chromatogram based on the data of absorbance/emission obtained from a chromatographic instrument under the controlled conditions of chromatographic analysis. b. interpreting the 3-D static and animated data graphs to predict the chemical and therapeutic properties of the analyte sample.

2. A method as claimed in claim 1, wherein the extract is subjected to separation analysis of analytes and chemically surrounding constituents of the analytes atoms/molecules based on pH and polarity under the influence of physico chemical properties like temperature, viscosity and ionic media using a Chromatography technique under experimental conditions.

3. A method as claimed in claim 1, wherein a data processor provides a novel concept of static and animated chromatographic finger printing of herbal medicines that is useful for the quick identification of actual profile of the compounds present in the medicine under use along with their therapeutic efficacy of the constituents.

4. A method as claimed in claim 1, wherein the atoms/molecules are separated using a separation media and arranged in the specific order of polarity along with conjugative property measuring the absorbance, emission, reflection, refraction or diffraction properties of an electromagnetic radiation by the analytes for chemical and therapeutic standardization.

5. A method as claimed in claim 1, wherein the method is useful to assess the healthy or diseased patterns of a human being, animal or a microorganism for different purposes of disease identification, drug selection, drug targeting and drug monitoring.

6. A method as claimed in claim 1, wherein variable factors like temperature, humidity, viscosity, ionic nature, on the physico chemical properties and thus therapeutic efficacy of a medicine is assessed using a 3-D energy box.

7. A method as claimed in claim 6, wherein the 3-D box is a container of three energies wherein the constituents of different properties has specific polarity and energy at any specified time.

8. A method as claimed in claim 6, wherein the 3-D box is the container of the three types of molecules with specific energies where in, the constituents with specific properties of the molecular structure, polarity and conjugation indicated by energy absorbed/emitted, will be indicating the therapeutic efficacy of the constituents and the medicines.

9. A method as claimed in claim 1, wherein the molecules in a sample matrix are separated by means of a separation technique and arrange in a specific order of polarity for chemical and therapeutic standardization based on the polarity and conjugation properties.

10. A method as claimed in claim 1, wherein the 3D animated chromatogram is generated after extracting organic, organo-metallic and metallic atoms or molecules using suitable solvent and subjecting the extract to the separation analysis based on pH and polarity under the influence of physico chemical properties like temperature, viscosity and ionic media using a Chromatography technique under experimental conditions.

11. A method as claimed in claim 1, wherein the contour and 3-D static and animated data graphs are movable in 0-360 degrees on any axis, of the ingredients eluted based on polarity and conjugative properties along with varying energies absorbed/emitted qualitatively and quantitatively and data graphs generated under different chemical and analytical conditions, and then converting the data into a static, animated data graph image.

12. A method as claimed in claim 1, wherein the interpretation includes analyzing the colored image of each of the pixels of x, y, z axis based on the selection of various properties like polarity, mass energy and colors denoting the concentrations of the various constituents eluted with time having a specific energy detected on a detector which can measure the energy absorbed or emitted and generating a chromatogram based on the data, absorbance/emission and color analyzed, having different polarities and energies at various retention times along with different physico chemical properties like conjugative and polarity properties of the analyte constituents eluted with time at different pH and temperatures.

13. A method as claimed in claim 1, wherein the 2-D and 3-D static and animated data graphs are divided into different zones representing a specific energy absorbed/emitted and related to efficacy of the medicine, the division of the image is based on the retention time indicated on X axis, wavelength on Y axis and absorbance of Z-axis, said X, Y and Z-axis are divided into three zones based on polarity, absorbance/emission and variable absorbance/emission qualitatively and quantitatively at specific time and physicochemical conditions.

14. A method as claimed in claim 1, wherein interpretation includes identifying the compounds in the said molecules by the absorptive and emission properties of various constituents in the image related to a specific efficacy due to its action on a specific single or multiple chemical and biological pathways and identifying, determining and classifying the constituents by the absorptive or emission of an electromagnetic, electrical or magnetic energy of the eluted constituents based on physico chemical properties like polar, medium polar and, less or non-polar properties and conjugation for chemical and therapeutic standardization of the sample analyzed.

15. A method as claimed in claim 1, wherein a detector flow cell with thermally varying and controlling facility which change the temperatures as programmed and detect the bathochromic, hypso chromic, hyper chromic and hypo chromic variations of the spectrum at varying analytical conditions, of the samples passing through a thermally controlled flow cell of detector for chromatographic fingerprinting as claimed in claim 1, for chemical and therapeutic standardizations.

16. A method as claimed in claim 1, wherein the said method analyzes a sample at different electromagnetic radiations, polarity, viscosity and temperature using suitable pumps to pump the liquids of mobile phase, having a detector which can measure the absorption or emission properties of analytes samples in a selected range of wavelength, having a data processor generating analysis data before and after coordination and compilation of signals from different types of detectors and analyzing the data for chemical and therapeutic standardization, decrypting and encrypting the data graphs after analysis of data, generating barcode for the data generated after analysis and finally arranging the data in specific data base folders.

17. A method as claimed in claim 1, wherein the physico chemical properties of carrier are varied for eluting the molecules of a sample matrix to be separated on a chromatographic separation media of a planar or closed chromatographic system for chemical and therapeutic standardization by chromatographic fingerprinting.

18. A method as claimed in claim 1, wherein the analytes after separation on a chromatographic system under different conditions of temperature, pH and viscosity are detected with detectors, which are able to detect the mass, fragmentation pattern, conductivity, polarity, refraction, reflection, diffraction, absorptive and emittive properties of the analytes over a range of electromagnetic radiation for chemical and therapeutic standardization of natural, biological and synthetic materials and medicines.

19. A method as claimed in claim 1, wherein the Chemical and therapeutic properties are assessed for a material using the absorbance, emission of the molecules at a specific single or multiple wavelengths of radiation energy ranges to which the matter is exposed.

20. A method as claimed in claim 1, wherein the arrangement of molecules in a specific order of physico chemical properties after separation on a separation media with or with out recycling the eluent molecules either in to the same column or into a battery of separation systems for chemical and therapeutic standardization.

21. A method as claimed in claim 1, wherein the matter is arranged in an order based on their physico chemical properties and kinetics for quantum chemical studies by using an equation E=m.sup.+p C.sup.lamda., wherein m is the mass, p is polarity at specific temperature, pressure at specified time/period of the analytes material and C.sup.lamda. is the speed of the respective radiation for the standardization of matter and radiation for the assessment of the quantum energy they contain

22. A method as claimed in claim 1, wherein analysing using the graphical data patterns of electromagnetic radiations absorbed, emitted, reflected, refracted, interfered, diffracted with the analytes and generating data graph for a sample by a separation method using different properties of the carrier media to separate over a separation media, separating and arranging the constituents in a specific order of polarity along with measured responses of the constituents with interaction of electromagnetic radiations is performed for chemical and therapeutic standardization of material under test.

23. A method as claimed in claim 1, where in the electromagnetic radiations absorbed/emitted by the constituents are presented diagonally opposite to each other on the scales of polarity axis and absorbance, electromagnetic radiation axis of the fingerprint indicating a specific quantum of energy at the specific pixel point dealt by the analytes molecules/molecular fragments.

24. A method as claimed in claim 1, wherein the polarity of the mobile phase of a non-aqueous and an aqueous solvent of a specific pH is controlled by varying the ratio of the mobile phase from 0% to 100% of an aqueous solvents like water or a buffer of a known pH, along with a non-aqueous solvent or vice-versa.

25. A method as claimed in claim 1, said method is carried out using standard analytical parameters like extraction with ethyl alcohol, maintaining a regular run time although the analysis of samples, eluting with a mobile phase of acetonitrile and phosphate buffer having a specific pH range, electromagnetic radiation range using a capable detector, maintaining column, total flow line and detector in a specific temperature range of 15-70.degree. C., a specific conductivity range.

26. A method as claimed in claim 1, wherein same standard analytical parameters like Extraction with same solvent Ethyl alcohol, same run time, same mobile phase acetonitrile along with phosphate buffer in a specific pH in the range of 3-9, same conductivity range of 0-50.times.10.sup.3 mhos and a same range of Electro Magnetic radiation from 200 nm-800 nm is used for Chromatographic Fingerprinting and chemical and therapeutic standardization along with subjecting the samples to different variable analytical factors like pH, temperature, column length, run time and Polarity of the stationary phase and mobile phase and maintaining the same order of arrangement of the molecules based on polarity, and molecular size in the specific order, at a specified time period is the basis of the assessment of chemical and therapeutic quality of the samples under study.

27. A method as claimed in claim 1, wherein the non-aqueous, organic and aqueous, water or buffer at a known temperature, viscosity and pH are solvents used are selected based on the range of temperature, viscosity, pH and polarity required.

28. A method as claimed in claim 1, wherein, same standard analytical parameters like Extraction, run time, mobile phase, range of Electro Magnetic radiation influenced by variable factors like pH, temperature, column length, run time, Polarity of the column, stationary phase and mobile phase, maintaining the same order of arrangement of the molecules based on polarity and molecular size in the specified order are used to achieve chemical and therapeutic standardization.

29. A method as claimed in claim 1 wherein Contour and 3-D static and animated data graphs movable in 0-360 degrees on any axis, of the ingredients eluted based on polarity and conjugative properties along with varying energies absorbed/emitted qualitatively and quantitatively and data graphs are generated under different chemical and analytical conditions.

30. A method as claimed in claim 1, wherein the molecules are eluted in a specific order of polarity with a range of conjugative property using detectors with measurement of emission and absorption of a electromagnetic radiation, conductivity, molecular structure for chemical and therapeutic standardization.

31. A method as claimed in claim 1, wherein the molecules are arranged in a specific order of physico chemical properties for chemical and therapeutic standardization.

32. A method as claimed in claim 1, having the data generated due to the separation of analytes over a separation media leading to chemical and therapeutic standardization of the analytes under test.

33. A method as claimed in claim 1, wherein the non-aqueous, organic and aqueous, water or buffer having specified pH, viscosity and temperature are selected based on the range of pH, viscosity, temperature and polarity required.

34. A method as claimed in claim 1, for chemical and therapeutic standardization based on the pattern of the energy data graphs generated due to the inter action of radiation with matter in a detection system to which the matter is exposed to, after an orderly separation.

35. A method as claimed in claim 1, wherein the atoms/molecules are separated using a chromatographic method of separation and arranged in the specific order of polarity using a separation technique where in the variable parameters like polarity, pH, temperature, ionic and electrical charge and viscosity of the reaction media, mobile phase, stationary phase and sample under analysis which will be varied leading to variations of the Tridosha properties and efficacy of the same.

36. A method as claimed in claim 1, wherein the method provides absorption/emission spectra of the compounds having displayed in the chromatographic fingerprint with conjugative and polarity properties of the molecules and the concentration of the individual concentrations of the molecules along with the polarity of the molecules.

37. A method as claimed in claim 1, wherein converting the data thus obtained in to a static, animated data graph, and analyzing of each of the pixels of x,y,z axis of the data graph, based on the selection of various properties like polarity, mass and energy and colors denoting the concentrations of the various constituents eluted with time having a specific energy detected on a detector which can measure the energy absorbed or emitted.

38. A method as claimed in claim 1 wherein a chromatogram is generated based on the data, absorbance/emission and color analyzed, having different polarities and energies at various retention times along with different physico chemical properties like conjugative and polarity properties of the analyte constituents eluted with time at different pH and temperatures.

39. A method as claimed in claim 1 wherein data is generated in the form of a 2-D and 3-D static and animated data graphs and divided in to different zones representing a specific energy absorbed/emitted and related to efficacy of the medicine, the division of the data graph is based on the retention time indicated on X axis and wavelength indicated on Y-axis and absorbance indicated on Z-axis, said X, Y and Z-axis are divided in to three zones based on polarity, absorbance/emission and variable absorbance/emission qualitatively and quantitatively at specific time and physicochemical conditions.

40. A method as claimed in claim 1, wherein identifying, determining and classifying the constituents by the absorptive or emission of an electromagnetic, electrical or magnetic energy of the eluted constituents is based on physico chemical properties like polar, medium polar and, less or non-polar properties and conjugation for chemical and therapeutic standardization of the sample analyzed.

41. A method as claimed in claim 1, wherein on analysis of 3-D and contour chromatograms using the data processor gives a static and animated data chromatogram and barcode with retention time, wavelength and Absorbance on its X, Y and Z-axis at specified time intervals.

42. A method as claimed in claim 1, wherein the absorption/emission data graphs of the analyte at different wavelengths presented together providing specific pattern of data graphs and data graphs for chemical and therapeutic standardization.

43. A method as claimed in claim 1, wherein the chemical and therapeutic standardization is based on the patterns of the energy data graphs generated due to the inter action of radiation with matter in a detection system to which the matter is exposed to after separating into individual analytes.

44. A method as claimed in claim 1, wherein converting the data comprising the energy absorbed/emitted due to the conjugative property and polarity properties along with quantitative data of the constituents of the medicine under study into a colored 2-D and 3-D static/animated analyzable data graph.

45. A method as claimed in claim 1, wherein the chemical and therapeutic standardization is achieved by interaction of matter to different individual electromagnetic radiations and the data is presented as chromatographic fingerprint.

46. A method as claimed in claim 1, where in the temperature, pH and polarity of the mobile phase is controlled by varying the temperature, the ratio of the mobile phase of a solvent between 0 to 100% of an aqueous solvent like Water or a phosphate buffer at a required pH by using suitable buffer to maintain the required pH, polarity and ending the mobile phase ratios of the solvents at the ratios where they started by a gradient, ternary or quaternary run.

47. A method as claimed in claim 1, wherein the properties of the analytes are based on, division of the data graph in to different therapeutic zones.

48. A method as claimed in claim 1, wherein the chromatographic is employed using a chromatographic apparatus selected from any commercially available High Pressure Liquid Chromatography apparatus with a Photo Diode Array detector, preferably with a gradient, ternary or quaternary system of pumps and having the separation media, injector, sample and detector flow cell in thermally controlled conditions.

49. A method as claimed in claim 45, wherein the chromatographic apparatus is selected from any commercially available HPLC apparatus with the Photo Diode Array detector, and other detectors which can measure the properties like Polarity, structure and Conjugation where in, the system preferably containing with a gradient, ternary or quaternary system of pumps.

50. A method as claimed in claim 1, wherein a detection system which arrays the results of interaction of radiation with matter for the molecules arranged in a specific order of polarity and results in the interpretation of chemical and therapeutic properties of analytes sample.

51. A method as claimed in claim 1, wherein a thermally protected and controlled system containing the separation media of stationary and mobile phases, detector flow cell system along with the flow line to develop chromatographic fingerprinting is used for chemical and therapeutic standardizations.

52. A data processor, which is combination of hardware enabled software for detection and identification of extracts of plant or animal origin, natural or synthetic sources possessing medicinal values able to be assessed by chromatographic fingerprinting as claimed in claim 1 and analysis of static and animated data graphs of an ingredient, said processor comprising: a. an analyzer (extracting colors) for analyzing the static and animated data graph based on the selection of various colors (with standards mentioned in release notes, life cycle, processing) denoting the concentrations of the various constituents eluted with time, polarity based on retention time and energies with respect to a specific energy at a specific pixel point/s as presented in the energy box, said energy box denoting the concentrations and energies of various constituents eluted with time having arranged in a specific order of polarity indicated as retention time; b. an analyzer for analyzing the data graphs of the medicinal extract using properties at different dimensions of the data graph; c. a means for generating a static and 3-D animated data graph movable from 0-360 degrees on any axis, having peaks at various retention times along with conjugative properties of the compounds eluted with time in a specified order of polarity; d. an identifier for identifying the compounds in the said extract by the electromagnetic radiation most preferably Ultra Violet and Visible range, absorptive properties of the various eluted constituents in the data graph; e. a means for correlating the Chemical, biological, bio chemical, bio physical and therapeutic activity of the of various eluted constituents present in the medicinal sample understudy based on the polarity and the conjugative properties of the molecules by dividing the static and 3-D animated data graph movable from 0-360 degrees on any axis, into therapeutic zones on X and Y axis indicated by the coordinates of the pixels equivalent to scale of retention time; f. a means capable of identifying the chemical and therapeutic properties of the constituents in the said materials (natural or synthetic) by the absorptive or emission properties of various constituents in the data graph; g. a means for generating a barcode for a selected peak(s) using the data graph coordinates viz., retention time, wavelength and Absorbance on its X, Y and Z-axis, R for number of red pixels, G for number of green pixels and B for number of blue pixels, provided by the proposed software; h. a means for generating a database of Chromatographic Fingerprints and barcodes for the samples, facilitating all kinds of database utilities like Enterprise Resource Planning (ERP) and Customer Resource Management (CRM) applications; and i. a means for generating a database of the ‘display windows’ for all the samples to be used by the ENTERPRISE RESOURCE PLANNING (ERP) and CUSTOMER RELATIONSHIP MANAGEMENT (CRM) type of business applications

53. A data processor as claimed in claim 78, wherein said software is having the following features: a. a means with a facility of opening chromatographic fingerprint data graphs in different Formats (extensions) like static BMP, JPEG, TIF, GIF data graphs and animated movies of AVI and MPEG formats from the file folders and analyze it for different colors present in the data graph with single pixel sensitivity; b. a means with a facility of display of the pixel information in the form of 1. a graph having a scale of X (0-(min. time scale) and Y (200-800 nm) coordinates and 2. a Pie diagram with individual values of each peak (Automatic and Manual) in two separate columns beside the graph; c. a means with a facility of printing all the data generated after analysis using PRINT Icon; d. a means with a facility of changing the page setup for printing using PAGE SETUP Icon; e. a means with a facility of selecting a part of the data graph and analyze using RESIZE Icon; f. a means with a facility of opening any number of data graph analysis windows for different data graphs, and display of status in WINDOW icon; g. a means with a facility of dividing the data graph in to three Zones at 20 min interval, using ZONE icon; h. a means with a facility of inverting the selected data graph using INVERT icon; i. a means with a facility of switching over to Notepad, Word pad and MS Word, using EDITOR icon; j. a means with a facility of operational information about various features of the Software using, the HELP icon; and k. a means with a facility of saving the data generated using SAVE AS icon as JEPG file format.

54. A data processor as claimed in claim 80, wherein an inbuilt embedded software provides a novel chromatographic finger printing of herbal medicines and formulations analyzed and are developed on a electromagnetic radiation detector like Photo Diode array Detector (PDA) connected to a chromatographic instrument like High Pressure Liquid Chromatograph, which delineates the data of the spectral properties of the constituents present in the material having the medicinal value, presented in a specific order of physico chemical properties like polarity along with conjugation generated under similar experimental analytical conditions.

55. A method as claimed in claim 1, wherein the measurement of absorbance energy indicates the activity of a constituent in absorbing the respective quantum of energy at a specific X, Y, Z coordinate points of the energy system with specific polarity and conjugative properties indicated by absorbance/emission of energy from the biological samples of diseased conditions making to cure the disease pattern and hence therapeutically indicative.

56. A method as claimed in claim 1, wherein the therapeutic efficacy of a medicine (Single or formulated) is assessed using the quality of the constituents present in a particular polarity and radiation absorptive or emission X, Y and Z coordinate points in any of zone of the static/animated Chromatographic Fingerprint at specified physico chemical and analytical conditions at a specified time.

57. A method as claimed in claim 1, where in the respective zones and X, Y and Z coordinates of the constituents have a specific property of chemical and therapeutic efficacy of the analytes constituents present in a medicine.

58. A method as claimed in claim 1, wherein influence of variable factors like temperature, pressure, pH and viscosity of the mobile phase, stationary phase and sample will be influenced to arrange the atoms and molecules in a specific order of polarity whose conjugation and molecular structure is analyzed along, with conductivity for the chemical and therapeutic standardization.

59. A method as claimed in claim 1, wherein the inter and intra correlations of molecules of different polarities is assessed when they are arranged in the order of polarity.

60. A method as claimed in claim 1, wherein the 3-D box is the container of the three energies where in the constituents of Fire (Agni) in nature or in the first zone of the Chromatographic Fingerprint, water (Jala) property in the second zone of the Chromatographic Fingerprinting and earth (Prithvi) in the last zone. The Air (Vayu) is present in the last zone and in the area where in there in no constituents were present in the entire container where in the container is indicative of space (Akasha) property.

61. A method as claimed in claim 1, wherein the data processor is capable of interpreting constituents between 0-20 minutes as high polar (Pitta) in nature which are in Zone 1 of the data graph wherein 0 minutes acts on acute and 20 acts on chronic conditions.

62. A method as claimed in claim 1, wherein the data processor is capable of interpreting constituents in the range of retention times 20-40 minutes, as medium polar (Kapha) in nature which are in Zone 2 of the data graph where in the constituents at 20 min acts on acute and 40 min acts on chronic conditions.

63. A method as claimed in claim 1, where in the data processor is capable of generating a chromatogram based on the color analyzed (extracted from finger print using a Graphic User Interface software developed), having peaks at various retention times along with different physico chemical properties like conjugative and polarity properties of the analytes constituents eluted with time.

64. A method as claimed in claim 1, wherein the data processor is capable of interpreting constituents in the range of retention times 40-60 minutes as non-polar (Vata) in nature which are in Zone 3 of the data graph where in constituents at 40 minutes acts on acute and 60 minutes is chronic conditions.

65. A method as claimed in claim 1, wherein the data processor is capable of interpreting constituents in the range of retention times 5-15 minutes as Astringent (Kashaya), in nature which are in Zone 1 of the data graph.

66. A method as claimed in claim 1, wherein the Astringent is capable of interpreting constituents in the range of retention times 15-25 minutes, as Pungent (Katu) in nature which are in Zone 1 and 2 of the data graph.

67. A method as claimed in claim 1, wherein the data processor is capable of interpreting constituents in the range of retention times 25-35 minutes, as Bitter (Tikta), in nature which are in Zone 2 of the data graph.

68. A method as claimed in claim 1, wherein the data processor is capable of interpreting constituents in the range of retention times 25-35 minutes, as Salty (Lavana), in nature which are in Zone 2 of the data graph.

69. A method as claimed in claim 1, wherein the data processor is capable of interpreting constituents in the range of retention times 30-40 minutes, as Sour (Amla), in nature which are in Zone 2 and 3 of the data graph.

70. A method as claimed in claim 1, wherein the data processor is capable of interpreting constituents in the range of retention times 35-55 minutes, as sweet/post assimilative (Madhura), in nature which are in Zone 2 and 3 of the data graph.

71. A method as claimed in claim 1, wherein the data processor is capable of interpreting constituents absorbing from 200-800 nm, as dosha kara/Vridhi/increase, in nature which are in y axis of Zone 1, 2 and 3 of the data graph, when a sample is analyzed on a separation media and molecules arranged in an order of polarity.

72. A method as claimed in claim 1, where in the data processor is capable of interpreting constituents absorbing from 200-400 nm, as decrease of respective conjugative property said to be decreasing (Dosha hara), in nature which are in Zone 1, 2 and 3 of the data graph, when a sample is analyzed on a separation media and molecules arranged in an order of polarity.

73. A method as claimed in claim 1, wherein the data processor is capable of interpreting constituents absorbing from 200-800 nm, as increase of respective property cold (Sheeta Veerya), in nature which are in Zone 2 of the data graph when a sample is analyzed using a separation media after the molecules arranged in an order of polarity.

74. A method as claimed in claim 1, wherein the data processor is capable of interpreting constituents absorbing from 200-800 nm, as increase of respective property will be hot (Ushna Veerya), in nature which are in Zone 1 of the data graph when a sample is analyzed on a separation media and molecules arranged in an order of polarity.

75. A method as claimed in claim 1, wherein the data processor is capable of interpreting the Post assimilative (Vipaka) property, which is absent before and present after interacting with the media/biological system in which it is present.

76. A method as claimed in claim 1, wherein the data processor is capable of interpreting the (Sookshma property), Smaller molecules lesser conjugative or absorbing sharply at lesser wave lengths, which are in different Zones of the data graph, when a sample is analyzed on a separation media and molecules arranged in an order of polarity.

77. A method as claimed in claim 1, wherein the data processor is capable of interpreting the dry (Rooksha), Volatile molecules, property based on the absorption spectra and polarity of the ingredients which are in different Zones of the data graph when a sample is analyzed on a separation media and molecules arranged in an order of polarity.

78. A method as claimed in claim 1, where in the data processor is capable of interpreting the (Snidha) Viscous medium to non polar molecules, property based on the absorption spectra of 200-800 nm and polarity of the ingredients in Zone 1, 2 and 3 of the data graph when a sample is analyzed on a separation media and molecules arranged in an order of polarity.

79. A method as claimed in claim 1, wherein the data processor is capable of interpreting the lighter (Laghu) property based on the absorption spectra, polarity and less number of ingredients in Zone 1, 2 and 3 of the data graph, when a sample is analyzed on a separation media and molecules arranged in an order of polarity.

80. A method as claimed in claim 1, wherein the data processor is capable of interpreting the heavy (Guru) property based on the absorption spectra, polarity and large number of ingredients in Zone 1, 2 and 3 of the data graph, when a sample is analyzed on a separation media and molecules arranged in an order of polarity.

81. A method as claimed in claim 1, wherein the data processor is capable of interpreting the semisolid (Sandra) property based on the absorption spectra of 200-800 nm and polarity of the ingredients in different Zones of the data graph, when a sample is analyzed on a separation media and molecules arranged in an order of polarity.

82. A method as claimed in claim 1, wherein the data processor is capable of interpreting the heavy (Sthoola) molecules with broad absorption property based on the absorption spectra and polarity of the ingredients in different Zones of the data graph when a sample is analyzed on a separation media and molecules arranged in an order of polarity.

83. A method as claimed in claim 1, wherein the data processor is capable of interpreting the chemical and therapeutic property of the analytes based on the 3-D and contour chromatographic fingerprints developed due to the interaction of radiation with matter and the data graph divided in to different zones and marked with respective therapeutic property based on specific X, Y and Z coordinates of the data graph or movie movable on all axis between 0-360 degrees, wherein the retention time value is not a limitation.

84. A tool for identifying disease employing method as claimed in claim 1, wherein the data processor is capable of interpreting diseased condition as anti viral for retention time of 0 to 5 minutes; as bio-enhancer for retention time of 5-10 minutes; as potency (vrishya) for retention time of 35 to 55 minutes; as anti helminthtic for retention time of 45 to 50 minutes; as channel obstruction for retention time of 45 minutes and 300 to 500 nm absorbance and as immunomodulatory for retention time of 32 to 50 minutes with a run time of 60 minutes.

85. A tool for identifying disease employing method as claimed in claim 84, wherein range of retention time identifying the diseased condition varies by varying the said run time.
